(19) United States
(12) Patent Application Publication
(10) Pub. No.: US 2011/0263454 A1
(43) Pub. Date: Oct. 27, 2011

(54) Methods of Identifying Functional Characteristics of Promoters, Transcription Modifying Proteins and Transcription Modulating Agents

(75) Inventors: Johan W. Jonker, Groningen (NL); Michael Downes, San Diego, CA (US); Ronald M. Evans, La Jolla, CA (US)

(73) Assignee: Salk Institute for Biological Studies, L Jolla, CA (US)

(21) Appl. No.: 13/061,500

(22) PCT Filed: Aug. 28, 2009
(86) PCT No.: PCT/US09/55441

§ 371 Date: Jul. 14, 2011

Related U.S. Application Data
(60) Provisional application No. 61/190,500, filed on Aug. 29, 2008.
(60) Provisional application No. 61/190,547, filed on Aug. 28, 2008.

(51) Int. Cl. C40B 30/06; C40B 60/12

(52) U.S. Cl. 506/10; 506/39

(57) ABSTRACT

Provided herein is, inter alia, methods and compositions useful in therapeutic interrogation of complex physiologic pathways by massively parallel and permissive transcriptional screening. Thus, methods and compositions are provided herein that are useful for high-throughput functional analysis of complex, transcriptionally regulated physiological pathways. While examples are provided relating to nuclear receptors, the methods and composition can be generalized and applied to any class of transcription factor or any class of gene product that can regulate the activity of transcription. For example, in addition to nuclear receptors, the methods and compositions provided herein are generally applicable to all known transcription factors and any gene encoded product that modulates said transcription factor activity. Moreover, data obtained through the methods provided herein are directly comparable thereby facilitating high-throughput functional analysis.

### CROSS-REFERENCES TO RELATED APPLICATIONS

This application is a national stage application under 37 U.S.C. §371 of International Application No. PCT/US2009/055441, filed Aug. 28, 2009, which claims the benefit of U.S. Provisional Application No. 61/190,547, filed Aug. 28, 2008, and U.S. Provisional Application No. 61/190,500, filed Aug. 29, 2008, all of which are incorporated herein by reference in their entireties and for all purposes.

### STATEMENT AS TO RIGHTS TO INVENTIONS MADE UNDER FEDERALLY SPONSORED RESEARCH OR DEVELOPMENT

The invention was made with United States Government support under grant number U19 DK62434 from the National Institutes of Health. The United States Government has certain rights in the invention.

### BACKGROUND OF THE INVENTION

Transcription factors present a growing area of possible therapeutic targets for novel drugs and treatments for a myriad of medical conditions. Particular classifications of transcription factors such as nuclear receptors are of particular interest. As opposed to integral membrane receptors or membrane-associated receptors, nuclear receptors typically reside in either the cytoplasm or nucleus of eukaryotic cells. The nuclear receptor superfamily includes numerous proteins that specifically bind physiologically relevant small molecules, such as hormones, vitamins, fatty acids or the like. Binding of an agonist or antagonist to a nuclear receptor induces the receptor to drive the transcription of particular nucleic acid regions under control of a transcription element in the cell in a positive or negative way.

The biology and physiology of some nuclear receptors has been characterized. For example, known and characterized nuclear receptors include those for glucocorticoids (GRs), androgens (ARs), mineralocorticoids (MRs), progestins (PRs), estrogens (ERs), thyroid hormones (TRs), vitamin D (VDRs), retinoids (RARs and RXRs), and the peroxisome proliferator activated receptors (PPARs) that bind eicosanoids. However, the nuclear receptor superfamily also includes “orphan receptors” that are structurally homologous to classic nuclear receptors, such as steroid and thyroid receptors, but for which ligands have not been identified.

Nuclear receptors are involved in a myriad of physiological processes and medical conditions such as hypertension, heart failure, atherosclerosis, inflammation, immunomodulation, hormone dependent cancers (e.g. breast, thyroid, and prostate cancer), modulation of reproductive organ function, hyperthyroidism, hypercholesterolemia and other abnormalities of lipoproteins, diabetes, osteoporosis, mood regulation, mentation, and obesity. Therefore, it would be advantageous to determine and characterize interactions between transcription factors, their modulation and potentially relevant promoters as a means to develop novel classes of drugs to treat disease by controlling transcription. It would also be advantageous to determine and characterize pathways involving nuclear receptors, other classes of transcription factors, cell signaling modulators of NRs and transcription factors (e.g., chromatin epigenetic modifiers such as histone acetyltranferases, deacetylases, kinases, methylransferases etc.) and other signaling molecules that transmit functional changes to the transcription machinery. Moreover, it would be helpful to develop modulators of these interaction such as novel pharmaceuticals.

One limitation in developing methods and compositions to accomplishing these advantages is that while all cells contain all genes, each cell type in the body expresses only a sub set of these genes. Physiology and cell identity is thus dependent on differential control of selective gene networks. Thus, for example, neuronal genes are expressed in neurons and hepatic genes are expressed in the liver. Interrogation of cell specific promoters as therapeutic targets has been thought to require the relevant cell type (e.g., neuron, liver, muscle, fat, heart, etc.) potentially corresponding to every cell type in the body. Thus, a permissive scanning approach is needed to allow use of one or a few easy to manipulate cell types to screen most if not all promoters independent of natural cell type restrictions.

The methods and compositions provided herein fulfill these and other needs in the art.

### BRIEF SUMMARY OF THE INVENTION

Methods and compositions are provided herein that are, inter alia, useful in therapeutic interrogation of complex physiologic pathways by massively parallel and permissive transcriptional screening. Thus, methods and compositions are provided herein that are useful for high-throughput functional analysis of complex, transcriptionally regulated physiological pathways. While illustrated for nuclear receptors, the methods and composition can be generalized and applied to any class of transcription factor or any class of gene product that can regulate the activity of transcription. Thus, for example, in addition to nuclear receptors, the methods and compositions provided herein are generally applicable to all known transcription factors and any gene encoded product that modulates said transcription factor activity. Moreover, data obtained through the methods provided herein are directly comparable thereby facilitating high-throughput functional analysis.

In one aspect, a method is provided of identifying a functional characteristic of a nucleic acid promoter sequence (e.g. a test nucleic acid promoter sequence). The nucleic acid promoter sequence may have a functional characteristic that is not known (either fully unknown or partially unknown) or is merely hypothesized (herein referred to as a “nucleic acid promoter sequence of unknown function” or a “nucleic acid promoter sequence not having a known functional characteristic”). The method includes transfecting a reporter cell with a nucleic acid promoter sequence linked to a nucleic acid reporter sequence. The reporter cell is transfected with a nucleic acid driver sequence encoding a transcription modifying protein. The transcription modifying protein may have a functional characteristic that is known (herein referred to as a “transcription modifying protein of known function” or a “transcription modifying protein having a known functional characteristic”). Transcription of the nucleic acid reporter sequence is detected thereby identifying the functional characteristic of the nucleic acid promoter sequence (e.g. a nucleic acid promoter sequence of unknown function).

In another aspect, a method of identifying a functional characteristic of a transcription modifying protein (e.g. a test transcription modifying protein) is provided. The transcription modifying protein may have a functional characteristic that is not known (either fully unknown or partially unknown) or is merely hypothesized (herein referred to as a “transcription modifying protein of unknown function” or a “transcription modifying protein not having a known functional characteristic”). The method includes transfecting a reporter cell with a nucleic acid promoter sequence linked to a nucleic acid reporter sequence. The nucleic acid promoter sequence may have a functional characteristic that is known (herein referred to as a “nucleic acid promoter sequence of known function” or a “nucleic acid promoter sequence having a known functional characteristic”). The reporter cell is transfected with a nucleic acid driver sequence encoding a transcription modifying protein (e.g. a transcription modifying protein of unknown function). Transcription of the nucleic acid reporter sequence is detected thereby identifying the functional characteristic of the transcription modifying protein.

In another aspect, a method is provided for identifying a functional characteristic of a nucleic acid promoter sequence (e.g. a test nucleic acid promoter sequence). The nucleic acid promoter sequence may be a nucleic acid promoter sequence of unknown function (i.e. not having a known functional characteristic). The method includes transfecting (each of) a plurality of reporter cells with the nucleic acid promoter sequence linked to a nucleic acid reporter sequence (i.e. each of the plurality of reporter cells are transfected with a nucleic acid promoter sequence linked to a nucleic acid reporter sequence having the same promoter and reporter sequences). The plurality of reporter cells is transfected with a nucleic acid driver sequence encoding a transcription modifying protein of known function (i.e. having a known functional characteristic) or a transcription modifying protein that forms part of a family of transcription modifying proteins. Each of said plurality of reporter cells is transfected with a different nucleic acid driver sequence encoding a transcription modifying protein (i.e. each of the plurality of reporter cells is transfected with a nucleic acid driver sequence encoding a different transcription modifying protein). Transcription of the nucleic acid reporter sequence is detected in at least one of the plurality of reporter cells thereby identifying the functional characteristic of the nucleic acid promoter sequence. One of skill will immediately recognize that known functional characteristics of the transcription modifying proteins or family of transcription modifying proteins may be correlated to the nucleic acid promoter sequence thereby identifying the functional characteristic of the nucleic acid promoter sequence.

In another aspect, a method is provided for identifying a functional characteristic of a nucleic acid promoter sequence (e.g. a test nucleic acid promoter sequence). The nucleic acid promoter sequence may be a nucleic acid promoter sequence of unknown function (i.e. not having a known functional characteristic). The method includes transfecting (each of) a plurality of reporter cells with the nucleic acid promoter sequence linked to a nucleic acid reporter sequence (i.e. each of the plurality of reporter cells are transfected with a nucleic acid promoter sequence linked to a nucleic acid reporter sequence having the same promoter and reporter sequences). The plurality of reporter cells is transfected with a nucleic acid driver sequence encoding a transcription modifying protein, wherein each of the plurality of reporter cells is transfected with a different nucleic acid driver sequence encoding a transcription modifying protein (i.e. each of the plurality of reporter cells is transfected with a nucleic acid driver sequence encoding a different transcription modifying protein). Transcription of the nucleic acid reporter sequence is detected in at least one of the plurality of reporter cells thereby obtaining a transcription modifying protein interaction profile for the nucleic acid promoter sequence. The transcription modifying protein interaction profile for the nucleic acid promoter sequence is compared to a plurality of transcription modifying protein interaction profiles for a plurality of nucleic acid promoter sequences of known function thereby identifying a functional characteristic of the nucleic acid promoter sequence.

In another aspect, a method is provided for identifying a functional characteristic of a transcription modifying protein (e.g. a test transcription modifying protein). The transcription modifying protein may be a transcription modifying protein of unknown function (i.e. not having a known functional characteristic). The method includes transfecting (each of) a plurality of reporter cells with the nucleic acid driver sequence encoding a transcription modifying protein (i.e. each of the plurality of reporter cells are transfected with the same nucleic acid driver sequence encoding the same transcription modifying protein). The plurality of reporter cells is transfected with a nucleic acid promoter sequence of known function (i.e. having a known functional characteristic) linked to a nucleic acid reporter sequence or a nucleic acid promoter sequence linked to a nucleic acid reporter sequence wherein the nucleic acid promoter sequence forms part of a family of a nucleic acid promoter sequences. Each of said plurality of reporter cells is transfected with a different nucleic acid promoter sequence linked to a nucleic acid reporter sequence. Transcription of the nucleic acid reporter sequence is detected in at least one of the plurality of reporter cells thereby identifying the functional characteristic of the nucleic acid promoter sequence. One of skill will immediately recognize that the functional characteristics of the nucleic acid promoter sequence of known function or family of nucleic acid promoter sequence of known function may be linked to the nucleic acid driver sequence encoding a transcription modifying protein (e.g. the test transcription modifying protein) thereby identifying the functional characteristic of the transcription modifying protein.

In another aspect, a method is provided for identifying a functional characteristic of a transcription modifying protein (e.g. a test transcription modifying protein). The transcription modifying protein may be a transcription modifying protein of unknown function (i.e. not having a known functional characteristic). The method includes transfecting (each of) a plurality of reporter cells with the nucleic acid driver sequence encoding a transcription modifying protein (i.e. each of the plurality of reporter cells are transfected with the same nucleic acid driver sequence encoding the same transcription modifying protein). The plurality of reporter cells is transfected with a nucleic acid promoter sequence of known function (i.e. having a known functional characteristic) linked to a nucleic acid reporter sequence or a nucleic acid promoter sequence linked to a nucleic acid reporter sequence wherein the nucleic acid promoter sequence forms part of a family of a nucleic acid promoter sequences. Each of the plurality of reporter cells is transfected with a different nucleic acid promoter sequence linked to a nucleic acid reporter sequence. Transcription of the nucleic acid reporter sequence in at least one of the plurality of reporter cells is detected thereby obtaining a nucleic acid promoter sequence interaction profile for the transcription modifying protein. The nucleic acid promoter sequence interaction profile for the transcription modifying protein is compared to a plurality of nucleic acid promoter sequence interaction profiles for a plurality of transcription modifying proteins of known function thereby identifying a functional characteristic of the transcription modifying protein.

In another aspect, a kit is provided for identifying a functional characteristic of a transcription modifying protein or a functional characteristic of a nucleic acid promoter sequence. The kit includes a multi-well plate, a plurality of reporter cells; and a library of nucleic acid promoter sequences linked to a nucleic acid reporter sequence or a library of nucleic acid driver sequence encoding a transcription modifying protein. Multi-well plates, libraries of nucleic acid promoter sequences linked to a nucleic acid reporter sequence and libraries of nucleic acid driver sequence encoding a transcription modifying protein are described above in the description of methods of the present invention, and are equally applicable to the kits provided herein.

### BRIEF DESCRIPTION OF THE DRAWINGS

FIG. 1 depicts a schematic wherein an NHR is coexpressed with a promoter or synthetic response element fused to the luciferase gene. Co-expression of a NHR with a promoter or synthetic response element fused to the luciferase gene allows for the detection of NHR-mediated transcriptional regulation.

FIG. 2 provides results obtained from the experimental approach depicted in FIG. 1 that confirm known NHR-promoter regulations: a) Specific and strong activation of the Constitutive Androstane Receptor (CAR) promoter by Nuclear Receptor HNF4-alpha; b) specific and strong activation of the SREBP1c promoter by Nuclear Receptors LXR-alpha and -beta; c) specific activation of the Bmal1 promoter by Nuclear Receptors ROR-alpha and ROR-gamma, and specific repression by Rev-Erb-alpha and Rev-Erb-beta.

FIG. 3 provides an illustration of an unsupervised hierarchical two-dimensional cluster analysis of selected promoters and nuclear receptors. Each row represents a NHR with or without ligand (total of 80 variables), and each column represents a single promoter that facilitates transcription of the indicated gene. As shown in the legend bar, lighter shade represents upregulation, grayer shade downregulation, and black no change. The row entries of FIG. 3, read from top to bottom and using customary nomenclature in the art, are the following: SF-1, LRH-1, PPARg ligand, ERR3, Era ligand, ERR2, TR4, LXRa ligand, LXRa, HNF4a, RURb, RURa, FXRb, FXRb ligand, PPARg, FXR ligand, PXR, Era, RARb, RARg, RARa, NR4a1, AR ligand, AR, TR2, RARb ligand, RARg ligand, RARa ligand, RXRg ligand, RXRa ligand, LXRb, LXRb ligand, PPARa ligand, PPARa, RORg, RORa, CTF2, CTF1 CTF3, PPARd ligand, PPARd, TRb2, RORb, PR, DAX-1, control 1, control 2, ERR1, GCNF, SHP, UDR, FXR, TRb1, RXRa, TRa2, TRa2 ligand, HNF4g, Erb, Erb ligand, NR4a2, NR4a3, UDR ligand, TRb2 ligand, TRb1 ligand, PXR ligand, CAR, CAR ligand, TLX, PNR, GR, hMR, hMR ligand, RXRg, RXRb ligand, RXRb, TRa1 ligand, TRa1, PR ligand, and GR ligand. Promoters referenced in FIG. 3, read from left to right, include promoters that facilitates transcription of the following genes: mSREBP1, mABCA1, mPgc1b, hPPARg1, hMDR1, mPer1, hCYP3A4, mBmal1, mLeptin, mNPY, mAdipo, hPPARg2, mGrelin, mDio1, hINFg, mDio2, mUCP3, mCAR, hCAR, mUCP, mRevErba, mADRP, hMyoD, hTNFa, mPOMC, mAgrp, mUCP2, hG6PD, and hIRF7.

FIG. 4 provides a schematic of the transcriptional regulation of Bmal1. The Nuclear Hormone Receptors Rev-erbα and RORα are an integral component of the circadian feedback loop. Rev-erbα represses and RORα activates transcription of Bmal1. In turn, Rev-Erbα and RORα are transcriptionally regulated by Bmal1/Clock through interaction with the E-box element present in their respective promoters.

FIG. 5 provides a schematic depicting the results of experiments performed to identify the NHRs that regulate the transcription of the Per1 and Rev-erbα genes. Functional Promoter Analysis reveals novel NHR mediated transcription of Circadian Pathway genes. Regulation of 1) Per1 by NR4a1, 2) Rev-erbα by the Thyroid Hormone Receptors (TRα and TRβ), Peroxisome Proliferator Activated Receptor γ (PPARγ) and Estrogen Related Receptor γ (ERRγ).

FIG. 6 depicts, in histogram form, selected data from Table 6: a) POMC; b) Ghrelin; c) Leptin; d) Agrp; and e) NPY. The Y-axis in FIGS. 6a-e represent the luciferase to LacZ ratio (luciferase/LacZ).

Each of FIG. 7 through FIG. 40 in turn depicts, as a histogram, data provided in Table 7 through Table 40, respectively. The columns in each of FIG. 7 through FIG. 40 are, from left to right: TRa1, TRa1 ligand, TRa2, TRa2 ligand, TRb1, TRb1 ligand, TRb2, TRb2 ligand, RARa, RARa ligand, RARb, RARb ligand, RARg, RARg ligand, PPARa, PPARa ligand, PPARg, PPARg ligand, PPARd, PPARd ligand, LXRa, LXRa ligand, LXRb, LXRb ligand, FXR, FXR ligand, FXRb, FXRb ligand, VDR, VDR ligand, PXR, PXR ligand, CAR, CAR ligand, control, RXRa, RXRa ligand, RXRb, RXRb ligand, RXRg, RXRg ligand, RVRa, RVRb, RORa, RORb, RORg, HNF4a, HNF4g, TR2, TR4, TLX, PNR, Era, Era ligand, Erb, Erb ligand, ERR1, ERR2, ERR3, CTF1, CTF2, CTF3, SF-1, control, GR, GR ligand, hMR, hMR ligand, PR, PR ligand, AR, AR ligand, NR4a1, NR4a2, NR4a3, LRH-1, GCNF, DAX-1, SHP and control, respectively. The specific promoters included in FIG. 7 through FIG. 40, respectively, facilitate transcription of the following gene products: Leptin, Ghrelin, Agrp, NPY, POMC, hPOMC, mCAR, hCAR, PGC1b, G6PD, MyoD, Per1, UCP1, mUCP2, mUCP3, MCP-1, IRF7, MDR1, CYP3A4, ADRP, Adiponectin, Dio1, Dio2, Bmal1, Bmal1, RevErba, RevErba, TNFa, IFNg, SREBP1c, SREBP1c, ABCA1, PPARg1, and PPARg2. FIG. 36 and FIG. 37 provide enhanced details for the SREBP1c experiment, as described herein. The Y-axis in FIG. 37 is SREBP-1C/LacZ.

FIG. 41 provides the results of promoter ontology screening, revealing an intricate NHR/circadian network.

FIG. 42 depicts a genetic tree of the FGF family. FGF21, FGF23 and FGF15 are regulated by PPARa, VDR and FXR, respectively. Using the NHR-screening methods provided herein, it was found that FGF1A is regulated by PPARγ.

FIG. 43 depicts transcriptional regulation of FGF1 promoters. The bottom panel shows the gene structure of FGF1, consisting of three exons (1-3) and three alternative promoters (A, B and D). Alternative transcripts are differentially expressed: FGF 1A is most highly expressed in heart, kidney and adipose. FGF1B in brain and FGF1D in liver. Using luciferase reporter assays strong activation of FGF1A by PPARγ and moderate activation of FGF1D by LXRa and PPARγ was found.

FIG. 44 depicts the genetic structure of the human FGF1 gene. The FGF1 gene is regulated by at least three independent promoters: A, B and D. Alternative splicing of these promoters to the three exons results in identical but differentially expressed FGF1 polypeptides.

FIG. 45 provides evidence that the PPRE in FGF1A is evolutionarily conserved. Alignment of FGF1A promoters from different species (bovine, canine, mouse, rat, orangutan, human and chimpanzee) shows strong evolutionary conservation. All these species have a 100% conserved PPRE, except for dog and rat, which each have two mismatches. In addition to the PPRE, the FGF 1A promoter also contains several other conserved elements. Sequences: cow (SEQ ID NO:50); dog (SEQ ID NO:51); horse (SEQ ID NO:52); chimp (SEQ ID NO:53); human (SEQ ID NO:54); orangutan (SEQ ID NO:55); rat (SEQ ID NO:56); mouse (SEQ ID NO:57); opossum (SEQ ID NO:58).

FIG. 46 depicts FGF1A regulation by PPARγ in various species. Ligand dependent PPARγ activation of the FGF1A promoter was found in human, mouse, rat and horse but not in dog and opossum. Inactivation of the PPRE by site directed mutagenesis (mutant) abolished regulation. The PPRE in chimpanzee, orangutan and bovine are identical to human and mouse; without wishing to be bound by any theory, it is believed that they are therefore active.

FIG. 47 depicts data on the regulation of FGF1A and FGF21 by feeding and PPARγ. Histograms of mRNA levels of FGF1A in white adipose tissue (WAT) and FGF21 in liver in response to feeding, fasting and PPARg ligand treatment (5 mg/kg oral BRL for 3 days) are provided.

FIG. 48a depicts glucose tolerance test results on male FGF1 knockout mice and wild-type mice (n=4) after 8 weeks of high fat diet (HFD) feeding. FIG. 48b depicts the corresponding results after 16 weeks.

FIG. 49 depicts results showing that FGF1 knockout mice display decreased fasting levels of insulin after 8 weeks of high fat diet.

FIG. 50 provides a proposed model of the roles of FGFs in energy metabolism in response to feeding and fasting: (left) in response to fasting, FGF21 is transcriptionally activated by PPARa and increases fat burning through increased lipolysis; and (right) in response to feeding, FGF1A is transcriptionally activated by PPARg and regulates insulin signaling.

FIG. 51 depicts activation of a control PPRE reporter in CV-1 cells with or without the NHR RXR. Sequence: AGGTCANAGGTCA (SEQ ID NO:48).

FIG. 52 depicts PPAR isotype specific promoter regulation, providing a group of promoters that are specifically regulated by one of the PPAR isotypes only.

FIG. 53 depicts PPAR isotype non-specific promoter regulation, indicating promoters that are regulated by multiple PPAR isotypes.

FIG. 54 depicts promoter repression by PPARs, providing promoters that are repressed by PPARs.

FIG. 55 depicts an unsupervised hierarchical cluster analysis of 288 promoters with a predicted PPRE.

FIG. 56 depicts the result that PPARa unique promoters contain a conserved binding site. PPRE sequence: AGGTCANAGGTCA (SEQ ID NO:48); conserved binding site sequence: GAGGCNGAGGC (SEQ ID NO:49).

FIG. 57a through FIG. 57c provide a proposed model for PPARa regulation: a) A protein complex termed “hemin response element binding protein (HREBP)” was demonstrated to bind to the GAGGCNGAGGC (SEQ ID NO:49) sequence (represented as a dark box in the linear structure) in the mTRAP promoter (Reddy et al., 1996, Blood 88:2288-2297); b) Ku70 and Ku80 were demonstrated to regulate the ApoC-IV gene through interaction with PPARγ/RXRα (Kim et al., 2008, J. Hepatol. 49:787-798); c) Proposed model for regulation of PPARα-specific promoters.

### DETAILED DESCRIPTION OF THE INVENTION

### I. Terminology

It is to be understood that the present invention is not limited to particular devices or biological systems, which can, of course, vary. It is also to be understood that the terminology used herein is for the purpose of describing particular embodiments only, and is not intended to be limiting. As used in this specification and the appended claims, the singular forms “a,” “an,” and “the” include plural referents unless the context clearly dictates otherwise. Thus, for example, reference to “a transcription factor” includes a combination of two or more transcription factors, and the like.

Unless defined otherwise, all technical and scientific terms used herein have the same meaning as commonly understood by one of ordinary skill in the art to which the invention pertains. Although any methods and materials similar or equivalent to those described herein can be used in the practice for testing of the present invention, the preferred materials and methods are described herein. In describing and claiming the present invention, the following terminology will be used in accordance with the definitions set out below.

A “biomolecule” as used herein, is an organic molecule that may be employed by or produced by a living cell, including large polymeric molecules such as proteins, polysaccharides, and nucleic acids as well as small molecules such as primary metabolites, secondary metabolites, and natural products.

A “chemical” as used herein refers to a chemical compound, which is a material with a specific chemical composition.

A “nucleic acid reporter sequence” is a nucleic acid encoding at least one reporter gene that produces a detectable reporter protein, e.g., a fluorescent protein, a luminescent protein, a secretable reporter protein, a luciferase, a secretable luciferase, a green fluorescent protein, or a red fluorescent protein. Some examples of useful nucleic acid reporter sequences are set forth in Tables 2 and 3, which discloses nucleic acid reporter sequences that facilitate the transcription of specific listed genes.

A “nucleic acid driver sequence” is a nucleic acid encoding a transcription driver, also referred to herein as a “transcription modifying protein.” The nucleic acid driver sequence is typically a DNA sequence.

A “transcription modifying protein” is a protein capable of modifying transcription of a particular gene by interacting, either directly or indirectly, with a nucleic acid promoter sequence. In some embodiments, the transcription modifying protein is a “transcription factor,” which is a DNA binding protein that influences the transcription of a gene product from genomic material. Various transcription factors specifically influence (e.g., promote) transcription of particular gene products. In other embodiments, the transcription modifying protein is a “nuclear receptor” or “nuclear hormone receptor,” which is a transcription modifying protein that activates or represses transcription of one or more genes in the nucleus (but can also have second messenger signaling actions), typically in conjunction with transcription factors. Nuclear receptors may be activated by their natural cognate ligands (i.e. nuclear receptor ligand) as well as by synthetic and/or non-native ligands. Nuclear receptors are ordinarily found in the cytoplasm or nucleus, rather than being membrane-bound. The transcription modifying proteins and nucleic acid promoter sequences herein can optionally be from or be derived from any species (e.g., human, primate, mouse, etc.). Also, the transcription modifying proteins and nucleic acid promoter sequences can be naturally occurring sequences, can be modified or recombinant or mutated versions of naturally occurring sequences, or can be allelic variants or disease/medical condition specific variants. Examples of transcription modulating agents useful in the methods provided herein are provided in Table 4.

A “transcription modulating agent,” as used herein, refers to a biomolecule or chemical agent that is capable of modulating the activity of a transcription modifying protein, a nucleic acid promoter sequence and/or interaction thereof, thereby modulating transcription of a transcription modifying protein responsive gene. A transcription modulating agent may be an “agonist” for a transcription modifying protein (e.g. a transcription factor or nuclear receptor), which is an agent that, when bound to the transcription modifying protein, activates the transcription modifying protein relative to the absence of the agonist. The activation can be similar in degree to that provided by a natural ligand hormone or similar molecule/compound for the transcription modifying protein, or can be stronger (optionally referred to as a “strong agonist”), or can be weaker (optionally referred to as a “weak agonist” or “partial agonist”). An example of a ligand hormone for a transcription factor is thyroid hormone, which is a natural hormone for the thyroid nuclear receptor. A “putative agonist” is an agent or compound to be tested for agonist activity. A transcription modulating agent may also be an “antagonist” for a for a transcription modifying protein (e.g. a transcription factor or nuclear receptor), which is an agent that reduces or blocks activity mediated by the transcription modifying protein (e.g. a transcription factor or nuclear receptor) in comparison to the absence of the antagonist, or in comparison to an agonist of the transcription modifying protein. The activity of the antagonist can be mediated, e.g., by blocking binding of an agonist to the receptor, or by altering receptor configuration and/or activity of the receptor. A “putative antagonist” is an agent to be tested for antagonist activity. A transcription modulating agent may also be a “modulator” of a transcription modifying protein (e.g. a transcription factor or nuclear receptor), which is an agent that “modulates” the activity of the factor's or receptor's influence on gene function. Thus, a modulator includes both agonists and antagonists. A transcription modulating agent may also be an “inverse agonist” for a transcription modifying protein (e.g. a transcription factor or nuclear receptor), which is an agent that reduces a low level of basal gene transcription that is otherwise promoted by certain factors/receptors in the absence of an agonist. A transcription modulating agent may also be “ligand” for a transcription modifying protein (e.g. a transcription factor or nuclear receptor) which is a biomolecule of chemical capable of binding to and forming a complex the transcription modifying protein. A ligand may be a synthetic or natural (i.e. non-synthetic), and may be chemically the same or different than the natural (e.g. endogenous) cognate ligand for the transcription modifying protein. For example, cortisol is a natural (e.g. native) ligand for the glucocorticoid receptor, while 3,5,3′-triiodo-L-thyronine (triiodothyronine, T₃ or thyroid hormone) is a natural ligand for the thyroid hormone receptor, etc. Ligands can also include synthetic and/or normative ligands in addition to native ligands. See Table 5 for further examples of various ligands.

A “transcription modifying protein responsive gene” is a gene whose transcription is altered in a cell in response to an interaction, either direct or indirect, between a transcription modifying protein (such as a transcription factor or nuclear receptor) and a nucleic acid promoter sequence linked to the transcription modifying protein responsive gene. A transcription modifying protein responsive gene includes nucleic acid reporter sequences, as described herein. Therefore, where a nucleic acid promoter sequence is “linked” to a transcription modifying protein responsive gene (e.g. a nucleic acid reporter sequence), it is to be understood that the nucleic acid promoter sequence is operationally linked to the transcription modifying protein responsive gene such that transcription of the transcription modifying protein responsive gene is partially or completely controlled by the nucleic acid promoter sequence (and the interaction of the nucleic acid promoter sequence with the transcription modifying protein). In this way, what is herein referred to as a “reporter construct” is formed. Thus, the transcription modifying protein may modulate the transcription of a transcription modifying protein responsive gene, for example and without limitation, in the absence of a transcription modifying protein ligand, in the presence of a transcription modifying protein ligand and/or in response to interaction with a transcription modulating agent. The transcription modifying protein can act while bound to DNA or while bound to other proteins directly or indirectly involved in transcription of a gene product. The activity of the responsive gene can also be modulated through transcription factor or nuclear receptor effects on second messenger signaling pathways.

A “library” is a set of compounds or compositions. It can take any of a variety of forms, e.g., comprising spatial organization (e.g., an array, e.g., a gridded array), or logical organization (e.g., as existing in a database, e.g., that can locate compounds or compositions in an external storage system). Examples of libraries of promoters, transcription modifying proteins and ligands are set forth in Tables 2, 3, 4 and 5.

A “nucleic acid promoter sequence” or “promoter” is a nucleic acid that facilitates transcription of a particular gene. Nucleic acid promoter sequence are typically regions of DNA located near the particular gene whose transcription is facilitated. In some embodiments, the nucleic acid promoter sequence is, or includes, a “transcription element,” which is a regulatory DNA region that allows transcription of a gene product from a gene. A transcription element comprises specific nucleic acid sequences that are recognized by one or more transcription factors or nuclear receptors. Thus, in some embodiments, the nucleic acid promoter sequence is, or includes, a transcription factor-binding site or a response element.

The term “test” in reference to an agent, compound, or method component (e.g. a nucleic acid promoter sequence, a transcription modulating agent, transcription modifying protein, a nucleic acid driver sequence encoding a transcription modifying protein, etc.) means that the referenced agent, compound, or method component is to be analyzed (e.g. screened, assayed, identified or characterized) in one or more of the methods described herein. The agent, compound, or method component can exist as a single isolated compound or can be a member of library.

The term “transfected” or “transfection” refers to the process of introducing nucleic acids into a cell by any appropriate method, including viral or non-viral means. Thus, as used herein, transfection includes transformation and transduction.

### II. Methods

Provided herein are novel methods, including high-throughput methods, for functional analysis of complex physiologic pathways. The methods include analysis of promoter functionality, transcription modifying protein functionally, and/or transcription modulating agent functionality. Disclosed herein are methods that allow, for the first time, high throughput functional analysis of physiologic pathway components in cellular systems. In some embodiments, the analysis is performed in a reporter cell (i.e. the cellular system is a reporter cell) wherein the reporter cell provides a generic environment thereby allowing the functional studies, such as the interactions between physiologic pathway components. By providing a generic environment, the reporter cell enables the study, inter alia, of physiologic pathways derived from tissues exogenous to the tissue from which the reporter cell was derived. Moreover, it has been found that the methods provided herein allow the study of interactions between components of physiologic pathways derived from different tissues. These properties of the reporter cell allow data obtained from the methods provided herein to be directly compared, even where the individual components of the system (e.g. the promoters and transcription modifying proteins) are derived from different tissues, or where the reporter cell is derived from a different tissue than the individual components.

Thus, methods (e.g. cell-based high-throughput methods) are provided herein for identifying a functional characteristic of a nucleic acid promoter sequence and/or a transcription modifying protein. The term “functional characteristic,” as used here, means a biological or molecular function of a nucleic acid promoter sequence or transcription modifying protein. The biological function may be a particular molecular interaction with another biomolecule or chemical in vitro, in situ or in vivo, or a product or result of the activity or inactivity of the nucleic acid promoter sequence or transcription modifying protein. For example, a functional characteristic of a nucleic acid promoter sequence may be its interaction (either direct or indirect) with a particular transcription factor, or the transcription of a transcription modifying protein responsive gene. Likewise, a functional characteristic of a transcription modifying protein may be its interaction (either direct or indirect) with a particular nucleic acid promoter sequence or transcription modulating agent. In addition, a functional characteristic of a nucleic acid promoter sequence or transcription modifying protein may be a phenotypic change in the cell (e.g. a reporter cell) resulting from the interaction between, presence of and/or activity level of the transcription modifying protein and/or nucleic acid promoter sequence within that cell. In some embodiments, the cell (e.g. reporter cell) forms part of a tissue, organ or organism. In this case, a functional characteristic of a nucleic acid promoter sequence or transcription modifying protein may be a change in a characteristic of the tissue, organ or organism due to the interaction between, presence of and/or activity level of the transcription modifying protein and/or nucleic acid promoter sequence in a cell that forms part of the tissue, organ or organism. In some embodiments, the change is morphological. Therefore, in some embodiments, the functional characteristic may be a disease state, formation of disease state or abrogation (e.g., treatment) of a disease state due to the interaction between, presence of and/or activity level of 1n some embodiments, the methods provided herein are not drawn to the treatment of a human.

In one aspect, a method is provided of identifying a functional characteristic of a nucleic acid promoter sequence (e.g. a test nucleic acid promoter sequence). The nucleic acid promoter sequence may have a functional characteristic that is not known (either fully unknown or partially unknown) or is merely hypothesized (herein referred to as a “nucleic acid promoter sequence of unknown function” or a “nucleic acid promoter sequence not having a known functional characteristic”). The method includes transfecting a reporter cell with a nucleic acid promoter sequence linked to a nucleic acid reporter sequence. The reporter cell is transfected with a nucleic acid driver sequence encoding a transcription modifying protein. The transcription modifying protein may have a functional characteristic that is known (herein referred to as a “transcription modifying protein of known function” or a “transcription modifying protein having a known functional characteristic”). Transcription of the nucleic acid reporter sequence is detected thereby identifying the functional characteristic of the nucleic acid promoter sequence (e.g. a nucleic acid promoter sequence of unknown function).

In another aspect, a method of identifying a functional characteristic of a transcription modifying protein (e.g. a test transcription modifying protein) is provided. The transcription modifying protein may have a functional characteristic that is not known (either fully unknown or partially unknown) or is merely hypothesized (herein referred to as a “transcription modifying protein of unknown function” or a “transcription modifying protein not having a known functional characteristic”). The method includes transfecting a reporter cell with a nucleic acid promoter sequence linked to a nucleic acid reporter sequence. The nucleic acid promoter sequence may have a functional characteristic that is known (herein referred to as a “nucleic acid promoter sequence of known function” or a “nucleic acid promoter sequence having a known functional characteristic”). The reporter cell is transfected with a nucleic acid driver sequence encoding a transcription modifying protein (e.g. a transcription modifying protein of unknown function). Transcription of the nucleic acid reporter sequence is detected thereby identifying the functional characteristic of the transcription modifying protein.

Where a functional characteristic is said to be “known” in relation to a transcription modifying protein or a nucleic acid promoter sequence, it will be understood that there is sufficient evidence correlating the functional characteristic to the transcription modifying protein or a nucleic acid promoter sequence such that a person having ordinary skill in the art would conclude that it is at least probable or highly probable that the transcription modifying protein or a nucleic acid promoter sequence has the functional characteristic (e.g. exhibits the functional characteristics).

For the methods described herein, the nucleic acid reporter sequence is a transcription modifying protein responsive gene as defined above. Therefore, using the guidance provided herein and the general knowledge in the art, one of skill will immediately understand that the identification of the functional characteristic (e.g. of the nucleic acid promoter sequence or the transcription modifying protein) is possible due to the interaction of the transcription modifying protein (either direct or indirect) with the nucleic acid promoter sequence as evidenced by the transcription and detection of the nucleic acid reporter sequence. Where either the nucleic acid promoter sequence or the transcription modifying protein has a known functional characteristic, the known functional characteristic is then linked to the transcription modifying protein or nucleic acid promoter sequence, respectively.

As described above, a reporter cell is a biological cell that provides a generic environment thereby allowing the study of the interaction, either direct or indirect, between a transcription modifying protein and a nucleic acid promoter sequence (also referred to herein as a “generic reporter cell”). Therefore, reporter cells are chosen such that the endogenous cellular machinery of the reporter cell does not substantially interfere with the interaction, either direct or indirect, between a transcription modifying protein and a nucleic acid promoter sequence. This generic environment typically allows the study of transcription modifying protein and a nucleic acid promoter sequence interactions regardless of the tissue or cellular derivation of the transcription modifying protein and a nucleic acid promoter sequence. In some embodiments, the reporter cell is a mammalian reporter cell, such as a human cell. In some embodiments, the reporter cell is a Human Embryonic Kidney cells (293 cells), or African Green Monkey Kidney Fibroblast cells (CV-1 cells). Further nonlimiting examples of reporter cells are described below in the “Examples” section. Using the teachings provided herein and the general knowledge in the art, one of skill can test and select appropriate cells to serve as reporter cells that exhibit adequate intracellular environments (e.g. generic intracellular environments) to study the interaction, either direct or indirect, between a transcription modifying protein and a nucleic acid promoter sequence.

In some embodiments, the nucleic acid driver sequence encoding a transcription modifying protein is chosen from, or forms part of, a library of nucleic acids encoding transcription modifying proteins. The library of nucleic acids encoding transcription modifying proteins may be a library of nucleic acids encoding a family of transcription modifying proteins. A “family of transcription modifying proteins,” as used herein, refers to a collection or set of transcription modifying proteins known to have (e.g. exhibit) a common functional characteristic, such as a family of transcription factors or a family of nuclear hormone receptors. The family of transcription modifying proteins is typically derived from a single species. For example, as described in more detail below, provided herein is a newly developed and validated cDNA expression library encompassing the entire Nuclear Hormone Receptor (“NHR” or “NR”) Family (see Table 4). Thus, in some embodiments, the nucleic acid driver sequence encodes one or more transcription modifying proteins set forth in Table 4.

Likewise, in some embodiments, the nucleic acid promoter sequence is chosen from, or forms part of, a library of nucleic acid promoter sequences. The library of nucleic acid promoter sequences may be a library of a family of nucleic acid promoter sequences. A “family of nucleic acid promoter sequences,” as used herein, refers to a collection or set of nucleic acid promoter sequences known to interact, either directly or indirectly, with a one or more of a family of transcription modifying proteins (e.g. a plurality of transcription modifying proteins within a family of transcription modifying proteins, including 10%, 20%, 30%, 40%, 50%, 60%, 70%, 80%, 90% or 100% of transcription modifying proteins within a family of transcription modifying proteins). In some embodiments, the nucleic acid promoter sequence is one or more of the nucleic acid promoters that facilitate the transcription of a gene product of a gene set forth in Table 2 and/or Table 3. Thus, in some embodiments, the library of nucleic acid promoter sequences is set forth in Table 2 and/or Table 3.

In another aspect, a method is provided for identifying a functional characteristic of a nucleic acid promoter sequence (e.g. a test nucleic acid promoter sequence). The nucleic acid promoter sequence may be a nucleic acid promoter sequence of unknown function (i.e. not having a known functional characteristic). The method includes transfecting (each of) a plurality of reporter cells with the nucleic acid promoter sequence linked to a nucleic acid reporter sequence (i.e. each of the plurality of reporter cells are transfected with a nucleic acid promoter sequence linked to a nucleic acid reporter sequence having the same promoter and reporter sequences). The plurality of reporter cells is transfected with a nucleic acid driver sequence encoding a transcription modifying protein of known function (i.e. having a known functional characteristic) or a transcription modifying protein that forms part of a family of transcription modifying proteins. Each of said plurality of reporter cells is transfected with a different nucleic acid driver sequence encoding a transcription modifying protein (i.e. each of the plurality of reporter cells is transfected with a nucleic acid driver sequence encoding a different transcription modifying protein). Transcription of the nucleic acid reporter sequence is detected in at least one of the plurality of reporter cells thereby identifying the functional characteristic of the nucleic acid promoter sequence. One of skill will immediately recognize that known functional characteristics of the transcription modifying proteins or family of transcription modifying proteins may be correlated to the nucleic acid promoter sequence thereby identifying the functional characteristic of the nucleic acid promoter sequence.

In another aspect, a method is provided for identifying a functional characteristic of a nucleic acid promoter sequence (e.g. a test nucleic acid promoter sequence). The nucleic acid promoter sequence may be a nucleic acid promoter sequence of unknown function (i.e. not having a known functional characteristic). The method includes transfecting (each of) a plurality of reporter cells with the nucleic acid promoter sequence linked to a nucleic acid reporter sequence (i.e. each of the plurality of reporter cells are transfected with a nucleic acid promoter sequence linked to a nucleic acid reporter sequence having the same promoter and reporter sequences). The plurality of reporter cells is transfected with a nucleic acid driver sequence encoding a transcription modifying protein, wherein each of the plurality of reporter cells is transfected with a different nucleic acid driver sequence encoding a transcription modifying protein (i.e. each of the plurality of reporter cells is transfected with a nucleic acid driver sequence encoding a different transcription modifying protein). Transcription of the nucleic acid reporter sequence is detected in at least one of the plurality of reporter cells thereby obtaining a transcription modifying protein interaction profile for the nucleic acid promoter sequence. The transcription modifying protein interaction profile for the nucleic acid promoter sequence is compared to a plurality of transcription modifying protein interaction profiles for a plurality of nucleic acid promoter sequences of known function thereby identifying a functional characteristic of the nucleic acid promoter sequence.

In some embodiments of the preceding two paragraphs, transcription of the nucleic acid reporter sequence is detected in 10%, 20%, 30%, 40%, 50%, 60%, 70%, 80%, 90% or 100% of the plurality of reporter cells. In some embodiments, the number of reporter cells transfected with a different nucleic acid driver sequence encoding a transcription modifying protein is at least or about 5, 10, 20, 30, 40, 50, 60, 70, 80, 90, 100, 200, 300, 400, 500, 1000, 5000 or 10000. In some embodiments, the number of reporter cells transfected with a different nucleic acid driver sequence encoding a transcription modifying protein may be from 20 to 10000. The number of reporter cells transfected with a different nucleic acid driver sequence encoding a transcription modifying protein may also be from 20 to 500. The number of reporter cells transfected with a different nucleic acid driver sequence encoding a transcription modifying protein may also be from 20 to 100. The number of reporter cells transfected with a different nucleic acid driver sequence encoding a transcription modifying protein may also be from 50 to 100. The number of reporter cells transfected with a different nucleic acid driver sequence encoding a transcription modifying protein may also correspond to the number or wells in a multi-well plate, such as about 6, 8, 12, 24, 48, 96, 384, or 1536. One of skill will immediately understand that where a multi-well plate is employed, a plurality of reporter cells within each well are typically employed wherein each reported cell within each well is transfected with the same promoter and reporter sequences and the same nucleic acid driver sequence encoding the same transcription modifying protein. Thus, the number of reporter cells transfected with a different nucleic acid driver sequence encoding a transcription modifying protein does not necessarily equal the total number of reporter cells used in the method.

In some embodiments, the steps of the method in the preceding three paragraphs may be repeated for a second nucleic acid promoter sequence linked to a nucleic acid reporter sequence in place of the nucleic acid promoter sequence, thereby identifying the functional characteristic of the second nucleic acid promoter sequence. This may be repeated for a plurality of nucleic acid promoter sequences. Thus, as further discussed below, in some embodiments, high throughput cellular-based methods are provided herein that are applicable to the study of functional characteristics of a plurality of (e.g. a library of) nucleic acid promoter sequences (e.g. 10, 20, 30, 40, 50, 100, 200, 300, 400, 500, 1000 or 10,000) against a plurality (e.g. a library) of transcription modifying proteins (e.g. 10, 20, 30, 40, 50, 100, 00, 300, 400, 500, 1000 or 10,000).

A “transcription modifying protein interaction profile,” as used herein, refers to a pattern of detected nucleic acid reporter sequence transcriptions detected for a given nucleic acid promoter sequence against a given set or panel of transcription modifying proteins. Thus, by comparing the transcription modifying protein interaction profile of a test nucleic acid promoter sequence to a previously obtained transcription modifying protein interaction profile of a nucleic acid promoter sequence of known function, the functional characteristic of the test nucleic acid promoter sequence may be linked to the functional characteristics of the nucleic acid promoter sequence of known function thereby identifying a functional characteristic of the test nucleic acid promoter sequence.

In another aspect, a method is provided for identifying a functional characteristic of a transcription modifying protein (e.g., a test transcription modifying protein). The transcription modifying protein may be a transcription modifying protein of unknown function (i.e. not having a known functional characteristic). The method includes transfecting (each of) a plurality of reporter cells with the nucleic acid driver sequence encoding a transcription modifying protein (i.e. each of the plurality of reporter cells are transfected with the same nucleic acid driver sequence encoding the same transcription modifying protein). The plurality of reporter cells is transfected with a nucleic acid promoter sequence of known function (i.e. having a known functional characteristic) linked to a nucleic acid reporter sequence or a nucleic acid promoter sequence linked to a nucleic acid reporter sequence wherein the nucleic acid promoter sequence forms part of a family of a nucleic acid promoter sequences. Each of said plurality of reporter cells is transfected with a different nucleic acid promoter sequence linked to a nucleic acid reporter sequence. Transcription of the nucleic acid reporter sequence is detected in at least one of the plurality of reporter cells thereby identifying the functional characteristic of the nucleic acid promoter sequence. One of skill will immediately recognize that the functional characteristics of the nucleic acid promoter sequence of known function or family of nucleic acid promoter sequence of known function may be linked to the nucleic acid driver sequence encoding a transcription modifying protein (e.g. the test transcription modifying protein) thereby identifying the functional characteristic of the transcription modifying protein.

In another aspect, a method is provided for identifying a functional characteristic of a transcription modifying protein (e.g. a test transcription modifying protein). The transcription modifying protein may be a transcription modifying protein of unknown function (i.e. not having a known functional characteristic). The method includes transfecting (each of) a plurality of reporter cells with the nucleic acid driver sequence encoding a transcription modifying protein (i.e. each of the plurality of reporter cells are transfected with the same nucleic acid driver sequence encoding the same transcription modifying protein). The plurality of reporter cells is transfected with a nucleic acid promoter sequence of known function (i.e. having a known functional characteristic) linked to a nucleic acid reporter sequence or a nucleic acid promoter sequence linked to a nucleic acid reporter sequence wherein the nucleic acid promoter sequence forms part of a family of a nucleic acid promoter sequences. Each of the plurality of reporter cells is transfected with a different nucleic acid promoter sequence linked to a nucleic acid reporter sequence. Transcription of the nucleic acid reporter sequence in at least one of the plurality of reporter cells is detected thereby obtaining a nucleic acid promoter sequence interaction profile for the transcription modifying protein. The nucleic acid promoter sequence interaction profile for the transcription modifying protein is compared to a plurality of nucleic acid promoter sequence interaction profiles for a plurality of transcription modifying proteins of known function thereby identifying a functional characteristic of the transcription modifying protein.

In some embodiments of the preceding two paragraphs, transcription of the nucleic acid reporter sequence is detected in 10%, 20%, 30%, 40%, 50%, 60%, 70%, 80%, 90% or 100% of the plurality of reporter cells. In some embodiments, the number of reporter cells transfected with a different nucleic acid promoter sequence is at least or about 5, 10, 20, 30, 40, 50, 60, 70, 80, 90, 100, 200, 300, 400, 500, 1000, 5000 or 10000. The number of reporter cells transfected with a different nucleic acid promoter sequence may be from 20 to 10000. The number of reporter cells transfected with a different nucleic acid promoter sequence may also be from 20 to 500. The number of reporter cells transfected with a different nucleic acid promoter sequence may also be from 20 to 100. The number of reporter cells transfected with a different nucleic acid promoter sequence may also be from 50 to 100. The number of reporter cells transfected with a different nucleic acid promoter sequence may also correspond to the number or wells in a multi-well plate, such as about 6, 8, 12, 24, 48, 96, 384, 1536. One of skill will immediately understand that where a multi-well plate is employed, a plurality of reporter cells within each well are typically employed wherein each reported cell within each well is transfected with the same promoter and reporter sequences and the same nucleic acid driver sequence encoding the same transcription modifying protein. Thus, the number of reporter cells transfected with a different nucleic acid promoter sequence does not necessarily equal the total number of reporter cells used in the method.

In some embodiments, the steps of the method in the preceding three paragraphs may be repeated for a second nucleic acid driver sequence encoding a transcription modifying protein in place of the nucleic acid driver sequence encoding a transcription modifying protein in the preceding three paragraphs, thereby identifying the functional characteristic of the second nucleic acid driver sequence encoding a transcription modifying protein. This may be repeated for a plurality of nucleic acid driver sequences encoding a transcription modifying protein. Thus, as further discussed below, in some embodiments, high throughput cellular-based methods are provided herein that are applicable to the study of functional characteristics of a plurality of (e.g. a library of) nucleic acid driver sequences encoding a transcription modifying protein (e.g. 10, 20, 30, 40, 50, 100, 200, 300, 400, 500, 1000 or 10,000) against a plurality (e.g. a library) of nucleic acid promoter sequences (e.g. 10, 20, 30, 40, 50, 100, 200, 300, 400, 500, 1000 or 10,000).

A “nucleic acid promoter sequence interaction profile,” as used herein, refers to a pattern of detected nucleic acid reporter sequence transcriptions detected for a given nucleic acid driver sequence (i.e. transcription modifying proteins) against a given set or panel of nucleic acid promoter sequences. Thus, by comparing the nucleic acid promoter sequence interaction profile of a test nucleic acid driver sequence encoding a transcription modifying protein to a previously obtained nucleic acid promoter sequence interaction profile of a nucleic acid driver sequence encoding a transcription modifying protein of known function, the functional characteristic of the test nucleic acid driver sequence encoding a transcription modifying protein may be linked to the functional characteristics of the nucleic acid driver sequence encoding a transcription modifying protein of known function thereby identifying a functional characteristic of the test nucleic acid driver sequence encoding a transcription modifying protein.

In another aspect, a method of identifying a transcription modulating agent is provided. The method includes transfecting a reporter cell with a nucleic acid promoter sequence linked to a nucleic acid reporter sequence. The nucleic acid promoter sequence may be a nucleic acid promoter sequence of known function (i.e. having a known functional characteristic). The reporter cell is transfected with a nucleic acid driver sequence encoding a transcription modifying protein. The transcription modifying protein may be a transcription modifying protein of known function (i.e. having a known functional characteristic). The reporter cell is also contacted with a transcription modulating agent (e.g. a test transcription modulating agent); or transfected with a nucleic acid encoding a transcription modulating agent. Modulation of transcription of the nucleic acid reporter sequence relative to an amount of transcription of the nucleic acid reporter sequence where the transcription modulating agent is absent under otherwise similar test conditions is detected, thereby identifying a transcription modulating agent. One of skill will understand that where the reporter cell is contacted with a transcription modulating agent, the contacting is under conditions allowing the transcription modulating agent to enter the intracellular space of the reporter cell (e.g. by passive diffusion, active transport, or other techniques such as electroporation, microinjection or chemical permeation). In some embodiments, the transcription modulating agent may act through binding to a cell surface receptor which may occur during the contacting step.

In another aspect, a method of identifying a transcription modulating agent is provided. The method includes transfecting a plurality of reporter cells with a nucleic acid promoter sequence linked to a nucleic acid reporter sequence. The nucleic acid promoter sequence may be a nucleic acid promoter sequence of known function (i.e. having a known functional characteristic). The plurality of reporter cells are transfected with a nucleic acid driver sequence encoding a transcription modifying protein, wherein each of the plurality of reporter cells is transfected with a different nucleic acid promoter sequence or a different nucleic acid driver sequence (or both). The reporter cell is also contacted with a test transcription modulating agent; or transfected with a nucleic acid encoding a transcription modulating agent. Modulation of an amount of transcription of a nucleic acid reporter sequence in at least one of the plurality of reporter cells relative to an amount of transcription of the nucleic acid reporter sequence wherein the transcription modulating agent is absent under otherwise similar test conditions is detected, thereby identifying a transcription modulator. One of skill will understand that where the reporter cell is contacted with a transcription modulating agent, the contacting is under conditions allowing the transcription modulating agent to enter the intracellular space of the reporter cell (e.g. by passive diffusion, active transport, or other techniques such as electroporation, microinjection or chemical permeation). In some embodiments, the transcription modulating agent may act through binding to a cell surface receptor which may occur during the contacting step.

In the preceding paragraph, modulation of an amount of transcription of a nucleic acid reporter sequences is detected in 10%, 20%, 30%, 40%, 50%, 60%, 70%, 80%, 90% or 100% of the plurality of reporter cells. In some embodiments, the number of reporter cells transfected with a different nucleic acid promoter sequence or a different nucleic acid driver sequence (or both) is at least or about 5, 10, 20, 30, 40, 50, 60, 70, 80, 90, 100, 200, 300, 400, 500, 1000, 5000 or 10000. The number of reporter cells transfected with a different nucleic acid promoter sequence or a different nucleic acid driver sequence (or both) may be from 20 to 10000. The number of reporter cells transfected with a different nucleic acid promoter sequence or a different nucleic acid driver sequence (or both) may also be from 20 to 500. The number of reporter cells transfected with a different nucleic acid promoter sequence or a different nucleic acid driver sequence (or both) may also be from 20 to 100. The number of reporter cells transfected with a different nucleic acid promoter sequence or a different nucleic acid driver sequence (or both) may also be from 50 to 100. The number of reporter cells transfected with a different nucleic acid promoter sequence or a different nucleic acid driver sequence (or both) may also correspond to the number or wells in a multi-well plate, such as about 6, 8, 12, 24, 48, 96, 384, 1536. One of skill will immediately understand that where a multi-well plate is employed, a plurality of reporter cells within each well are typically employed wherein each reported cell within each well is transfected with the same promoter and reporter sequences and the same nucleic acid driver sequence encoding the same transcription modifying protein. Thus, the number of reporter cells transfected with a different nucleic acid promoter sequence or a different nucleic acid driver sequence (or both) does not necessarily equal the total number of reporter cells used in the method.

In some embodiments, the steps of the method in the preceding two paragraphs may be repeated for a second test transcription modulating agent, thereby identifying a second transcription modulating agent. This may be repeated test transcription modulating agents. Thus, as further discussed below, in some embodiments, high throughput cellular-based methods are provided herein that are applicable identifying a plurality of transcription modulating agents. Moreover, the methods may employ a plurality (e.g. a library) of transcription modifying proteins (e.g. 10, 20, 30, 40, 50, 100, 200, 300, 400, 500, 1000 or 10,000) and/or a plurality (e.g. a library) of nucleic acid promoter sequences (e.g. 10, 20, 30, 40, 50, 100, 200, 300, 400, 500, 1000 or 10,000).

In some embodiments of the aspects of the preceding paragraphs where a plurality of reporter cells are used, a plurality of reporters cells are transfected with the nucleic acid promoter sequence and the nucleic acid driver sequence in a ratio of about one nucleic acid promoter sequence to about one nucleic acid driver sequence. In some embodiments, the plurality of reporter cells are transfected using reverse transfection, as disclosed herein and as generally known in the art.

In some embodiments, each of the plurality of reporter cells transfected with a different nucleic acid driver sequence or nucleic acid promoter sequence are present in a different container. Such a container may be any container appropriate for allowing cells to transcribe a detectable level of the nucleic acid reporter sequences for purposes of the methods described above. Thus, the contained typically contains cellular growth media (e.g. in a stripped and/or hormone-free media). The contained may be a well of a multi-well plate, such as a multi-well plate with 6, 8, 12, 24, 48, 96, 384, or 1536 wells. In some embodiments, the multi-well plate includes from about 50 to about 1000 wells. In some embodiments, each of the different containers include about 3000 to about 5000 reporter cells.

In some embodiments, the methods further include contacting a cell (or plurality of cells) or transfecting a cell (or plurality of cells)

The methods also include pairing members of a validated expression library comprising nucleic acid driver sequences encoding transcription modifying proteins (e.g. cDNAs that encode transcription factors) with members of a pathway-specific promoter library (i.e. nucleic acid promoter sequences). Because each member of the promoter library is operably coupled (i.e. linked) to reporter constructs (i.e. nucleic acid reporter sequences), the methods can permit the simultaneous, pathway-specific analysis of transcription factor/promoter interactions, e.g., in vivo or in situ. Also provided are methods that can be useful for identifying compounds (a transcription modulating agent) that modulate, e.g., increase or decrease, the transcriptional activity of one or more gene or gene product, e.g., one or more circadian pathway gene. See Example 1. In particular embodiments, the methods can be used with compositions, e.g., cDNA expression libraries and/or reporter cell arrays, provided by the invention to identify such compounds.

In some embodiments, the transcription modifying protein is a transcription factor. Thus, provided herein are methods of identifying or analyzing a network of transcription factor-promoter interactions, such as transcription factor-transcription element interactions. The methods include providing a set of at least two (e.g. 2, 3, 4, 5 or more) different reporter nucleic acid constructs that each include at least one gene transcription element derived from at least one gene of interest. The transcription element in each reporter construct in the set is operably coupled to at least one nucleic acid subsequence encoding at least one heterologous reporter moiety (nucleic acid reporter sequence), e.g., a fluorescent protein, a luminescent protein, a secretable reporter protein, a luciferase, a secretable luciferase, a green fluorescent protein, or a red fluorescent protein. Collectively, the set of reporter constructs includes transcription elements from at least three different genes of interest that are all members of a selected gene pathway, e.g., a circadian gene pathway; an inflammation gene pathway, a reproductive gene pathway, a metabolic gene pathway, a metabolic syndrome related gene pathway, an obesity related gene pathway, an insulin response gene pathway, a lipid metabolism gene pathway, a sugar metabolism gene pathway, a cholesterol transport gene pathway, a xenobiotic metabolism gene pathway, a cardiovascular gene pathway, a steroidogenic pathway, drug pumps (transporters), growth factors (FGFs), neurotransmitter receptors, a feeding related pathway (HPA axis), or a cancer related gene pathway. It will be appreciated that in various embodiments herein, identification/analysis of genes within a pathway wherein the genes do not necessarily have to interact directly with each other is allowed.

The methods also include providing a set of at least two (e.g. 2, 3, 4, 5 or more) nucleic acid driver sequences encoding a transcription modifying protein, also referred to herein as “driver nucleic acid constructs” or “driver constructs.” Individual members of the set of driver constructs may encode at least one operable transcription modifying protein (e.g. a transcription factor such as a nuclear receptor). As described above, the methods may also employ one or more transcription modulating agents, such as a transcription factor knock down agent that blocks expression of at least one transcription factor, e.g., antisense or siRNA molecule. In some methods, the reporter constructs and driver constructs are transfected into an array of reporter cells, optionally with a Fugene® HD transfection reagent. The driver nucleic acids constructs that direct the expression of reporter constructs in the array of reporter cells are then determined in order to identify or analyze the network of transcription factor/gene element interactions.

The set of reporter constructs used in the methods can optionally include at least, e.g., 5, 10, 20, 50, 100, 250, or 500 or more different transcription elements derived from at least, e.g., 5, 10, 20, 50, 100, 250, or 500 or more different genes, and the set of driver constructs can optionally encode at least, e.g., 5, 10, 20, 40, 50, or 100 or more different transcription factors, including at least, e.g., 5 10, 20, 40, 48, 49, or 50 or more different full-length, active transcription factor (e.g., nuclear hormone receptors). In certain embodiments of the methods, the set of reporter constructs can comprise at least 29 or 30 different transcription elements derived from at least 29 or 30 different genes, and/or a set of driver constructs can optionally encode at least 48 or 49 different validated, full-length, and active nuclear hormone receptors. In certain embodiments, the set of reporter constructs can comprise at least 10, 20, 30 or more different transcription elements derived from at least 10, 20, 30 or more different genes, and/or a set of driver constructs can optionally encode at least 10, 20, 30, 40 or even 50 different validated, full-length, and active nuclear hormone receptors.

The set of reporter constructs used in the methods can optionally be selected from, e.g., a vector (a vector such as a pGL3 series or a pGL4 series vector from Promega) with any of the sequences corresponding to the transcription element accession numbers in Table 2 or 3 or the sequences corresponding to the transcription elements in Table 6. As known in the art, the term “accession” or “accession number” in the context of bioinformatics refers to a unique identifier given to a biological polymer sequence (e.g., nucleic acid, protein) when it is submitted to a sequence database. Exemplary databases include those provided at the National Center for Biotechnology Information (NCBI). The gene transcription elements can optionally be selected from the sequences corresponding to accession numbers, e.g., NM_{—}007427 (SEQ ID NO:20), NM_{—}021488 (SEQ ID NO:21), NM_{—}008493 (SEQ ID NO:22), NM_{—}023456 (SEQ ID NO:23), NM_{—}008895 (SEQ ID NO:24), NM_{—}001035256 (SEQ ID NO:25), NM_{—}009803 (SEQ ID NO:26), NM_{—}001077482 (SEQ ID NO:27), NM_{—}138712 (SEQ ID NO:28), NM_{—}015869 (SEQ ID NO:29), NM_{—}021724 (SEQ ID NO:30), NM_{—}009463 (SEQ ID NO:31), NM_{—}011671 (SEQ ID NO:32), NM_{—}009464 (SEQ ID NO:33), NM_{—}133263 (SEQ ID NO:34), NM_{—}007408 (SEQ ID NO:35), NM_{—}009605 (SEQ ID NO:36), AB373959 (SEQ ID NO:37), NM_{—}013454 (SEQ ID NO:38), NM_{—}007860 (SEQ ID NO:39), NM_{—}010050 (SEQ ID NO:40), NM_{—}002478 (SEQ ID NO:41), NM_{—}000402 (SEQ ID NO:42), NM_{—}000927 (SEQ ID NO:43), NG_{—}000004, NM_{—}000594 (SEQ ID NO:45), NM_{—}000619 (SEQ ID NO:46), and NM_{—}001572 (SEQ ID NO:47). The CYP3A locus (NG_{—}000004) includes all known members of the 3A subfamily of the cytochrome P450 superfamily of genes, and maps to loci 7q21.3-q22.1. A representative gene for this family includes, but is not limited to, CYP3A4 (SEQ ID NO:44).

In particular embodiments of the methods, gene transcription elements can optionally be derived from a plurality of circadian pathway genes that include, e.g., Bmal1, Clock, NPAS2, Per1, Per2, Per3, Cry1, Cry2, Rev-erb α, Rev-erb β, Rora, Rorb, Rorc, Dec1, Dec2, Dbp, Tef, Hlf, and E4 bp4. In some embodiments, gene transcription elements can optionally be derived from a plurality of genes as set forth in Table 2 and/or Table 3. A set of reporter nucleic acid constructs can optionally comprise transcription elements that are derived from Per1 or Rev-erbα, and the set of driver nucleic acids can comprise NR4a1, TRα, TRβ, PPARγ or ERRγ.

A set of driver constructs can optionally encode a plurality of nuclear hormone receptors, e.g., nuclear hormone receptors that mediate response to, e.g., a lipid, a steroid, a retinoid, a hormone, and/or a xenobiotic. The plurality of nuclear hormone receptors encoded by a set of driver constructs can optionally include, e.g., NR1A1, NR1A2, NR1B1, NR1B2, NR1B3, NR1C1, NR1C2, NR1C3, NR1D1, NR1D2, NR1F1, NR1F2, NR1F3, NR1H2, NR1H3, NR1H4, NR1H5, NR111, NR112, NR113, NR2A1, NR2A2, NR2B1, NR2B2, NR2B3, NR2C1, NR2C2, NR2E1, NR2E3, NR2F1, NR2F2, NR2F6, NR3A1, NR3A2, NR3B1, NR3B2, NR3B3, NR3C1, NR3C2, NR3C3, NR3C4, NR4A1, NR4A2, NR4A3, NR5A1, NR5A2, NR6A1, NR0B1, and NR0B2. A set of driver constructs can optionally encode transcription factor (e.g., nuclear hormone receptor) sequences selected from those referenced in Table 4 and/or Table 6, e.g., within an expression vector such as pcDNA3.1 and comprising a C-terminally linked V5H6 tag. Optionally, the set of driver constructs used in the methods can encode one or more histone acetyl transferase (HAT), histone deacetylase (HDAC) and/or histone methylransferase (HMT).

Arrays of reporter cells that can be used in the methods of identifying or analyzing a network of transcription factor-gene element interactions are also provided herein. The array of reporter cells can optionally be formatted in one or more microtiter tray or trays (also referred to herein as a “multi-well plate”), wherein each well of the microtiter tray or trays comprises cells (also referred to herein as “wells”) co-transfected with, e.g., at least one reporter construct and at least one driver construct; or with at least, e.g., 3, 5, 10, 50, 100, 150, 250, or 500 or more reporter constructs and at least, e.g., 3, 5, 10, 25, 50, or 100 or more driver constructs. In some embodiments, the cells comprising the array can be transfected with at least, e.g., 3, 5, 10, 25, 48, 49, or 50 different driver constructs that encode, e.g., nuclear hormone receptors. The array of reporter cells can optionally comprise Human Embryonic Kidney cells (293 cells), or African Green Monkey Kidney Fibroblast cells (CV-1 cells). The cells can optionally be incubated in a stripped, hormone-free media.

Determining which driver nucleic acids direct expression of which reporter constructs can optionally include performing an unsupervised hierarchical two dimensional cluster analysis that clusters reporter constructs into functional classes on the basis of similarity in regulation by the driver constructs. Transcription factor-gene element interactions can optionally be determined by arranging the transfected reporter cells in a manner that homologous transcription elements in the transfected reporter cells are grouped according to sequence similarity, so that transfected reporter cells comprising homologous transcription elements with higher levels of sequence similarity are located in closer proximity within the array. In such arrangements, transfected cells comprising homologous driver nucleic acids can be grouped by sequence similarity, whereby transfected cells comprising driver nucleic acids that display higher levels of sequence similarity are also located in closer proximity within the array.

Methods of identifying or analyzing a network of transcription factor-gene element interactions transcription factor-gene element interactions can optionally further include adding a plurality of transcription modulating agents such as transcription factor ligands to the array of reporter cells, wherein each of the plurality of ligands are added to individual array reported cells transfected by a cognate driver. Such transcription factor ligands can include, e.g., ligands as listed in Table 5.

The methods described herein can optionally further include steps to determine an effect of a transcription modulating agent, such as a chemical compound, on an interaction between a transcription modifying protein, such as transcription factor, and a nucleic acid promoter sequence, such as a gene transcription element. For example, a plurality of compounds can be added to the array of reporter cells, wherein at least one compound is added to each of a plurality of reporter cells of the array, and an effect of a compound on the nucleic acid reporter sequence expression can then be determined. Optionally, at least, e.g., 10,000, 20,000, 30,000, 40,000 or 50,000, or 100,000 or more different transcription modulating agents (e.g. compounds) can be added to the different reporter cell members of the array (wherein each reporter cell member may be physically separated, e.g. in different wells of a multi-well plate, from other reporter cells which are contacted with a different transcription modulating agent). In particular embodiments, at least 10,000 different transcription modulating agents (e.g. compounds) can be added to the array, wherein a single different transcription modulating agents (e.g. compound) can be added to individual array member reporter cell such that each comprise at least one reporter construct and at least one driver construct. The driver constructs in such embodiments may collectively encode at least 20, at least 50, or at least 100 or more different transcription modifying proteins (e.g. transcription factors) and the reporter nucleic acid constructs collectively can comprise at least 20, at least 50, at least 100, at least 250, or at least 500 or more different reporters (e.g. transcription elements). For example, the array members can comprise at least 2, at least 5, at least 10, at least 25, or at least 48, or at least 49, or at least 50 driver constructs that encode transcription modifying proteins, e.g., nuclear hormone receptors. Methods of analyzing or identifying a network of transcription modifying protein-promoter interactions, can optionally further include a step of selectively screening for a compound that has an effect on a single transcription modifying protein (e.g. transcription factor) or a set of closely related transcription modifying proteins, but which does not have an effect on other transcription modifying protein encoded by the set of driver nucleic acids.

The compounds added to the array of reporter cell can optionally be selected from, e.g., a pharmacophore library, a library of compounds that follow Lipinski's “Rule of 5,” a library of transcription factor modulators, a library of nuclear hormone receptor modulators, and a library of compounds selected for a structural relationship to a transcription factor, transcription factor ligand, nuclear hormone receptor or nuclear hormone receptor ligand.

In some embodiments, the nucleic acid promoter sequence facilitates transcription of a circadian pathway gene. For example, the nucleic acid promoter sequence may facilitate the expression of a product of one or more genes selected from the group consisting of: Bmal1, Clock, NPAS2, Per1, Per2, Per3, Cry1, Cry2, Rev-erb α, Rev-erb β, Rora, Rorb, Rorc, Dec1, Dec2, Dbp, Tef, Hlf, and E4 bp4. In some embodiments, the genes are set forth in Table 2 and/or Table 3. In other separate or related embodiments, nucleic acid drive sequence encoding a transcription modifying protein may encode a nuclear hormone receptor, such as a nuclear hormone receptors selected from NR1A1, NR1A2, NR1B1, NR1B2, NR1B3, NR1C1, NR1C2, NR1C3, NR1D1, NR1D2, NR1F1, NR1F2, NR1F3, NR1H2, NR1H3, NR1H4, NR1H5, NR111, NR112, NR113, NR2A1, NR2A2, NR2B1, NR2B2, NR2B3, NR2C1, NR2C2, NR2E1, NR2E3, NR2F1, NR2F2, NR2F6, NR3A1, NR3A2, NR3B1, NR3B2, NR3B3, NR3C1, NR3C2, NR3C3, NR3C4, NR4A1, NR4A2, NR4A3, NR5A1, NR5A2, NR6A1, NR0B1, and NR0B2. And in some related or separate embodiments, a test transcription modulating agent may be evaluated in an effort to identify a transcription modulating agent capable to modulating the expression of protein related to the circadian pathway (such as Bmal1, Clock, NPAS2, Per1, Per2, Per3, Cry1, Cry2, Rev-erb α, Rev-erb β, Rora, Rorb, Rorc, Dec1, Dec2, Dbp, Tef, Hlf, and E4 bp4).

The methods may include exposing the members of a reporter cell array to a library transcription modulating agents (e.g. a compound library) which comprises potential (e.g. test) modulators of nuclear hormone receptor-mediated expression of a gene product of Bmal1, Clock, NPAS2, Per1, Per2, Per3, Cry1, Cry2, Rev-erb α, Rev-erb β, Rora, Rorb, Rorc, Dec1, Dec2, Dbp, Tef, Hlf, or E4 bp4, such that at least one compound is contacted to each of the plurality of members of the array. In some embodiments, the gene products are set forth in Table 2 and/or Table 3. Such a compound library can include, e.g., any one of the compound libraries described herein. The methods include identifying members of the array that display an effect of the compound on driver mediated expression of at least one reporter construct, thereby identifying the modulator. This set of methods can optionally further comprise adding a plurality of transcription factor ligands to the array of reporter cells in a manner wherein a different member of the plurality of ligands is added to individual array members transduced by a cognate driver nucleic acid.

An array of reporter cells can individually comprise one or more reporter nucleic acids which themselves individually comprise at least one transcription regulatory element that facilitates expression of, e.g., at least three genes, at least five genes, or at least seven genes selected from the group consisting of Bmal1, Clock, NPAS2, Per1, Per2, Per3, Cry1, Cry2, Rev-erb α, Rev-erb β, Rora, Rorb, Rorc, Dec1, Dec2, Dbp, Tef, Hlf, and E4 bp4. In some embodiments, the genes are set forth in Table 2 and/or Table 3. The members of the array can optionally be produced by co-transfection with a reporter nucleic acid and a driver nucleic acid, and the reporter cells comprising the array can be exposed to a compound library during or after said co-transfection. Optionally, the reporter cells comprising the array can be exposed to a compound library before co-transfection.

In some embodiments, at least 10,000, 20,000, 30,000, 40,000 or 50,000, or 100,000 or more different compounds can be added to the array. In such embodiments, a different compound is added to individual array members that each comprise at least one reporter nucleic acid and at least one driver nucleic acid (or optionally at least three reporter nucleic acid and at least three driver nucleic acid constructs). The driver nucleic acids of these embodiments collectively encode at least 20, at least 48, at least 49, at least 50, or at least 100 or more different transcription factors, and the reporter nucleic acids can collectively comprise at least 20, at least 50, at least 100, at least 250, or at least 500 or more different transcription elements.

In other embodiments, the nucleic acid reporter sequence may facilitate transcription of a protein product of Per1 or Rev-erb α, wherein the nucleic acid reporter sequence is operably linked to at least one reporter nucleic acid sequence. The reporter cells in the array also individually comprise one or more members of a set of driver nucleic acids constructs encoding a transcription modifying proteins selected from NR4a1, TRα, TRβ, PPARγ and ERRγ. Methods may include exposing a compound library comprising potential modulators of NR4a1, TRα, TRβ, PPARγ or ERRγ mediated expression of Per1 or Rev-erbα to the members of the array, such that at least one compound is contacted to each of a plurality of members of the array. Such a compound library can include any one of the libraries described previously. The modulator(s) of a circadian pathway gene is identified by identifying members of the array that display an effect of the compound on NR4a1, TRα, TRβ, PPARγ or ERRγ mediated expression of at least one reporter construct.

Thus, arrays of reporter cells are provided herein that are produced by co-transfection with a reporter nucleic acid construct and a driver nucleic acid construct. The arrays of reporter cells may be exposed to a library of transcription modulating agents (e.g. a compound library) during or after co-transfection. Optionally, the members of the array can be exposed to the compound library before co-transfection.

Also provided herein are cDNA expression libraries (e.g. nucleic acid driver sequences encoding a transcription modifying protein) comprising at least 5 different full-length expressible nuclear hormone receptor cDNA sequences, which, when expressed, produce an active gene product. A cDNA expression library of the invention can optionally include, e.g., at least 30, at least 48, or at least 49 different sequence and activity validated expressible nuclear hormone receptor cDNA sequences. The cDNA sequences that comprise an expression library of the invention can optionally be cloned into a pcDNA3.1 expression vector and comprise a C-terminally linked V5H6 tag. The invention also provides cDNA library comprising one or more, e.g., 2, 3, 4, 5 or more constructs selected from the group consisting of the sequences corresponding to accession numbers: NM_{—}178060, NM_{—}009380, NM_{—}009024, NM_{—}011243, NM_{—}011244, NM_{—}011144, NM_{—}011145, NM_{—}011146, NM_{—}145434, NM_{—}011584, NM_{—}013646, NM_{—}146095, NM_{—}011281, NM_{—}009473, NM_{—}013839, NM_{—}009108, NM_{—}198658, NM_{—}009504, NM_{—}010936, NM_{—}009803, NM_{—}008261, NM_{—}013920, NM_{—}011305, NM_{—}011306, NM_{—}009107, NM_{—}011629, NM_{—}011630, NM_{—}152229, NM_{—}013708, NM_{—}010151, NM_{—}009697, NM_{—}010150, NM_{—}007956, NM_{—}207707, NM_{—}007953, NM_{—}011934, NM_{—}011935, NM_{—}008173, XM_{—}356093, NM_{—}008829, X53779, NM_{—}010444, NM_{—}013613, NM_{—}015743, NM_{—}139051, NM_{—}030676, NM_{—}010264, NM_{—}007430, NM_{—}011850, or to the sequence of any transcription factor described in Table 6.

The invention also provides reporter cell arrays that can collectively comprise a set of at least 5 different full-length expressible transcription factor cDNA sequences that, when expressed, produce at least one active gene product. The sequences can encode one or more nuclear hormone receptor, histone acetyl transferase (HAT), histone deacetylase (HDACs) and/or histone methylransferase (HMT). The reporter cell array additionally can comprise a set of at least 5 different reporter constructs, each of which comprises at least one gene transcription element derived from at least one gene of interest, each of which transcription elements is operably coupled to at least one nucleic acid subsequence encoding at least one heterologous reporter moiety, e.g., any one of the reporter moieties described previously. The 5 different reporter constructs can optionally collectively comprise 5 different gene transcription elements from 5 different genes of interest, wherein the genes of interest are active in the same gene pathway, e.g., any of the gene pathways described previously. In certain embodiments, the set of reporter constructs in a reporter cell array can optionally comprise, e.g., at least 10 different transcription elements derived from at least 10 different genes, at least 20 different transcription elements derived from at least 20 different genes, at least 30 different transcription elements derived from at least 30 different genes, at least 50 different transcription elements derived from at least 50 genes, at least 100 different transcription elements derived from at least 100 different genes, at least 250 different transcription elements derived from at least 250 genes, or at least 500 or more different transcription elements derived from at least 500 or more genes. In such embodiments, the set of transcription factor cDNAs can encode at least 10, at least 20, at least 30, or at least 48 or 49, full-length, and active nuclear hormone receptors.

In certain embodiments, a reporter cell array can optionally include gene transcription elements (e.g. nucleic acid promoter sequence linked to a nucleic acid reporter sequence) that are derived from (e.g. facilitate transcription of a gene product of) a plurality of circadian pathway genes, e.g., Bmal1, Clock, NPAS2, Per1, Per2, Per3, Cry1, Cry2, Rev-erb α, Rev-erb β, Rora, Rorb, Rorc, Dec1, Dec2, Dbp, Tef, Hlf, and E4 bp4. In some embodiments, the gene products are set forth in Table 2 and/or Table 3. The gene transcription elements can optionally be derived from at least one gene of interest in, e.g., a circadian pathway gene, an inflammation pathway gene, a reproductive pathway gene, a metabolic gene, a metabolic syndrome related gene, an obesity related gene, an insulin response pathway gene, a lipid metabolism gene, a sugar metabolism gene, a cholesterol transport gene, a xenobiotic metabolism gene, a cardiovascular pathway gene, steroidogenic pathway, drug pumps (transporters), growth factors (FGFs), neurotransmitter receptors, a feeding related pathway (HPA axis), or a cancer related gene. A reporter cell array can optionally include a set of reporter nucleic acid constructs that comprises transcription elements derived from Per1 or Rev-erbα and the set of nuclear hormone receptor nucleic acids can encode TRα, TRβ, PPARγ or ERRγ.

Those of skill in the art will appreciate that that the methods provided herein, e.g., methods of identifying functional characteristics, identifying transcription modulating agents, or analyzing a network of transcription factor-gene element interactions, can be used alone or in combination with any of the cDNA expression libraries, reporter cell arrays, or other compositions described herein. Systems that include any of the compositions described herein are also a features of the invention. Such systems can optionally include detectors, array readers, excitation light sources, and the like.

Kits that incorporate the compositions described herein and/or that utilize the methods herein are a feature of this invention. Such kits can also optionally include additional useful reagents such as media, containers, and instructions as to enable the use of, e.g., driver constructs, reporter gene constructs, etc., to test one or more compound libraries, to identify a compound that modulates one or more transcription factor-gene element interaction, to identify functional characteristics of promoters and/or transcription modifying proteins, as further described below.

In some embodiments, the physiologic pathway includes a Nuclear Hormone Receptor. Also provided herein are newly developed and validated cDNA expression library encompassing the entire Nuclear Hormone Receptor (NHR) Family (see Table 4) paired with relevant collations of promoters whose genes encode potentially therapeutic and/or pathologic products. Since products of genes are only rarely therapeutic targets, the invention identifies promoters of key genes whose transcription can be controlled by one or more drugable Nuclear Receptors or NHR-associated products. The methods provided herein include identifying regulable NHR-target promoter pairs, providing a means to repurpose existing therapeutic drugs and/or providing a novel high throughput screen for new classes of therapeutic pharmacophores. Essentially, drugs developed to regulate promoters of key genes act as surrogate agonists or antagonists of the actual gene product. Surrogate agonists or antagonists either increase or decrease the key gene product to achieve their therapeutic effect. The assays and methods of the invention are both sensitive and quantitative and also provide the key structural activity relationship (SAR) needed to develop novel pharmaceuticals to control complex physiologic pathways. In various embodiments, the various moieties herein can be sequenced and/or activity validated.

NHRs and their associated co-factors (such as HATs, HDACs & HMTs) are ideal drug targets. The importance of these transcription factors in maintaining the normal physiological state is illustrated by the large number of drugs that have been developed to combat disorders that have inappropriate nuclear receptor signaling as a key pathological determinant. These disorders affect every field of medicine, including reproductive biology, inflammation, metabolism, cancer, diabetes, cardiovascular disease, and obesity.

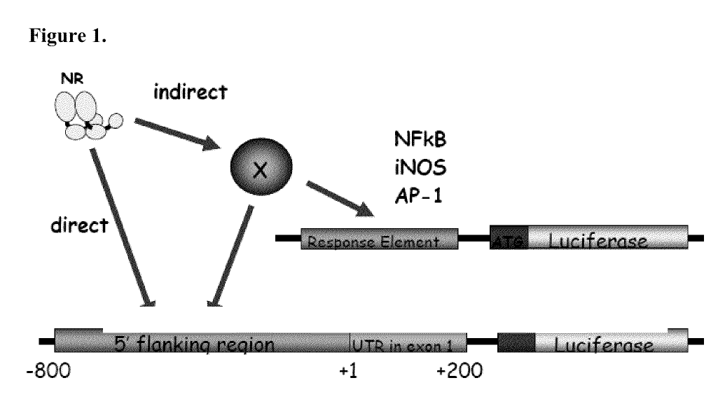

The NHR-promoter screens of the invention consist of testing all members (or optionally a subset of such) of the NHR family against a set of promoters that control the production of important therapeutic products (e.g., genes within a particular physiological pathway such as the circadian pathway). NHRs and their ligands (or NHR co-factors and their synthetic modulators) can be used to dial up or down the levels of the therapeutic or pathologic product, effectively changing its cellular activity in a controlled fashion. In various embodiments, screening can be based on highly sensitive and quantitative automated transcriptional assays using luciferase-based reporters. A fully developed and validated full-length cDNA expression library for all 49 members of the NHR family is also shown in the invention. Each of the receptors was cloned into the pcDNA3.1 mammalian expression vector, C-terminally linked to a V5H6 tag, sequenced and validated for functional activity. Co-expression of these modified NHR constructs individually with therapeutic promoters (or synthetic response elements) driving the luciferase gene allows for rapid non hybridization-dependent quantitative analysis of drug dependent transcriptional regulation by the NHR-family. FIG. 1 displays a schematic showing the basic concept of the NHR-promoter screens herein. As can be seen, co-expression of a NHR with a promoter or synthetic response element fused to the luciferase gene allows for the detection of NHR-mediated transcriptional regulation.

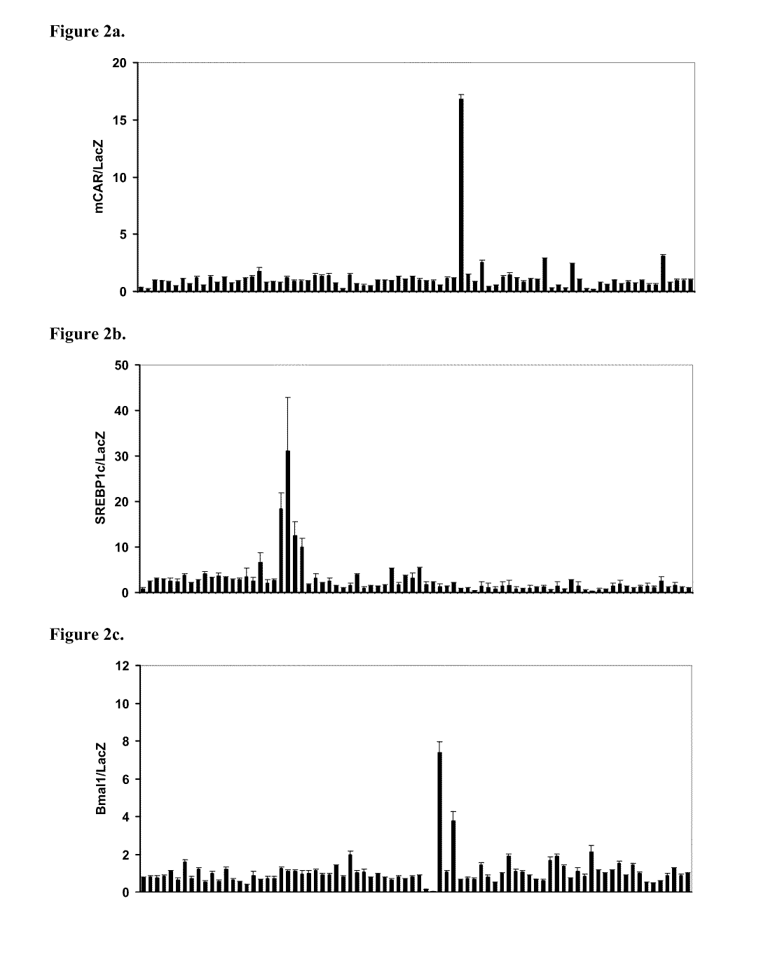

Herein is provided results of experiments that have tested and validated the use, feasibility and reproducibility of the functional NHR-promoter screen in a variety of formats, including the 48-well format. Briefly, each NHR/NHR homodimer or NHR/RXR heterodimer was co-expressed with a promoter and LacZ (as a control for transfection efficiency) in mammalian cells. After transfection, ligands were added (where applicable) and samples were assayed for luciferase and LacZ activity. In this way, the inventors explored the use of this functional NHR-promoter screen with a selection of about 30 promoters covering various pathways such as inflammation, lipid and sugar metabolism, cholesterol transport, xenobiotic metabolism, and circadian rhythm. See Tables 6 et seq. Based on the results from this screen, this approach proved to be extremely powerful as the inventors were able to confirm known NHR-promoter regulations as well as to identify novel interactions. See FIG. 2 and the Examples section below. FIG. 2 shows specific and strong activation of the Constitutive Androstane Receptor (CAR) promoter by Nuclear Receptor HNF4-alpha (panel A) and specific and strong activation of the SREBP1c promoter by Nuclear Receptors LXR-alpha and -beta (panel B). The figure also shows specific activation of the Bmal1 promoter by Nuclear Receptors ROR-alpha and -gamma, and specific repression by Rev-Erb-alpha and -beta.

One of the major challenges in the post-genomic era is to develop drugs that exploit the fundamental function and interplay of genes that build and maintain the organism. The availability of the complete human genome sequence, with the advent of bioinformatic tools and array technologies, provides a new opportunity for drug development. In the last few years, genomic approaches such as microarray expression analyses and ChIP-chip transcription factor binding assays have led to a more comprehensive view of genetic pathways. However, these technologies do not identify the functional interactions between genes or connections within networks. Furthermore, these technologies, which have a limited signal-to-noise ratio, are primarily used to functionally validate large-scale genomic experiments. The current invention uses Nuclear Hormone Receptors (NHRs) to identify the functional interactions between genes or connections within networks that can be controlled by new classes of therapeutic drugs. The most general application of the approach is the creation of genome-wide functional reporter assays that identify controllable and drugable pathways in living cell systems.

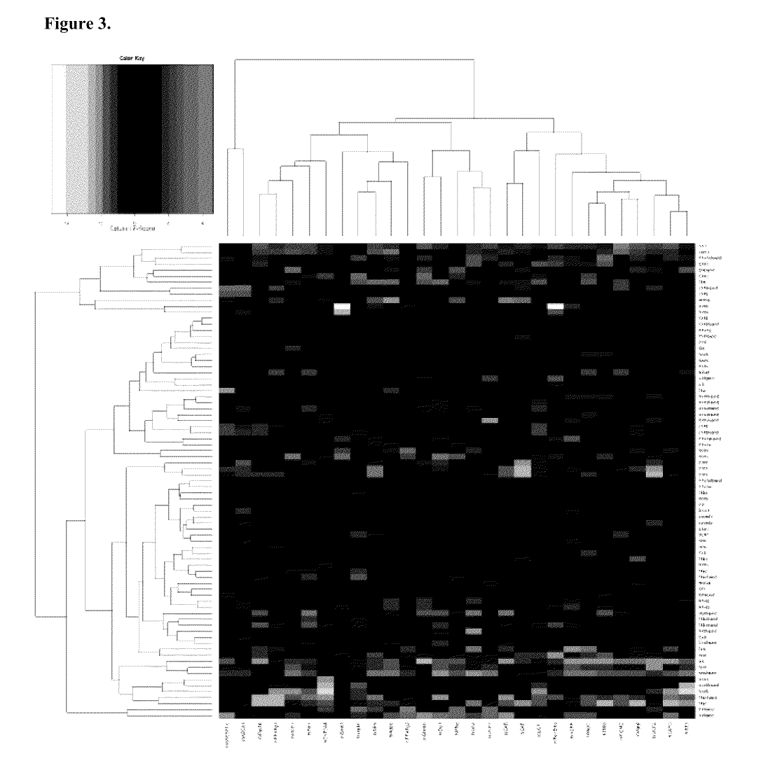

In some embodiments, an unsupervised, hierarchical clustering algorithm further can be used to cluster a set of promoters from the circadian pathway on the basis of their similarities in regulation by the NHRs. For example, the NHRs were clustered on the basis of their regulation of each of the 29 promoters. See FIG. 3. In the figure, each row represents a NHR with and without ligand, for a total of 80 variables, and each column a single promoter that facilitates transcription of the named gene. In FIG. 3, a lighter shade represents upregulation, a grayer shade represents downregulation and black indicates no change. As can be seen from this limited dataset, clustering of the NHRs is well in accordance with their phylogenetic relationships. For example, the closely related receptors SF1 and LRH1 were clustered, as were Rev-Erb alpha and -beta, and RARalpha, -beta and -gamma. Within the promoters, expected relationships were identified as well, such as clustering of SREBP1c and ABCA1, two genes that are involved in cholesterol metabolism and of MDR1 and CYP450, two genes with overlapping substrate specificities. Thus, unsupervised clustering with this limited dataset provides powerful insight in suggesting how collations of therapeutic promoters can be commonly regulated by NHRs. It is contemplated that using larger sets of promoters will greatly increase this power and allow for the identification of novel and more complex NHR-promoter networks controlling disease relevant pathologies. It will be appreciated that other embodiments of the invention can also obtain wherein the promoters and/or NHR can optionally be gridded in any arrangement imposed by a software filter to digitally reconstruct layout.

The paired NHR-therapeutic promoter screens provide a powerful tool to identify and develop novel classes of drugs based on increasing or decreasing transcription of single promoters encoding disease relevant gene products. While the invention is primarily described herein with use of nuclear hormone receptors, it will be appreciated that the screens can be expanded to other TF families and transcriptional co-regulators such as (but not limited to), e.g., histone acetyl transferases (HATs), histone deacetylaes (HDACs) and histone methylransferases (HMTs). The invention will enable drug discovery for complex physiologic pathways and gene networks known to be important in human disease.

Various embodiments of methods provided herein include the identification of NHR responsive promoters whose gene products comprise the core components of the Circadian Clock. In mammals, the circadian system comprises a master clock located in the hypothalamus that is directly entrained by the light/dark cycle and which coordinates the phases of local clocks in the periphery in order to ensure optimal timing of the physiology. The Circadian Clock plays broad roles in sleep, metabolism and feeding behavior. Altered Circadian rhythms can result in sleep disruption, increased weight (obesity), metabolic disease (including insulin resistance, hyperlipidemia, hyperglycemia, hypertension and atherosclerosis) and drug metabolism. See, e.g., Green, et al., (2008) “The Meter of Metabolism.” Cell 134:728-742. Because of its anatomical location and its physical complexity the clock poses one of the most challenging drug targets in medicine. The technology described in the present application provides a straightforward, high throughput, sensitive, and quantitative strategy to identify therapeutic agonists and/or antagonists that can predictably modulate the circadian clock (and other complex regulatory circuits) for therapeutic benefit.

Circadian rhythms are biorhythms with a cycle of about 24 hours, and are in vivo phenomena that can be commonly observed in numerous organisms ranging from unicellular organisms to human beings. Circadian rhythms are controlled by a transcriptional feedback system fluctuating as a function of the light-dark cycle. The negative feedback loop of the molecular clock mechanism involves two key transcription factors, CLOCK and BMAL1, which form a heterodimer and regulate the rhythmic transcription of the Period (Per1-3) and Cryptochrome (Cry1-2) genes. In turn, PER/CRY heterodimers act as negative regulators of BMAL1/CLOCK (FIG. 1). The NHRs Rev-erbα and RORα are an integral part of this negative feedback loop by regulating the transcription of Bmal1.

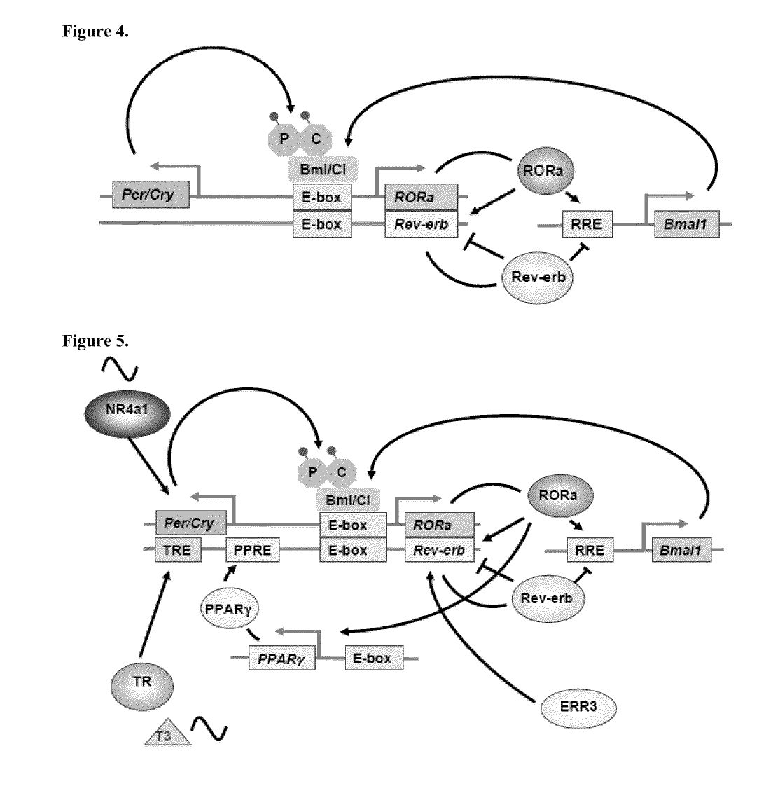

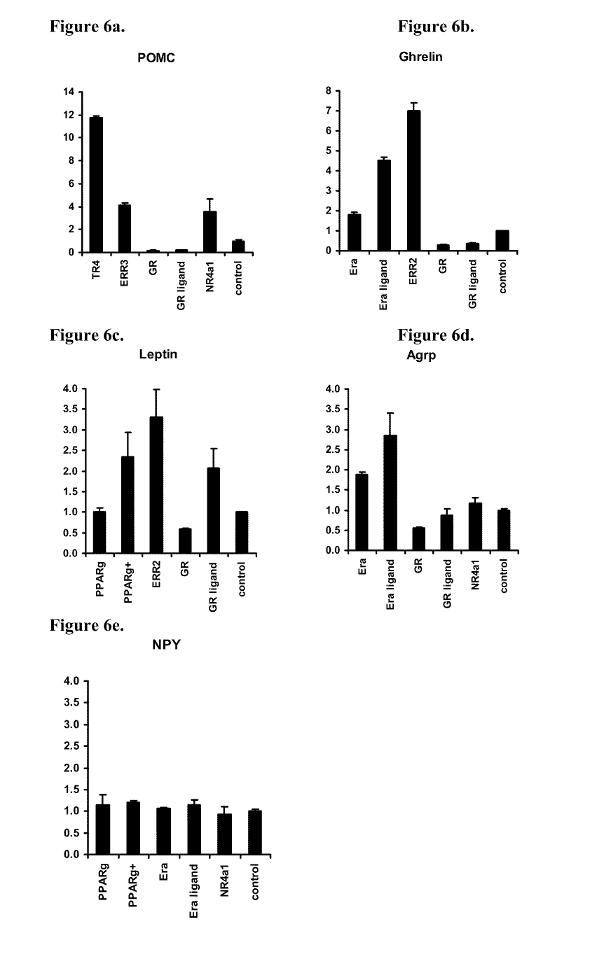

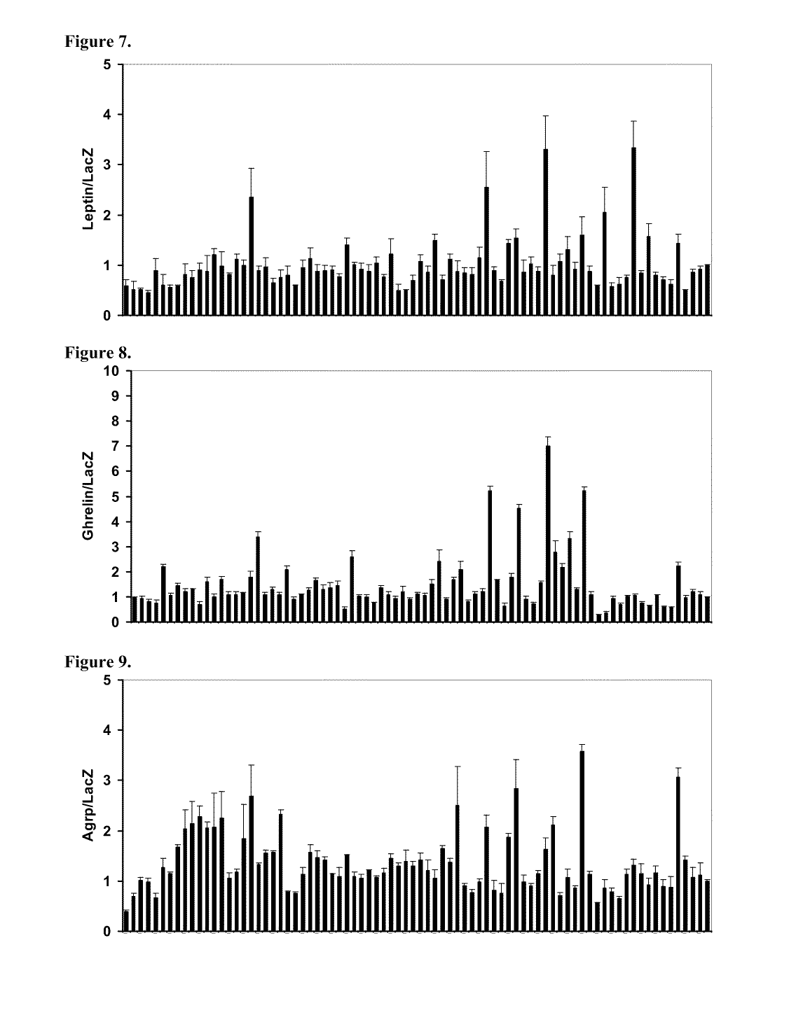

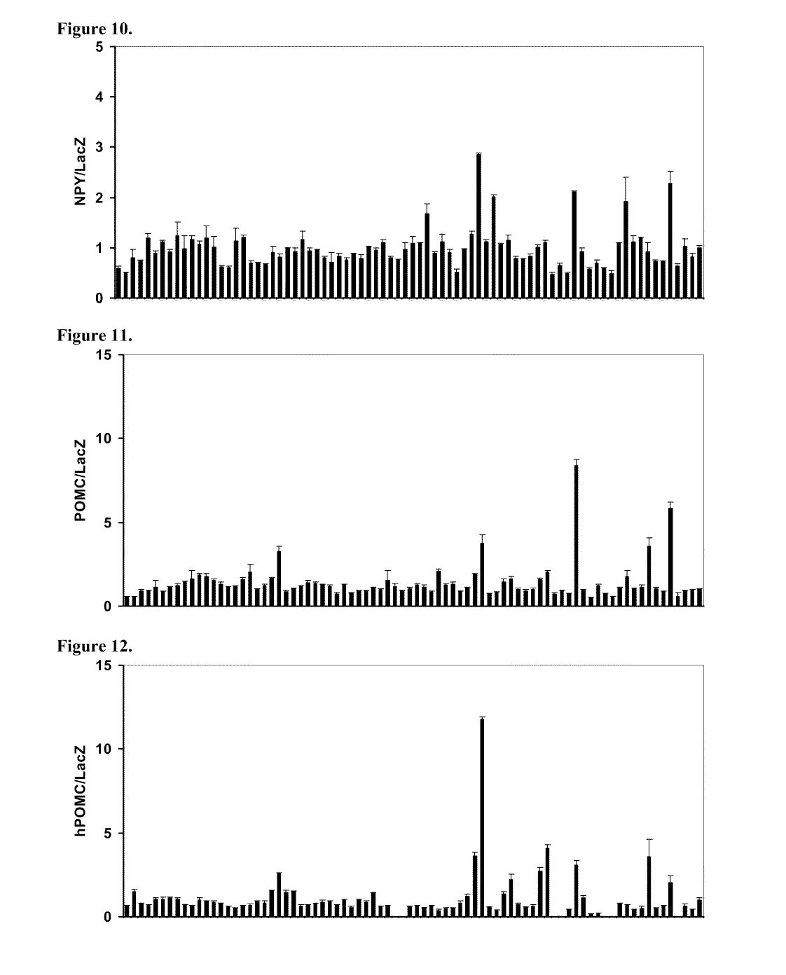

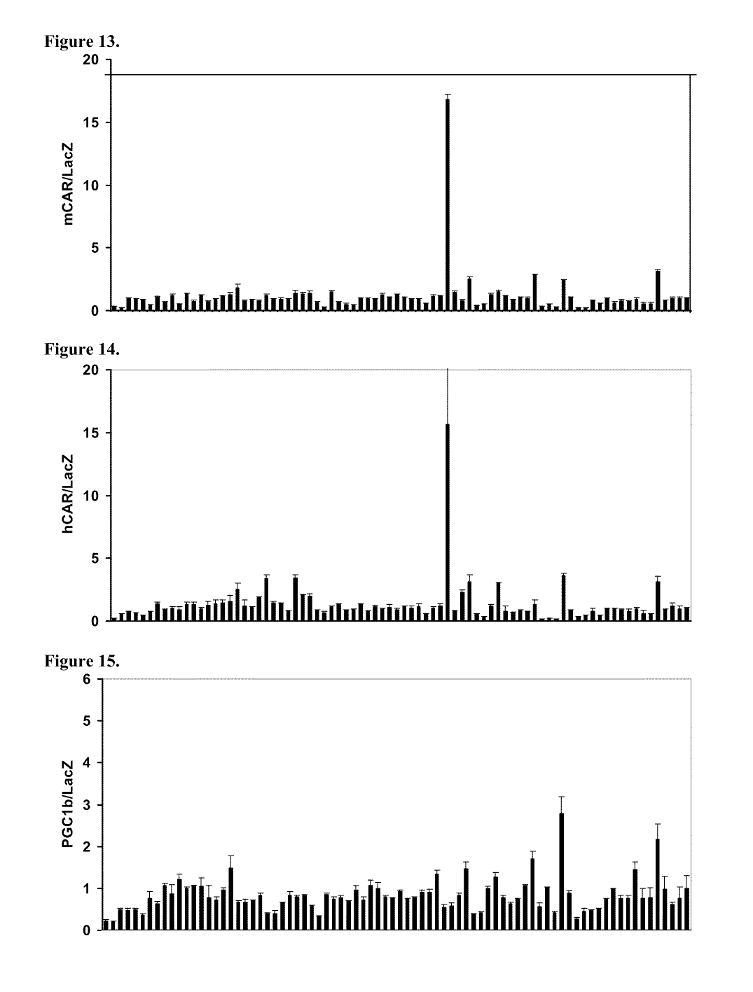

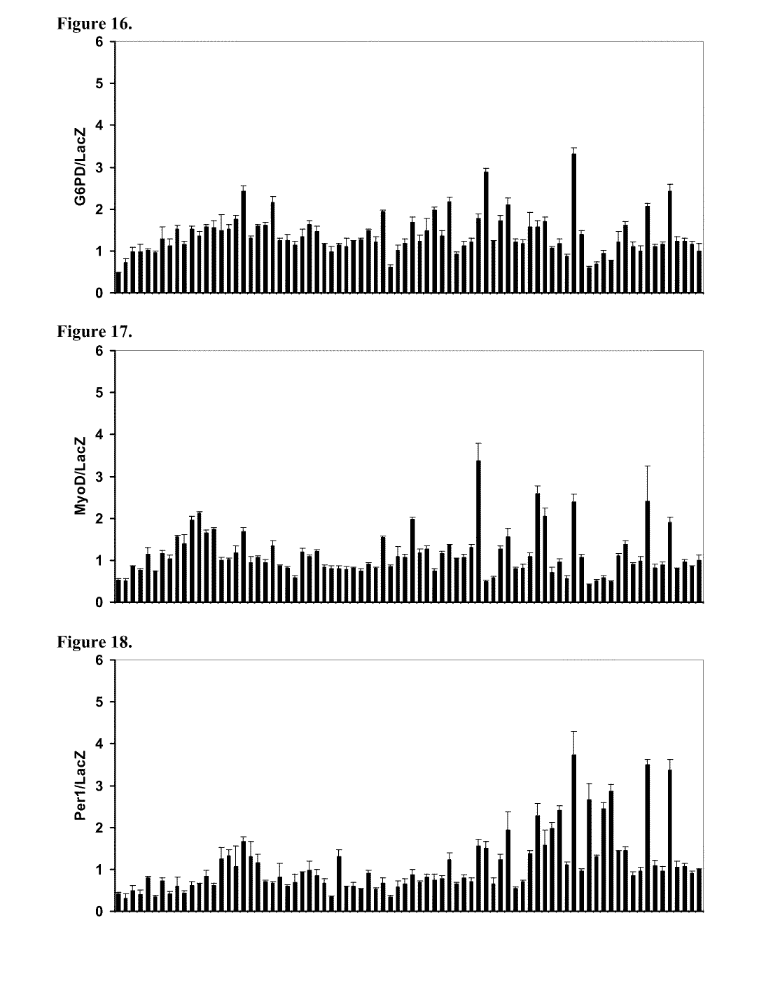

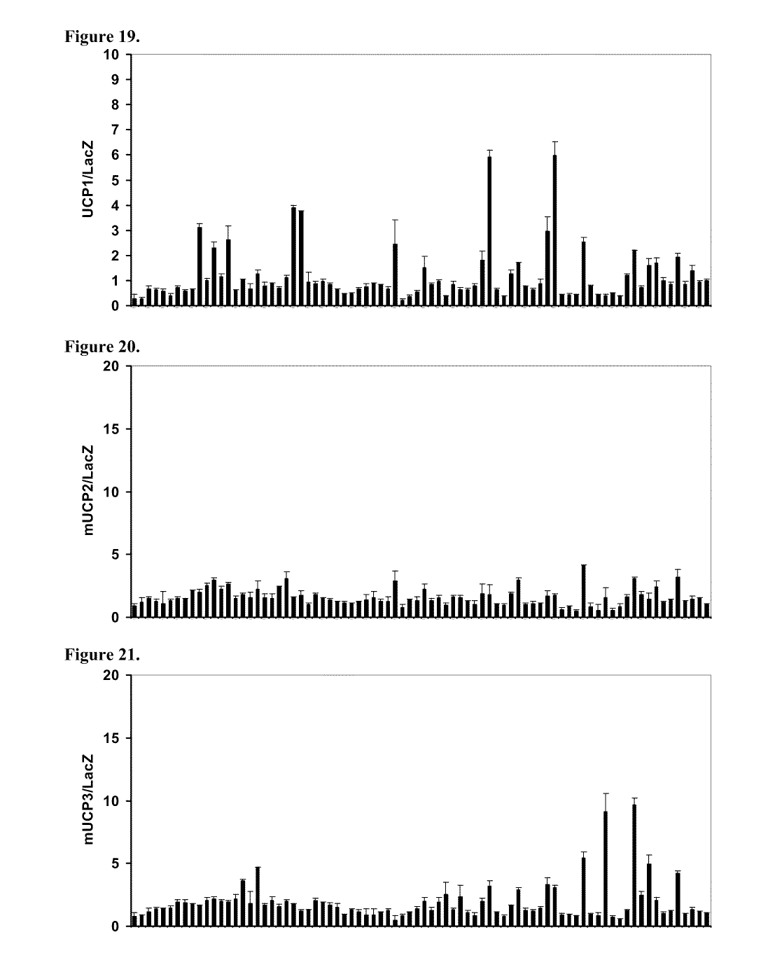

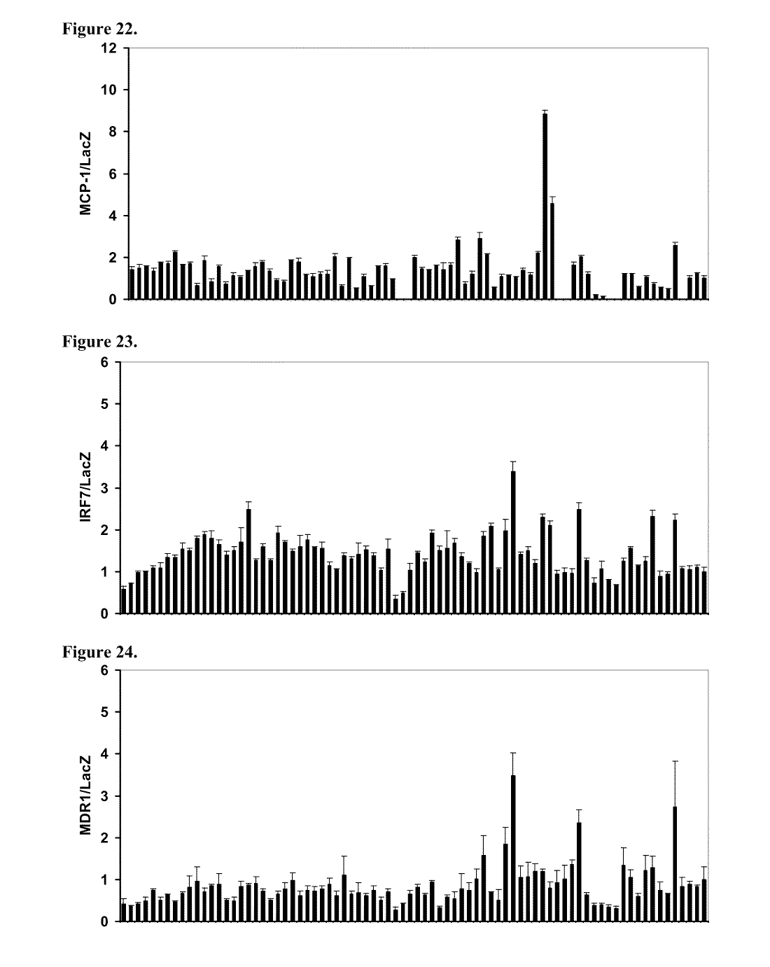

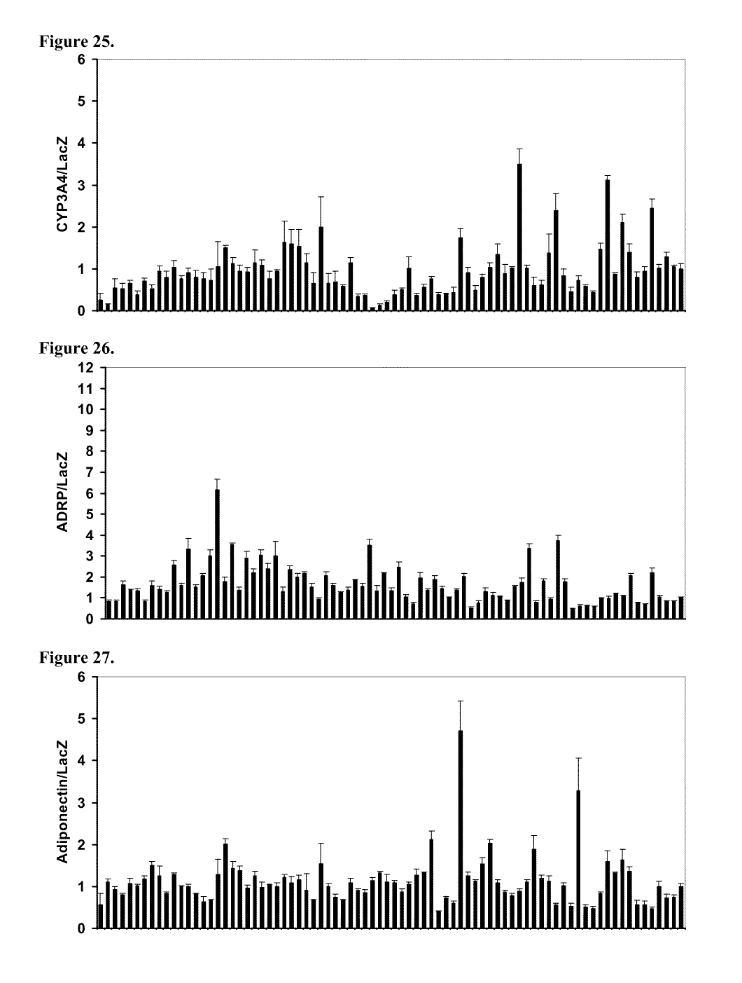

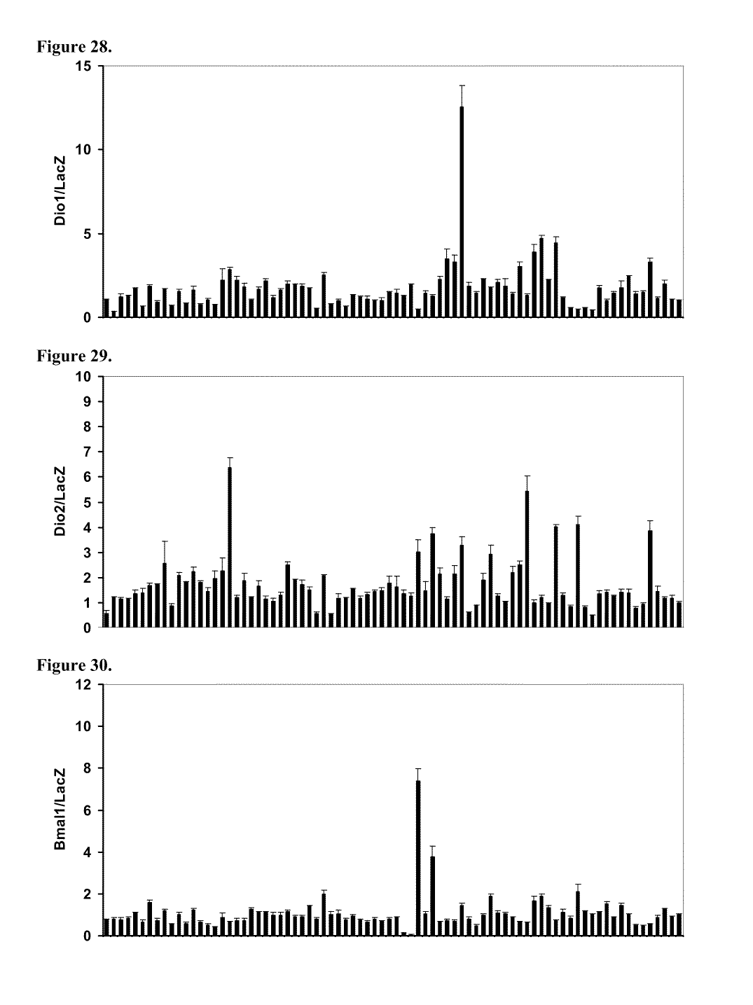

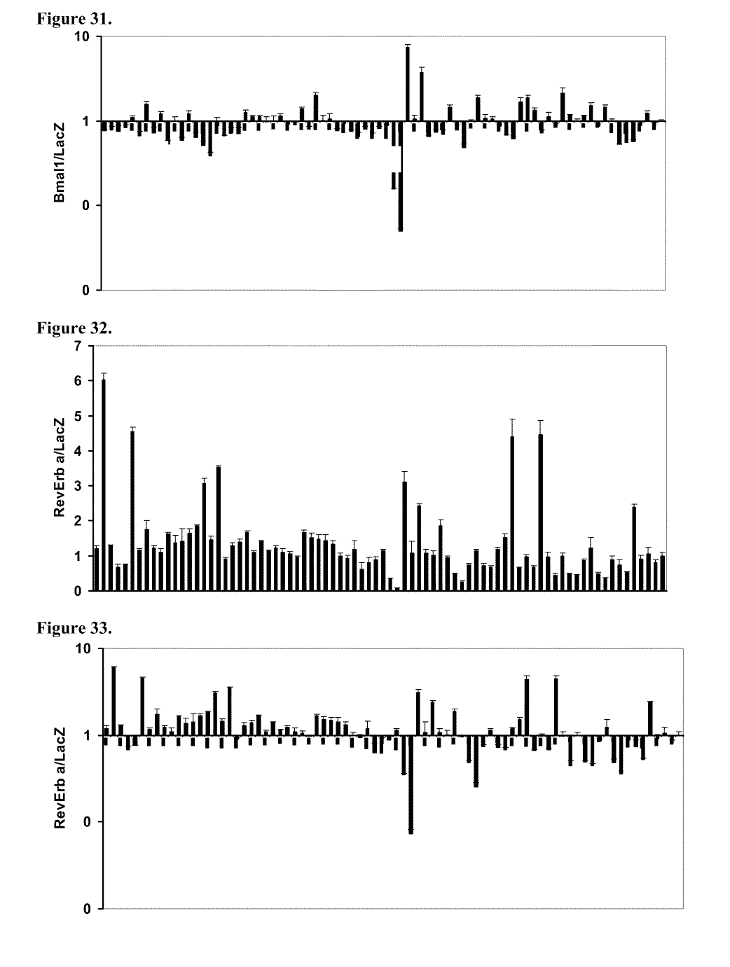

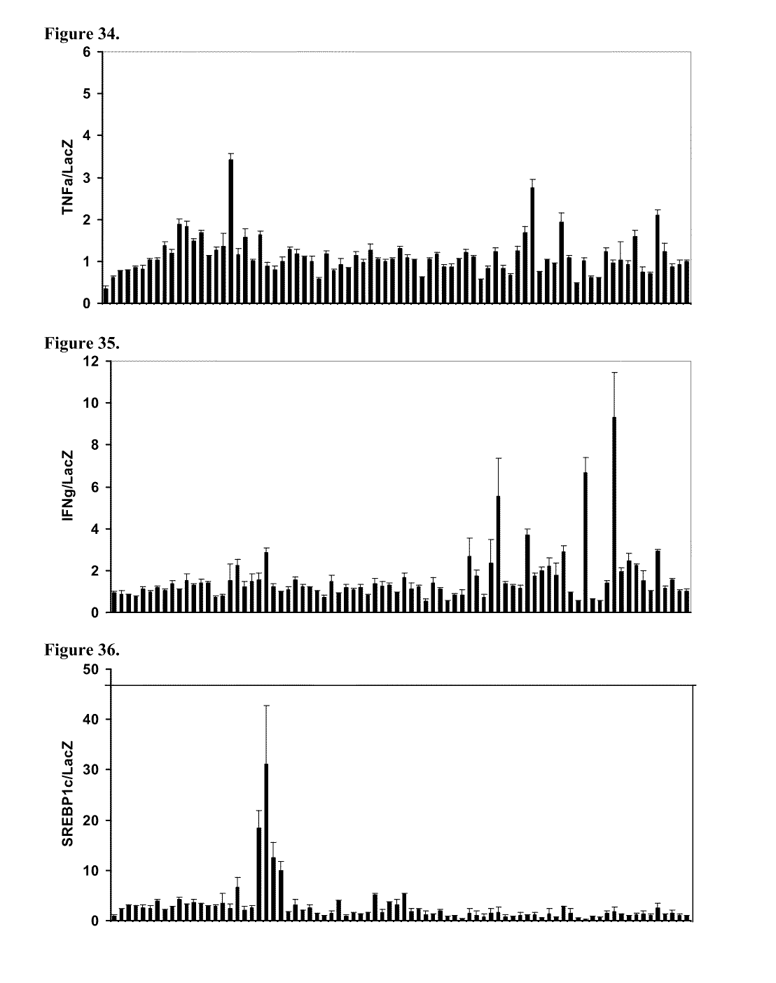

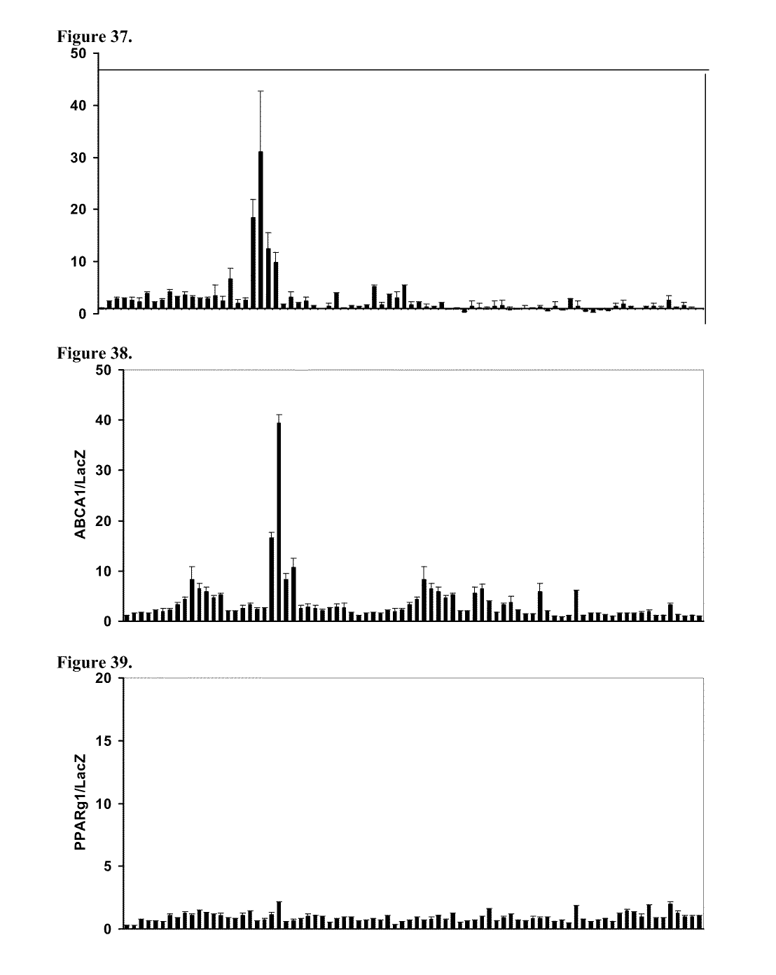

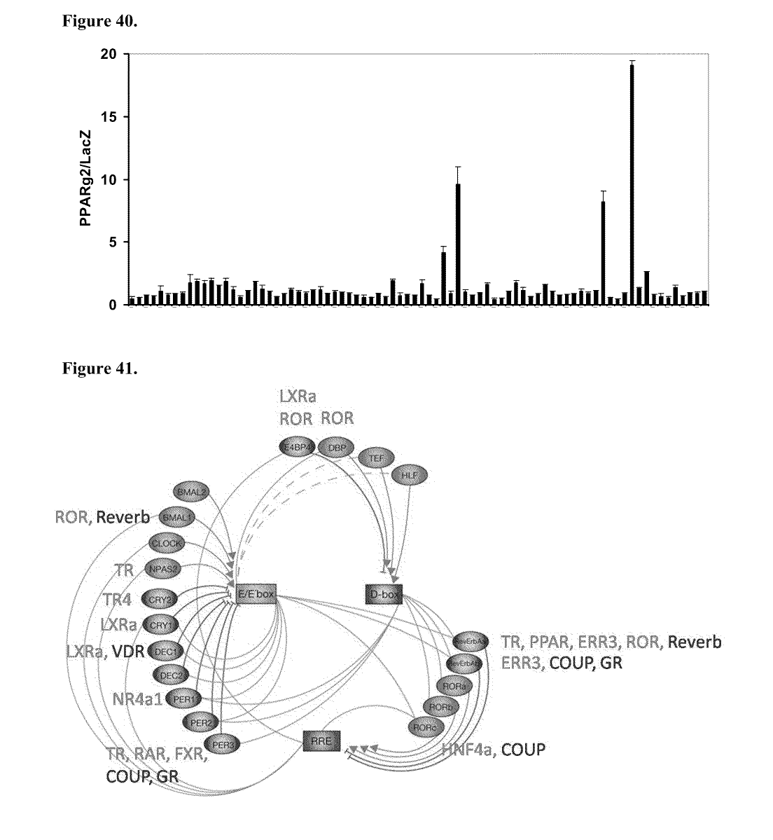

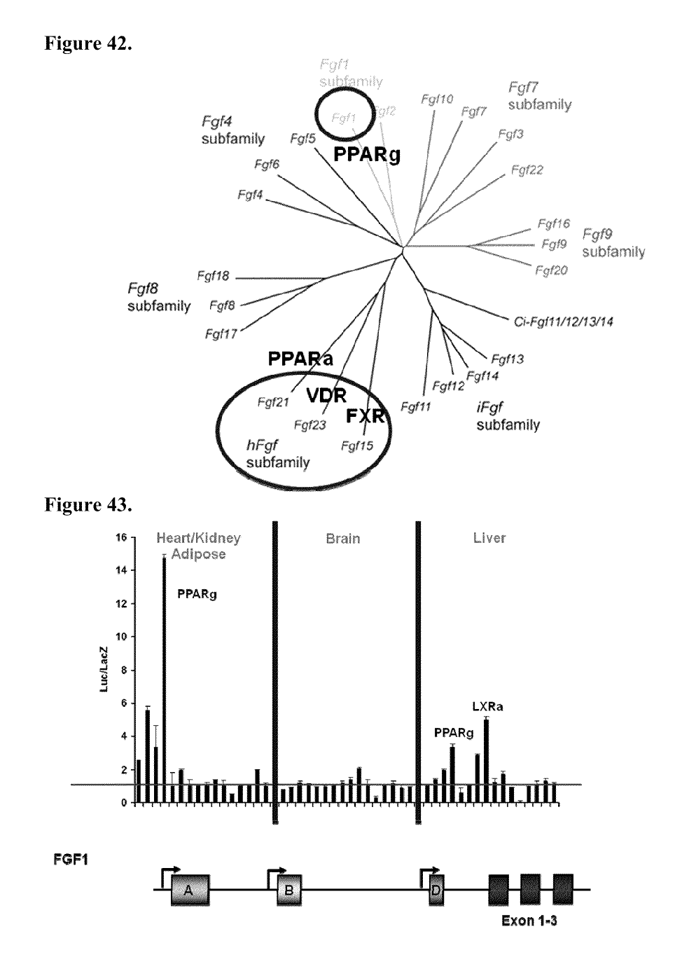

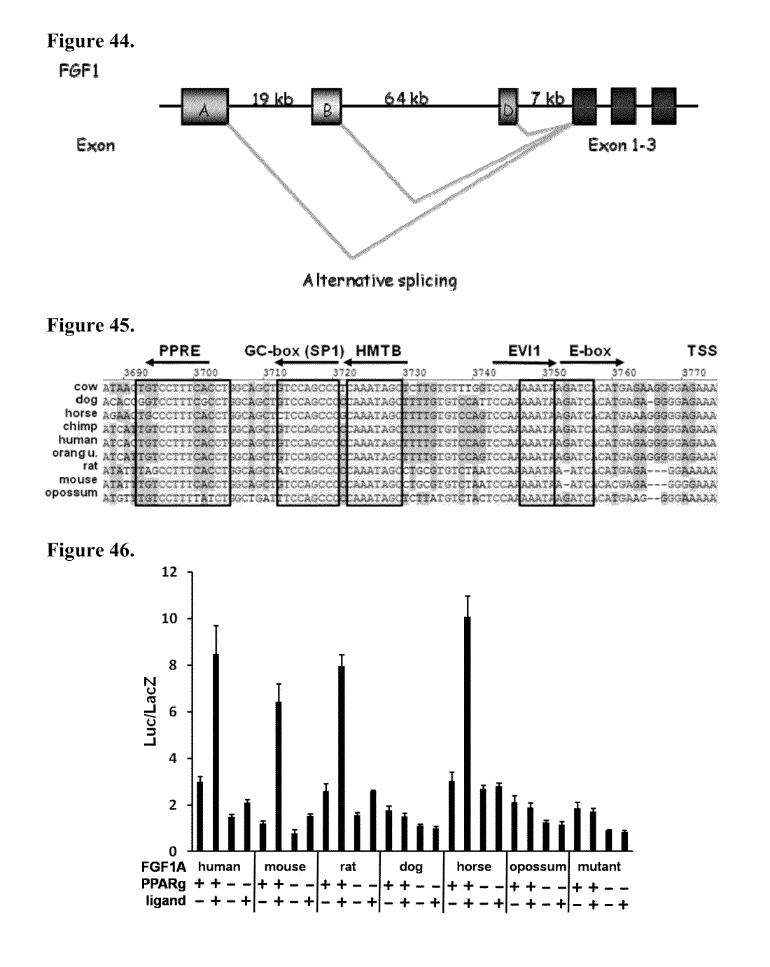

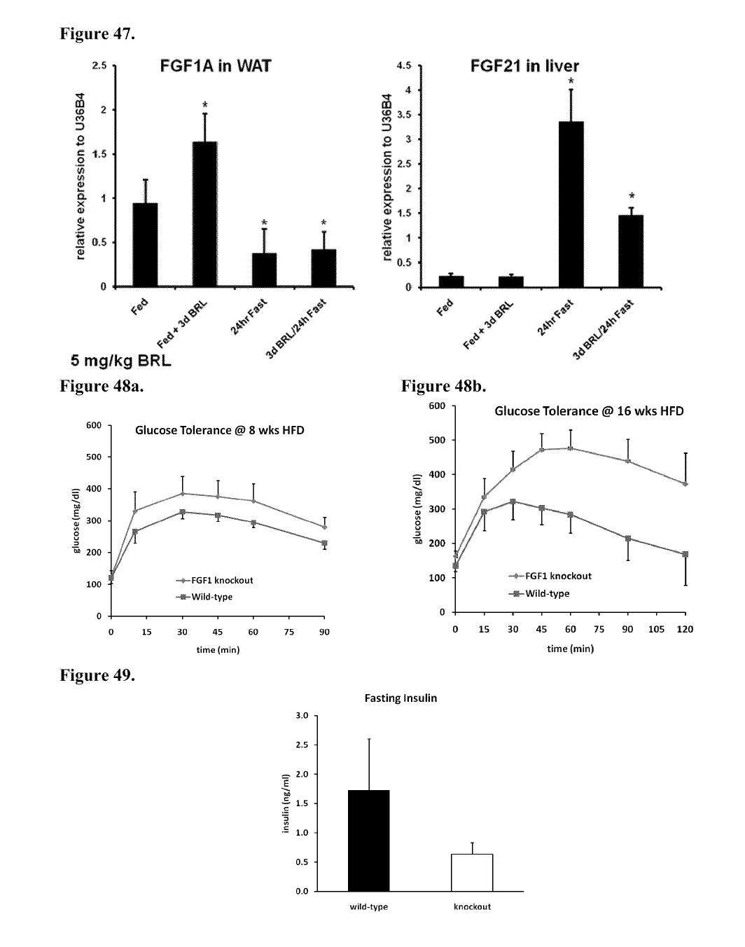

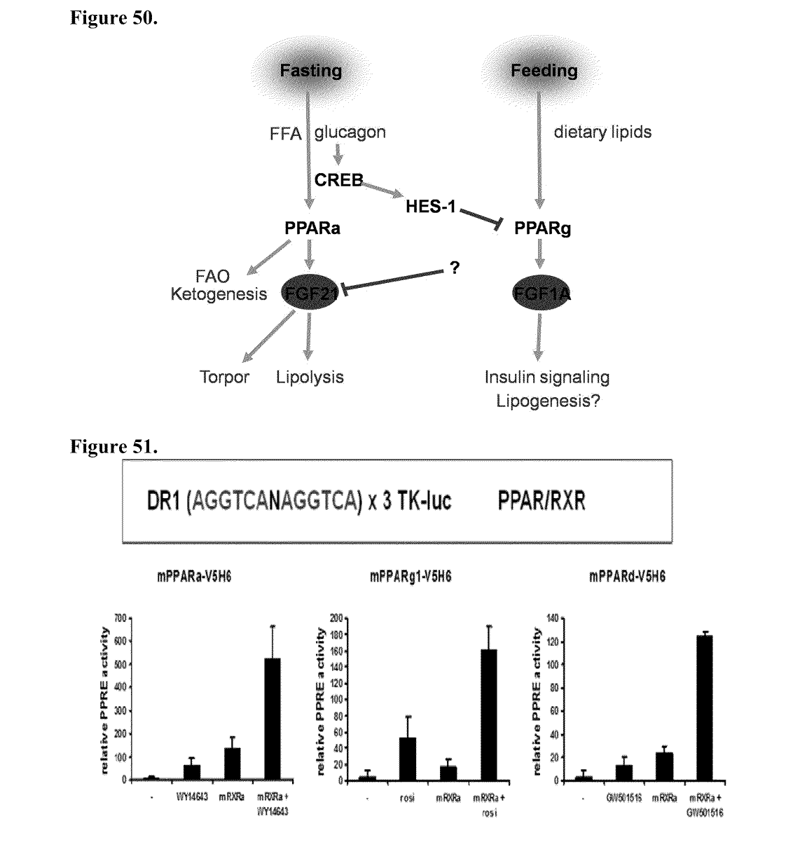

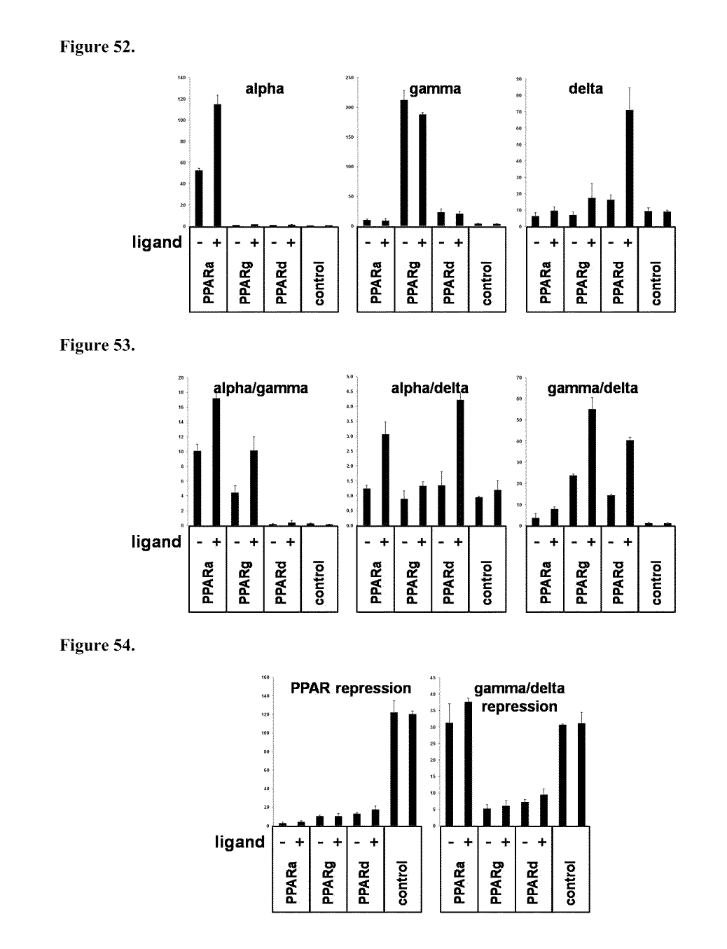

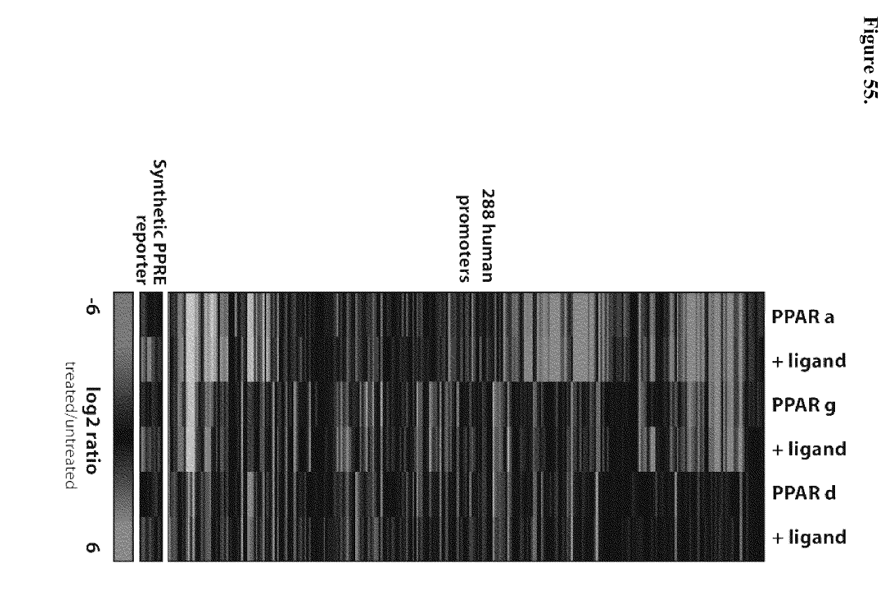

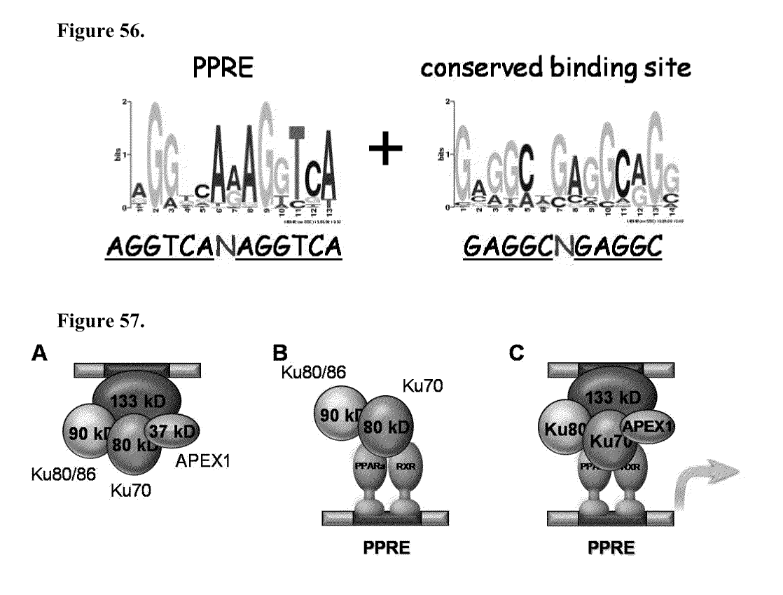

As illustrated in the Examples below, functional promoter analysis of the Per1, Rev-erbα and Bmal1 promoters revealed that these clock genes (and thus the production of their therapeutic gene products) can be regulated by a previously unrecognized subset on NHRs. See FIGS. 4 and 5. These promoters, when paired with their cognate regulatory NHRs, now comprise a new high throughput screening tool for novel drugs to control and reset the circadian clock.

Nuclear Hormone Receptors (NHRs) comprise a large family of ligand-modulated transcription factors that mediate responses to a wide range of lipophilic signaling molecules such as lipids, steroids, retinoids, hormones, vitamins, and xenobiotics. As sensors for these signals they provide an important link between transcriptional regulation and physiology. The NHRs are characterized by a DNA-binding domain (DBD), which targets the receptor to specific DNA sequences known as hormone response elements (HREs), and a ligand-binding domain (LBD), which senses the signal and ensures both specificity and selectivity of the physiologic response. The NHRs constitute one of the largest groups of transcription factors in animals (48 genes in humans, 49 in mice). This superfamily includes not only the classic endocrine receptors that mediate the actions of steroid hormones, thyroid hormones, and the fat-soluble vitamins A and D, but also includes a large number of so-called orphan nuclear receptors, whose ligands, target genes, and physiological functions are still largely unknown.

The invention provides methods of identifying transcription modulating agents that, e.g., increase or decrease, the transcriptional activity of one or more transcription factor-gene element interactions. The methods can be advantageously used to identify and/or analyze a network of transcription factor-gene element interactions. Briefly, the methods include providing an array of reporter cells into which a set of at least three different reporter nucleic acid constructs, that each include at least one gene transcription element derived from at least one gene of interest, have been transfected (e.g. transduced). The transcription element in each reporter construct in the set is operably coupled to at least one nucleic acid subsequence encoding at least one heterologous reporter moiety, e.g., any of the reporter moieties described herein (such as luciferase). Collectively, the set of reporter constructs can optionally include at least, e.g., 3, 5, 10, 20, 50, 100, 250, or 500 or more, different transcription elements derived from at least, e.g., 3, 5, 10, 20, 50, 100, 250, or 500 or more different genes of interest that are all members of a selected gene pathway, e.g., any of the gene pathways described herein. In certain embodiments, the set of reporter constructs can comprise at least 30 different transcription elements derived from at least 30 different genes. In other embodiments, the reporter constructs can include sequences such as, e.g., the sequences corresponding to the accession numbers listed in Tables 2 and/or 3 and/or to the sequences corresponding to the transcription elements listed in Table 6.

In some embodiments, the cells in the array of reporter cells are also transfected (e.g. transduced) with at a set of least 3 driver nucleic acids, wherein each of the driver nucleic acids encodes at least one operable transcription factor or transcription factor knock down agent that blocks expression of at least one transcription factor. The set of driver constructs can optionally include at least, e.g., 5, 10, 20, 40, 50, or 100 or more different transcription factors, including at least, e.g., 5, 10, 20, 40, 48, 49, or 50 or more different full-length, active nuclear hormone receptors, e.g., nuclear hormone receptors that mediate a response to any of the lipophilic signaling molecules described herein. The NHR encoded by the driver constructs can optionally include, e.g., those listed in Table 4 and/or 6, or, e.g., one or more HAT, HDAC, and/or HMT.

In some embodiments, the methods include determining which driver nucleic acids direct the expression of which reporter constructs in the array. The methods can optionally include adding a plurality of, e.g., transcription factor ligands (e.g., natural, synthetic, native, non-native, etc.), e.g., T3 (3-3-5-Triiodo-L-thyronine), ATRA (all-trans Retinoic Acid), TTNBP, 9-cis retinoic acid, WY14643, GW501516, BRL49653 (Rosiglitazone), T0901317, GW4064, Vitamin D3 (1,25 dihydroxyvitamin D3), PCN, Hyperforin, TCPOBOP, 13-cis retinoic acid, LG100268, β-estradiol, Dexamethasone, Hydrocortisone (Cortisol), Progesterone, or Androstane, to an array of reporter cells, wherein the ligands are added to individual array members transduced by a cognate driver construct. A plurality of compounds can be added to an array of reporter cells, and the compounds' effect(s) on reporter moiety expression can be analyzed to determine whether a transcription factor-gene element interaction, e.g., transcription, has been, e.g., increased or decreased. In particular embodiments, at least, e.g., 10,000, 20,000, 30,000, 40,000 or 50,000, or 100,000 or more different compounds can be added to the members of the array. In particular embodiments, at least 10,000 different compounds can be added to the array, wherein a single different compound can be added to individual array members that each comprise at least one reporter construct and at least one driver construct, or wherein a single different compound can be added to individual array members that each comprise at least three reporter constructs and at least three driver constructs.

The driver constructs in such embodiments collectively encode at least 20, at least 50, or at least 100 or more different transcription factors and the reporter nucleic acid constructs collectively can comprise at least 20, at least 50, at least 100, at least 250, or at least 500 or more different transcription elements. For example, the array members can comprise at least 2, at least 5, at least 10, at least 25, or at least 48, or at least 49, or at least 50 driver constructs that encode, e.g., nuclear hormone receptors. Methods of analyzing or identifying a network of transcription factor-gene element interactions can optionally further include a step of selectively screening for a compound that has an effect on a single transcription factor, or on a set of closely related transcription factors, but which does not have an effect on other transcription factors encoded by the set of driver nucleic acids.

In particular embodiments of the methods, gene transcription elements can optionally be derived from a plurality of circadian pathway genes that include, e.g., Bmal1, Clock, NPAS2, Per1, Per2, Per3, Cry1, Cry2, Rev-erb α, Rev-erb β, Rora, Rorb, Rorc, Dec1, Dec2, Dbp, Tef, Hlf, and E4 bp4. A set of reporter nucleic acid constructs can optionally comprise transcription elements that are derived from Per1 or Rev-erbα, and the set of driver nucleic acids can comprise NR4a1, TRα, TRβ, PPARγ or ERRγ.

In certain embodiments, methods for identifying one or more compound that modulates the transcriptional levels of one or more circadian pathway gene are provided. In some methods, an array of reporter cells can be made in which each of the reporter cells comprises at least one reporter construct, which itself comprises at least one transcription regulatory element that is operably linked to at least one reporter nucleic acid. The transcription elements of a reporter construct can be derived from, e.g., Bma1, Clock, NPAS2, Per1, Per2, Per3, Cry1, Cry2, Rev-erb α, Rev-erb β, Rora Rorb, Rorc, Dec1, Dec2, Dbp, Tef, Hlf, or E4 bp4. The reporter cells in the array also comprise a set of driver constructs, which collectively encode a plurality of nuclear hormone receptors.

To identify transcriptional modulators, the cells in the array are exposed to a library of compounds, e.g., a library that includes potential modulators of nuclear hormone receptor-mediated expression of any one or more the genes listed above, such that at least one compound is contacted to each of the cells in the array. Driver-mediated expression of a reporter construct is then monitored to determine the effect of a compound on transcription, i.e., of the reporter construct, e.g., by monitoring the levels of accumulated active gene product that is encoded by the reporter constructs. In some embodiments, at least 10,000 different compounds can be added to the array. In such embodiments, a different compound is added to individual array members that each comprises at least one (or at least three) reporter nucleic acid and at least one (or at least three) driver nucleic acid. The driver nucleic acids of these embodiments collectively encode at least 20, at least 48, at least 49, at least 50, or at least 100 different transcription factors, and the reporter nucleic acids can collectively comprise at least 20, at least 50, at least 100, at least 250, or at least 500 different transcription elements.

In other methods provided by the invention, reporter cells in an array desirably comprise reporter constructs, which themselves include regulatory elements derived from Per1 or Rev-erbα operably linked to at least one reporter nucleic acid sequence. The reporter cells in the array also individually comprise one or more members of a set of driver constructs that includes e.g., NR4a1, TRα, TRβ, PPARγ, or ERRγ. A compound library comprising potential modulators of Per1 and/or Rev-erbα can be exposed to members the array of reporter cells in a manner such that at least one compound is contacted to each of a plurality of reporter cells in the array. Modulators can be identified by determining which compound produces an effect on the NR4a1, TRα, TRβ, PPARγ, or ERRγ-mediated expression of at least one reporter construct.

Such modulators can include, but are not limited to, compounds in libraries of transcription factor modulators, compounds in libraries of nuclear hormone receptor modulators, transcription factor ligands, nuclear hormone receptors, nuclear hormone receptor ligands and/or the like, as described herein. In particular embodiments, it is desirable to screen for one or more compound that has an effect on, e.g., a single transcription factor or a selected related set of closely related transcription factors, but which does not have a global effect on other transcription factors encoded by the set of driver nucleic acids in the reporter cells.

The present invention also provides a variety of libraries, including libraries of modulators (e.g., agonists, antagonists, etc.), receptors, receptor/agonist complexes, transcription factors, nuclear receptors, transcription elements, transcription element—reporter gene constructs, etc. For example, in one aspect, the invention provides libraries of agonists for a nuclear receptor, in which the library comprises a plurality of different agonists.

The libraries of the invention optionally include any of the physical components of the invention described anywhere herein, including agonists and antagonists (including those having any physical structure noted herein), modulator/receptor complexes (including those having any physical structure noted herein), or the like. Similarly, the receptor can be any of those noted herein, e.g., those involved in the circadian pathway, etc.

High throughput screening formats are particularly useful in identifying modulators that effect, e.g., increase or decrease, the transcriptional levels of one or more, e.g., circadian pathway gene, an inflammation pathway gene, a reproductive pathway gene, a metabolic pathway gene, a metabolic syndrome related pathway gene, an obesity related gene, an insulin response pathway gene, a lipid metabolism pathway gene, a sugar metabolism pathway gene, a cholesterol transport pathway gene, a xenobiotic metabolism pathway gene, a cancer related gene pathway, a steroidogenic pathway, drug pumps (transporters), growth factors (FGFs), neurotransmitter receptors, a feeding related pathway (HPA axis), and/or a cardiovascular pathway gene. Generally in these methods, an array of reporter cells is exposed, serially or in parallel, to a plurality of test compounds comprising putative modulators (e.g., the members of a modulator library), as described above. Modulation of the transcriptional activity of reporter nucleic acid(s) by a test compound is detected, thereby identifying one or more modulator compound that can be of use to, e.g., alleviate or ameliorate a disease state or produce a therapeutic effect.

Essentially any available compound library, e.g., a peptide library, a library of compounds that bear a structural similarity to a transcription factor, a library of transcription factor ligands, a library of nuclear hormone receptors, a library of nuclear hormone receptor ligands, or any one or combination of compound libraries described herein, can be screened to identify putative modulators in a high-throughput format against a biological or biochemical sample, e.g., an array or reporter cells. As noted, the cells included in the array are not necessarily limiting and can be, e.g., Human Kidney Embryonic cells (293 cells), African Green Monkey Fibroblast cells (CV-1 cells), and/or the like. The library members can then be assayed, optionally in a high-throughput fashion, for the ability to modulate the transcription of one or more gene genes in the pathways described above.

A library of compounds used in the methods can include, e.g., at least 10,000 different compounds, e.g., at least 50,000 different compounds, or, e.g., at least 10,000, at least 100,000 or more different compounds, wherein each of the different compounds is added to individual array members that each comprise at least one (or at least three) driver construct(s), wherein the driver(s) collectively encode(s) at least 20 different transcription factors, and the reporter nucleic acid constructs collectively comprise at least 20 different transcription elements.

Modulators of a transcription factor/gene element interaction, e.g., in any of the pathways described herein (e.g., the circadian pathway), can be identified, e.g., using the methods described herein, to screen, e.g., a combinatorial compound library. Such libraries can include compounds sharing a common structural scaffold, with one or more scaffold substituents being varied (randomly or in a selected manner). The efficiency with which such modulators are identified can be optimized by prescreening or pre-selecting a library's constituents for desirable properties, e.g., oral availability, reduced toxicity, bioavailability, chemical structure, known activity, nuclear localization, ingestibility, and/or the like, to insure that compounds with the greatest potential for development, e.g., as therapeutic agents, are highly represented in any library to be screened.

A combinatorial compound library, e.g., a library comprising a variety of diverse, but structurally similar molecules synthesized by combinatorial chemistry methodologies, can be selected to comprise a majority of members that conform, e.g., to Lipinski's Rule of 5, a set of criteria by which the oral availability of a combinatorial compound can be evaluated. The rule states that an orally active drug, e.g., exhibiting desirable pharmacokinetic properties, will likely have i) no more than 5 hydrogen bond donors, ii) no more than 10 hydrogen bond acceptors, iii) a molecular weight under 500 g/mol, and iv) a partition coefficient log P less than 5, e.g., the compound will be lipophilic. Lipinski's Rule is useful in drug development and is typically applied at an early stage of drug design in order to select against putative modulators with poor absorption, distribution, metabolism, and excretion properties.

The efficiency of a screen to identify modulators of the transcription of one or more gene, e.g., of a physiological pathway described herein (such as a circadian pathway gene), e.g., in a combinatorial compound library, can also be enhanced by the use of in silico techniques to prioritize compounds with desirable characteristics, e.g., those described above, to be used in the methods provided herein, from the universe of compounds that can be synthesized and tested. For example, a “virtual library,” e.g., a computational enumeration of all possible structures with a given set of desirable biological properties, can be screened for promising candidates for use, e.g., in the methods described herein. For example, a pharmacophore can be used as a query to screen a database of compounds for molecules that share a distinct repertoire of structural and chemical features. As used herein, a “pharmacophore” is a three-dimensional configuration of steric and electronic properties common to all compounds that exhibit a particular biological activity.

Pharmacophore models are typically computationally-derived and are generally based on molecules, e.g., proteins, ligands, small organic compounds, and/or the like, that are known to bind the target of interest, e.g., a nuclear hormone receptor, a nuclear hormone, a transcription factor, and/or the like. Pharmacophore models developed in this manner can be refined using algorithms to search structural databases to identify ligands with similar three-dimensional features, which can have a greater-than-average probability of being active against the target, e.g., any one or more of the targets of interest described herein. Further details regarding pharmacophore identification are described in Khedkar, et al. (2007) “Pharmacophore modeling in drug development and discovery: an overview.” Med Chem 3:187-197; Reddy, et al. (2007) “Virtual screening in drug discovery—a computational perspective.” Curr Protein Pept Sci 8:329-51; McInnes (2007) “Virtual screening strategies in drug discovery.” Curr Opin Chem Biol 11:494-502; and Balakin, et al. (2006) “Rational design approaches to chemical libraries for hit identification.” Curr Drug Discov Technol 3:49-65.

Because a pharmacophore describes compounds based on their biological activity, using a pharmacophore to query a three-dimensional structure database can lead to the identification of new, structurally diverse candidate compounds, e.g., that can be synthesized and used in the methods described herein to identify modulators of the transcriptional levels of one or more circadian (or other) pathway gene. Computational screening can be most beneficial when a number of structurally diverse compounds, or “scaffolds,” are found for a given pharmacophore.

The number of members, e.g., chemical variants that comprise the same basic chemical architecture as the scaffold, but which are each distinguished by unique side chains and R-groups, by which each scaffold is represented, is not particularly limited. Including a wide variety of diverse scaffolds in an overall combinatorial compound library can improve the probability that a screen, e.g., to identify modulators of a transcription factor-gene element interaction, will uncover desirable “lead” compounds, e.g., compounds with advantageous pharmacological and or biological properties whose chemical structures can be used as scaffolds in further in vitro screens. Identifying multiple diverse desirable lead compounds can also be useful in managing the risk of compound attrition during subsequent screens to optimize potency, selectivity and/or pharmacokinetic properties, and during clinical development.

Various criteria, such as ADME (described in Balani, et al. (2005) “Strategy of utilizing in vitro and in vivo ADME tools for leaf optimization and drug candidate selection.” Curr Top Med Chem 5:1033-8), statistical methods, such as QSAR (described in Patani, et al. (1996) “Bioisosterism: A Rational Approach in Drug Design.” Chem. Rev 96:3147-3176 and Freyhult, et al. (2003) “Structural modeling extends QSAR analysis of antibody-lysozyme interactions to 3D-QSAR.” J Biophys 84:2264-2272), and algorithms, (reviewed in, e.g., Dror, et al. (2006) “Predicting molecular interactions in silico: A guide to pharmacophore identification and its applications to drug design.” Curr Med Chem 11:71-90), can be helpful in selecting the most beneficially useful compounds and scaffolds in a virtual library, e.g., of compounds that modulate a transcription factor-gene element interaction, for actual synthesis. Other useful strategies for compound selection are described in, e.g., Olah, et al. (2004) “Strategies for compound selection.” Curr Drug Discov Technol 1:211-220.

In some embodiments, a method of screening of libraries of transcription modulating agents (e.g. modulator compounds such as chemicals based upon pharmacophore models) are provided. Many three-dimensional structural databases of compounds, suitable for construction of pharmacophore compounds are commercially available, e.g., from the Sigma Chemical Company (Saint Louis, Mo.), Aldrich chemical company (St. Louis Mo.), Chembridge (San Diego, Calif.), Inte:Ligand (Austria), and others. Virtual compound library screening services can be performed by, e.g., Quantum Pharmaceuticals (Moscow, Russia), BIOMOL, and Chembridge, and others.

Libraries of synthesized compounds may be employed, which also may be screened for their effects on transcription modifying protein-promoter activity, e.g., to a identify a modulator of a circadian (or other) gene pathway, are readily available, e.g., from TimTec (Newark, Del.), ArQule (Medford, Mass.), Exclusive Chemistry, LLC (Russia), and many others. Many companies, including those mentioned above, can custom synthesize compound libraries and/or offer library screening services, e.g., of proprietary compound libraries.

A variety of peptide libraries are commercially available from, e.g., Princeton BioMolecules (Langhorne, Pa.) and Cambridge Peptides (Cambridge, UK). Kinase inhibitor libraries, phosphatase inhibitor libraries, and HDAC inhibitor libraries are available from EMD Biosciences (Germany), BIOMOL International (Plymouth Meeting, Pa.), TopoTarget (Denmark), and many others.

The source of transcription modulating agents, such as modulator test compounds, for such systems and in the practice of the methods of the invention can optionally be any commercially available or proprietary library of materials, including compound libraries from the companies noted above, as well as typical compound and compound library suppliers such as Sigma (St. Louis Mo.), Aldrich (St. Louis Mo.), Agilent Technologies (Palo Alto, Calif.) or the like. The format of the library will vary depending on the system to be used. Libraries can be formatted in typical liquid phase arrays, e.g., using microtiter trays, can be formatted onto sets of beads, and/or can be formatted for microfluidic screening in either solid or liquid phase arrays.

Often, combinatorial compound libraries can conveniently be formatted into available micro-well plates comprising, e.g., 384 wells (or multiples thereof). Similarly, microfluidic formats, or other available formats, can be used, in which case the relevant library is formatted into arrays of members that fit the available instrumentation.

Automated systems can be adapted to detect the transcriptional levels of, e.g., a reporter construct, to find, e.g., one or more modulators of a circadian (or other) pathway gene. Laboratory systems can also perform, e.g., repetitive fluid handling operations (e.g., pipetting) for transferring material to or from reagent storage systems that comprise arrays, such as microtiter trays or other chip trays, which are used as basic container elements for a variety of automated laboratory methods. Similarly, such systems can manipulate, e.g., microtiter trays and control a variety of environmental conditions such as temperature, exposure to light or air, and the like. Many such automated systems are commercially available and can be adapted to the detection of the transcriptional levels of one or more circadian pathway gene or other pathway gene(s). Examples of automated systems that can be adapted according to the invention include those from Caliper Technologies (including the former Zymark Corporation, Hopkinton, Mass.), which utilize various Zymate systems, which typically include, e.g., robotics and fluid handling modules. Similarly, the common ORCA® robot, which is used in a variety of laboratory systems, e.g., for microtiter tray manipulation, is also commercially available, e.g., from Beckman Coulter, Inc. (Fullerton, Calif.). A number of automated approaches to high-throughput activity screening are provided by the Genomics Institute of the Novartis Foundation (La Jolla, Calif.). See GNF.org on the world-wide web. Microfluidic screening applications are also commercially available from Caliper Technologies Corp. For example, LabMicrofluidic device high throughput screening system (HTS) by Caliper Technologies, Mountain View, Calif. or the HP/Agilent technologies Bioanalyzer using LabChip™ technology by Caliper Technologies Corp. can be adapted for use in the present invention.

In one illustrative embodiment, libraries of reporter cells are arrayed in microwell plates (e.g., 96, 384 or more well plates), which can be accessed by standard fluid handling robotics, e.g., using a pipettor or other fluid handler with a standard ORCA robot (Optimized Robot for Chemical Analysis) available from Beckman Coulter (Fullerton, Calif.). Standard commercially available workstations such as the Caliper Life Sciences (Hopkinton, Mass.), Sciclone ALH 3000 workstation, and Rapidplate™ 96/384 workstation provide precise 96 and 384-well fluid transfers in a small, highly scalable format. Plate management systems such as the Caliper Life Sciences Twister® II Advanced Capability Microplate Handler for End-Users, OEM's and Integrators provide plate handling, storage and management capabilities for fluid handling, while the Presto™ AutoStack provides fast reliable access to consumables presenting trays of tips, reagents, microplates or deep wells to an automated device (e.g., the ALH 3000) without robotic arm intervention.

In another illustrative embodiment, microfluidic systems for handling and analyzing microscale fluid samples, including cell based and non-cell based approaches that can be used for analysis of test compounds on biological samples in the present invention are also available, e.g., the Caliper Life Sciences various LabChip® technologies (e.g., LabChip® 90 and 3000) and related Agilent Technologies (Palo Alto, Calif.) 2100 and 5100 devices. Similarly, interface devices between microfluidic and standard plate handling technologies are also commercially available. For example, the Caliper Technologies LabChip® 3000 uses “sipper chips” as a “chip-to-world” interface that allows automated sampling from microtiter plates. To meet the needs of high-throughput environments, the LabChip® 3000 employs four or even twelve sippers on a single chip so that samples can be processed, in parallel, up to twelve at a time. Solid phase libraries of materials can also be conveniently accessed using sipper or pipetting technology, e.g., solid phase libraries can be gridded on a surface and dried for later rehydration with a sipper or pipette and accessed through the sipper or pipette.

As already noted, with regard to the systems and methods provided herein, the particular libraries of compounds can be any of those that now exist, e.g., those that are commercially available, or that are proprietary. A number of libraries of test compounds exist including, e.g., those from Sigma (St. Louis Mo.), and Aldrich (St. Louis Mo.). Other current compound library providers include Actimol (Newark Del.), providing e.g., the Actiprobe 10 and Actiprobe 25 libraries of 10,000 and 25,000 compounds, respectively; BioMol (Philadelphia, Pa.); Enamine (Kiev, Ukraine) which produces custom libraries of billions of compounds from thousands of different building blocks; TimTec (Newark Del.), which produces general screening stock compound libraries containing >100,000 compounds, as well as template-based libraries with common heterocyclic lattices, libraries for targeted mechanism based selections, including kinase modulators, etc., privileged structure libraries that include compounds containing chemical motifs that are more frequently associated with higher biological activity than other structures, diversity libraries that include compounds pre-selected from available stocks of compounds with maximum chemical diversity, plant extract libraries, natural products and natural product-derived libraries, etc; AnalytiCon Discovery (Germany) including NatDiverse (natural product analogue screening compounds) and MEGAbolite (natural product screening compounds); Chembridge (San Diego, Calif.) including a wide array of targeted or general and custom or stock libraries; ChemDiv (San Diego, Calif.) providing a variety of compound diversity libraries including CombiLab and the International Diversity Collection; Comgenix (Hungary) including ActiVerse™ libraries; MicroSource (Gaylordsville, Conn.) including natural libraries, agro libraries, the NINDS custom library, the genesis plus library and others; Polyphor (Switzerland) including privileged core structures as well as novel scaffolds; Prestwick Chemical (Washington D.C.), including the Prestwick chemical collection and others that are pre-screened for biotolerance; Tripos (St. Louis, Mo.), including large lead screening libraries; and many others. Academic institutions such as the Zelinsky Institute of Organic Chemistry (Russian Federation) also provide libraries of considerable structural diversity that can be screened in the methods of the invention.

Some embodiments of the invention comprise identifying or analyzing one or more networks of transcription factor-gene element interactions (e.g., as in the circadian pathway, etc.). Various other embodiments of the invention comprise methods of screening for compounds or agents that modulate (e.g., increase or decrease activity of) a transcription factor such as a nuclear receptor, and thus modulate transcription of one or more genes under transcriptional control of such factor. The screening can be done in a container, in a cell, tissue or organism, etc.

While various embodiments are illustrated in terms of use with luciferase assays, it will be appreciated that in some instances the embodiments of the invention can be optimized for use with additional and/or alternative assays (e.g., non-luciferase bioluminescent assays, assays for quantification of nucleic acid transcribed, etc.).

In particular embodiments, the invention provides methods of identifying or analyzing one or more networks of transcription factor-gene element interactions by providing at least three different reporter nucleic acid constructs, each comprising at least one transcription element derived from at least one gene of interest and each that is operably coupled to a nucleic acid sequence comprising or encoding a reporter moiety (e.g., luciferase) wherein the set collectively comprises transcription elements from at least three different genes of interest from a selected gene pathway; providing at least three driver nucleic acid constructs (each comprising at least one operable transcription factor or at least one transcription factor knock down agent that blocks expression of as least one transcription factor); co-transfecting the reporter and driver constructs into an array of reporter cells and determining which driver nucleic acids direct expression of which reporter constructs, e.g., by monitoring production of the reporter moiety(ies).

In other embodiments, the invention provides methods of producing, identifying and designing modulators that influence transcription factor (e.g., nuclear receptor) activity. The methods can involve confirming or testing, e.g., by screening, an agent or compound for activity that modulates the effect(s), e.g., as described herein (e.g., agonist activity), of an activated receptor, e.g., in a mammalian cell.

In various methods herein, a sample comprising a reporter nucleic acid construct and a driver nucleic acid construct is contacted with a test compound and the test compound's effect (e.g., an agonist or antagonist effect) on the transcriptional activity of the transcriptional factor (within the driver construct) on the transcription element (within the reporter construct) is determined by transcription of one or more gene product (e.g., a reporter gene such as luciferase) under control of the transcription element. Modulator compounds identified by these methods are also features of the invention.

Expression levels of a gene can be altered by changes in the transcription of the gene product (i.e. transcription of mRNA), and/or by changes in translation of the gene product (i.e. translation of protein), and/or by post-translational modification(s) (e.g. protein folding, glycosylation, etc.). Assays in various embodiments of the invention comprise monitoring of transcription factor activity (e.g., for identification/analysis of pathways and/or for identification of transcription factor modulators) through production of luciferase. However, other embodiments of the invention can optionally include assaying for level of transcribed mRNA (or other nucleic acids derived from nucleic acids that encode a polypeptide comprising a transcription factor responsive gene), level of translated protein, activity of translated protein, etc. Examples of such approaches are described below. These examples are intended to be illustrative and not limiting.

As further detailed herein, a modulator can be, e.g., an agonist of a transcription factor and thus induce activity of the transcription element, or an antagonist of the transcription factor and thus suppress activity of the transcription element. Such modulators can include, but are not limited to, polypeptides, altered or mutated versions of naturally occurring transcription factor ligands, recombinant or orthogonal transcription factor ligands, small organic molecules, naturally occurring compounds, or the like. Modulators can include compounds that specifically bind to the transcription factor, to a transcription factor co-factor, or to the transcription element. In the methods comprising identifying or analyzing networks of transcription factor-gene element interactions, various embodiments can comprise use of one or more natural ligand or known agonist/antagonist (as well as any needed co-factors) appropriate for the transcription factor(s) under analysis. See, e.g., Table 5.

Particular embodiments of the invention follow transcription factor activity through monitoring of luciferase activity. As illustrated, reporter constructs of various embodiments of the invention comprise luciferase genes under control of a transcription element. Thus, activation of the transcription element by a driver construct (comprising a transcription factor) leads to production of luciferase to be monitored. In addition to, or alternative to, the detection of luciferase, other embodiments of the invention can optionally include monitoring of other reporter polypeptides and/or monitoring of nucleic acid expression level(s) of a reporter gene (e.g., luciferase), and/or detection and/or quantification by detecting and/or quantifying the amount and/or activity of a translated reporter encoded polypeptide. Alterations in expression or activity of a reporter encoded protein (e.g., luciferase) can also optionally be monitored.

In many embodiments of the current invention, transcription modifying protein activity on one or more promoter (whether to identify/analyze a pathway network or to test a putative modulator) is monitored through use of luciferase as the reporter gene in the reporter constructs. For example, as illustrated further below, the invention includes reporter constructs comprising a promoter/transcription element (e.g., a circadian pathway promoter/transcription element such as shown in Table 2) from one or more gene of interest in one or more physiological pathway (e.g., the circadian pathway) fused with a luciferase reporter gene. It will be appreciated that while circadian promoters/transcription elements, etc. are shown in the Examples, etc. herein, other pathways (e.g., inflammation, etc.) and other promoters/transcription elements (e.g., tumor necrosis factor, member 2, the hTNFα promoter in the inflammation pathway) can also utilize luciferase constructs to monitor transcription factor activity on the promoters/transcription elements of genes of interest. Thus, in various embodiments, the invention comprises one or more reporter constructs (or a set of reporter constructs comprising one or more transcription element—reporter gene fusion each having a transcription element from one or more genes of interest common to the same gene pathway) wherein the reporter moiety is selected from the group consisting of: a fluorescent protein, a luminescent protein, a secretable reporter protein, a luciferase, a secretable luciferase, a green fluorescent protein, and a red fluorescent protein

Use of luciferase constructs and their related assays are well known to those of skill in the art. See, e.g., Greer, et al., “Imaging of light emission from the expression of luciferases in living cells and organisms: a review,” Luminescence, 2002, January-February, 17(1):43-74, Hutchens, et al., “Applications of bioluminescence imaging to the study of infectious diseases,” Cellular Microbiology, 9:2315-2322, etc.

In addition to luciferase, various embodiments of the current invention can also utilize other bioluminescent or biofluorescent reporter proteins in the promoter/transcription element—reporter gene constructs of the invention. For example, in addition to and/or alternative to luciferase, the invention can use, e.g., a fluorescent protein, a luminescent protein, a secretable reporter protein, a luciferase, a secretable luciferase, a green fluorescent protein, and a red fluorescent protein.

Secretable luciferase (as well as other secretable reporter gene products) that can be used in various embodiments of the invention can be seen in, e.g., WO/2008/073805 “Secretable Reporter System,” filed Dec. 6, 2007. Other bioluminescent and biofluorescent reporter proteins that can be used in various constructs of the invention will be familiar to those of skill in the art. See, e.g., Haugland, Handbook of Fluorescent Probes and Research Products, Molecular Probes, Inc., Eugene Oreg., 2005, and the references cited therein.

The reporter protein expressed when the promoter is activated can be detected and quantified by any of a number of methods well known to those of skill in the art in addition to use of luciferase assays. These can include analytic biochemical methods such as electrophoresis, capillary electrophoresis, high performance liquid chromatography (HPLC), thin layer chromatography (TLC), hyperdiffusion chromatography, and the like, or various immunological methods such as fluid or gel precipitin reactions, immunodiffusion (single or double), immunoelectrophoresis, radioimmunoassay (RIA), enzyme-linked immunosorbent assays (ELISAs), immunofluorescent assays, western blotting, and the like.

For example, an encoded polypeptide (e.g., luciferase) can be detected/quantified in an electrophoretic protein separation (e.g. a 1- or 2-dimensional electrophoresis). Means of detecting proteins using electrophoretic techniques are well known to those of skill in the art (see generally, R. Scopes (1982) Protein Purification, Springer-Verlag, N.Y.; Deutscher, (1990) Methods in Enzymology Vol. 182: Guide to Protein Purification, Academic Press, Inc., N.Y.). Western blot (immunoblot) analysis can be used to detect and quantify the presence of an encoded reporter protein.

The encoded reporter polypeptide can also be detected using an immunoassay. As used herein, an immunoassay is an assay that utilizes an antibody to specifically bind to the analyte (e.g., the target polypeptide(s)). The immunoassay is thus characterized by detection of specific binding of a reporter polypeptide to an antibody as opposed to the use of other physical or chemical properties to isolate, target, and quantify the analyte.

Any of a number of well recognized immunological binding assays are well suited to detection or quantification of the reporter polypeptide(s). For a review of general immunoassays, see Asai (1993) Methods in Cell Biology Volume 37: Antibodies in Cell Biology, Academic Press, Inc. New York; Stites & Ten (1991) Basic and Clinical Immunology 7th Edition. Immunological binding assays (or immunoassays) typically utilize a “capture agent” such as an antibody to specifically bind to and often immobilize an analyte (e.g., a reporter polypeptide such as luciferase).

Immunoassays also often utilize a labeling agent to specifically bind to and label the binding complex formed by the capture agent and the analyte. The labeling agent can itself be one of the moieties comprising the antibody/analyte complex. Thus, the labeling agent can be a labeled polypeptide or a labeled antibody that specifically recognizes the already bound target polypeptide. Alternatively, the labeling agent can be a third moiety, such as another antibody, that specifically binds to the capture agent /polypeptide complex.

Immunoassays for detecting the target polypeptide(s) can be either competitive or noncompetitive. Noncompetitive immunoassays are assays in which the amount of captured analyte is directly measured. In one preferred “sandwich” assay, for example, the capture agents (antibodies) can be bound directly to a solid substrate where they are immobilized. These immobilized antibodies then capture the target polypeptide present in a test sample. The target polypeptide thus immobilized is then bound by a labeling agent, such as a second antibody bearing a label.

In competitive assays, the amount of analyte (reporter polypeptide) present in the sample is measured indirectly by measuring the amount of an added (exogenous) analyte displaced (or competed away) from a capture agent (antibody) by the analyte present in the sample. In one competitive assay, a known amount of, in this case, labeled polypeptide is added to the sample and the sample is then contacted with a capture agent. The amount of labeled polypeptide bound to the antibody is inversely proportional to the concentration of target polypeptide present in the sample.

The level of reporter polypeptide present can also be determined by an enzyme immunoassay (EIA) which utilizes, depending on the particular protocol employed, unlabeled or labeled (e.g., enzyme-labeled) derivatives of polyclonal or monoclonal antibodies or antibody fragments or single-chain antibodies that bind reporter polypeptide(s), either alone or in combination. In the case where the antibody that binds the target polypeptide(s) is not labeled, a different detectable marker, for example, an enzyme-labeled antibody capable of binding to the monoclonal antibody which binds the target polypeptide, can be employed. Any of the known modifications of EIA, for example, enzyme-linked immunoabsorbent assay (ELISA), can also be employed.

Immunoassays can also include, for example, fluorescent immunoassays using antibody conjugates or antigen conjugates of fluorescent substances such as fluorescein or rhodamine, latex agglutination with antibody-coated or antigen-coated latex particles, haemagglutination with antibody-coated or antigen-coated red blood corpuscles, and immunoassays employing an avidin-biotin or strepavidin-biotin detection systems, and the like.

Changes in expression levels of a reporter gene (e.g., luciferase) can also be detected by measuring changes in mRNA and/or a nucleic acid derived from the mRNA (e.g. reverse-transcribed cDNA, etc.) that encodes a polypeptide of the gene product or a gene product of a nucleic acid that is under control of the transcription element in the reporter construct.

The nucleic acid (e.g., mRNA nucleic acid derived from mRNA) is, in certain embodiments, isolated from a sample (e.g., a well in a sample plate, a cell, etc.) according to any of a number of methods well known to those of skill in the art. Methods of isolating mRNA are well known to those of skill in the art. For example, methods of isolation and purification of nucleic acids are described in detail in by Tijssen ed., (1993) Chapter 3 of Laboratory Techniques in Biochemistry and Molecular Biology: Hybridization With Nucleic Acid Probes, Part I. Theory and Nucleic Acid Preparation, Elsevier, N.Y. and Tijssen ed.

The nucleic acid sample can be amplified prior to assaying for expression level. Methods of amplifying nucleic acids are well known to those of skill in the art and include, but are not limited to polymerase chain reaction (PCR, see, e.g., Innis, et al., (1990) PCR Protocols. A guide to Methods and Application, Academic Press, Inc. San Diego,), ligase chain reaction (LCR) (see Wu and Wallace (1989) Genomics 4:560, Landegren, et al. (1988) Science 241:1077, and Barringer, et al. (1990) Gene 89:117), transcription amplification (Kwoh, et al. (1989) Proc. Natl. Acad. Sci. USA 86:1173), self-sustained sequence replication (Guatelli, et al. (1990) Proc. Nat. Acad. Sci. USA 87:1874), dot PCR, and linker adapter PCR, etc.).

In another embodiment, amplification-based assays can be used to measure reporter expression (transcription) level. In such amplification-based assays, the reporter nucleic acid sequences (i.e., a nucleic acid comprising an encoded reporter polypeptide such as that for luciferase) act as template(s) in amplification reaction(s) (e.g. Polymerase Chain Reaction (PCR) or reverse-transcription PCR (RT-PCR)). In a quantitative amplification, the amount of amplification product will be proportional to the amount of template (e.g., reporter encoding mRNA) in the original sample. Comparison to appropriate (e.g. a sample unexposed to a test agent) controls provides a measure of the transcript level.

Methods of “quantitative” amplification are well known to those of skill in the art. For example, quantitative PCR involves simultaneously co-amplifying a known quantity of a control sequence using the same primers. This provides an internal standard that can be used to calibrate the PCR reaction. Detailed protocols for quantitative PCR are provided in Innis, et al. (1990) PCR Protocols, A Guide to Methods and Applications, Academic Press, Inc. N.Y.).

Any of the methods provided herein are amenable to high throughput screening. Preferred assays detect increases or decreases in reporter (e.g., luciferase) transcription and/or translation, e.g., in response to the presence of a test transcription modulating agent (e.g. a test compound).

Cells (or wells in an assay plate) utilized in the methods of this invention need not be contacted with a single test agent at a time. For example, to facilitate high-throughput screening, a single cell/well/etc. can be contacted by at least two, preferably by at least 5, more preferably by at least 10, and most preferably by at least 20 test compounds. If the cell/well scores positive, it can be subsequently tested with a subset of the test agents until the agents having the activity are identified.

High throughput assays for various reporter gene products such as luciferase are well known to those of skill in the art. For example, multi-well fluorimeters are commercially available (e.g., from Perkin-Elmer). In addition, high throughput screening systems are commercially available (see, e.g., Zymark Corp., Hopkinton, Mass.; Air Technical Industries, Mentor, Ohio; Beckman Instruments, Inc. Fullerton, Calif.; Precision Systems, Inc., Natick, Mass., etc.). These systems typically automate entire procedures including all sample and reagent pipetting, liquid dispensing, timed incubations, and final readings of the microplate in detector(s) appropriate for the assay. These configurable systems provide high throughput and rapid start up as well as a high degree of flexibility and customization. The manufacturers of such systems provide detailed protocols of the various high throughputs. Thus, for example, Zymark Corp. provides technical bulletins describing screening systems for detecting the modulation of gene transcription, ligand binding, and the like.

High throughput screening formats are particularly useful in identifying modulators of transcription factors. Generally in these methods, one or more biological sample that includes a transcription factor (i.e., in a driver construct and along with reporter constructs, etc.) is contacted, serially or in parallel, with a plurality of test compounds comprising putative modulators (e.g., the members of a modulator library). Binding to or modulation of the activity of the transcription factor by a test compound is detected, thereby identifying one or more modulator compound that binds to or modulates activity of the transcription factor.

As detailed above, essentially any available compound library, e.g., a peptide library, or any one or combination of compound libraries described herein, can be screened to identify putative modulators in a high-throughput format against a biological or biochemical sample.

### III. Kits and Compositions

In another aspect, a kit is provided for identifying a functional characteristic of a transcription modifying protein or a functional characteristic of a nucleic acid promoter sequence. The kit includes a multi-well plate, a plurality of reporter cells; and a library of nucleic acid promoter sequences linked to a nucleic acid reporter sequence or a library of nucleic acid driver sequence encoding a transcription modifying protein. Multi-well plates, libraries of nucleic acid promoter sequences linked to a nucleic acid reporter sequence and libraries of nucleic acid driver sequence encoding a transcription modifying protein are described above in the description of methods of the present invention, and are equally applicable to the kits provided herein.

Thus, kits for carrying out the subject methods. For example, kits can include the driver and/or reporter constructs of the invention, in combination with other kit components, such as packaging materials, instructions for user of the methods or the like. Libraries can also be packaged in kits, e.g., comprising library components such as arrays in combination with packaging materials, instructions for array use or the like. Kits generally contain one or more reagents necessary or useful for practicing the methods of the invention. Reagents can be supplied in pre-measured units so as to provide for uniformity and precision in test results.

Also provided herein is a library of reporter cells. Each reporter cell comprises a first plasmid comprising a nucleic acid promoter sequence and a second plasmid comprising a nucleic acid driver sequence encoding a transcription modifying protein. In some embodiments, each reporter cell further comprises a transcription modulating agent. In certain embodiments, the nucleic acid promoter sequence in each reporter cell in the library of reporter cells is different and/or the nucleic acid driver sequence encoding a transcription modifying protein in each reporter cell in the library of reporter cells is different. Where each reporter cell further comprises a transcription modulating agent, the transcription modulating agent in each reporter cell is different.

The library of reporter cells may be arranged in an array format (i.e. an spatial arrangement optimized for high throughput methods provided herein). The array format may be a grid format ordered for easily interpreting data results. In some embodiments, the library of reporter cells are arranged in the wells of a multi-well plate wherein reporter cells having the same nucleic acid promoter sequence and the same nucleic acid driver sequence (and the same transcription modulating agent when present) are in the same well of the multi-well plate. The number wells in a multi-well plate may be about 6, 8, 12, 24, 48, 96, 384, 1536.

In some embodiments, the number of reporter cells in the library comprising a different nucleic acid driver sequence encoding a transcription modifying protein, a different nucleic acid promoter sequence, a different nucleic acid driver sequence encoding a transcription modifying protein and a different nucleic acid promoter sequence, and/or a different transcription modulating agent is at least or about 5, 10, 20, 30, 40, 50, 60, 70, 80, 90, 100, 200, 300, 400, 500, 1000, 5000 or 10,000. In some embodiments the number of reporter cells in the library comprising a different nucleic acid driver sequence encoding a transcription modifying protein, a different nucleic acid promoter sequence, a different nucleic acid driver sequence encoding a transcription modifying protein and a different nucleic acid promoter sequence, and/or a different transcription modulating agent may be from 20 to 10000. The number of reporter cells in the library comprising a different nucleic acid driver sequence encoding a transcription modifying protein, a different nucleic acid promoter sequence, a different nucleic acid driver sequence encoding a transcription modifying protein and a different nucleic acid promoter sequence, and/or a different transcription modulating agent may also be from 20 to 500. The number of reporter cells in the library comprising a different nucleic acid driver sequence encoding a transcription modifying protein, a different nucleic acid promoter sequence, a different nucleic acid driver sequence encoding a transcription modifying protein and a different nucleic acid promoter sequence, and/or a different transcription modulating agent may also be from 20 to 100. The number of reporter cells in the library comprising a different nucleic acid driver sequence encoding a transcription modifying protein, a different nucleic acid promoter sequence, a different nucleic acid driver sequence encoding a transcription modifying protein and a different nucleic acid promoter sequence, and/or a different transcription modulating agent may also be from 50 to 100.

### EXAMPLES

It is understood that the examples and embodiments described herein are for illustrative purposes only and that various modifications or changes in light thereof will be suggested to persons skilled in the art and are to be included within the spirit and purview of this application and scope of the appended claims.

### Example 1

### Functional Analysis of Transcription by the Nuclear Hormone Receptor Family: Circadian Pathway Discovery

There is described herein the development of a novel high-throughput method for functional analysis of complex transcriptional pathways controlled by the Nuclear Hormone Receptor (NHR or NR) Superfamily. The approach employs a validated cDNA expression library including all mouse NHRs combinatorially paired with a large collection of pathway specific promoter-reporter libraries. The pairing facilitates rapid evaluation of the transcriptional regulation of each genetic pathway by any NR in a given context (i.e., in the presence or absence of ligand, in different cell lines etc.).

In a first example, there has been evaluated the response of the Circadian Rhythm genetic circuit to a broad selection of receptors and their ligands. Circadian rhythms are postulated to be controlled by a transcriptional feedback system fluctuating as a function of the light-dark cycle and defects in rhythm are known to directly contribute to metabolic disease. See, e.g., Green, et al., (2008) “The Meter of Metabolism.” Cell 134: 728-742. The negative feedback loop of the molecular clock mechanism involves two key transcription factors, CLOCK and BMAL1 which form a heterodimer and regulate the rhythmic transcription of the Period (Per1-3) and Cryptochrome (Cry1-2) genes. In turn, PER/CRY heterodimers act as negative regulators of BMAL1/CLOCK. The NHRs Rev-erbα and RORα are a known integral part of this negative feedback loop, which acts by regulating the transcription of Bmal1. Using a NR-promoter collation (PC) screen, new NRs have been identified that potently modulate the Circadian Rhythm Circuit and which can help provide new insight into the treatment of circadian disorders such as jet lag insomnia and glucose homeostasis. The NR PC screen can be useful characterizing transcriptional regulation by NHRs from the single gene level to more complex networks.

Genome-wide functional reporter assays, e.g., those described herein, can provide a global view of nuclear receptor pathway activity in living cells. NHRs can be used to identify the functional interactions between genes and/or connections within gene networks that can be controlled by new classes of therapeutic drugs. The most general application of the methods is in the creation of genome-wide functional reporter assays that can be used in living cell systems to identify genetic pathways that can be controlled and modulated by, e.g., NHRs and/or therapeutics that affect the activity of, e.g., NHRs and/or NHR-associated products.

Because genes under the transcriptional control of NHRs do not always encode proteins that can be optimally used as therapeutic targets in, e.g., drug screens, we use the methods described herein to identify those promoters whose transcription is controlled by NHR or NHR-associated products. Such NHR-target promoter pairs can then be used in high-throughput screens to identify compounds that can modulate, e.g., increase or decrease, transcription of the genes encoded downstream. Target compounds, e.g., modulators, can include, e.g., existing therapeutic drugs and/or new classes of therapeutic pharmacophores. Such target compounds can act as surrogate agonists or antagonists to modulate the transcriptional expression of key gene product to, e.g., produce a therapeutic effect or alleviate a pathological state. The methods provided by the invention are both sensitive and quantitative, and, importantly, they can establish the key structural activity relationship (SAR) needed to develop novel pharmaceuticals to control complex physiological pathways.

NHRs and their associated co-factors (such as HATs, HDACs, HMTs and the like) are drug targets. The importance of these TFs in maintaining the normal physiological state is illustrated by the large number of drugs that have been developed to combat disorders that have inappropriate nuclear receptor signaling as a key pathological determinant. These disorders affect every field of medicine, including reproductive biology, inflammation, metabolism, cancer, diabetes, cardiovascular disease, and obesity.

Accordingly, there is provided herein a high-throughput method for the functional analysis of complex physiological pathways controlled by the Nuclear Hormone Receptor (NHR) family. The invention includes a validated cDNA expression library that encompasses the entire NHR family. This library is paired with a collection of promoters comprising HREs whose gene products can be modulated to, e.g., produce a therapeutic effect or alleviate a pathological state. The validated cDNA expression library and promoter constructs can be used to evaluate the functional regulation of the genome by any member of the NHR family under a condition of interest, e.g., in the presence or absence of ligand, in different cell lines, etc.

The NHR-promoter screen described herein tests all members of the NHR-family against a set of promoters that control the production of, e.g., gene products whose aberrant expression can lead to a disease state. See Tables 6, et seq. Screening is based on highly sensitive and quantitative automated transcriptional assays in which the aforementioned promoters drive the transcriptional expression of luciferase-based reporters. We have developed and validated a full-length cDNA expression library for all 49 members of the NHR family. Each of the receptors was cloned into the pcDNA3.1 mammalian expression vector, C-terminally linked to a V5H6 tag, sequenced and validated for functional activity. Co-expression of these modified NHR constructs individually with the promoters, e.g., promoters described herein or synthetic response elements, that drive the transcription of luciferase allows for rapid non hybridization-dependent quantitative analysis of drug dependent transcriptional regulation by the NHR-family (FIG. 1). The promoters (and reporter genes) tested were cloned into pGLA3 or pGLA4 vectors from Promega. NHRs, their ligands, NHR co-factors and/or synthetic modulators of NHR activity can be used to modulate, e.g., increase of decrease, the transcriptional levels of a downstream gene of interest, e.g., whose modulated transcriptional expression can alleviate a disease state or promote a therapeutic effect, effectively changing its cellular activity in a controlled fashion.

The use, feasibility, and reproducibility of the functional NHR-promoter screen in a 48-well format have been tested validated. Briefly, there were co-expressed 50 ng of each NHR/NHR homodimer or NHR/RXR heterodimer with 100 ng promoter/luciferase construct and 50 ng of LacZ (as a control for transfection efficiency) in CV-1 cells using Fugene HD (Roche) as a transfection reagent (alternatively or additionally, a CMV-YFP construct can be used as a transfection control). Each of the nuclear hormone receptors that were used in these experiments was cloned into a pcDNA3.1 vector and comprised a C-terminally linked V5H6 tag. Twenty-four hours after transfection, appropriate ligands were added, where applicable, (see Table 5 for various ligands and concentrations and after 48 hrs, samples were assayed for luciferase and LacZ activity. To measure for luciferase activity 15 ul of sample was added to 30 ul of luciferase buffer (20 mM tricine, 1.07 mM MgCarbonate, 2.67 mM MgSulfate, 0.1 mM Na_{z}-EDTA, 5 mM DTT, 5 mM ATP, 0.15 mg/ml CoA, 0.5 mM Luciferin), mixed briefly, and run in a Perkin Elmer Victor 5 luminometer. Thus, the functional NHR-promoter screen was used to observe the transcriptional activity of 29 promoters from various physiological pathways including inflammation, lipid and sugar metabolism, cholesterol transport, xenobiotic metabolism, and circadian rhythm. See Tables 6, et seq.

In one embodiment, the methods provided by invention were used to identify NHR responsive promoters whose gene products regulate the Circadian Clock. In mammals, the circadian system comprises a master clock located in the hypothalamus that is directly entrained by the light/dark cycle. This master clock also coordinates the phases of local clocks in the periphery to ensure optimal timing of the physiology (Green, et al., (2008) “The Meter of Metabolism.” Cell 134: 728-742). The Circadian Clock plays broad roles in sleep, metabolism and feeding behavior. Altered Circadian rhythms can result in sleep disruption, increased weight (obesity) and metabolic disease, e.g., insulin resistance, hyperlipidemia, hyperglycemia, hypertension and atherosclerosis, and drug metabolism (Green, et al., (2008) “The Meter of Metabolism.” Cell 134: 728-742). The anatomical location and physical complexity of the mammalian circadian master clock have stymied the identification of potential drug targets that can be used, e.g., to screen for compounds that modulate the circadian master clock's activities. The invention described herein provides a straightforward, high throughput, sensitive, and quantitative strategy to identify agonists and antagonists that can find therapeutic use in predictably modulating the circadian clock and, e.g., other complex regulatory circuits.

Circadian rhythms are biorhythms with a cycle of about 24 hours and are in vivo phenomena that can be commonly observed in numerous organisms ranging from unicellular organisms to human beings (Green, et al., (2008)). Circadian rhythms are controlled by a transcriptional feedback system fluctuating as a function of the light-dark cycle. The negative feedback loop of the molecular clock mechanism involves two key transcription factors, CLOCK and BMAL1, which form a heterodimer and regulate the rhythmic transcription of the Period (Per1-3) and Cryptochrome (Cry1-2) genes. In turn, PER/CRY heterodimers act as negative regulators of BMAL1/CLOCK (FIG. 4). As shown in FIG. 4, the Nuclear Hormone Receptors Rev-erbα and RORα are an integral component of the circadian feedback loop. Rev-erbα represses transcription of Bmal1 and RORα activates transcription of Bmal1. In turn, Rev-Erbα and RORα are transcriptionally regulated by Bmal1/Clock through interaction with the E-box element present in their respective promoters. Thus, Rev-erbα and RORα play an integral parts in this negative feedback loop. Functional promoter analysis of the Per1, Rev-erbα and Bmal1 promoters, e.g., using the protocols described herein, revealed that these clock genes, and, therefore, the proteins they encode, can be regulated by a previously unrecognized subset on NHRs (FIG. 2). These promoters, when paired with their cognate regulatory NHRs, now comprise a new high throughput screening tool to identify therapeutically useful compounds that, e.g., control and reset the circadian clock.

Protocol for High Throughput Screening in a 384-well format. In order to perform high throughput screenings, e.g., in a 384 well format, transfections and reporter assays can be performed in 384-well tissue culture plates. Per well, a total of 65 ng DNA (30 ng NR dimer, 30 ng promoter and 5 ng lacZ as an optional transfection control) can be used in transfections, which are performed in quadruplicate. 0.195 μl of Fugene HD (Roche) is added to each transfection, e.g., each well, at a ratio of 3:1 μl Fugene HD: μg DNA. Alternatively or additionally, a construct comprising yellow fluorescent protein (YFP) under the control of a CMV promoter can be used as a transfection control to permit a visual readout of transfection efficiency (exemplary compositions that would be used with embodiments comprising CMV-YFP are shown in Table 1A and Table 1B below).

TABLE 1

| A | | B | |
|---|---|---|---|
| NR/RXR | Per well | NR/NR | Per well |
| heterodimer | (384-well format) | homodimer | (384-well format) |
| NR | 15 ng | NR | 30 ng |
| RXRa | 15 ng | | |
| Promoter | 30 ng | Promoter | 30 ng |
| CMV-YFP | 5 ng | CMV-YFP | 5 ng |
| TOTAL | 65 ng | TOTAL | 65 ng |

Each construct used in the transfections is diluted to an appropriate concentration such that the correct amount of DNA can be aliquotted to a well in a 5 μl volume. Following the addition of DNA, 5 μl of a Fugene HD/OptiMEM cocktail (0.195 μl Fugene HD: 4.805 μl OptiMEM) is added to each well. The 384-well plates are then shaken gently at room temperature for 5 minutes.

4000 CV-1 or AD293 cells are distributed into each of the wells containing DNA, such that the final volume in each of the wells is 100 μl. The cells are grown in media comprising phenol red-free DMEM, superstripped serum (final concentration 10%), and with appropriate antibiotics (e.g., penicillin and streptomycin). The plates are once again shaken gently, covered, sealed with breathable tape, and incubated at 37° C.

24-48 hours following transfection, ligand is added to the transfected cells. Briefly, phenol-free DMEM medium supplemented with superstripped serum (10% final concentration) is prepared for the addition of ligand. (See Table 5 for details regarding which ligands and what concentration of each ligand). 5 μl of this medium/ligand mix is added to each well such that the final concentration of ligand per well is as shown in Table 5.

24 hours following the addition of ligand, the cells are assayed for luciferase activity. The 384-well plates are removed from the incubator and allowed to cool to room temperature. Following the removal of media from the cells, luciferase assay reagent (e.g., 30 ul of Promega Luciferase Assay Reagent) is added to each well. The 384-well plates are shaken for 15 minutes and gently centrifuged. Each plate is then read in a luminometer. The luciferase activity of each sample is then normalized to the lacZ activity of the sample to permit comparison of reporter activity between reporter cells. Of course, it will be appreciated that those skilled in the art will be familiar with numerous luciferase reagents and protocols that can optionally be used to measure luciferase activity (e.g., reagents/assays from Targeting Systems, El Cajon, Calif.). It will also be appreciated that the individual steps (e.g., luciferase assays, transfection, incubation, etc.) involved in HTP screening and in the 48 well screenings can share, or comprise, similar protocol steps.

Results of assays of numerous transcription factor (e.g., NHRs) against selected transcription elements are shown in Table 6. The promoters that facilitate transcription of the indicated gene products that were tested using the protocols described herein are listed in the first row of the table. The nuclear hormone receptors and, where applicable, ligands that were assayed for their transcriptional effects on the promoters are listed in the first column of the table. The data represent the luciferase activity of each sample normalized to both the lacZ activity of that sample and to a control, e.g., no NHR or ligand, as customary in the art. As described previously, these normalizations allow the transcriptional activity of each reporter cell to be compared to other samples.

Tables 7-40 show the transcriptional effects of the hormone receptors, and, where applicable, ligands (orphan receptors are screened without ligand), on each individual promoter. The data in the first column of each table shows the luciferase activity of each assay normalized to the lacZ activity of that sample. The second column of each table shows the standard deviation (SD) for the results in the first column. The third and fourth columns of data show the lacZ normalized luciferase activity and standard deviation data of columns 1 and 2, respectively, further normalized to a control, e.g., no NHR or ligand. The control data of each table are shown in their last rows.

Table 30 depicts normalized luciferase activity vs. NHR or NHR+ligand for the Bmal1 promoter. Table 31 depicts the data of Table 30 on a logarithmic scale.

Table 32 depicts normalized luciferase activity vs. NHR or NHR+ligand for the RevErba promoter. Table 33 depicts the data of Table 32 on a logarithmic scale.

Table 36 depicts normalized luciferase activity vs. NHR or NHR+ligand for the SREBP1c promoter. Table 37 depicts the data of Table 36 on a logarithmic scale.

Results obtained from this approach confirmed known NHR-promoter regulations (FIG. 2) as well as identified novel interactions (FIG. 5). FIG. 2a shows specific and strong activation of the Constitutive Androstane Receptor (CAR) promoter by Nuclear Receptor HNF4-alpha. FIG. 2b shows the specific and strong activation of the SREBP1c promoter by Nuclear Receptors LXR-alpha and -beta. FIG. 2c shows specific activation of the Bmal1 promoter by Nuclear Receptors ROR-alpha and -gamma, and specific repression by Rev-Erb-alpha and -beta. FIG. 5 reveals novel NHR mediated transcription of Circadian Pathway genes. Regulation of 1) Per1 by NR4a1, 2) Rev-erbα by the Thyroid Hormone Receptors (TRα and TRβ), Peroxisome Proliferator Activated Receptor γ (PPARγ) and Estrogen Related Receptor γ (ERRγ).

An unsupervised, hierarchical clustering algorithm further allowed the clustering of this set of promoters that facilitate transcription of the named gene on the basis of their similarities in regulation by the NHRs. Similarly, the NHRs were clustered on the basis of their regulation of each of the 29 promoters (FIG. 3). In FIG. 3, each row represents a NHR with and without ligand (total of 80 variables) and each column a single promoter. As shown in the legend bar, a lighter shade represents upregulation, a grayer shade represents downregulation and black represents no change. Using this limited dataset, clustering of the NHRs was in accordance with their phylogenetic relationships. For example, the closely related receptors SF1 and LRH1 were clustered, as were Rev-Erb alpha and -beta, and RARalpha, -beta and -gamma. Within the promoters, expected relationships were identified as well, such as clustering of SREBP1c and ABCA1, two genes that are involved in cholesterol metabolism and of MDR1 and CYP450, two genes with overlapping substrate specificities. Thus, unsupervised clustering with this limited dataset can be used to identify promoters that may be commonly regulated by, e.g., one or more NHR of interest. Using larger sets of promoters can greatly increase this power and can be used to identify novel and/or more complex NHR-promoter networks controlling disease relevant pathologies. FIG. 3 is an illustration bioinformatic analysis of data directly comparing data points of a large data set resulting from clustering techniques as is set forth herein, which sets forth all possible regulatory combinations thereby predicting how pathways can be regulated by one or more NHRs and their drugs.

The paired NHR-target promoter screens can also be used to identify and develop novel classes of drugs that modulate, e.g., the transcription of individual NHR-regulated promoters upstream of genes that, e.g., encode proteins whose aberrant expression cause a disease state. These screens described herein can also be used to screen other TF families and transcriptional co-regulators including, but not limited to, e.g., histone acetyl transferases (HATs), histone deacetylaes (HDACs) and histone methylransferases (HMTs). This format and/or screening method can permit the discovery of compounds that regulate complex physiological pathways and/or gene networks known to be important in human disease.

Extensive variations on the procedures described above are readily available to the skilled artisan. For example, a detailed investigation of a set of 19 promoters that facilitate transcription of the named gene (Table 2) identifies a wide range of NHR mediation regulations, as depicted in FIG. 41.

### Example 2

### Regulation of the Fibroblast Growth Factor 9FGF) Family by NHRs

Provided herein are methods for the identification of NHR responsive promoters whose gene products comprise the Fibroblast Growth Factor (FGF) family. FGFs are a family of 22 distinct polypeptide hormones with diverse biological activities including angiogenesis, development, and cellular proliferation and differentiation (Beenken & Mohammadi, 2009, Nat. Rev. Drug Discov. 8:235-253). Recently, several members of this family have been identified as targets of the NHRs VDR (FGF23), PPARa (FGF21) and FXR (FGF15/19), mediating some of the pleiotropic actions of these NHRs (FIG. 42).

The involvement of FGF signaling in human disease is well documented. Deregulated FGF signaling can contribute to pathological conditions either through gain- or loss-of-function mutations in the ligands themselves, or their receptors (FGFRs). For example, FGF23 gain of function in autosomal dominant hypophosphataemic rickets, FGF10 loss of function in lacrimo-auriculo-dento-digital syndrome (LADD syndrome), FGF3 loss of function in deafness and FGF8 loss of function in Kallmann syndrome. Gain- or loss-of-function mutations in FGFRs are known to contribute to many skeletal syndromes, Kallmann syndrome, LADD syndrome and cancer.

Without wishing to be bound by any theory, it is believed that the FGFs themselves are poor drug targets. Accordingly, the promoter ontology screen described herein provides a means to identify FGFs whose transcription can be controlled by one or more drugable NHRs.

Screening for FGF regulation by NHRs. The methods described herein provide a straightforward, high throughput, sensitive and quantitative strategy to identify therapeutic agonists and antagonists that can predictably modulate FGF and FGFR expression for therapeutic benefit. Promoter constructs were designed and screened for all 22 members of the FGF-family for novel regulation by the NHRs. Of particular interest is the strong and specific transcriptional regulation of FGF1A, one of the alternative splice variants of FGF1, by PPARγ (FIG. 43). The FGF 1 gene is regulated by at least three (A, B and D) different promoters. Alternative splicing of these promoters to the three exons of the FGF1 gene results in identical but differentially expressed FGF1 polypeptides (FIG. 44). FGF1A is highly expressed in heart, kidney and adipose, FGF1B is highly expressed in brain and FGF1D is highly expressed in liver. A list of promoters for genes whose gene products comprise the human FGF family is provided in Table 41.

FGF1A promoter analysis. To gain more insight into the regulation of the FGF1A promoter by PPARγ, the putative PPRE was localized. See FIG. 45. Inactivation of this PPRE by site directed mutagenesis resulted in a complete loss of response of the FGF1A promoter to PPARγ. See FIG. 46. The evolutionary conservation of FGF1A was determined and found to be highly conserved in a wide range of mammals (bovine, canine, horse, chimpanzee, human, orangutan, rat, mouse, and opossum). The PPRE in the FGF1A promoter in these species also showed strong conservation and was demonstrated to be responsive to PPARγ activation in all species except for the more distantly related canine and opossum (FIG. 46). Together, these findings suggest a physiologically important function of regulation of the FGF1A promoter by PPARγ, present in a wide range of mammals. In addition to a strong conservation of the PPRE in this promoter, several other highly conserved elements were detected (e.g. SP1, HMTB, EVI1 and E-box).

In vivo function. The present findings parallel a recently discovered pathway in which FGF21 is activated by PPARa (Inagaki et al., 2007, Cell Metab. 5:415-425.). PPARa regulates the utilization of fat as an energy source during starvation and is the molecular target for the fibrate dyslipidemia drugs. FGF21 is induced directly by PPARa in liver in response to fasting and PPARa agonists (FIG. 47, right panel). FGF21 in turn stimulates lipolysis in white adipose tissue and ketogenesis in liver. FGF21 also reduces physical activity and promotes torpor, a short-term hibernation-like state of regulated hypothermia that conserves energy.

Recently, it was also reported that treatment of pre-adipocytes with recombinant FGF1 results in increased proliferation and adipogenesis (Hutley et al., 2004, Diabetes 53:3097-3106; Newell et al., 2006, FASEB J. 20:2615-2617). These findings and the fact that PPARγ is a critical regulator of adipogenesis suggest that PPARγ might regulate FGF1 in adipose in response to feeding.

To test this hypothesis the expression of FGF1A in response to feeding, fasting and PPARγ ligand treatment was determined (FIG. 47, left panel). It was found that in fed mice, oral administration of PPARγ ligand (5 mg/kg BRL for 3 days) significantly increased the mRNA levels of FGF1A. This increase was similar to that of the adipocyte protein AP2 (also known as Fatty acid binding protein 4, FABP4), which is the strongest known PPARγ target in adipose. On the other hand, overnight fasting resulted in an about two-fold decrease in FGF1A mRNA levels, perhaps indicating a feedback regulation through the PPARα/FGF21 axis.

FGF1 knockout mice. To further test the in vivo role of PPARγ mediated FGF1 regulation in response to feeding, data on FGF1-knockout mice were obtained. Previously, FGF1 knockout mice have been generated and analyzed in the context of wound healing and cardiovascular changes. However, neither these mice, nor FGF1/FGF2 double knockout mice displayed any significant phenotype (Miller et al., 2000, Mol. Cell. Biol. 20:2260-2268).

To study the role of FGF1 in energy metabolism, FGF1 knockout and wild-type littermates were fed with a high fat diet (HFD). FGF1 knockout mice became severely diabetic as compared to wild-types, as indicated by a highly reduced glucose tolerance (FIG. 48). Moreover, a two-fold reduction in the fasting levels of insulin was found after 8 weeks of HFP, suggesting a decreased secretion of insulin rather than increased insulin resistance (FIG. 49).

Model for role of FGFs in energy metabolism. Together, the present findings suggest a role for a PPARγ-FGF1 endocrine signaling pathway in regulating diverse metabolic aspects of the adaptive response to feeding (FIG. 50). According to this model, in response to fasting, FGF21 is transcriptionally activated by PPARa and increases fat burning through increased lipolysis. Furthermore, in response to feeding, FGF1A is transcriptionally activated by PPARγ and regulates insulin signaling.

### Example 3

### Characterization of the PPAR Regulome

As known in the art, a subgroup of NHRs, the peroxisome proliferator-activated receptors (PPARα, γ, and δ) are important regulators of lipid metabolism. Although they share significant structural similarity, the biological effects associated with each PPAR isotype are distinct. For example, PPARa and PPARγ regulate fatty acid catabolism, whereas PPARγ controls lipid storage and adipogenesis. PPARa is predominantly expressed in the liver where it enhances fatty acid combustion by upregulation of the genes encoding enzymes in β-oxidation. PPARγ is mainly expressed in adipose tissue and serves as an essential regulator for adipocyte differentiation and promotes lipid storage in mature adipocytes by increasing the expression of several key genes in this pathway. PPARγ is widely expressed and has been shown to be a key regulator of fat burning in peripheral tissues by coordinating fatty acid oxidation and energy uncoupling. The different functions of PPARs in vivo can be explained only in part by the different tissue distributions of the three receptors. However, the question of whether the receptors have different intrinsic activities and how they regulate distinct target genes has only been partially explored. Also, the effects of cofactors (e.g., PGC1a), different ligands, SNPs and different RXR isoforms on the PPAR regulome have not been systematically addressed.

Approach. To address these questions, the PPAR isotype-specific regulation of a library of promoters containing a predicted PPAR response element (PPRE) was characterized by methods provided herein. This PPRE promoter library was generated by interrogating the human genome with a PPRE-specific matrix derived from reported PPAR functionally regulated sites (Lemay et al., 2006, J. Lipid Res. 47:1583-1587). Using this PPRE-specific matrix, potential PPREs were identified with the criteria that they must be located within at least 2 kB (constituting the proximal promoter) of a transcriptional start site of a known gene thereby maximizing the potential functionality of the PPRE sites. Subsequently, 1.5 to 2 kB regions upstream from the transcriptional start site of identified genes with predicted PPRE sites were cloned into a pGL4 luciferase reporter vector creating a promoter library comprised of a total of 296 PPRE constructs.

Validation. Validation was sought that the PPRE promoter library has potential value in identifying new PPAR targets. First, transfection conditions were established, as known in the art, in which the control promoter containing multiple synthetic PPREs (DR1x3TK-luc) and was robustly activated by all three isoforms of PPARs in the presence or absence of their heterodimeric partner (RXR) or their respective ligands. See FIG. 51.

Screen for PPAR regulome. After establishing validated conditions, all the 296 promoters from the PPRE library for PPAR activity with the three PPAR isoforms were screened. Interestingly and unexpectedly, several distinct patterns of regulation were identified. These include PPAR-isotype specific regulation (FIG. 52) as well as combinations of different isotypes (e.g., PPARα/γ or PPARα/δ-specific activation) (FIG. 53) or repression by one or more of the PPAR isotypes (FIG. 54). These results indicate that using this screen we can identify novel PPAR target genes that were positive for PPAR activity as well as detect potential PPAR isoform-specific gene targets. Approximately 80 percent of the promoters screened were positive for PPAR activity, validating the design as well as the usefulness of our PPRE library for identifying new PPAR targets and thus potentially the identification of novel targets for treatment of disease.

Identification of a conserved binding site in PPARa specific promoters. Bioinformatic analyses, as known in the art, was conducted to determine the basis of the observed isotype specificity. First, unsupervised, hierarchical clustering analysis allowed clustering of this set of 288 promoters on the basis of their similarities in regulation by the different PPAR-isotypes and their respective ligands. An illustration of data directly comparing data points of this large data set resulting from this clustering technique is set forth in the bioinformatic analysis shown in FIG. 55, which sets forth all possible regulatory combinations thereby predicting how pathways can be regulated by one or more PPAR isoforms and their drugs. More specifically, data for particular PPAR-isotypes is set forth, for example, in previous FIGS. 52-54. It was observed that a relatively large proportion of the promoters was specifically regulated by PPARα.

All promoters that are specifically regulated by PPARa (>4 fold, 42 promoters) with promoters that are regulated by one or more of the PPAR-isotypes but not specifically by PPARα (>4 fold, 27 promoters) were then compared. No difference was found in the PPRE motifs between the two data sets (FIG. 56, left panel), nor was there found a conserved 5′ flanking sequence for the PPARa unique set. Interestingly, however, an additional conserved sequence (GAGGCNGAGGC) (SEQ ID NO:49) within the PPARa unique promoters was identified (FIG. 56, right panel). The term “N” as used herein in the context of DNA sequences refers to any nucleotide (A, C, G or T).

A protein complex binding to this sequence has previously been characterized in the promoter of tartrate-resistant acid phosphatase (TRAP) (Reddy et al., 1996, Blood 88:2288-2297). TRAP is an iron-containing protein encoded by the same gene that codes for uteroferrin, a placental iron transport protein. In human peripheral mononuclear cells, TRAP expression is inhibited at the transcriptional level by both hemin (ferric protoporphyrin IX) and protoporphyrin IX. Further studies with mTRAP deletion mutants showed that the hemin effect was dependent on repressor activity in the mTRAP promoter and led to the identification of a DNA binding protein complex in nuclear extracts of hemin-treated cells termed hemin response element binding protein (HREBP). Analysis of HREBP identified four components with apparent molecular masses of 133-, 90-, 80-, and 37-kD, respectively (Reddy et al., 1998, Blood 91:1793-1801). The 80- and 90-kD components were later identified as the p70 (XRCC6) and p80/86 (XRCC5) subunits of Ku antigen (KuAg) respectively, whereas the 37-kD component represented ref1 (redox factor protein 1, APEX1). The identity of the 133-kD protein is still unknown (FIG. 57a).

Recently, this Ku antigen complex (Ku70 and Ku80) as well as nuclear receptors PPARγ/RXRα were identified as key transcriptional regulators of apolipoprotein C-IV (ApoC-IV), a member of the apolipoprotein family implicated in liver steatosis (Kim et al., 2008, J. Hepatol. 49:787-798). Further analysis suggested that this regulation relies on complex formation between Ku70 and Ku80 and PPARγ/RXRα (FIG. 57b). Without wishing to be bound by any theory, it appears that together these findings suggest that PPAR activity could be modified through the interaction with the “HREBP” complex (FIG. 57c).

While the foregoing invention has been described in some detail for purposes of clarity and understanding, it will be clear to one skilled in the art from a reading of this disclosure that various changes in form and detail can be made without departing from the true scope of the invention. For example, all the techniques and apparatus described above can be used in various combinations. All publications, patents, patent applications, and/or other documents cited in this application are incorporated by reference in their entirety for all purposes to the same extent as if each individual publication, patent, patent application, and/or other document were individually indicated to be incorporated by reference for all purposes.

### Tables 2-41

TABLE 2
List of genes whose transcription is facilitated by promoters utilized in the methods
described herein.

| Name | ACCESSION | Description | SEQ ID NO: |
|---|---|---|---|
| Bmal1 | NM_001178 | Transcription Factor, heterodimerizes with Clock, | 1 |
| | | core clock TF | |
| Clock | NM_004898 | Transcription Factor, heterodimerizes with | 2 |
| | | Bmal1, core clock TF | |
| NPAS2 | NM_002518 | Transcription Factor, heterodimerizes with Bmal1 | 3 |
| Per1 | NM_002616 | Period 1, heterodimerizes with Cry1 and Cry2 | 4 |
| Per2 | NM_022817 | Period 2, heterodimerizes with Cry1 and Cry2 | 5 |
| Per3 | NM_016831 | Period 3, heterodimerizes with Cry1 and Cry2 | 6 |
| Cry1 | NM_004075 | Cryptochrome 1, heterodimerizes with Per1,2, | 7 |
| | | and 3 | |
| Cry2 | NM_021117 | Cryptochrome 2, heterodimerizes with Per1,2, | 8 |
| | | and 3 | |
| Rev-erb alpha | NM_021724 | Nuclear Hormone Receptor, repressor (represses | 9 |
| | | Bmal1) | |
| Rev-erb beta | NM_005126 | Nuclear Hormone Receptor, repressor | 10 |
| Rora | NM_134261 | Nuclear Hormone Receptor, activator (activates | 11 |
| | | Bmal1) | |
| Rorb | NM_006914 | Nuclear Hormone Receptor, activator | 12 |
| Rorc | NM_005060 | Nuclear Hormone Receptor, activator (activates | 13 |
| | | Bmal1) | |
| Dec1 | NM_003670 | Transcription Factor (bHLH family), negative | 14 |
| | | regulator of molecular clock | |
| Dec2 | NM_030762 | Transcription Factor (bHLH family), negative | 15 |
| | | regulator of molecular clock | |
| Dbp | NM_001352 | Transcription Factor (PAR bZIP family), | 16 |
| | | circadian expression in SCN | |
| Tef | NM_003216 | Transcription Factor (PAR bZIP family), | 17 |
| | | circadian expression in SCN | |
| Hlf | NM_002126 | Transcription Factor (PAR bZIP family), | 18 |
| | | circadian expression in SCN | |
| E4bp4 | NM_005384 | Transcription Factor (PAR bZIP family), negative | 19 |
| | | regulator of mol. clock | |

TABLE 3
List of genes whose transcription is facilitated by validated promoters utilized in the
methods described herein.

| | | | |
|---|---|---|---|
| Name | ACCESSION | Full name | SEQ ID NO: |

Feeding behavior

| | | | |
|---|---|---|---|
| mAGRP | NM_007427 | Agouti Related Protein | 20 |
| mGhrelin | NM_021488 | | 21 |
| mLeptin | NM_008493 | | 22 |
| mNPY | NM_023456 | Neuropeptide Y | 23 |
| mPOMC | NM_008895 | Pro-opiomelanocortin α | 24 |
| hPOMC | NM_001035256 | Pro-opiomelanocortin α | 25 |

Nuclear Hormone Receptors

| | | | |
|---|---|---|---|
| mCAR | NM_009803 | Constitutive Androstane Receptor | 26 |
| hCAR | NM_001077482 | Constitutive Androstane Receptor | 27 |
| hPPARg-1 | NM_138712 | Peroxisome Proliferator Activated | 28 |
| | | Receptor γ-1 | |
| hPPARg-2 | NM_015869 | Peroxisome Proliferator Activated | 29 |
| | | Receptor γ-2 | |
| hRev-Erb α | NM_021724 | | 30 |

Metabolism & Transport

| | | | |
|---|---|---|---|
| mUCP1 | NM_009463 | Uncoupling Protein 1 | 31 |
| mUCP2 | NM_011671 | Uncoupling Protein 2 | 32 |
| mUCP3 | NM_009464 | Uncoupling Protein 3 | 33 |
| mPGC1β | NM_133263 | PPARγ coactivator 1β | 34 |
| mADRP | NM_007408 | Adipose Differentiation Related | 35 |
| | | Protein | |
| mAdiponectin | NM_009605 | | 36 |
| mSREBP1-c | AB373959 | Sterol regulatory-element binding | 37 |
| | | protein 1c | |
| mABCA1 | NM_013454 | | 38 |
| mDio1 | NM_007860 | Deiodinase, iodothyronine, type I | 39 |
| mDio2 | NM_010050 | Deiodinase, iodothyronine, type II | 40 |
| hMyoD | NM_002478 | Myogenic differentiation | 41 |
| hG6PD | NM_000402 | Glucose-6-phosphate dehydrogenase | 42 |
| hABCB1 | NM_000927 | | 43 |
| hCYP3A | NG_000004 | Cytochrome P450 3A (exemplified by | 44 |
| | | CYP3A4, NM_017460) | |

Inflammation

| | | | |
|---|---|---|---|
| hTNFα | NM_000594 | Tumor necrosis factor, member 2 | 45 |
| hIFNγ | NM_000619 | Interferon γ | 46 |
| hIRF7 | NM_001572 | Interferon regulatory factor 7 | 47 |

TABLE 4
Nuclear Receptor cDNAs: Full length, sequence verified, cDNA's of all murine
Nuclear Hormone Receptors (pcDNA3.1-V5H6 backbone)

| Class | Official | Full name | Short | Accession NR | Alternative names |
|---|---|---|---|---|---|
| 1A | NR1A1 | Thyroid receptor a | TRa | NM_178060 | c-erbA-1, THRA |
| | NR1A2 | Thyroid receptor b | TRb | NM_009380 | c-erbA-2, THRB |
| 1B | NR1B1 | Retinoic acid receptor α | RARa | NM_009024 | |
| | NR1B2 | Retinoic acid receptor β | RARb | NM_011243 | HAP |
| | NR1B3 | Retinoic acid receptor γ | RARg | NM_011244 | RARD |
| 1C | NR1C1 | Peroxisome proliferator | PPARa | NM_011144 | |
| | | activated receptor α | | | |
| | NR1C2 | Peroxisome proliferator | PPARd | NM_011145 | PPARb, NUC1, |
| | | activated receptor δ | | | FAAR |
| | NR1C3 | Peroxisome proliferator | PPARg | NM_011146 | |
| | | activated receptor γ | | | |
| 1D | NR1D1 | Rev-Erb α | REVERBa | NM_145434 | EAR1, EAR1A |
| | NR1D2 | Rev-Erb β | REVERBb | NM_011584 | EAR1b, BD73, |
| | | | | | RVR, HZF2 |
| 1F | NR1F1 | RAR-related Orphan | RORa | NM_013646 | RZRa |
| | | Receptor α | | | |
| | NR1F2 | RAR-related Orphan | RORb | NM_146095 | RZRb |
| | | Receptor β | | | |
| | NR1F3 | RAR-related Orphan | RORg | NM_011281 | TOR |
| | | Receptor γ | | | |
| 1H | NR1H2 | Liver X Receptor β | LXRb | NM_009473 | UR, OR-1, NER1, |
| | | | | | RIP15 |
| | NR1H3 | Liver X Receptor α | LXRa | NM_013839 | RLD1, LXR |
| | NR1H4 | Farnesoid X Receptor | FXR | NM_009108 | FXR, RIP14, |
| | | | | | HRR1 |
| | NR1H5 | mouse FXRb (in human | FXRb | NM_198658 | |
| | | pseudogene?) | | | |
| 1I | NR1I1 | Vitamin D Receptor | VDR | NM_009504 | |
| | NR1I2 | Pregnane X Receptor | PXR | NM_010936 | ONR1, SXR, BXR |
| | NR1I3 | Constitutive | CAR | NM_009803 | MB67, CAR1, |
| | | Androstane Receptor | | | CARα |
| 2A | NR2A1 | Hepatocyte Nuclear | HNF4a | NM_008261 | HNF4 |
| | | Factor α | | | |
| | NR2A2 | Hepatocyte Nuclear | HNF4g | NM_013920 | HNF4G |
| | | Factor γ | | | |
| 2B | NR2B1 | Retinoic X Receptor α | RXRa | NM_011305 | |
| | NR2B2 | Retinoic X Receptor β | RXRb | NM_011306 | H-2RIIBP, RCoR-1 |
| | NR2B3 | Retinoic X Receptor γ | RXRg | NM_009107 | |
| 2C | NR2C1 | Testicular Orphan | TR2 | NM_011629 | TR2, TR2-11 |
| | | Nuclear Receptor 2 | | | |
| | NR2C2 | Testicular Orphan | TR4 | NM_011630 | TR4, TAK1 |
| | | Nuclear Receptor 4 | | | |
| 2E | NR2E1 | Tailless (homolog of | TLX | NM_152229 | TLL, XTLL |
| | | drosophila) | | | |
| | NR2E3 | Photoreceptor-specific | PNR | NM_013708 | |
| | | Nuclear Receptor | | | |
| 2F | NR2F1 | COUP-TF1 | CTF1 | NM_010151 | COUPTFA, EAR3, |
| | | | | | SVP44 |
| | NR2F2 | COUP-TF2 | CTF2 | NM_009697 | COUPTF, ARP1, |
| | | | | | SVP40 |
| | NR2F6 | COUP-TF3 | CTF3 | NM_010150 | EAR2 |
| 3A | NR3A1 | Estrogen Receptor α | ERa | NM_007956 | ERa |
| | NR3A2 | Estrogen Receptor β | ERb | NM_207707 | ERb |
| 3B | NR3B1 | Estrogen Related | ERRa | NM_007953 | ERR1 |
| | | Receptor α | | | |
| | NR3B2 | Estrogen Related | ERRb | NM_011934 | ERR2 |
| | | Receptor β | | | |
| | NR3B3 | Estrogen Related | ERRg | NM_011935 | ERR3 |
| | | Receptor γ | | | |
| 3C | NR3C1 | Glucocorticoid | GR | NM_008173 | |
| | | Receptor | | | |
| | NR3C2 | Mineralocorticoid | MR | XM_356093 | |
| | | Receptor | | | |
| | NR3C3 | Progesterone Receptor | PR | NM_008829 | |
| | NR3C4 | Androsterone Receptor | AR | X53779 | |
| 4A | NR4A1 | NR4a1 | NR4a1 | NM_010444 | NGFIB, TR3, N10, |
| | | | | | NUR77, NAK1 |
| | NR4A2 | NR4a2 | NR4a2 | NM_013613 | NURR1, NOT, |
| | | | | | RNR1, HZF-3, |
| | | | | | TINOR |
| | NR4A3 | NR4a3 | NR4a3 | NM_015743 | NOR1, MINOR |
| 5A | NR5A1 | Steroidogenic Factor 1 | SF1 | NM_139051 | ELP, FTZ-F1, |
| | | | | | AD4BP |
| | NR5A2 | Liver Receptor | LRH1 | NM_030676 | xFF1rA, xFF1rB, |
| | | Homolog | | | FFLR, PHR, FTF |
| 6A | NR6A1 | Germ Cell Nuclear | GCNF1 | NM_010264 | RTR |
| | | Factor | | | |
| 0B | NR0B1 | DAX1 | DAX1 | NM_007430 | AHCH |
| | NR0B2 | Small Heterodimer | SHP | NM_011850 | |
| | | Partner | | | |

TABLE 5
Nuclear Receptor ligands

| Class | Official | Full name | Short | Ligand | Conc. | |
|---|---|---|---|---|---|---|
| 1A | NR1A1 | Thyroid receptor a | TRa | Thyroid hormones and | 100 nM-1 μM | |
| | | | | derivatives | | |
| | | | | T3 (3-3-5-Triiodo-L- | | |
| | | | | thyronine) | | |
| | NR1A2 | Thyroid receptor b | TRb | Thyroid hormones and | 100 nM-1 μM | |
| | | | | derivatives | | |
| | | | | T3 (3-3-5-Triiodo-L- | | |
| | | | | thyronine) | | |
| 1B | NR1B1 | Retinoic acid receptor α | RARa | Retinoids and derivatives | 1 | μM |
| | | | | ATRA (all-trans Retinoic | 100 | nM |
| | | | | Acid), | 1 | μM |
| | | | | TTNBP | | |
| | | | | 9-cis retinoic acid | | |
| | NR1B2 | Retinoic acid receptor β | RARb | Retinoids and derivatives | 1 | μM |
| | | | | ATRA (all-trans Retinoic | 100 | nM |
| | | | | Acid), | 1 | μM |
| | | | | TTNBP | | |
| | | | | 9-cis retinoic acid | | |
| | NR1B3 | Retinoic acid receptor γ | RARg | Retinoids and derivatives | 1 | μM |
| | | | | ATRA (all-trans Retinoic | 100 | nM |
| | | | | Acid), | 1 | μM |
| | | | | TTNBP | | |
| | | | | 9-cis retinoic acid | | |
| 1C | NR1C1 | Peroxisome proliferator | PPARa | WY14643 | 30 | μM |
| | | activated receptor α | | | | |
| | NR1C2 | Peroxisome proliferator | PPARd | GW501516 | 100 | nM |
| | | activated receptor δ | | | | |
| | NR1C3 | Peroxisome proliferator | PPARg | BRL49653 | 1 | μM |
| | | activated receptor γ | | (Rosiglitazone) | | |
| 1D | NR1D1 | Rev-Erb α | REVERBa | | | |
| | NR1D2 | Rev-Erb β | REVERBb | | | |
| 1F | NR1F1 | RAR-related Orphan | RORa | | | |
| | | Receptor α | | | | |
| | NR1F2 | RAR-related Orphan | RORb | | | |
| | | Receptor β | | | | |
| | NR1F3 | RAR-related Orphan | RORg | | | |
| | | Receptor γ | | | | |
| 1H | NR1H2 | Liver X Receptor β | LXRb | Sterols and derivatives | 1 | μM |
| | | | | T0901317 | | |
| | NR1H3 | Liver X Receptor α | LXRa | Sterols and derivatives | 1 | μM |
| | | | | T0901317 | | |
| | NR1H4 | Farnesoid X Receptor | FXR | Bile acids and derivatives | 1 | μM |
| | | | | Fexaramine, | | |
| | | | | GW4064 | | |
| | NR1H5 | mouse FXRb | FXRb | | | |
| 1I | NR1I1 | Vitamin D Receptor | VDR | Vitamin D3 and its | 1-10 | nM |
| | | | | derivatives | | |
| | | | | 1,25 dihydroxyvitamin | | |
| | | | | D3 | | |
| | NR1I2 | Pregnane X Receptor | PXR | Xenobiotics including | 1 | μM |
| | | | | PCN | | |
| | | | | Hyperforin | 1 | μM |
| | NR1I3 | Constitutive Androstane | CAR | Xenobiotics including | 250 | nM |
| | | Receptor | | TCPOBOP | | |
| 2A | NR2A1 | Hepatocyte Nuclear | HNF4a | | | |
| | | Factor α | | | | |
| | NR2A2 | Hepatocyte Nuclear | HNF4g | | | |
| | | Factor γ | | | | |
| 2B | NR2B1 | Retinoic X Receptor α | RXRa | Retinoids including: | | |
| | | | | 9-cis retinoic acid | 1 | μM |
| | | | | 13-cis retinoic acid | 1 | μM |
| | | | | LG100268 | 100 | nM |
| | NR2B2 | Retinoic X Receptor β | RXRb | Retinoids including: | | |
| | | | | 9-cis retinoic acid | 1 | μM |
| | | | | 13-cis retinoic acid | 1 | μM |
| | | | | LG100268 | 100 | nM |
| | NR2B3 | Retinoic X Receptor γ | RXRg | Retinoids including | | |
| | | | | 9-cis retinoic acid | 1 | μM |
| | | | | 13-cis retinoic acid | 1 | μM |
| | | | | LG100268 | 100 | nM |
| 2C | NR2C1 | Testicular Orphan | TR2 | | | |
| | | Nuclear Receptor 2 | | | | |
| | NR2C2 | Testicular Orphan | TR4 | | | |
| | | Nuclear Receptor 4 | | | | |
| 2E | NR2E1 | Tailless (homolog of | TLX | | | |
| | | drosophila) | | | | |
| | NR2E3 | Photoreceptor-specific | PNR | | | |
| | | Nuclear Receptor | | | | |
| 2F | NR2F1 | COUP-TF1 | CTF1 | | | |
| | NR2F2 | COUP-TF2 | CTF2 | | | |
| | NR2F6 | COUP-TF3 | CTF3 | | | |
| 3A | NR3A1 | Estrogen Receptor α | ERa | Estrogens and related | 100 | nM |
| | | | | derivatives, β-estradiol | | |
| | NR3A2 | Estrogen Receptor β | ERb | Estrogens and related | 100 | nM |
| | | | | derivatives, β-estradiol | | |
| 3B | NR3B1 | Estrogen Related | ERRa | | | |
| | | Receptor α | | | | |
| | NR3B2 | Estrogen Related | ERRb | | | |
| | | Receptor β | | | | |
| | NR3B3 | Estrogen Related | ERRg | | | |
| | | Receptor γ | | | | |
| 3C | NR3C1 | Glucocorticoid Receptor | GR | Glucocorticoids and | 10-100 | nM |
| | | | | related derivatives, | | |
| | | | | Dexamethasone | | |
| | NR3C2 | Mineralocorticoid | MR | Mineralocorticoids and | 1 | μM |
| | | Receptor | | related derivatives, | | |
| | | | | Hydrocortisone (Cortisol) | | |
| | NR3C3 | Progesterone Receptor | PR | Progesterone | 50 | nM |
| | NR3C4 | Androsterone Receptor | AR | Androgens and related | 50 | nM |
| | | | | derivatives, | | |
| | | | | Androstane | | |
| 4A | NR4A1 | NR4a1 | NR4a1 | | | |
| | NR4A2 | NR4a2 | NR4a2 | | | |
| | NR4A3 | NR4a3 | NR4a3 | | | |
| 5A | NR5A1 | Steroidogenic Factor 1 | SF1 | | | |
| | NR5A2 | Liver Receptor Homolog | LRH1 | | | |
| 6A | NR6A1 | Germ Cell Nuclear Factor | GCNF1 | | | |
| 0B | NR0B1 | DAX1 | DAX1 | | | |
| | NR0B2 | Small Heterodimer | SHP | | | |
| | | Partner | | | | |

TABLE 6a
Results of assays of transcription factor (+/− ligand)
with selected transcription elements as described herein.

| | mCAR | hCAR | mPgc1b | hG6PD | hMyoD | mPer1 | mUCP! | mUCP2 |
|---|---|---|---|---|---|---|---|---|
| TRa1 | 0.29 | 0.18 | 0.22 | 0.48 | 0.53 | 0.41 | 0.28 | 0.93 |
| TRa1 ligand | 0.22 | 0.54 | 0.20 | 0.72 | 0.51 | 0.30 | 0.28 | 1.24 |
| TRa2 | 0.97 | 0.80 | 0.50 | 0.98 | 0.86 | 0.50 | 0.66 | 1.50 |
| TRa2 ligand | 0.93 | 0.67 | 0.47 | 0.97 | 0.76 | 0.40 | 0.63 | 1.27 |
| TRb1 | 0.82 | 0.47 | 0.50 | 1.02 | 1.14 | 0.79 | 0.56 | 1.12 |
| TRb1 ligand | 0.44 | 0.73 | 0.36 | 0.95 | 0.74 | 0.35 | 0.40 | 1.31 |
| TRb2 | 1.09 | 1.42 | 0.77 | 1.29 | 1.16 | 0.73 | 0.72 | 1.53 |
| TRb2 ligand | 0.66 | 0.88 | 0.63 | 1.12 | 1.04 | 0.41 | 0.56 | 1.48 |
| RARa | 1.22 | 1.05 | 1.07 | 1.53 | 1.57 | 0.59 | 0.63 | 2.11 |
| RARa ligand | 0.53 | 0.94 | 0.88 | 1.16 | 1.40 | 0.44 | 3.12 | 1.99 |
| RARb | 1.30 | 1.31 | 1.21 | 1.52 | 1.95 | 0.62 | 1.00 | 2.52 |
| RARb ligand | 0.75 | 1.31 | 1.00 | 1.37 | 2.13 | 0.65 | 2.29 | 2.99 |
| RARg | 1.24 | 0.99 | 1.07 | 1.57 | 1.65 | 0.84 | 1.13 | 2.21 |
| RARg ligand | 0.73 | 1.28 | 1.05 | 1.57 | 1.74 | 0.61 | 2.64 | 2.68 |
| PPARa | 0.88 | 1.39 | 0.79 | 1.49 | 1.01 | 1.25 | 0.59 | 1.52 |
| PPARa ligand | 1.14 | 1.42 | 0.72 | 1.52 | 1.02 | 1.32 | 1.01 | 1.84 |
| PPARg | 1.25 | 1.58 | 0.96 | 1.77 | 1.18 | 1.07 | 0.66 | 1.56 |
| PPARg ligand | 1.79 | 2.56 | 1.49 | 2.44 | 1.69 | 1.67 | 1.26 | 2.26 |
| PPARd | 0.79 | 1.22 | 0.67 | 1.30 | 0.94 | 1.30 | 0.79 | 1.57 |
| PPARd ligand | 0.84 | 1.09 | 0.67 | 1.60 | 1.06 | 1.15 | 0.87 | 1.53 |
| LXRa | 0.78 | 1.87 | 0.71 | 1.62 | 0.95 | 0.70 | 0.69 | 2.39 |
| LXRa ligand | 1.21 | 3.37 | 0.84 | 2.16 | 1.35 | 0.67 | 1.11 | 3.08 |
| LXRb | 0.92 | 1.44 | 0.40 | 1.25 | 0.86 | 0.82 | 3.88 | 1.55 |
| LXRb ligand | 0.91 | 1.37 | 0.40 | 1.24 | 0.81 | 0.59 | 3.75 | 1.73 |
| FXR | 0.88 | 0.78 | 0.66 | 1.14 | 0.58 | 0.68 | 0.95 | 1.02 |
| FXR ligand | 1.42 | 3.41 | 0.84 | 1.35 | 1.20 | 0.92 | 0.88 | 1.79 |
| FXRb | 1.35 | 2.10 | 0.80 | 1.63 | 1.09 | 0.98 | 0.95 | 1.52 |
| FXRb ligand | 1.39 | 1.98 | 0.83 | 1.46 | 1.22 | 0.85 | 0.85 | 1.38 |
| VDR | 0.69 | 0.83 | 0.58 | 1.15 | 0.83 | 0.67 | 0.63 | 1.24 |
| VDR ligand | 0.26 | 0.69 | 0.34 | 0.97 | 0.79 | 0.34 | 0.48 | 1.16 |
| PXR | 1.49 | 1.16 | 0.86 | 1.14 | 0.80 | 1.30 | 0.47 | 1.08 |
| PXR ligand | 0.66 | 1.35 | 0.75 | 1.11 | 0.79 | 0.59 | 0.68 | 1.24 |
| CAR | 0.51 | 0.82 | 0.78 | 1.24 | 0.81 | 0.60 | 0.74 | 1.38 |
| CAR ligand | 0.45 | 0.92 | 0.69 | 1.28 | 0.74 | 0.52 | 0.88 | 1.57 |
| control | 0.96 | 1.31 | 0.96 | 1.49 | 0.91 | 0.91 | 0.82 | 1.29 |
| RXRa | 0.97 | 0.78 | 0.72 | 1.22 | 0.81 | 0.53 | 0.66 | 1.25 |
| RXRa ligand | 0.94 | 1.16 | 1.07 | 1.94 | 1.53 | 0.67 | 2.45 | 2.93 |
| RXRb | 1.27 | 0.95 | 0.99 | 0.62 | 0.86 | 0.35 | 0.21 | 0.80 |
| RXRb ligand | 1.09 | 1.08 | 0.80 | 1.01 | 1.09 | 0.58 | 0.35 | 1.37 |
| RXRg | 1.25 | 0.93 | 0.76 | 1.17 | 1.07 | 0.66 | 0.55 | 1.31 |
| RXRg ligand | 1.04 | 1.18 | 0.93 | 1.68 | 1.98 | 0.87 | 1.51 | 2.25 |
| RVRa | 0.89 | 1.05 | 0.74 | 1.23 | 1.18 | 0.68 | 0.85 | 1.30 |
| RVRb | 0.91 | 1.13 | 0.78 | 1.48 | 1.28 | 0.82 | 0.96 | 1.59 |
| RORa | 0.55 | 0.58 | 0.91 | 1.98 | 0.75 | 0.75 | 0.38 | 0.95 |
| RORb | 1.15 | 1.05 | 0.90 | 1.37 | 1.17 | 0.78 | 0.86 | 1.60 |
| RORg | 1.13 | 1.22 | 1.34 | 2.18 | 1.36 | 1.22 | 0.62 | 1.54 |
| HNF4a | 16.83 | 15.62 | 0.54 | 0.93 | 1.03 | 0.65 | 0.63 | 1.24 |
| HNF4g | 1.43 | 0.81 | 0.57 | 1.13 | 1.06 | 0.81 | 0.79 | 1.04 |
| TR2 | 0.81 | 2.30 | 0.83 | 1.22 | 1.31 | 0.72 | 1.82 | 1.90 |
| TR4 | 2.52 | 3.15 | 1.46 | 1.77 | 3.38 | 1.57 | 5.94 | 1.81 |
| TLX | 0.39 | 0.56 | 0.38 | 2.89 | 0.49 | 1.51 | 0.63 | 1.02 |
| PNR | 0.55 | 0.38 | 0.42 | 1.23 | 0.59 | 0.65 | 0.37 | 0.95 |
| Era | 1.25 | 1.20 | 0.99 | 1.72 | 1.28 | 1.23 | 1.28 | 1.89 |
| Era ligand | 1.49 | 3.02 | 1.26 | 2.10 | 1.55 | 1.94 | 1.68 | 2.96 |
| Erb | 1.18 | 0.81 | 0.77 | 1.21 | 0.80 | 0.55 | 0.75 | 1.04 |
| Erb ligand | 0.82 | 0.67 | 0.63 | 1.18 | 0.81 | 0.71 | 0.63 | 1.11 |
| ERR1 | 1.07 | 0.82 | 0.75 | 1.58 | 1.09 | 1.37 | 0.88 | 1.11 |
| ERR2 | 0.99 | 0.77 | 1.07 | 1.58 | 2.60 | 2.28 | 2.95 | 1.68 |
| ERR3 | 2.87 | 1.34 | 1.70 | 1.70 | 2.05 | 1.58 | 5.98 | 1.76 |
| CTF1 | 0.31 | 0.14 | 0.57 | 1.06 | 0.71 | 1.97 | 0.41 | 0.61 |
| CTF2 | 0.51 | 0.23 | 1.03 | 1.17 | 0.96 | 2.41 | 0.43 | 0.82 |
| CTF3 | 0.29 | 0.14 | 0.42 | 0.87 | 0.56 | 1.10 | 0.42 | 0.49 |
| SF-1 | 2.43 | 3.60 | 2.80 | 3.32 | 2.39 | 3.73 | 2.54 | 4.09 |
| control | 1.08 | 0.88 | 0.88 | 1.40 | 1.07 | 0.96 | 0.79 | 0.85 |
| GR | 0.23 | 0.36 | 0.27 | 0.60 | 0.42 | 2.67 | 0.42 | 0.54 |
| GR ligand | 0.20 | 0.46 | 0.46 | 0.70 | 0.51 | 1.30 | 0.39 | 1.59 |
| hMR | 0.77 | 0.81 | 0.48 | 0.94 | 0.59 | 2.44 | 0.48 | 0.54 |
| hMR ligand | 0.59 | 0.47 | 0.50 | 0.77 | 0.48 | 2.86 | 0.38 | 0.84 |
| PR | 0.98 | 1.00 | 0.75 | 1.22 | 1.11 | 1.44 | 1.21 | 1.63 |
| PR ligand | 0.63 | 0.99 | 0.98 | 1.61 | 1.37 | 1.45 | 2.20 | 3.08 |
| AR | 0.81 | 0.89 | 0.76 | 1.11 | 0.91 | 0.86 | 0.74 | 1.79 |
| AR ligand | 0.71 | 0.77 | 0.76 | 0.99 | 0.99 | 0.97 | 1.61 | 1.47 |
| NR4a1 | 0.94 | 0.97 | 1.45 | 2.07 | 2.41 | 3.50 | 1.70 | 2.42 |
| NR4a2 | 0.57 | 0.58 | 0.76 | 1.10 | 0.82 | 1.08 | 0.99 | 1.18 |
| NR4a3 | 0.57 | 0.54 | 0.77 | 1.16 | 0.89 | 0.97 | 0.86 | 1.37 |
| LRH-1 | 3.11 | 3.14 | 2.17 | 2.42 | 1.91 | 3.37 | 1.92 | 3.19 |
| GCNF | 0.78 | 0.93 | 0.99 | 1.23 | 0.80 | 1.06 | 0.85 | 1.27 |
| DAX-1 | 0.96 | 1.20 | 0.62 | 1.23 | 0.97 | 1.07 | 1.39 | 1.44 |
| SHP | 0.95 | 0.99 | 0.76 | 1.15 | 0.85 | 0.90 | 0.93 | 1.49 |
| control | 1.00 | 1.00 | 1.00 | 1.00 | 1.00 | 1.00 | 1.00 | 1.00 |

TABLE 6b
Results of assays of transcription factor (+/− ligand) with selected
transcription elements as described herein; continued from Table 6a.

| | mUCP3 | mMCP-1 | hPOMC | hIRF7 | hMDR1 | hCYP3A4 | mADRP | mAdiponectin |
|---|---|---|---|---|---|---|---|---|
| TRa1 | 0.81 | 1.41 | 0.65 | 0.58 | 0.42 | 0.25 | 0.85 | 0.56 |
| TRa1 ligand | 0.91 | 1.50 | 1.51 | 0.72 | 0.37 | 0.16 | 0.84 | 1.11 |
| TRa2 | 1.17 | 1.56 | 0.78 | 0.98 | 0.42 | 0.54 | 1.65 | 0.93 |
| TRa2 ligand | 1.40 | 1.34 | 0.69 | 0.99 | 0.49 | 0.52 | 1.37 | 0.80 |
| TRb1 | 1.37 | 1.76 | 1.05 | 1.09 | 0.74 | 0.64 | 1.34 | 1.06 |
| TRb1 ligand | 1.47 | 1.70 | 1.06 | 1.09 | 0.51 | 0.37 | 0.85 | 1.02 |
| TRb2 | 1.94 | 2.24 | 1.13 | 1.34 | 0.63 | 0.71 | 1.59 | 1.17 |
| TRb2 ligand | 1.86 | 1.64 | 1.06 | 1.33 | 0.48 | 0.52 | 1.41 | 1.51 |
| RARa | 1.76 | 1.70 | 0.74 | 1.54 | 0.67 | 0.94 | 1.26 | 1.25 |
| RARa ligand | 1.61 | 0.66 | 0.61 | 1.50 | 0.82 | 0.80 | 2.58 | 0.84 |
| RARb | 2.08 | 1.84 | 1.00 | 1.79 | 0.97 | 1.03 | 1.61 | 1.29 |
| RARb ligand | 2.20 | 0.84 | 0.92 | 1.89 | 0.70 | 0.76 | 3.33 | 1.00 |
| RARg | 1.98 | 1.57 | 0.87 | 1.80 | 0.85 | 0.91 | 1.54 | 1.00 |
| RARg ligand | 1.96 | 0.72 | 0.80 | 1.64 | 0.89 | 0.80 | 2.07 | 0.81 |
| PPARa | 2.15 | 1.14 | 0.57 | 1.39 | 0.51 | 0.76 | 3.01 | 0.64 |
| PPARa ligand | 3.65 | 1.06 | 0.49 | 1.51 | 0.49 | 0.73 | 6.16 | 0.68 |
| PPARg | 1.83 | 1.36 | 0.65 | 1.70 | 0.83 | 1.06 | 1.79 | 1.28 |
| PPARg ligand | 4.65 | 1.57 | 0.66 | 2.48 | 0.87 | 1.51 | 3.57 | 2.00 |
| PPARd | 1.69 | 1.78 | 0.89 | 1.27 | 0.90 | 1.12 | 1.39 | 1.42 |
| PPARd ligand | 2.03 | 1.34 | 0.81 | 1.59 | 0.72 | 0.95 | 2.91 | 1.37 |
| LXRa | 1.58 | 0.91 | 1.58 | 1.26 | 0.51 | 0.93 | 2.20 | 0.97 |
| LXRa ligand | 1.97 | 0.84 | 2.59 | 1.91 | 0.65 | 1.15 | 3.05 | 1.26 |
| LXRb | 1.73 | 1.86 | 1.46 | 1.71 | 0.78 | 1.08 | 2.40 | 0.98 |
| LXRb ligand | 1.23 | 1.76 | 1.47 | 1.48 | 0.99 | 0.76 | 2.99 | 1.03 |
| FXR | 1.30 | 1.16 | 0.65 | 1.59 | 0.61 | 0.93 | 1.32 | 1.00 |
| FXR ligand | 2.07 | 1.09 | 0.70 | 1.76 | 0.74 | 1.63 | 2.34 | 1.21 |
| FXRb | 1.89 | 1.18 | 0.79 | 1.57 | 0.73 | 1.60 | 2.00 | 1.09 |
| FXRb ligand | 1.69 | 1.21 | 0.87 | 1.55 | 0.78 | 1.53 | 2.19 | 1.17 |
| VDR | 1.49 | 2.02 | 0.90 | 1.15 | 0.90 | 1.15 | 1.54 | 0.91 |
| VDR ligand | 0.90 | 0.62 | 0.69 | 1.05 | 0.62 | 0.65 | 0.92 | 0.67 |
| PXR | 1.34 | 1.96 | 0.98 | 1.38 | 1.10 | 1.98 | 2.05 | 1.55 |
| PXR ligand | 1.18 | 0.50 | 0.57 | 1.31 | 0.66 | 0.65 | 1.60 | 1.00 |
| CAR | 0.90 | 1.08 | 1.00 | 1.42 | 0.68 | 0.70 | 1.25 | 0.74 |
| CAR ligand | 0.90 | 0.62 | 0.87 | 1.53 | 0.62 | 0.58 | 1.39 | 0.67 |
| control | 1.15 | 1.54 | 1.40 | 1.38 | 0.75 | 1.15 | 1.83 | 1.09 |
| RXRa | 1.27 | 1.60 | 0.61 | 1.04 | 0.51 | 0.35 | 1.57 | 0.91 |
| RXRa ligand | 0.51 | 0.96 | 0.65 | 1.54 | 0.71 | 0.36 | 3.52 | 0.86 |
| RXRb | 0.83 | 0.00 | 0.00 | 0.34 | 0.28 | 0.06 | 1.36 | 1.14 |
| RXRb ligand | 1.17 | 0.00 | 0.00 | 0.50 | 0.42 | 0.13 | 2.17 | 1.33 |
| RXRg | 1.41 | 1.98 | 0.58 | 1.04 | 0.65 | 0.19 | 1.34 | 1.10 |
| RXRg ligand | 1.97 | 1.43 | 0.66 | 1.44 | 0.82 | 0.37 | 2.48 | 1.08 |
| RVRa | 1.24 | 1.40 | 0.53 | 1.24 | 0.64 | 0.50 | 1.05 | 0.88 |
| RVRb | 1.91 | 1.59 | 0.66 | 1.91 | 0.94 | 1.01 | 0.71 | 1.06 |
| RORa | 2.56 | 1.41 | 0.38 | 1.51 | 0.32 | 0.36 | 1.96 | 1.27 |
| RORb | 1.33 | 1.65 | 0.52 | 1.55 | 0.58 | 0.56 | 1.38 | 1.32 |
| RORg | 2.38 | 2.81 | 0.50 | 1.69 | 0.54 | 0.76 | 1.87 | 2.12 |
| HNF4a | 1.06 | 0.73 | 0.81 | 1.36 | 0.77 | 0.37 | 1.47 | 0.40 |
| HNF4g | 0.84 | 1.20 | 1.23 | 1.20 | 0.75 | 0.40 | 1.03 | 0.72 |
| TR2 | 2.01 | 2.91 | 3.65 | 0.98 | 1.01 | 0.44 | 1.38 | 0.60 |
| TR4 | 3.19 | 2.15 | 11.80 | 1.85 | 1.57 | 1.74 | 2.02 | 4.71 |
| TLX | 1.11 | 0.57 | 0.60 | 2.09 | 0.70 | 0.90 | 0.52 | 1.25 |
| PNR | 0.79 | 1.09 | 0.34 | 1.04 | 0.52 | 0.50 | 0.77 | 1.13 |
| Era | 1.66 | 1.11 | 1.37 | 1.97 | 1.85 | 0.80 | 1.31 | 1.54 |
| Era ligand | 2.91 | 1.06 | 2.21 | 3.40 | 3.48 | 1.04 | 1.11 | 2.03 |
| Erb | 1.28 | 1.37 | 0.74 | 1.42 | 1.06 | 1.35 | 1.08 | 1.09 |
| Erb ligand | 1.18 | 1.16 | 0.58 | 1.51 | 1.06 | 0.89 | 0.88 | 0.88 |
| ERR1 | 1.47 | 2.22 | 0.63 | 1.19 | 1.20 | 1.01 | 1.54 | 0.78 |
| ERR2 | 3.32 | 8.84 | 2.70 | 2.30 | 1.20 | 3.49 | 1.76 | 0.88 |
| ERR3 | 3.06 | 4.55 | 4.09 | 2.10 | 0.79 | 1.02 | 3.37 | 1.11 |
| CTF1 | 0.93 | 0.00 | 0.00 | 0.94 | 0.92 | 0.59 | 0.79 | 1.89 |
| CTF2 | 0.91 | 0.00 | 0.00 | 0.97 | 1.01 | 0.61 | 1.80 | 1.20 |
| CTF3 | 0.82 | 1.64 | 0.42 | 0.97 | 1.36 | 1.37 | 0.93 | 1.13 |
| SF-1 | 5.46 | 2.04 | 3.06 | 2.49 | 2.36 | 2.39 | 3.75 | 0.56 |
| control | 0.94 | 1.20 | 1.13 | 1.28 | 0.63 | 0.83 | 1.77 | 1.02 |
| GR | 0.88 | 0.22 | 0.16 | 0.72 | 0.39 | 0.45 | 0.48 | 0.53 |
| GR ligand | 9.12 | 0.15 | 0.19 | 1.08 | 0.39 | 0.73 | 0.63 | 3.29 |
| hMR | 0.74 | 0.00 | 0.00 | 0.80 | 0.34 | 0.58 | 0.62 | 0.51 |
| hMR ligand | 0.54 | 0.00 | 0.00 | 0.68 | 0.31 | 0.43 | 0.59 | 0.47 |
| PR | 1.27 | 1.20 | 0.75 | 1.25 | 1.35 | 1.47 | 1.00 | 0.84 |
| PR ligand | 9.66 | 1.18 | 0.68 | 1.56 | 1.06 | 3.11 | 0.99 | 1.60 |
| AR | 2.50 | 0.58 | 0.42 | 1.14 | 0.60 | 0.88 | 1.21 | 1.32 |
| AR ligand | 4.95 | 1.07 | 0.50 | 1.25 | 1.22 | 2.10 | 1.10 | 1.62 |
| NR4a1 | 2.07 | 0.71 | 3.57 | 2.31 | 1.29 | 1.40 | 2.07 | 1.36 |
| NR4a2 | 1.01 | 0.55 | 0.49 | 0.88 | 0.74 | 0.79 | 0.77 | 0.57 |
| NR4a3 | 1.19 | 0.48 | 0.63 | 0.95 | 0.65 | 0.93 | 0.71 | 0.57 |
| LRH-1 | 4.24 | 2.57 | 2.03 | 2.24 | 2.73 | 2.45 | 2.22 | 0.47 |
| GCNF | 0.98 | 0.00 | 0.00 | 1.08 | 0.83 | 1.02 | 1.05 | 1.00 |
| DAX-1 | 1.31 | 1.02 | 0.63 | 1.06 | 0.89 | 1.29 | 0.84 | 0.73 |
| SHP | 1.15 | 1.22 | 0.43 | 1.10 | 0.84 | 1.04 | 0.85 | 0.73 |
| control | 1.00 | 1.00 | 1.00 | 1.00 | 1.00 | 1.00 | 1.00 | 1.00 |

TABLE 6c
Results of assays of transcription factor (+/− ligand) with selected
transcription elements as described herein; continued from Table 6b.

| | mDio1 | mDio2 | mBmal1 | mRevErba | hTNFa | hIFNg | mSREBP1-c | mABCA1 |
|---|---|---|---|---|---|---|---|---|
| TRa1 | 1.05 | 0.58 | 0.76 | 1.20 | 0.35 | 0.95 | 0.83 | 1.08 |
| TRa1 ligand | 0.36 | 1.21 | 0.78 | 6.03 | 0.62 | 0.89 | 2.32 | 1.57 |
| TRa2 | 1.24 | 1.16 | 0.75 | 1.28 | 0.77 | 0.85 | 2.96 | 1.71 |
| TRa2 ligand | 1.30 | 1.16 | 0.83 | 0.67 | 0.78 | 0.74 | 2.96 | 1.56 |
| TRb1 | 1.70 | 1.36 | 1.10 | 0.76 | 0.85 | 1.12 | 2.59 | 2.06 |
| TRb1 ligand | 0.64 | 1.38 | 0.66 | 4.55 | 0.81 | 0.99 | 2.38 | 1.97 |
| TRb2 | 1.87 | 1.70 | 1.59 | 1.17 | 1.03 | 1.20 | 3.86 | 2.31 |
| TRb2 ligand | 0.89 | 1.71 | 0.73 | 1.76 | 1.04 | 1.06 | 2.16 | 3.26 |
| RARa | 1.66 | 2.56 | 1.21 | 1.24 | 1.39 | 1.39 | 2.65 | 4.39 |
| RARa ligand | 0.69 | 0.88 | 0.53 | 1.10 | 1.19 | 1.11 | 4.20 | 8.25 |
| RARb | 1.54 | 2.08 | 1.00 | 1.63 | 1.89 | 1.53 | 3.28 | 6.55 |
| RARb ligand | 0.81 | 1.82 | 0.58 | 1.37 | 1.84 | 1.30 | 3.64 | 5.87 |
| RARg | 1.61 | 2.24 | 1.22 | 1.42 | 1.48 | 1.43 | 3.27 | 4.69 |
| RARg ligand | 0.78 | 1.80 | 0.64 | 1.66 | 1.69 | 1.42 | 2.93 | 5.23 |
| PPARa | 1.06 | 1.46 | 0.52 | 1.86 | 1.13 | 0.71 | 2.90 | 1.90 |
| PPARa ligand | 0.75 | 1.97 | 0.39 | 3.07 | 1.28 | 0.81 | 3.51 | 2.01 |
| PPARg | 2.23 | 2.26 | 0.88 | 1.45 | 1.37 | 1.51 | 2.47 | 2.56 |
| PPARg ligand | 2.85 | 6.37 | 0.66 | 3.53 | 3.43 | 2.26 | 6.61 | 3.31 |
| PPARd | 2.23 | 1.21 | 0.72 | 0.90 | 1.16 | 1.24 | 2.04 | 2.46 |
| PPARd ligand | 1.83 | 1.86 | 0.71 | 1.29 | 1.58 | 1.49 | 2.63 | 2.59 |
| LXRa | 1.06 | 1.21 | 1.26 | 1.40 | 1.01 | 1.55 | 18.48 | 16.56 |
| LXRa ligand | 1.68 | 1.67 | 1.11 | 1.68 | 1.62 | 2.86 | 31.04 | 39.44 |
| LXRb | 2.19 | 1.15 | 1.11 | 1.10 | 0.88 | 1.22 | 12.48 | 8.25 |
| LXRb ligand | 1.18 | 1.06 | 0.97 | 1.42 | 0.79 | 0.98 | 9.94 | 10.71 |
| FXR | 1.62 | 1.29 | 1.00 | 1.13 | 0.99 | 1.08 | 1.71 | 2.50 |
| FXR ligand | 1.99 | 2.50 | 1.14 | 1.24 | 1.30 | 1.57 | 3.24 | 2.85 |
| FXRb | 1.93 | 1.93 | 0.92 | 1.11 | 1.18 | 1.22 | 2.08 | 2.54 |
| FXRb ligand | 1.84 | 1.73 | 0.91 | 1.06 | 1.11 | 1.20 | 2.54 | 2.17 |
| VDR | 1.71 | 1.51 | 1.40 | 0.98 | 1.00 | 1.01 | 1.43 | 2.71 |
| VDR ligand | 0.51 | 0.57 | 0.79 | 1.68 | 0.58 | 0.72 | 1.02 | 2.82 |
| PXR | 2.52 | 2.08 | 2.00 | 1.52 | 1.17 | 1.50 | 1.51 | 2.72 |
| PXR ligand | 0.75 | 0.54 | 1.02 | 1.47 | 0.78 | 0.89 | 3.91 | 1.65 |
| CAR | 1.01 | 1.17 | 1.05 | 1.43 | 0.92 | 1.19 | 0.97 | 1.08 |
| CAR ligand | 0.65 | 1.20 | 0.77 | 1.32 | 0.83 | 1.08 | 1.44 | 1.57 |
| control | 1.36 | 1.55 | 0.94 | 1.00 | 1.14 | 1.19 | 1.36 | 1.71 |
| RXRa | 1.24 | 1.18 | 0.75 | 0.94 | 0.97 | 0.82 | 1.62 | 1.56 |
| RXRa ligand | 1.10 | 1.33 | 0.65 | 1.19 | 1.27 | 1.38 | 5.21 | 2.06 |
| RXRb | 0.99 | 1.45 | 0.80 | 0.62 | 1.05 | 1.26 | 1.69 | 1.97 |
| RXRb ligand | 0.98 | 1.47 | 0.69 | 0.80 | 1.00 | 1.30 | 3.63 | 2.31 |
| RXRg | 1.48 | 1.77 | 0.81 | 0.88 | 1.04 | 0.96 | 3.10 | 3.26 |
| RXRg ligand | 1.44 | 1.62 | 0.88 | 1.14 | 1.30 | 1.68 | 5.34 | 4.39 |
| RVRa | 1.27 | 1.37 | 0.16 | 0.35 | 1.09 | 1.13 | 1.78 | 8.25 |
| RVRb | 1.97 | 1.26 | 0.05 | 0.07 | 1.04 | 1.22 | 2.24 | 6.55 |
| RORa | 0.47 | 3.01 | 7.40 | 3.11 | 0.62 | 0.55 | 1.28 | 5.87 |
| RORb | 1.44 | 1.47 | 1.06 | 1.07 | 1.05 | 1.40 | 1.37 | 4.69 |
| RORg | 1.29 | 3.74 | 3.77 | 2.42 | 1.17 | 1.12 | 2.00 | 5.23 |
| HNF4a | 2.25 | 2.14 | 0.65 | 1.08 | 0.87 | 0.55 | 0.82 | 1.90 |
| HNF4g | 3.49 | 1.14 | 0.73 | 1.01 | 0.87 | 0.83 | 0.92 | 2.01 |
| TR2 | 3.32 | 2.15 | 0.69 | 1.87 | 1.06 | 0.85 | 0.32 | 5.55 |
| TR4 | 12.55 | 3.31 | 1.44 | 0.95 | 1.21 | 2.67 | 1.48 | 6.49 |
| TLX | 1.88 | 0.60 | 0.78 | 0.48 | 1.10 | 1.76 | 1.09 | 3.88 |
| PNR | 1.44 | 0.89 | 0.49 | 0.25 | 0.57 | 0.71 | 0.82 | 1.76 |
| Era | 2.26 | 1.90 | 1.00 | 0.74 | 0.83 | 2.37 | 1.46 | 3.39 |
| Era ligand | 1.77 | 2.94 | 1.90 | 1.14 | 1.23 | 5.53 | 1.65 | 3.71 |
| Erb | 2.09 | 1.27 | 1.09 | 0.72 | 0.83 | 1.39 | 0.77 | 2.21 |
| Erb ligand | 1.85 | 1.04 | 1.06 | 0.67 | 0.68 | 1.28 | 0.82 | 1.41 |
| ERR1 | 1.39 | 2.20 | 0.87 | 1.19 | 1.26 | 1.17 | 0.98 | 1.47 |
| ERR2 | 3.05 | 2.52 | 0.68 | 1.51 | 1.68 | 3.70 | 1.08 | 5.88 |
| ERR3 | 1.32 | 5.45 | 0.61 | 4.40 | 2.75 | 1.75 | 1.26 | 2.04 |
| CTF1 | 3.89 | 1.00 | 1.67 | 0.66 | 0.74 | 2.00 | 0.64 | 0.99 |
| CTF2 | 4.69 | 1.20 | 1.89 | 0.97 | 1.03 | 2.20 | 1.41 | 0.84 |
| CTF3 | 2.23 | 0.97 | 1.35 | 0.68 | 0.95 | 1.79 | 0.71 | 1.01 |
| SF-1 | 4.45 | 4.02 | 0.73 | 4.47 | 1.93 | 2.91 | 2.84 | 6.12 |
| control | 1.16 | 1.29 | 1.12 | 0.98 | 1.08 | 0.93 | 1.45 | 1.15 |
| GR | 0.55 | 0.84 | 0.84 | 0.44 | 0.47 | 0.56 | 0.47 | 1.52 |
| GR ligand | 0.47 | 4.11 | 2.12 | 1.00 | 1.02 | 6.67 | 0.27 | 1.50 |
| hMR | 0.55 | 0.81 | 1.17 | 0.49 | 0.62 | 0.65 | 0.69 | 1.21 |
| hMR ligand | 0.41 | 0.50 | 1.00 | 0.44 | 0.59 | 0.53 | 0.61 | 0.99 |
| PR | 1.75 | 1.36 | 1.14 | 0.86 | 1.24 | 1.42 | 1.45 | 1.58 |
| PR ligand | 1.01 | 1.41 | 1.51 | 1.23 | 0.97 | 9.34 | 1.85 | 1.62 |
| AR | 1.43 | 1.26 | 0.86 | 0.48 | 1.04 | 1.97 | 1.30 | 1.48 |
| AR ligand | 1.76 | 1.41 | 1.44 | 0.36 | 0.92 | 2.47 | 0.98 | 1.73 |
| NR4a1 | 2.45 | 1.39 | 1.00 | 0.88 | 1.60 | 2.24 | 1.27 | 2.04 |
| NR4a2 | 1.41 | 0.79 | 0.52 | 0.74 | 0.75 | 1.53 | 1.42 | 1.11 |
| NR4a3 | 1.48 | 0.94 | 0.48 | 0.53 | 0.70 | 1.03 | 1.11 | 1.21 |
| LRH-1 | 3.31 | 3.85 | 0.56 | 2.39 | 2.10 | 2.95 | 2.58 | 3.32 |
| GCNF | 1.13 | 1.44 | 0.88 | 0.92 | 1.22 | 1.15 | 1.14 | 1.36 |
| DAX-1 | 2.00 | 1.19 | 1.25 | 1.05 | 0.87 | 1.55 | 1.55 | 1.04 |
| SHP | 1.07 | 1.17 | 0.89 | 0.81 | 0.93 | 1.01 | 1.09 | 1.21 |
| control | 1.00 | 1.00 | 1.00 | 1.00 | 1.00 | 1.00 | 1.00 | 1.00 |

TABLE 6d
Results of assays of transcription factor (+/− ligand) with selected
transcription elements as described herein; continued from Table 6c.

| | hPPARg1 | hPPARg2 | mPOMC | mNPY | mAgrp | mGhrelin | mLeptin |
|---|---|---|---|---|---|---|---|
| TRa1 | 0.29 | 0.50 | 0.56 | 0.59 | 0.39 | 0.98 | 0.58 |
| TRa1 ligand | 0.26 | 0.55 | 0.54 | 0.50 | 0.70 | 0.93 | 0.51 |
| TRa2 | 0.74 | 0.74 | 0.92 | 0.81 | 1.02 | 0.81 | 0.51 |
| TRa2 ligand | 0.64 | 0.68 | 0.89 | 0.75 | 0.98 | 0.76 | 0.45 |
| TRb1 | 0.60 | 1.07 | 1.15 | 1.20 | 0.66 | 2.21 | 0.89 |
| TRb1 ligand | 0.56 | 0.78 | 0.86 | 0.88 | 1.27 | 1.07 | 0.60 |
| TRb2 | 1.10 | 0.88 | 1.12 | 1.12 | 1.15 | 1.44 | 0.56 |
| TRb2 ligand | 0.91 | 0.92 | 1.24 | 0.92 | 1.67 | 1.20 | 0.58 |
| RARa | 1.26 | 1.73 | 1.43 | 1.24 | 2.05 | 1.29 | 0.82 |
| RARa ligand | 1.08 | 1.88 | 1.63 | 0.99 | 2.14 | 0.70 | 0.75 |
| RARb | 1.46 | 1.72 | 1.85 | 1.17 | 2.27 | 1.61 | 0.91 |
| RARb ligand | 1.27 | 1.92 | 1.78 | 1.07 | 2.05 | 1.01 | 0.88 |
| RARg | 1.16 | 1.51 | 1.53 | 1.20 | 2.06 | 1.70 | 1.21 |
| RARg ligand | 1.08 | 1.90 | 1.30 | 1.01 | 2.25 | 1.09 | 0.98 |
| PPARa | 0.84 | 1.20 | 1.13 | 0.62 | 1.06 | 1.07 | 0.81 |
| PPARa ligand | 0.86 | 0.58 | 1.16 | 0.61 | 1.17 | 1.16 | 1.11 |
| PPARg | 1.10 | 1.08 | 1.57 | 1.14 | 1.84 | 1.80 | 1.00 |
| PPARg ligand | 1.42 | 1.78 | 2.05 | 1.20 | 2.69 | 3.39 | 2.35 |
| PPARd | 0.67 | 1.24 | 1.02 | 0.70 | 1.32 | 1.07 | 0.89 |
| PPARd ligand | 0.74 | 1.04 | 1.21 | 0.70 | 1.55 | 1.31 | 0.97 |
| LXRa | 1.17 | 0.64 | 1.70 | 0.67 | 1.58 | 1.08 | 0.65 |
| LXRa ligand | 2.11 | 0.87 | 3.26 | 0.91 | 2.32 | 2.07 | 0.75 |
| LXRb | 0.55 | 1.19 | 0.88 | 0.81 | 0.78 | 0.89 | 0.81 |
| LXRb ligand | 0.64 | 1.02 | 1.03 | 0.99 | 0.75 | 1.08 | 0.60 |
| FXR | 0.80 | 0.89 | 1.20 | 0.92 | 1.14 | 1.26 | 0.95 |
| FXR ligand | 1.02 | 1.13 | 1.39 | 1.16 | 1.58 | 1.66 | 1.13 |
| FXRb | 1.07 | 1.22 | 1.34 | 0.94 | 1.46 | 1.29 | 0.88 |
| FXRb ligand | 0.98 | 0.88 | 1.25 | 0.95 | 1.42 | 1.37 | 0.88 |
| VDR | 0.55 | 1.03 | 1.16 | 0.79 | 1.14 | 1.47 | 0.90 |
| VDR ligand | 0.76 | 0.94 | 0.72 | 0.72 | 1.09 | 0.53 | 0.77 |
| PXR | 0.92 | 0.91 | 1.30 | 0.83 | 1.51 | 2.61 | 1.40 |
| PXR ligand | 0.90 | 0.72 | 0.78 | 0.76 | 1.09 | 1.04 | 1.01 |
| CAR | 0.67 | 0.63 | 0.92 | 0.88 | 1.06 | 1.00 | 0.93 |
| CAR ligand | 0.69 | 0.59 | 0.93 | 0.79 | 1.22 | 0.74 | 0.88 |
| control | 0.81 | 0.92 | 1.08 | 1.03 | 1.07 | 1.35 | 1.05 |
| RXRa | 0.66 | 0.67 | 0.99 | 0.95 | 1.17 | 1.10 | 0.77 |
| RXRa ligand | 1.05 | 1.94 | 1.54 | 1.10 | 1.46 | 0.94 | 1.22 |
| RXRb | 0.34 | 0.75 | 1.19 | 0.80 | 1.30 | 1.20 | 0.50 |
| RXRb ligand | 0.55 | 0.81 | 0.90 | 0.76 | 1.39 | 0.89 | 0.49 |
| RXRg | 0.63 | 0.74 | 1.06 | 0.97 | 1.30 | 1.13 | 0.70 |
| RXRg ligand | 0.91 | 1.67 | 1.28 | 1.08 | 1.42 | 1.06 | 1.08 |
| RVRa | 0.67 | 0.76 | 1.13 | 1.09 | 1.21 | 1.52 | 0.86 |
| RVRb | 0.81 | 0.48 | 0.85 | 1.67 | 1.05 | 2.43 | 1.50 |
| RORa | 1.07 | 4.19 | 2.08 | 0.90 | 1.65 | 0.89 | 0.71 |
| RORb | 0.74 | 0.89 | 1.29 | 1.12 | 1.37 | 1.70 | 1.12 |
| RORg | 1.18 | 9.59 | 1.30 | 0.91 | 2.51 | 2.09 | 0.87 |
| HNF4a | 0.51 | 1.02 | 0.90 | 0.52 | 0.91 | 0.82 | 0.84 |
| HNF4g | 0.61 | 0.76 | 1.07 | 0.96 | 0.77 | 1.11 | 0.82 |
| TR2 | 0.66 | 0.95 | 1.92 | 1.27 | 0.98 | 1.21 | 1.15 |
| TR4 | 0.96 | 1.65 | 3.75 | 2.86 | 2.06 | 5.23 | 2.56 |
| TLX | 1.57 | 0.43 | 0.74 | 1.11 | 0.82 | 1.66 | 0.89 |
| PNR | 0.67 | 0.51 | 0.81 | 2.00 | 0.76 | 0.62 | 0.68 |
| Era | 0.93 | 1.00 | 1.47 | 1.07 | 1.88 | 1.80 | 1.43 |
| Era ligand | 1.14 | 1.78 | 1.65 | 1.15 | 2.85 | 4.52 | 1.54 |
| Erb | 0.66 | 1.13 | 1.00 | 0.79 | 0.98 | 0.91 | 0.86 |
| Erb ligand | 0.64 | 0.65 | 0.90 | 0.76 | 0.91 | 0.74 | 1.03 |
| ERR1 | 0.86 | 0.84 | 1.00 | 0.83 | 1.15 | 1.56 | 0.88 |
| ERR2 | 0.86 | 1.59 | 1.57 | 1.02 | 1.64 | 7.00 | 3.30 |
| ERR3 | 0.92 | 1.04 | 2.02 | 1.11 | 2.12 | 2.79 | 0.80 |
| CTF1 | 0.58 | 0.71 | 0.73 | 0.47 | 0.71 | 2.18 | 1.07 |
| CTF2 | 0.64 | 0.76 | 0.94 | 0.65 | 1.08 | 3.32 | 1.31 |
| CTF3 | 0.47 | 0.85 | 0.75 | 0.48 | 0.86 | 1.31 | 0.92 |
| SF-1 | 1.80 | 1.09 | 8.37 | 2.12 | 3.58 | 5.23 | 1.60 |
| control | 0.76 | 0.91 | 0.94 | 0.93 | 1.13 | 1.09 | 0.87 |
| GR | 0.54 | 1.15 | 0.50 | 0.57 | 0.55 | 0.27 | 0.58 |
| GR ligand | 0.70 | 8.23 | 1.21 | 0.69 | 0.87 | 0.37 | 2.06 |
| hMR | 0.82 | 0.51 | 0.73 | 0.58 | 0.79 | 0.95 | 0.57 |
| hMR ligand | 0.60 | 0.43 | 0.57 | 0.48 | 0.65 | 0.71 | 0.62 |
| PR | 1.18 | 0.88 | 1.10 | 1.09 | 1.13 | 1.03 | 0.76 |
| PR ligand | 1.46 | 19.10 | 1.76 | 1.92 | 1.32 | 1.05 | 3.35 |
| AR | 1.31 | 1.34 | 1.05 | 1.12 | 1.15 | 0.75 | 0.84 |
| AR ligand | 0.95 | 2.59 | 1.12 | 1.19 | 0.92 | 0.63 | 1.56 |
| NR4a1 | 1.88 | 0.81 | 3.58 | 0.92 | 1.17 | 1.04 | 0.80 |
| NR4a2 | 0.85 | 0.68 | 1.05 | 0.72 | 0.88 | 0.60 | 0.71 |
| NR4a3 | 0.88 | 0.57 | 0.87 | 0.72 | 0.88 | 0.56 | 0.62 |
| LRH-1 | 2.01 | 1.38 | 5.85 | 2.28 | 3.07 | 2.23 | 1.43 |
| GCNF | 1.29 | 0.69 | 0.61 | 0.64 | 1.42 | 0.97 | 0.50 |
| DAX-1 | 0.98 | 0.94 | 0.92 | 1.02 | 1.07 | 1.21 | 0.87 |
| SHP | 0.99 | 0.93 | 0.95 | 0.81 | 1.12 | 1.08 | 0.91 |
| control | 1.00 | 1.00 | 1.00 | 1.00 | 1.00 | 1.00 | 1.00 |

TABLE 6e
Selected results of assays from Tables 6a-6d of hPOMC.

| | | |
|---|---|---|
| PPARg | 0.6 | 0.0 |
| PPARg ligand | 0.7 | 0.1 |
| TR4 | 11.8 | 0.1 |
| ERR3 | 4.1 | 0.2 |
| Era | 1.4 | 0.1 |
| Era ligand | 2.2 | 0.3 |
| GR | 0.2 | 0.0 |
| GR ligand | 0.2 | 0.0 |
| NR4a1 | 3.6 | 1.1 |
| control | 1.0 | 0.1 |

TABLE 6f
Selected results of assays from Tables 6a-6d of mGhrelin.

| | | |
|---|---|---|
| PPARg | 1.8 | 0.2 |
| PPARg ligand | 3.4 | 0.2 |
| TR4 | 5.2 | 0.2 |
| Era | 1.8 | 0.1 |
| Era ligand | 4.5 | 0.2 |
| ERR2 | 7.0 | 0.4 |
| GR | 0.3 | 0.0 |
| GR ligand | 0.4 | 0.0 |
| NR4a1 | 1.0 | 0.1 |
| control | 1.0 | 0.0 |

TABLE 6g
Selected results of assays from Tables 6a-6d of mLeptin.

| | | |
|---|---|---|
| PPARg | 1.0 | 0.1 |
| PPARg+ | 2.4 | 0.6 |
| TR4 | 2.6 | 0.7 |
| Era | 1.4 | 0.1 |
| Era ligand | 1.5 | 0.2 |
| ERR2 | 3.3 | 0.7 |
| GR | 0.6 | 0.0 |
| GR ligand | 2.1 | 0.5 |
| NR4a1 | 0.8 | 0.1 |
| control | 1.0 | 0.0 |

TABLE 6h
Selected results of assays from Tables 6a-6d of mAgrp.

| | | |
|---|---|---|
| PPARg | 1.8 | 0.7 |
| PPARg ligand | 2.7 | 0.6 |
| TR4 | 2.1 | 0.2 |
| Era | 1.9 | 0.1 |
| Era ligand | 2.8 | 0.6 |
| ERR2 | 1.6 | 0.2 |
| GR | 0.6 | 0.0 |
| GR ligand | 0.9 | 0.2 |
| NR4a1 | 1.2 | 0.1 |
| control | 1.0 | 0.0 |

TABLE 6i
Selected results of assays from Tables 6a-6d of mNPY.

| | | |
|---|---|---|
| PPARg | 1.1 | 0.2 |
| PPARg+ | 1.2 | 0.0 |
| TR4 | 2.9 | 0.0 |
| Era | 1.1 | 0.0 |
| Era ligand | 1.2 | 0.1 |
| ERR2 | 1.0 | 0.0 |
| GR | 0.6 | 0.0 |
| GR ligand | 0.7 | 0.1 |
| NR4a1 | 0.9 | 0.2 |
| control | 1.0 | 0.0 |

TABLE 7
Results for assay for listed components for mLeptin.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 1.7 | 0.3 | TRa1 | 0.6 | 0.12 |
| TRa1 ligand | 1.5 | 0.5 | TRa1 ligand | 0.5 | 0.17 |
| TRa2 | 1.5 | 0.1 | TRa2 | 0.5 | 0.03 |
| TRa2 ligand | 1.3 | 0.1 | TRa2 ligand | 0.4 | 0.04 |
| TRb1 | 2.6 | 0.7 | TRb1 | 0.9 | 0.24 |
| TRb1 ligand | 1.8 | 0.6 | TRb1 ligand | 0.6 | 0.21 |
| TRb2 | 1.6 | 0.1 | TRb2 | 0.6 | 0.05 |
| TRb2 ligand | 1.7 | 0.1 | TRb2 ligand | 0.6 | 0.02 |
| RARa | 2.4 | 0.6 | RARa | 0.8 | 0.20 |
| RARa ligand | 2.2 | 0.4 | RARa ligand | 0.7 | 0.15 |
| RARb | 2.7 | 0.4 | RARb | 0.9 | 0.14 |
| RARb ligand | 2.6 | 0.9 | RARb ligand | 0.9 | 0.31 |
| RARg | 3.6 | 0.3 | RARg | 1.2 | 0.11 |
| RARg ligand | 2.9 | 0.9 | RARg ligand | 1.0 | 0.30 |
| PPARa | 2.4 | 0.1 | PPARa | 0.8 | 0.04 |
| PPARa ligand | 3.3 | 0.3 | PPARa ligand | 1.1 | 0.11 |
| PPARg | 2.9 | 0.3 | PPARg | 1.0 | 0.10 |
| PPARg ligand | 6.9 | 1.7 | PPARg ligand | 2.4 | 0.57 |
| PPARd | 2.6 | 0.3 | PPARd | 0.9 | 0.10 |
| PPARd ligand | 2.8 | 0.5 | PPARd ligand | 1.0 | 0.17 |
| LXRa | 1.9 | 0.3 | LXRa | 0.7 | 0.09 |
| LXRa ligand | 2.2 | 0.4 | LXRa ligand | 0.8 | 0.15 |
| LXRb | 2.4 | 0.5 | LXRb | 0.8 | 0.18 |
| LXRb ligand | 1.7 | 0.0 | LXRb ligand | 0.6 | 0.01 |
| FXR | 2.8 | 0.4 | FXR | 0.9 | 0.15 |
| FXR ligand | 3.3 | 0.6 | FXR ligand | 1.1 | 0.22 |
| FXRb | 2.6 | 0.4 | FXRb | 0.9 | 0.14 |
| FXRb ligand | 2.6 | 0.3 | FXRb ligand | 0.9 | 0.11 |
| VDR | 2.6 | 0.3 | VDR | 0.9 | 0.09 |
| VDR ligand | 2.2 | 0.2 | VDR ligand | 0.8 | 0.07 |
| PXR | 4.1 | 0.4 | PXR | 1.4 | 0.15 |
| PXR ligand | 3.0 | 0.1 | PXR ligand | 1.0 | 0.04 |
| CAR | 2.7 | 0.3 | CAR | 0.9 | 0.11 |
| CAR ligand | 2.6 | 0.4 | CAR ligand | 0.9 | 0.13 |
| control | 3.1 | 0.3 | control | 1.0 | 0.12 |
| RXRa | 2.3 | 0.2 | RXRa | 0.8 | 0.05 |
| RXRa ligand | 3.6 | 0.9 | RXRa ligand | 1.2 | 0.30 |
| RXRb | 1.5 | 0.4 | RXRb | 0.5 | 0.12 |
| RXRb ligand | 1.4 | 0.0 | RXRb ligand | 0.5 | 0.01 |
| RXRg | 2.1 | 0.3 | RXRg | 0.7 | 0.10 |
| RXRg ligand | 3.2 | 0.4 | RXRg ligand | 1.1 | 0.13 |
| RVRa | 2.5 | 0.4 | RVRa | 0.9 | 0.13 |
| RVRb | 4.4 | 0.3 | RVRb | 1.5 | 0.11 |
| RORa | 2.1 | 0.3 | RORa | 0.7 | 0.10 |
| RORb | 3.3 | 0.3 | RORb | 1.1 | 0.11 |
| RORg | 2.6 | 0.6 | RORg | 0.9 | 0.22 |
| HNF4a | 2.5 | 0.3 | HNF4a | 0.8 | 0.11 |
| HNF4g | 2.4 | 0.4 | HNF4g | 0.8 | 0.13 |
| TR2 | 3.4 | 0.6 | TR2 | 1.1 | 0.22 |
| TR4 | 7.5 | 2.1 | TR4 | 2.6 | 0.70 |
| TLX | 2.6 | 0.2 | TLX | 0.9 | 0.07 |
| PNR | 2.0 | 0.1 | PNR | 0.7 | 0.03 |
| Era | 4.2 | 0.2 | Era | 1.4 | 0.08 |
| Era ligand | 4.5 | 0.5 | Era ligand | 1.5 | 0.18 |
| Erb | 2.5 | 0.7 | Erb | 0.9 | 0.24 |
| Erb ligand | 3.0 | 0.4 | Erb ligand | 1.0 | 0.13 |
| ERR1 | 2.6 | 0.2 | ERR1 | 0.9 | 0.08 |
| ERR2 | 9.7 | 2.0 | ERR2 | 3.3 | 0.68 |
| ERR3 | 2.4 | 0.6 | ERR3 | 0.8 | 0.20 |
| CTF1 | 3.1 | 0.5 | CTF1 | 1.1 | 0.16 |
| CTF2 | 3.8 | 0.7 | CTF2 | 1.3 | 0.25 |
| CTF3 | 2.7 | 0.4 | CTF3 | 0.9 | 0.15 |
| SF-1 | 4.7 | 1.1 | SF-1 | 1.6 | 0.36 |
| control | 2.5 | 0.3 | control | 0.9 | 0.11 |
| GR | 1.7 | 0.1 | GR | 0.6 | 0.02 |
| GR ligand | 6.0 | 1.4 | GR ligand | 2.1 | 0.49 |
| hMR | 1.7 | 0.2 | hMR | 0.6 | 0.08 |
| hMR ligand | 1.8 | 0.4 | hMR ligand | 0.6 | 0.14 |
| PR | 2.2 | 0.1 | PR | 0.8 | 0.04 |
| PR ligand | 9.8 | 1.5 | PR ligand | 3.3 | 0.52 |
| AR | 2.5 | 0.1 | AR | 0.8 | 0.05 |
| AR ligand | 4.6 | 0.8 | AR ligand | 1.6 | 0.27 |
| NR4a1 | 2.3 | 0.2 | NR4a1 | 0.8 | 0.06 |
| NR4a2 | 2.1 | 0.2 | NR4a2 | 0.7 | 0.07 |
| NR4a3 | 1.8 | 0.3 | NR4a3 | 0.6 | 0.09 |
| LRH-1 | 4.2 | 0.6 | LRH-1 | 1.4 | 0.19 |
| GCNF | 1.5 | 0.0 | GCNF | 0.5 | 0.02 |
| DAX-1 | 2.5 | 0.2 | DAX-1 | 0.9 | 0.06 |
| SHP | 2.7 | 0.2 | SHP | 0.9 | 0.07 |
| control | 2.9 | 0.0 | control | 1.0 | 0.01 |

TABLE 8
Results for assay for listed components for mGhrelin.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 51.2 | 0.1 | TRa1 | 1.0 | 0.00 |
| TRa1 ligand | 48.6 | 4.4 | TRa1 ligand | 0.9 | 0.08 |
| TRa2 | 42.5 | 4.5 | TRa2 | 0.8 | 0.09 |
| TRa2 ligand | 39.7 | 5.6 | TRa2 ligand | 0.8 | 0.11 |
| TRb1 | 115.6 | 5.0 | TRb1 | 2.2 | 0.10 |
| TRb1 ligand | 56.0 | 4.7 | TRb1 ligand | 1.1 | 0.09 |
| TRb2 | 75.1 | 5.7 | TRb2 | 1.4 | 0.11 |
| TRb2 ligand | 62.5 | 7.1 | TRb2 ligand | 1.2 | 0.14 |
| RARa | 67.2 | 3.0 | RARa | 1.3 | 0.06 |
| RARa ligand | 36.7 | 5.8 | RARa ligand | 0.7 | 0.11 |
| RARb | 84.4 | 9.0 | RARb | 1.6 | 0.17 |
| RARb ligand | 52.7 | 6.4 | RARb ligand | 1.0 | 0.12 |
| RARg | 88.8 | 6.3 | RARg | 1.7 | 0.12 |
| RARg ligand | 56.9 | 6.7 | RARg ligand | 1.1 | 0.13 |
| PPARa | 56.2 | 6.6 | PPARa | 1.1 | 0.13 |
| PPARa ligand | 60.6 | 1.5 | PPARa ligand | 1.2 | 0.03 |
| PPARg | 93.9 | 11.4 | PPARg | 1.8 | 0.22 |
| PPARg ligand | 177.2 | 10.8 | PPARg ligand | 3.4 | 0.21 |
| PPARd | 56.1 | 6.1 | PPARd | 1.1 | 0.12 |
| PPARd ligand | 68.3 | 4.1 | PPARd ligand | 1.3 | 0.08 |
| LXRa | 56.7 | 5.2 | LXRa | 1.1 | 0.10 |
| LXRa ligand | 108.3 | 8.9 | LXRa ligand | 2.1 | 0.17 |
| LXRb | 46.7 | 5.0 | LXRb | 0.9 | 0.10 |
| LXRb ligand | 56.7 | 1.7 | LXRb ligand | 1.1 | 0.03 |
| FXR | 65.7 | 5.6 | FXR | 1.3 | 0.11 |
| FXR ligand | 86.5 | 5.2 | FXR ligand | 1.7 | 0.10 |
| FXRb | 67.4 | 9.5 | FXRb | 1.3 | 0.18 |
| FXRb ligand | 71.8 | 10.5 | FXRb ligand | 1.4 | 0.20 |
| VDR | 76.6 | 8.8 | VDR | 1.5 | 0.17 |
| VDR ligand | 27.6 | 3.2 | VDR ligand | 0.5 | 0.06 |
| PXR | 136.2 | 13.0 | PXR | 2.6 | 0.25 |
| PXR ligand | 54.2 | 3.1 | PXR ligand | 1.0 | 0.06 |
| CAR | 52.2 | 4.7 | CAR | 1.0 | 0.09 |
| CAR ligand | 38.9 | 2.7 | CAR ligand | 0.7 | 0.05 |
| control | 70.4 | 5.4 | control | 1.3 | 0.10 |
| RXRa | 57.4 | 5.7 | RXRa | 1.1 | 0.11 |
| RXRa ligand | 49.0 | 5.1 | RXRa ligand | 0.9 | 0.10 |
| RXRb | 62.9 | 11.6 | RXRb | 1.2 | 0.22 |
| RXRb ligand | 46.6 | 4.2 | RXRb ligand | 0.9 | 0.08 |
| RXRg | 59.0 | 3.1 | RXRg | 1.1 | 0.06 |
| RXRg ligand | 55.2 | 4.9 | RXRg ligand | 1.1 | 0.09 |
| RVRa | 79.3 | 9.4 | RVRa | 1.5 | 0.18 |
| RVRb | 126.8 | 23.7 | RVRb | 2.4 | 0.45 |
| RORa | 46.6 | 3.6 | RORa | 0.9 | 0.07 |
| RORb | 89.1 | 4.4 | RORb | 1.7 | 0.08 |
| RORg | 109.2 | 16.6 | RORg | 2.1 | 0.32 |
| HNF4a | 42.6 | 3.4 | HNF4a | 0.8 | 0.06 |
| HNF4g | 58.1 | 4.5 | HNF4g | 1.1 | 0.09 |
| TR2 | 63.2 | 5.7 | TR2 | 1.2 | 0.11 |
| TR4 | 273.5 | 8.9 | TR4 | 5.2 | 0.17 |
| TLX | 86.6 | 2.2 | TLX | 1.7 | 0.04 |
| PNR | 32.4 | 6.8 | PNR | 0.6 | 0.13 |
| Era | 93.8 | 7.1 | Era | 1.8 | 0.13 |
| Era ligand | 236.3 | 8.5 | Era ligand | 4.5 | 0.16 |
| Erb | 47.5 | 6.5 | Erb | 0.9 | 0.13 |
| Erb ligand | 38.5 | 2.5 | Erb ligand | 0.7 | 0.05 |
| ERR1 | 81.4 | 4.6 | ERR1 | 1.6 | 0.09 |
| ERR2 | 365.8 | 20.0 | ERR2 | 7.0 | 0.38 |
| ERR3 | 145.9 | 23.2 | ERR3 | 2.8 | 0.44 |
| CTF1 | 113.8 | 7.9 | CTF1 | 2.2 | 0.15 |
| CTF2 | 173.3 | 13.9 | CTF2 | 3.3 | 0.27 |
| CTF3 | 68.4 | 3.4 | CTF3 | 1.3 | 0.07 |
| SF-1 | 273.2 | 7.9 | SF-1 | 5.2 | 0.15 |
| control | 57.1 | 5.6 | control | 1.1 | 0.11 |
| GR | 14.3 | 1.5 | GR | 0.3 | 0.03 |
| GR ligand | 19.2 | 2.5 | GR ligand | 0.4 | 0.05 |
| hMR | 49.7 | 3.8 | hMR | 1.0 | 0.07 |
| hMR ligand | 37.0 | 2.0 | hMR ligand | 0.7 | 0.04 |
| PR | 53.6 | 1.2 | PR | 1.0 | 0.02 |
| PR ligand | 55.1 | 3.6 | PR ligand | 1.1 | 0.07 |
| AR | 39.2 | 3.4 | AR | 0.8 | 0.07 |
| AR ligand | 33.1 | 0.9 | AR ligand | 0.6 | 0.02 |
| NR4a1 | 54.5 | 2.6 | NR4a1 | 1.0 | 0.05 |
| NR4a2 | 31.5 | 1.3 | NR4a2 | 0.6 | 0.02 |
| NR4a3 | 29.4 | 1.5 | NR4a3 | 0.6 | 0.03 |
| LRH-1 | 116.6 | 7.8 | LRH-1 | 2.2 | 0.15 |
| GCNF | 50.7 | 3.8 | GCNF | 1.0 | 0.07 |
| DAX-1 | 63.3 | 4.1 | DAX-1 | 1.2 | 0.08 |
| SHP | 56.5 | 6.9 | SHP | 1.1 | 0.13 |
| control | 52.3 | 0.5 | control | 1.0 | 0.01 |

TABLE 9
Results for assay for listed components for mAgrp.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 15.4 | 1.2 | TRa1 | 0.4 | 0.03 |
| TRa1 ligand | 27.8 | 1.9 | TRa1 ligand | 0.7 | 0.05 |
| TRa2 | 40.3 | 2.4 | TRa2 | 1.0 | 0.06 |
| TRa2 ligand | 39.0 | 2.9 | TRa2 ligand | 1.0 | 0.07 |
| TRb1 | 26.1 | 3.6 | TRb1 | 0.7 | 0.09 |
| TRb1 ligand | 50.4 | 6.9 | TRb1 ligand | 1.3 | 0.17 |
| TRb2 | 45.6 | 1.4 | TRb2 | 1.1 | 0.03 |
| TRb2 ligand | 66.3 | 1.8 | TRb2 ligand | 1.7 | 0.05 |
| RARa | 81.1 | 14.6 | RARa | 2.0 | 0.37 |
| RARa ligand | 84.9 | 17.5 | RARa ligand | 2.1 | 0.44 |
| RARb | 90.2 | 8.5 | RARb | 2.3 | 0.21 |
| RARb ligand | 81.3 | 5.0 | RARb ligand | 2.0 | 0.13 |
| RARg | 81.9 | 27.1 | RARg | 2.1 | 0.68 |
| RARg ligand | 89.4 | 20.7 | RARg ligand | 2.3 | 0.52 |
| PPARa | 42.1 | 4.1 | PPARa | 1.1 | 0.10 |
| PPARa ligand | 46.5 | 2.7 | PPARa ligand | 1.2 | 0.07 |
| PPARg | 73.0 | 27.2 | PPARg | 1.8 | 0.69 |
| PPARg ligand | 106.5 | 24.7 | PPARg ligand | 2.7 | 0.62 |
| PPARd | 52.4 | 1.2 | PPARd | 1.3 | 0.03 |
| PPARd ligand | 61.6 | 2.3 | PPARd ligand | 1.6 | 0.06 |
| LXRa | 62.5 | 1.3 | LXRa | 1.6 | 0.03 |
| LXRa ligand | 92.1 | 3.6 | LXRa ligand | 2.3 | 0.09 |
| LXRb | 31.0 | 0.8 | LXRb | 0.8 | 0.02 |
| LXRb ligand | 29.7 | 1.4 | LXRb ligand | 0.7 | 0.03 |
| FXR | 45.1 | 5.1 | FXR | 1.1 | 0.13 |
| FXR ligand | 62.5 | 5.6 | FXR ligand | 1.6 | 0.14 |
| FXRb | 58.1 | 5.2 | FXRb | 1.5 | 0.13 |
| FXRb ligand | 56.4 | 2.2 | FXRb ligand | 1.4 | 0.05 |
| VDR | 45.3 | 0.4 | VDR | 1.1 | 0.01 |
| VDR ligand | 43.3 | 7.1 | VDR ligand | 1.1 | 0.18 |
| PXR | 60.0 | 0.3 | PXR | 1.5 | 0.01 |
| PXR ligand | 43.2 | 3.5 | PXR ligand | 1.1 | 0.09 |
| CAR | 42.2 | 2.8 | CAR | 1.1 | 0.07 |
| CAR ligand | 48.2 | 0.5 | CAR ligand | 1.2 | 0.01 |
| control | 42.5 | 1.5 | control | 1.1 | 0.04 |
| RXRa | 46.4 | 3.2 | RXRa | 1.2 | 0.08 |
| RXRa ligand | 57.8 | 3.2 | RXRa ligand | 1.5 | 0.08 |
| RXRb | 51.6 | 2.4 | RXRb | 1.3 | 0.06 |
| RXRb ligand | 55.1 | 9.0 | RXRb ligand | 1.4 | 0.23 |
| RXRg | 51.5 | 3.8 | RXRg | 1.3 | 0.10 |
| RXRg ligand | 56.5 | 5.3 | RXRg ligand | 1.4 | 0.13 |
| RVRa | 47.9 | 8.6 | RVRa | 1.2 | 0.22 |
| RVRb | 41.7 | 6.9 | RVRb | 1.1 | 0.17 |
| RORa | 65.6 | 2.1 | RORa | 1.7 | 0.05 |
| RORb | 54.3 | 3.2 | RORb | 1.4 | 0.08 |
| RORg | 99.6 | 30.7 | RORg | 2.5 | 0.77 |
| HNF4a | 36.1 | 1.9 | HNF4a | 0.9 | 0.05 |
| HNF4g | 30.4 | 2.6 | HNF4g | 0.8 | 0.07 |
| TR2 | 39.0 | 2.4 | TR2 | 1.0 | 0.06 |
| TR4 | 81.8 | 9.8 | TR4 | 2.1 | 0.25 |
| TLX | 32.4 | 7.5 | TLX | 0.8 | 0.19 |
| PNR | 30.1 | 7.9 | PNR | 0.8 | 0.20 |
| Era | 74.4 | 2.8 | Era | 1.9 | 0.07 |
| Era ligand | 112.9 | 22.5 | Era ligand | 2.8 | 0.57 |
| Erb | 39.0 | 5.4 | Erb | 1.0 | 0.14 |
| Erb ligand | 36.0 | 1.5 | Erb ligand | 0.9 | 0.04 |
| ERR1 | 45.5 | 2.2 | ERR1 | 1.1 | 0.05 |
| ERR2 | 65.0 | 8.5 | ERR2 | 1.6 | 0.21 |
| ERR3 | 84.0 | 6.6 | ERR3 | 2.1 | 0.17 |
| CTF1 | 28.2 | 2.5 | CTF1 | 0.7 | 0.06 |
| CTF2 | 42.7 | 6.2 | CTF2 | 1.1 | 0.16 |
| CTF3 | 34.2 | 1.7 | CTF3 | 0.9 | 0.04 |
| SF-1 | 141.9 | 5.3 | SF-1 | 3.6 | 0.13 |
| control | 44.8 | 2.3 | control | 1.1 | 0.06 |
| GR | 22.0 | 1.0 | GR | 0.6 | 0.02 |
| GR ligand | 34.4 | 6.2 | GR ligand | 0.9 | 0.16 |
| hMR | 31.2 | 2.7 | hMR | 0.8 | 0.07 |
| hMR ligand | 25.6 | 2.1 | hMR ligand | 0.6 | 0.05 |
| PR | 44.7 | 4.7 | PR | 1.1 | 0.12 |
| PR ligand | 52.4 | 4.4 | PR ligand | 1.3 | 0.11 |
| AR | 45.8 | 7.5 | AR | 1.2 | 0.19 |
| AR ligand | 36.6 | 5.0 | AR ligand | 0.9 | 0.13 |
| NR4a1 | 46.3 | 5.2 | NR4a1 | 1.2 | 0.13 |
| NR4a2 | 35.1 | 5.8 | NR4a2 | 0.9 | 0.15 |
| NR4a3 | 34.7 | 8.2 | NR4a3 | 0.9 | 0.21 |
| LRH-1 | 121.6 | 7.4 | LRH-1 | 3.1 | 0.19 |
| GCNF | 56.5 | 2.8 | GCNF | 1.4 | 0.07 |
| DAX-1 | 42.3 | 8.0 | DAX-1 | 1.1 | 0.20 |
| SHP | 44.6 | 9.4 | SHP | 1.1 | 0.24 |
| control | 39.7 | 0.8 | control | 1.0 | 0.02 |

TABLE 10
Results for assay for listed components for mNPY.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 49.3 | 4.0 | TRa1 | 0.6 | 0.05 |
| TRa1 ligand | 42.0 | 1.3 | TRa1 ligand | 0.5 | 0.02 |
| TRa2 | 67.8 | 12.9 | TRa2 | 0.8 | 0.15 |
| TRa2 ligand | 62.7 | 0.8 | TRa2 ligand | 0.7 | 0.01 |
| TRb1 | 100.7 | 6.6 | TRb1 | 1.2 | 0.08 |
| TRb1 ligand | 74.2 | 4.9 | TRb1 ligand | 0.9 | 0.06 |
| TRb2 | 93.7 | 3.0 | TRb2 | 1.1 | 0.04 |
| TRb2 ligand | 77.1 | 3.5 | TRb2 ligand | 0.9 | 0.04 |
| RARa | 103.8 | 22.9 | RARa | 1.2 | 0.27 |
| RARa ligand | 82.9 | 20.9 | RARa ligand | 1.0 | 0.25 |
| RARb | 97.9 | 6.0 | RARb | 1.2 | 0.07 |
| RARb ligand | 89.9 | 5.8 | RARb ligand | 1.1 | 0.07 |
| RARg | 100.5 | 19.8 | RARg | 1.2 | 0.24 |
| RARg ligand | 85.1 | 17.5 | RARg ligand | 1.0 | 0.21 |
| PPARa | 51.7 | 3.3 | PPARa | 0.6 | 0.04 |
| PPARa ligand | 51.0 | 2.7 | PPARa ligand | 0.6 | 0.03 |
| PPARg | 95.6 | 20.5 | PPARg | 1.1 | 0.24 |
| PPARg ligand | 101.0 | 3.8 | PPARg ligand | 1.2 | 0.05 |
| PPARd | 58.5 | 4.1 | PPARd | 0.7 | 0.05 |
| PPARd ligand | 58.7 | 1.3 | PPARd ligand | 0.7 | 0.02 |
| LXRa | 56.2 | 1.2 | LXRa | 0.7 | 0.01 |
| LXRa ligand | 76.4 | 9.9 | LXRa ligand | 0.9 | 0.12 |
| LXRb | 68.0 | 5.1 | LXRb | 0.8 | 0.06 |
| LXRb ligand | 83.3 | 0.9 | LXRb ligand | 1.0 | 0.01 |
| FXR | 77.7 | 6.6 | FXR | 0.9 | 0.08 |
| FXR ligand | 97.1 | 14.1 | FXR ligand | 1.2 | 0.17 |
| FXRb | 79.0 | 4.3 | FXRb | 0.9 | 0.05 |
| FXRb ligand | 80.1 | 1.5 | FXRb ligand | 1.0 | 0.02 |
| VDR | 66.7 | 3.6 | VDR | 0.8 | 0.04 |
| VDR ligand | 60.1 | 15.8 | VDR ligand | 0.7 | 0.19 |
| PXR | 69.8 | 5.1 | PXR | 0.8 | 0.06 |
| PXR ligand | 63.4 | 3.2 | PXR ligand | 0.8 | 0.04 |
| CAR | 74.2 | 0.5 | CAR | 0.9 | 0.01 |
| CAR ligand | 66.3 | 6.2 | CAR ligand | 0.8 | 0.07 |
| control | 86.2 | 0.3 | control | 1.0 | 0.00 |
| RXRa | 80.0 | 4.2 | RXRa | 1.0 | 0.05 |
| RXRa ligand | 92.1 | 5.6 | RXRa ligand | 1.1 | 0.07 |
| RXRb | 66.9 | 2.4 | RXRb | 0.8 | 0.03 |
| RXRb ligand | 63.8 | 1.4 | RXRb ligand | 0.8 | 0.02 |
| RXRg | 81.2 | 11.3 | RXRg | 1.0 | 0.13 |
| RXRg ligand | 91.1 | 11.3 | RXRg ligand | 1.1 | 0.13 |
| RVRa | 91.9 | 1.3 | RVRa | 1.1 | 0.02 |
| RVRb | 140.6 | 16.1 | RVRb | 1.7 | 0.19 |
| RORa | 75.4 | 2.3 | RORa | 0.9 | 0.03 |
| RORb | 94.2 | 12.4 | RORb | 1.1 | 0.15 |
| RORg | 76.5 | 4.2 | RORg | 0.9 | 0.05 |
| HNF4a | 43.5 | 4.7 | HNF4a | 0.5 | 0.06 |
| HNF4g | 80.7 | 2.4 | HNF4g | 1.0 | 0.03 |
| TR2 | 106.6 | 4.9 | TR2 | 1.3 | 0.06 |
| TR4 | 239.8 | 2.4 | TR4 | 2.9 | 0.03 |
| TLX | 93.5 | 4.3 | TLX | 1.1 | 0.05 |
| PNR | 168.3 | 4.3 | PNR | 2.0 | 0.05 |
| Era | 89.5 | 2.1 | Era | 1.1 | 0.02 |
| Era ligand | 96.7 | 8.6 | Era ligand | 1.2 | 0.10 |
| Erb | 66.5 | 3.4 | Erb | 0.8 | 0.04 |
| Erb ligand | 64.2 | 1.9 | Erb ligand | 0.8 | 0.02 |
| ERR1 | 69.6 | 3.5 | ERR1 | 0.8 | 0.04 |
| ERR2 | 85.4 | 3.4 | ERR2 | 1.0 | 0.04 |
| ERR3 | 93.1 | 2.7 | ERR3 | 1.1 | 0.03 |
| CTF1 | 39.2 | 3.4 | CTF1 | 0.5 | 0.04 |
| CTF2 | 54.7 | 3.6 | CTF2 | 0.7 | 0.04 |
| CTF3 | 40.6 | 2.4 | CTF3 | 0.5 | 0.03 |
| SF-1 | 177.6 | 1.7 | SF-1 | 2.1 | 0.02 |
| control | 77.7 | 5.9 | control | 0.9 | 0.07 |
| GR | 47.8 | 2.7 | GR | 0.6 | 0.03 |
| GR ligand | 57.9 | 5.2 | GR ligand | 0.7 | 0.06 |
| hMR | 48.9 | 2.4 | hMR | 0.6 | 0.03 |
| hMR ligand | 40.0 | 5.7 | hMR ligand | 0.5 | 0.07 |
| PR | 91.7 | 0.4 | PR | 1.1 | 0.00 |
| PR ligand | 161.4 | 40.2 | PR ligand | 1.9 | 0.48 |
| AR | 93.8 | 9.6 | AR | 1.1 | 0.11 |
| AR ligand | 99.9 | 1.6 | AR ligand | 1.2 | 0.02 |
| NR4a1 | 77.0 | 15.8 | NR4a1 | 0.9 | 0.19 |
| NR4a2 | 60.4 | 3.4 | NR4a2 | 0.7 | 0.04 |
| NR4a3 | 60.4 | 1.5 | NR4a3 | 0.7 | 0.02 |
| LRH-1 | 191.6 | 20.2 | LRH-1 | 2.3 | 0.24 |
| GCNF | 53.5 | 3.7 | GCNF | 0.6 | 0.04 |
| DAX-1 | 86.0 | 13.0 | DAX-1 | 1.0 | 0.16 |
| SHP | 68.3 | 6.4 | SHP | 0.8 | 0.08 |
| control | 84.0 | 4.1 | control | 1.0 | 0.05 |

TABLE 11
Results for assay for listed components for mPOMC.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 38.9 | 1.6 | TRa1 | 0.6 | 0.02 |
| TRa1 ligand | 37.3 | 3.8 | TRa1 ligand | 0.5 | 0.06 |
| TRa2 | 63.6 | 5.0 | TRa2 | 0.9 | 0.07 |
| TRa2 ligand | 61.3 | 2.9 | TRa2 ligand | 0.9 | 0.04 |
| TRb1 | 79.4 | 26.0 | TRb1 | 1.2 | 0.38 |
| TRb1 ligand | 59.0 | 3.5 | TRb1 ligand | 0.9 | 0.05 |
| TRb2 | 77.1 | 3.5 | TRb2 | 1.1 | 0.05 |
| TRb2 ligand | 85.4 | 7.8 | TRb2 ligand | 1.2 | 0.11 |
| RARa | 98.5 | 3.2 | RARa | 1.4 | 0.05 |
| RARa ligand | 112.7 | 33.5 | RARa ligand | 1.6 | 0.49 |
| RARb | 127.4 | 6.6 | RARb | 1.8 | 0.10 |
| RARb ligand | 122.8 | 12.6 | RARb ligand | 1.8 | 0.18 |
| RARg | 105.9 | 6.1 | RARg | 1.5 | 0.09 |
| RARg ligand | 89.6 | 11.4 | RARg ligand | 1.3 | 0.17 |
| PPARa | 77.6 | 4.9 | PPARa | 1.1 | 0.07 |
| PPARa ligand | 80.0 | 3.0 | PPARa ligand | 1.2 | 0.04 |
| PPARg | 108.0 | 11.6 | PPARg | 1.6 | 0.17 |
| PPARg ligand | 141.4 | 30.1 | PPARg ligand | 2.1 | 0.44 |
| PPARd | 70.0 | 0.6 | PPARd | 1.0 | 0.01 |
| PPARd ligand | 83.2 | 8.6 | PPARd ligand | 1.2 | 0.12 |
| LXRa | 117.1 | 1.3 | LXRa | 1.7 | 0.02 |
| LXRa ligand | 225.1 | 23.2 | LXRa ligand | 3.3 | 0.34 |
| LXRb | 60.8 | 3.7 | LXRb | 0.9 | 0.05 |
| LXRb ligand | 71.2 | 4.1 | LXRb ligand | 1.0 | 0.06 |
| FXR | 82.5 | 3.1 | FXR | 1.2 | 0.05 |
| FXR ligand | 96.1 | 9.2 | FXR ligand | 1.4 | 0.13 |
| FXRb | 92.5 | 7.4 | FXRb | 1.3 | 0.11 |
| FXRb ligand | 86.5 | 4.7 | FXRb ligand | 1.3 | 0.07 |
| VDR | 79.8 | 7.9 | VDR | 1.2 | 0.11 |
| VDR ligand | 49.7 | 5.3 | VDR ligand | 0.7 | 0.08 |
| PXR | 89.4 | 0.6 | PXR | 1.3 | 0.01 |
| PXR ligand | 53.9 | 3.7 | PXR ligand | 0.8 | 0.05 |
| CAR | 63.8 | 3.4 | CAR | 0.9 | 0.05 |
| CAR ligand | 64.0 | 1.4 | CAR ligand | 0.9 | 0.02 |
| control | 74.3 | 4.1 | control | 1.1 | 0.06 |
| RXRa | 68.0 | 4.3 | RXRa | 1.0 | 0.06 |
| RXRa ligand | 106.1 | 40.5 | RXRa ligand | 1.5 | 0.59 |
| RXRb | 81.8 | 12.9 | RXRb | 1.2 | 0.19 |
| RXRb ligand | 62.0 | 2.4 | RXRb ligand | 0.9 | 0.03 |
| RXRg | 73.2 | 4.7 | RXRg | 1.1 | 0.07 |
| RXRg ligand | 88.0 | 7.2 | RXRg ligand | 1.3 | 0.10 |
| RVRa | 77.9 | 8.2 | RVRa | 1.1 | 0.12 |
| RVRb | 58.4 | 4.3 | RVRb | 0.8 | 0.06 |
| RORa | 143.4 | 9.0 | RORa | 2.1 | 0.13 |
| RORb | 88.7 | 5.3 | RORb | 1.3 | 0.08 |
| RORg | 89.5 | 9.6 | RORg | 1.3 | 0.14 |
| HNF4a | 62.0 | 1.9 | HNF4a | 0.9 | 0.03 |
| HNF4g | 73.9 | 5.4 | HNF4g | 1.1 | 0.08 |
| TR2 | 132.1 | 2.9 | TR2 | 1.9 | 0.04 |
| TR4 | 258.7 | 35.2 | TR4 | 3.8 | 0.51 |
| TLX | 51.1 | 2.4 | TLX | 0.7 | 0.04 |
| PNR | 56.0 | 4.1 | PNR | 0.8 | 0.06 |
| Era | 101.4 | 9.9 | Era | 1.5 | 0.14 |
| Era ligand | 113.6 | 7.9 | Era ligand | 1.6 | 0.11 |
| Erb | 69.1 | 5.6 | Erb | 1.0 | 0.08 |
| Erb ligand | 62.3 | 5.2 | Erb ligand | 0.9 | 0.08 |
| ERR1 | 68.9 | 4.8 | ERR1 | 1.0 | 0.07 |
| ERR2 | 108.6 | 7.8 | ERR2 | 1.6 | 0.11 |
| ERR3 | 139.4 | 8.2 | ERR3 | 2.0 | 0.12 |
| CTF1 | 50.0 | 4.8 | CTF1 | 0.7 | 0.07 |
| CTF2 | 64.6 | 2.0 | CTF2 | 0.9 | 0.03 |
| CTF3 | 51.8 | 0.8 | CTF3 | 0.8 | 0.01 |
| SF-1 | 577.5 | 26.1 | SF-1 | 8.4 | 0.38 |
| control | 64.9 | 3.7 | control | 0.9 | 0.05 |
| GR | 34.5 | 2.2 | GR | 0.5 | 0.03 |
| GR ligand | 83.8 | 6.3 | GR ligand | 1.2 | 0.09 |
| hMR | 50.3 | 2.5 | hMR | 0.7 | 0.04 |
| hMR ligand | 39.3 | 1.6 | hMR ligand | 0.6 | 0.02 |
| PR | 75.8 | 2.0 | PR | 1.1 | 0.03 |
| PR ligand | 121.7 | 25.0 | PR ligand | 1.8 | 0.36 |
| AR | 72.2 | 2.3 | AR | 1.0 | 0.03 |
| AR ligand | 77.1 | 11.1 | AR ligand | 1.1 | 0.16 |
| NR4a1 | 246.9 | 34.3 | NR4a1 | 3.6 | 0.50 |
| NR4a2 | 72.2 | 5.7 | NR4a2 | 1.0 | 0.08 |
| NR4a3 | 59.7 | 3.2 | NR4a3 | 0.9 | 0.05 |
| LRH-1 | 403.8 | 23.0 | LRH-1 | 5.9 | 0.33 |
| GCNF | 42.0 | 14.0 | GCNF | 0.6 | 0.20 |
| DAX-1 | 63.4 | 2.3 | DAX-1 | 0.9 | 0.03 |
| SHP | 65.6 | 2.6 | SHP | 1.0 | 0.04 |
| control | 69.0 | 3.2 | control | 1.0 | 0.05 |

TABLE 12
Results for assay for listed components for hPOMC.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 2.8 | 0.1 | TRa1 | 0.6 | 0.03 |
| TRa1 ligand | 6.5 | 0.5 | TRa1 ligand | 1.5 | 0.11 |
| TRa2 | 3.3 | 0.3 | TRa2 | 0.8 | 0.06 |
| TRa2 ligand | 3.0 | 0.2 | TRa2 ligand | 0.7 | 0.04 |
| TRb1 | 4.5 | 0.3 | TRb1 | 1.0 | 0.06 |
| TRb1 ligand | 4.6 | 0.5 | TRb1 ligand | 1.1 | 0.12 |
| TRb2 | 4.9 | 0.3 | TRb2 | 1.1 | 0.07 |
| TRb2 ligand | 4.5 | 0.3 | TRb2 ligand | 1.1 | 0.07 |
| RARa | 3.2 | 0.0 | RARa | 0.7 | 0.01 |
| RARa ligand | 2.6 | 0.4 | RARa ligand | 0.6 | 0.09 |
| RARb | 4.3 | 0.6 | RARb | 1.0 | 0.14 |
| RARb ligand | 4.0 | 0.2 | RARb ligand | 0.9 | 0.05 |
| RARg | 3.7 | 0.3 | RARg | 0.9 | 0.06 |
| RARg ligand | 3.4 | 0.1 | RARg ligand | 0.8 | 0.02 |
| PPARa | 2.4 | 0.4 | PPARa | 0.6 | 0.09 |
| PPARa ligand | 2.1 | 0.2 | PPARa ligand | 0.5 | 0.04 |
| PPARg | 2.8 | 0.2 | PPARg | 0.6 | 0.04 |
| PPARg ligand | 2.8 | 0.5 | PPARg ligand | 0.7 | 0.13 |
| PPARd | 3.8 | 0.3 | PPARd | 0.9 | 0.08 |
| PPARd ligand | 3.5 | 0.6 | PPARd ligand | 0.8 | 0.13 |
| LXRa | 6.8 | 0.1 | LXRa | 1.6 | 0.03 |
| LXRa ligand | 11.1 | 0.2 | LXRa ligand | 2.6 | 0.05 |
| LXRb | 6.3 | 0.4 | LXRb | 1.5 | 0.10 |
| LXRb ligand | 6.3 | 0.2 | LXRb ligand | 1.5 | 0.06 |
| FXR | 2.8 | 0.3 | FXR | 0.6 | 0.06 |
| FXR ligand | 3.0 | 0.2 | FXR ligand | 0.7 | 0.04 |
| FXRb | 3.4 | 0.1 | FXRb | 0.8 | 0.03 |
| FXRb ligand | 3.7 | 0.6 | FXRb ligand | 0.9 | 0.13 |
| VDR | 3.8 | 0.2 | VDR | 0.9 | 0.05 |
| VDR ligand | 3.0 | 0.2 | VDR ligand | 0.7 | 0.05 |
| PXR | 4.2 | 0.2 | PXR | 1.0 | 0.05 |
| PXR ligand | 2.4 | 0.4 | PXR ligand | 0.6 | 0.08 |
| CAR | 4.3 | 0.2 | CAR | 1.0 | 0.06 |
| CAR ligand | 3.7 | 0.4 | CAR ligand | 0.9 | 0.09 |
| control | 6.0 | 0.3 | control | 1.4 | 0.07 |
| RXRa | 2.6 | 0.1 | RXRa | 0.6 | 0.01 |
| RXRa ligand | 2.8 | 0.2 | RXRa ligand | 0.7 | 0.05 |
| RXRb | | | RXRb | 0.0 | 0.00 |
| RXRb ligand | | | RXRb ligand | 0.0 | 0.00 |
| RXRg | 2.5 | 0.1 | RXRg | 0.6 | 0.03 |
| RXRg ligand | 2.8 | 0.1 | RXRg ligand | 0.7 | 0.01 |
| RVRa | 2.3 | 0.1 | RVRa | 0.5 | 0.02 |
| RVRb | 2.8 | 0.2 | RVRb | 0.7 | 0.04 |
| RORa | 1.6 | 0.3 | RORa | 0.4 | 0.07 |
| RORb | 2.2 | 0.1 | RORb | 0.5 | 0.03 |
| RORg | 2.1 | 0.2 | RORg | 0.5 | 0.05 |
| HNF4a | 3.5 | 0.6 | HNF4a | 0.8 | 0.13 |
| HNF4g | 5.3 | 0.5 | HNF4g | 1.2 | 0.11 |
| TR2 | 15.7 | 1.0 | TR2 | 3.6 | 0.22 |
| TR4 | 50.7 | 0.5 | TR4 | 11.8 | 0.12 |
| TLX | 2.6 | 0.1 | TLX | 0.6 | 0.01 |
| PNR | 1.5 | 0.2 | PNR | 0.3 | 0.05 |
| Era | 5.9 | 0.5 | Era | 1.4 | 0.13 |
| Era ligand | 9.5 | 1.4 | Era ligand | 2.2 | 0.32 |
| Erb | 3.2 | 0.4 | Erb | 0.7 | 0.09 |
| Erb ligand | 2.5 | 0.1 | Erb ligand | 0.6 | 0.02 |
| ERR1 | 2.7 | 0.4 | ERR1 | 0.6 | 0.09 |
| ERR2 | 11.6 | 1.1 | ERR2 | 2.7 | 0.26 |
| ERR3 | 17.6 | 0.9 | ERR3 | 4.1 | 0.22 |
| CTF1 | | | CTF1 | 0.0 | 0.00 |
| CTF2 | | | CTF2 | 0.0 | 0.00 |
| CTF3 | 1.8 | 0.1 | CTF3 | 0.4 | 0.02 |
| SF-1 | 13.1 | 1.2 | SF-1 | 3.1 | 0.28 |
| control | 4.8 | 0.6 | control | 1.1 | 0.13 |
| GR | 0.7 | 0.1 | GR | 0.2 | 0.03 |
| GR ligand | 0.8 | 0.1 | GR ligand | 0.2 | 0.02 |
| hMR | | | hMR | 0.0 | 0.00 |
| hMR ligand | | | hMR ligand | 0.0 | 0.00 |
| PR | 3.2 | 0.4 | PR | 0.7 | 0.08 |
| PR ligand | 2.9 | 0.2 | PR ligand | 0.7 | 0.06 |
| AR | 1.8 | 0.1 | AR | 0.4 | 0.02 |
| AR ligand | 2.2 | 0.7 | AR ligand | 0.5 | 0.15 |
| NR4a1 | 15.3 | 4.6 | NR4a1 | 3.6 | 1.07 |
| NR4a2 | 2.1 | 0.2 | NR4a2 | 0.5 | 0.05 |
| NR4a3 | 2.7 | 0.1 | NR4a3 | 0.6 | 0.03 |
| LRH-1 | 8.7 | 1.9 | LRH-1 | 2.0 | 0.44 |
| GCNF | | | GCNF | 0.0 | 0.00 |
| DAX-1 | 2.7 | 0.6 | DAX-1 | 0.6 | 0.14 |
| SHP | 1.9 | 0.1 | SHP | 0.4 | 0.02 |
| control | 4.3 | 0.6 | control | 1.0 | 0.13 |

TABLE 13
Results for assay for listed components for mCAR.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 10.9 | 2.9 | TRa1 | 0.3 | 0.08 |
| TRa1 ligand | 8.2 | 0.3 | TRa1 ligand | 0.2 | 0.01 |
| TRa2 | 37.1 | 1.1 | TRa2 | 1.0 | 0.03 |
| TRa2 ligand | 35.5 | 2.0 | TRa2 ligand | 0.9 | 0.05 |
| TRb1 | 31.3 | 3.0 | TRb1 | 0.8 | 0.08 |
| TRb1 ligand | 16.9 | 1.7 | TRb1 ligand | 0.4 | 0.04 |
| TRb2 | 41.7 | 2.0 | TRb2 | 1.1 | 0.05 |
| TRb2 ligand | 25.2 | 1.5 | TRb2 ligand | 0.7 | 0.04 |
| RARa | 46.3 | 4.3 | RARa | 1.2 | 0.11 |
| RARa ligand | 20.2 | 0.5 | RARa ligand | 0.5 | 0.01 |
| RARb | 49.6 | 2.6 | RARb | 1.3 | 0.07 |
| RARb ligand | 28.7 | 2.8 | RARb ligand | 0.8 | 0.07 |
| RARg | 47.1 | 2.3 | RARg | 1.2 | 0.06 |
| RARg ligand | 28.0 | 1.3 | RARg ligand | 0.7 | 0.03 |
| PPARa | 33.6 | 2.3 | PPARa | 0.9 | 0.06 |
| PPARa ligand | 43.5 | 2.6 | PPARa ligand | 1.1 | 0.07 |
| PPARg | 47.7 | 6.6 | PPARg | 1.3 | 0.17 |
| PPARg ligand | 68.2 | 11.8 | PPARg ligand | 1.8 | 0.31 |
| PPARd | 30.1 | 1.8 | PPARd | 0.8 | 0.05 |
| PPARd ligand | 32.0 | 2.9 | PPARd ligand | 0.8 | 0.08 |
| LXRa | 29.5 | 2.3 | LXRa | 0.8 | 0.06 |
| LXRa ligand | 46.3 | 3.7 | LXRa ligand | 1.2 | 0.10 |
| LXRb | 34.9 | 2.9 | LXRb | 0.9 | 0.08 |
| LXRb ligand | 34.7 | 3.6 | LXRb ligand | 0.9 | 0.09 |
| FXR | 33.6 | 3.5 | FXR | 0.9 | 0.09 |
| FXR ligand | 54.0 | 7.6 | FXR ligand | 1.4 | 0.20 |
| FXRb | 51.3 | 3.5 | FXRb | 1.3 | 0.09 |
| FXRb ligand | 52.9 | 6.9 | FXRb ligand | 1.4 | 0.18 |
| VDR | 26.5 | 1.8 | VDR | 0.7 | 0.05 |
| VDR ligand | 9.9 | 0.7 | VDR ligand | 0.3 | 0.02 |
| PXR | 56.8 | 4.6 | PXR | 1.5 | 0.12 |
| PXR ligand | 25.1 | 1.4 | PXR ligand | 0.7 | 0.04 |
| CAR | 19.41301 | 3.882529 | CAR | 0.5 | 0.10 |
| CAR ligand | 17.18838 | 1.581637 | CAR ligand | 0.5 | 0.04 |
| control | 36.5 | 1.7 | control | 1.0 | 0.05 |
| RXRa | 36.9 | 1.3 | RXRa | 1.0 | 0.03 |
| RXRa ligand | 35.7 | 1.5 | RXRa ligand | 0.9 | 0.04 |
| RXRb | 48.6 | 3.4 | RXRb | 1.3 | 0.09 |
| RXRb ligand | 41.4 | 0.9 | RXRb ligand | 1.1 | 0.02 |
| RXRg | 47.5 | 2.7 | RXRg | 1.2 | 0.07 |
| RXRg ligand | 39.8 | 2.7 | RXRg ligand | 1.0 | 0.07 |
| RVRa | 34.0 | 2.2 | RVRa | 0.9 | 0.06 |
| RVRb | 34.5 | 3.0 | RVRb | 0.9 | 0.08 |
| RORa | 20.9 | 1.6 | RORa | 0.5 | 0.04 |
| RORb | 43.7 | 5.3 | RORb | 1.1 | 0.14 |
| RORg | 43.1 | 3.7 | RORg | 1.1 | 0.10 |
| HNF4a | 641.2 | 15.5 | HNF4a | 16.8 | 0.41 |
| HNF4g | 54.5 | 4.6 | HNF4g | 1.4 | 0.12 |
| TR2 | 31.0 | 3.0 | TR2 | 0.8 | 0.08 |
| TR4 | 96.2 | 8.1 | TR4 | 2.5 | 0.21 |
| TLX | 15.0 | 0.8 | TLX | 0.4 | 0.02 |
| PNR | 21.0 | 0.7 | PNR | 0.6 | 0.02 |
| Era | 47.8 | 5.8 | Era | 1.3 | 0.15 |
| Era ligand | 56.7 | 5.8 | Era ligand | 1.5 | 0.15 |
| Erb | 44.8 | 2.0 | Erb | 1.2 | 0.05 |
| Erb ligand | 31.3 | 4.1 | Erb ligand | 0.8 | 0.11 |
| ERR1 | 40.9 | 1.5 | ERR1 | 1.1 | 0.04 |
| ERR2 | 37.8 | 3.0 | ERR2 | 1.0 | 0.08 |
| ERR3 | 109.5 | 1.9 | ERR3 | 2.9 | 0.05 |
| CTF1 | 11.8 | 1.3 | CTF1 | 0.3 | 0.04 |
| CTF2 | 19.3 | 1.4 | CTF2 | 0.5 | 0.04 |
| CTF3 | 11.2 | 1.0 | CTF3 | 0.3 | 0.03 |
| SF-1 | 92.6 | 1.5 | SF-1 | 2.4 | 0.04 |
| control | 41.0 | 1.1 | control | 1.1 | 0.03 |
| GR | 8.74 | 0.83 | GR | 0.2 | 0.02 |
| GR ligand | 7.68 | 0.65 | GR ligand | 0.2 | 0.02 |
| hMR | 29.38 | 1.81 | hMR | 0.8 | 0.05 |
| hMR ligand | 22.46 | 1.07 | hMR ligand | 0.6 | 0.03 |
| PR | 37.53 | 1.10 | PR | 1.0 | 0.03 |
| PR ligand | 24.05 | 3.25 | PR ligand | 0.6 | 0.09 |
| AR | 30.88 | 4.35 | AR | 0.8 | 0.11 |
| AR ligand | 27.02 | 2.36 | AR ligand | 0.7 | 0.06 |
| NR4a1 | 35.66 | 3.68 | NR4a1 | 0.9 | 0.10 |
| NR4a2 | 21.74 | 3.69 | NR4a2 | 0.6 | 0.10 |
| NR4a3 | 21.58 | 4.24 | NR4a3 | 0.6 | 0.11 |
| LRH-1 | 118.58 | 5.28 | LRH-1 | 3.1 | 0.14 |
| GCNF | 29.68 | 1.60 | GCNF | 0.8 | 0.04 |
| DAX-1 | 36.74 | 4.60 | DAX-1 | 1.0 | 0.12 |
| SHP | 36.17 | 5.75 | SHP | 0.9 | 0.15 |
| control | 38.11 | 2.04 | control | 1.0 | 0.05 |

TABLE 14
Results for assay for listed components for hCAR.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 5.6 | 2.5 | TRa1 | 0.2 | 0.08 |
| TRa1 ligand | 17.1 | 1.8 | TRa1 ligand | 0.5 | 0.06 |
| TRa2 | 25.1 | 0.5 | TRa2 | 0.8 | 0.02 |
| TRa2 ligand | 21.2 | 0.7 | TRa2 ligand | 0.7 | 0.02 |
| TRb1 | 14.8 | 1.0 | TRb1 | 0.5 | 0.03 |
| TRb1 ligand | 22.9 | 1.7 | TRb1 ligand | 0.7 | 0.05 |
| TRb2 | 44.8 | 2.2 | TRb2 | 1.4 | 0.07 |
| TRb2 ligand | 27.9 | 2.6 | TRb2 ligand | 0.9 | 0.08 |
| RARa | 33.2 | 2.3 | RARa | 1.1 | 0.07 |
| RARa ligand | 29.6 | 6.0 | RARa ligand | 0.9 | 0.19 |
| RARb | 41.4 | 7.1 | RARb | 1.3 | 0.22 |
| RARb ligand | 41.5 | 6.4 | RARb ligand | 1.3 | 0.20 |
| RARg | 31.4 | 3.0 | RARg | 1.0 | 0.10 |
| RARg ligand | 40.6 | 8.4 | RARg ligand | 1.3 | 0.27 |
| PPARa | 43.9 | 8.8 | PPARa | 1.4 | 0.28 |
| PPARa ligand | 45.0 | 8.8 | PPARa ligand | 1.4 | 0.28 |
| PPARg | 49.8 | 14.5 | PPARg | 1.6 | 0.46 |
| PPARg ligand | 81.0 | 14.6 | PPARg ligand | 2.6 | 0.46 |
| PPARd | 38.6 | 15.5 | PPARd | 1.2 | 0.49 |
| PPARd ligand | 34.4 | 1.1 | PPARd ligand | 1.1 | 0.03 |
| LXRa | 58.9 | 1.5 | LXRa | 1.9 | 0.05 |
| LXRa ligand | 106.4 | 10.9 | LXRa ligand | 3.4 | 0.35 |
| LXRb | 45.5 | 3.5 | LXRb | 1.4 | 0.11 |
| LXRb ligand | 43.2 | 3.0 | LXRb ligand | 1.4 | 0.09 |
| FXR | 24.6 | 1.9 | FXR | 0.8 | 0.06 |
| FXR ligand | 107.9 | 8.1 | FXR ligand | 3.4 | 0.26 |
| FXRb | 66.5 | 0.7 | FXRb | 2.1 | 0.02 |
| FXRb ligand | 62.7 | 5.1 | FXRb ligand | 2.0 | 0.16 |
| VDR | 26.1 | 1.6 | VDR | 0.8 | 0.05 |
| VDR ligand | 21.7 | 2.6 | VDR ligand | 0.7 | 0.08 |
| PXR | 36.5 | 0.8 | PXR | 1.2 | 0.03 |
| PXR ligand | 42.5 | 1.3 | PXR ligand | 1.3 | 0.04 |
| CAR | 25.90308 | 3.577052 | CAR | 0.8 | 0.11 |
| CAR ligand | 28.95684 | 1.579625 | CAR ligand | 0.9 | 0.05 |
| control | 41.5 | 1.5 | control | 1.3 | 0.05 |
| RXRa | 24.7 | 2.1 | RXRa | 0.8 | 0.07 |
| RXRa ligand | 36.8 | 2.5 | RXRa ligand | 1.2 | 0.08 |
| RXRb | 30.1 | 3.1 | RXRb | 1.0 | 0.10 |
| RXRb ligand | 34.2 | 8.4 | RXRb ligand | 1.1 | 0.27 |
| RXRg | 29.3 | 3.2 | RXRg | 0.9 | 0.10 |
| RXRg ligand | 37.4 | 0.4 | RXRg ligand | 1.2 | 0.01 |
| RVRa | 33.3 | 4.6 | RVRa | 1.1 | 0.14 |
| RVRb | 35.7 | 8.1 | RVRb | 1.1 | 0.26 |
| RORa | 18.2 | 1.3 | RORa | 0.6 | 0.04 |
| RORb | 33.3 | 2.6 | RORb | 1.1 | 0.08 |
| RORg | 38.6 | 5.8 | RORg | 1.2 | 0.19 |
| HNF4a | 493.6 | 166.9 | HNF4a | 15.6 | 5.28 |
| HNF4g | 25.5 | 0.9 | HNF4g | 0.8 | 0.03 |
| TR2 | 72.7 | 6.3 | TR2 | 2.3 | 0.20 |
| TR4 | 99.4 | 16.3 | TR4 | 3.1 | 0.51 |
| TLX | 17.6 | 1.5 | TLX | 0.6 | 0.05 |
| PNR | 11.9 | 0.4 | PNR | 0.4 | 0.01 |
| Era | 37.8 | 3.8 | Era | 1.2 | 0.12 |
| Era ligand | 95.4 | 2.6 | Era ligand | 3.0 | 0.08 |
| Erb | 25.7 | 13.2 | Erb | 0.8 | 0.42 |
| Erb ligand | 21.2 | 1.6 | Erb ligand | 0.7 | 0.05 |
| ERR1 | 25.8 | 2.0 | ERR1 | 0.8 | 0.06 |
| ERR2 | 24.2 | 1.2 | ERR2 | 0.8 | 0.04 |
| ERR3 | 42.2 | 11.3 | ERR3 | 1.3 | 0.36 |
| CTF1 | 4.5 | 1.2 | CTF1 | 0.1 | 0.04 |
| CTF2 | 7.2 | 0.8 | CTF2 | 0.2 | 0.03 |
| CTF3 | 4.5 | 0.4 | CTF3 | 0.1 | 0.01 |
| SF-1 | 113.6 | 6.1 | SF-1 | 3.6 | 0.19 |
| control | 27.9 | 0.5 | control | 0.9 | 0.02 |
| GR | 11.24734 | 0.578258 | GR | 0.4 | 0.02 |
| GR ligand | 14.67661 | 0.865229 | GR ligand | 0.5 | 0.03 |
| hMR | 25.6 | 6.1 | hMR | 0.8 | 0.19 |
| hMR ligand | 14.7 | 0.2 | hMR ligand | 0.5 | 0.01 |
| PR | 31.5 | 0.2 | PR | 1.0 | 0.01 |
| PR ligand | 31.3 | 1.8 | PR ligand | 1.0 | 0.06 |
| AR | 28.0 | 2.5 | AR | 0.9 | 0.08 |
| AR ligand | 24.3 | 6.8 | AR ligand | 0.8 | 0.22 |
| NR4a1 | 30.7 | 4.0 | NR4a1 | 1.0 | 0.13 |
| NR4a2 | 18.4 | 8.3 | NR4a2 | 0.6 | 0.26 |
| NR4a3 | 16.9 | 1.7 | NR4a3 | 0.5 | 0.05 |
| LRH-1 | 99.1 | 12.6 | LRH-1 | 3.1 | 0.40 |
| GCNF | 29.2 | 1.7 | GCNF | 0.9 | 0.05 |
| DAX-1 | 38.0 | 8.7 | DAX-1 | 1.2 | 0.28 |
| SHP | 31.3 | 6.1 | SHP | 1.0 | 0.19 |
| control | 31.6 | 3.0 | control | 1.0 | 0.10 |

TABLE 15
Results for assay for listed components for PGC1b.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 2.63 | 0.34 | TRa1 | 0.2 | 0.03 |
| TRa1 ligand | 2.42 | 0.20 | TRa1 ligand | 0.2 | 0.02 |
| TRa2 | 5.89 | 0.30 | TRa2 | 0.5 | 0.03 |
| TRa2 ligand | 5.54 | 0.59 | TRa2 ligand | 0.5 | 0.05 |
| TRb1 | 5.89 | 0.26 | TRb1 | 0.5 | 0.02 |
| TRb1 ligand | 4.27 | 0.45 | TRb1 ligand | 0.4 | 0.04 |
| TRb2 | 9.07 | 1.89 | TRb2 | 0.8 | 0.16 |
| TRb2 ligand | 7.42 | 0.68 | TRb2 ligand | 0.6 | 0.06 |
| RARa | 12.69 | 0.72 | RARa | 1.1 | 0.06 |
| RARa ligand | 10.37 | 2.43 | RARa ligand | 0.9 | 0.21 |
| RARb | 14.32 | 1.65 | RARb | 1.2 | 0.14 |
| RARb ligand | 11.86 | 0.41 | RARb ligand | 1.0 | 0.03 |
| RARg | 12.70 | 0.02 | RARg | 1.1 | 0.00 |
| RARg ligand | 12.46 | 2.42 | RARg ligand | 1.1 | 0.20 |
| PPARa | 9.33 | 3.37 | PPARa | 0.8 | 0.28 |
| PPARa ligand | 8.58 | 0.97 | PPARa ligand | 0.7 | 0.08 |
| PPARg | 11.35 | 0.68 | PPARg | 1.0 | 0.06 |
| PPARg ligand | 17.63 | 3.41 | PPARg ligand | 1.5 | 0.29 |
| PPARd | 7.88 | 0.44 | PPARd | 0.7 | 0.04 |
| PPARd ligand | 7.92 | 0.79 | PPARd ligand | 0.7 | 0.07 |
| LXRa | 8.40 | 0.24 | LXRa | 0.7 | 0.02 |
| LXRa ligand | 9.98 | 0.51 | LXRa ligand | 0.8 | 0.04 |
| LXRb | 4.69 | 0.16 | LXRb | 0.4 | 0.01 |
| LXRb ligand | 4.73 | 0.78 | LXRb ligand | 0.4 | 0.07 |
| FXR | 7.82 | 0.21 | FXR | 0.7 | 0.02 |
| FXR ligand | 9.97 | 0.93 | FXR ligand | 0.8 | 0.08 |
| FXRb | 9.48 | 0.31 | FXRb | 0.8 | 0.03 |
| FXRb ligand | 9.81 | 0.22 | FXRb ligand | 0.8 | 0.02 |
| VDR | 6.85 | 0.33 | VDR | 0.6 | 0.03 |
| VDR ligand | 4.02 | 0.16 | VDR ligand | 0.3 | 0.01 |
| PXR | 10.19 | 0.38 | PXR | 0.9 | 0.03 |
| PXR ligand | 8.83 | 0.53 | PXR ligand | 0.7 | 0.04 |
| CAR | 9.21 | 0.60 | CAR | 0.8 | 0.05 |
| CAR ligand | 8.14 | 0.21 | CAR ligand | 0.7 | 0.02 |
| control | 11.4 | 1.4 | control | 1.0 | 0.12 |
| RXRa | 8.6 | 0.9 | RXRa | 0.7 | 0.07 |
| RXRa ligand | 12.7 | 1.5 | RXRa ligand | 1.1 | 0.13 |
| RXRb | 11.7 | 1.9 | RXRb | 1.0 | 0.16 |
| RXRb ligand | 9.4 | 0.5 | RXRb ligand | 0.8 | 0.04 |
| RXRg | 9.0 | 0.3 | RXRg | 0.8 | 0.03 |
| RXRg ligand | 11.0 | 0.4 | RXRg ligand | 0.9 | 0.03 |
| RVRa | 8.8 | 0.2 | RVRa | 0.7 | 0.02 |
| RVRb | 9.3 | 0.2 | RVRb | 0.8 | 0.02 |
| RORa | 10.8 | 0.5 | RORa | 0.9 | 0.04 |
| RORb | 10.7 | 0.9 | RORb | 0.9 | 0.08 |
| RORg | 15.9 | 1.0 | RORg | 1.3 | 0.09 |
| HNF4a | 6.4 | 0.9 | HNF4a | 0.5 | 0.08 |
| HNF4g | 6.8 | 0.9 | HNF4g | 0.6 | 0.08 |
| TR2 | 9.8 | 0.7 | TR2 | 0.8 | 0.06 |
| TR4 | 17.3 | 2.0 | TR4 | 1.5 | 0.17 |
| TLX | 4.5 | 0.2 | TLX | 0.4 | 0.02 |
| PNR | 4.9 | 0.3 | PNR | 0.4 | 0.03 |
| Era | 11.8 | 0.6 | Era | 1.0 | 0.05 |
| Era ligand | 14.9 | 1.4 | Era ligand | 1.3 | 0.12 |
| Erb | 9.2 | 0.7 | Erb | 0.8 | 0.06 |
| Erb ligand | 7.4 | 0.5 | Erb ligand | 0.6 | 0.05 |
| ERR1 | 8.8 | 0.2 | ERR1 | 0.7 | 0.02 |
| ERR2 | 12.7 | 0.1 | ERR2 | 1.1 | 0.01 |
| ERR3 | 20.1 | 2.1 | ERR3 | 1.7 | 0.18 |
| CTF1 | 6.7 | 1.0 | CTF1 | 0.6 | 0.08 |
| CTF2 | 12.2 | 0.1 | CTF2 | 1.0 | 0.01 |
| CTF3 | 4.9 | 0.5 | CTF3 | 0.4 | 0.04 |
| SF-1 | 33.2 | 4.7 | SF-1 | 2.8 | 0.40 |
| control | 10.4 | 0.7 | control | 0.9 | 0.06 |
| GR | 3.2 | 0.5 | GR | 0.3 | 0.04 |
| GR ligand | 5.4 | 0.8 | GR ligand | 0.5 | 0.07 |
| hMR | 5.7 | 0.2 | hMR | 0.5 | 0.02 |
| hMR ligand | 5.9 | 0.2 | hMR ligand | 0.5 | 0.02 |
| PR | 8.9 | 0.2 | PR | 0.7 | 0.02 |
| PR ligand | 11.6 | 0.3 | PR ligand | 1.0 | 0.02 |
| AR | 9.0 | 0.8 | AR | 0.8 | 0.07 |
| AR ligand | 9.0 | 0.9 | AR ligand | 0.8 | 0.08 |
| NR4a1 | 17.1 | 2.2 | NR4a1 | 1.4 | 0.18 |
| NR4a2 | 9.0 | 2.7 | NR4a2 | 0.8 | 0.23 |
| NR4a3 | 9.2 | 2.9 | NR4a3 | 0.8 | 0.24 |
| LRH-1 | 25.7 | 4.4 | LRH-1 | 2.2 | 0.37 |
| GCNF | 11.7 | 3.5 | GCNF | 1.0 | 0.30 |
| DAX-1 | 7.4 | 0.5 | DAX-1 | 0.6 | 0.04 |
| SHP | 9.0 | 3.2 | SHP | 0.8 | 0.27 |
| control | 11.8 | 3.6 | control | 1.0 | 0.31 |

TABLE 16
Results for assay for listed components for G6PD.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 18.0 | 0.3 | TRa1 | 0.5 | 0.01 |
| TRa1 ligand | 27.1 | 3.3 | TRa1 ligand | 0.7 | 0.09 |
| TRa2 | 36.6 | 3.8 | TRa2 | 1.0 | 0.10 |
| TRa2 ligand | 36.4 | 6.9 | TRa2 ligand | 1.0 | 0.18 |
| TRb1 | 38.1 | 1.1 | TRb1 | 1.0 | 0.03 |
| TRb1 ligand | 35.6 | 1.4 | TRb1 ligand | 1.0 | 0.04 |
| TRb2 | 48.3 | 10.8 | TRb2 | 1.3 | 0.29 |
| TRb2 ligand | 41.8 | 6.3 | TRb2 ligand | 1.1 | 0.17 |
| RARa | 57.1 | 3.4 | RARa | 1.5 | 0.09 |
| RARa ligand | 43.2 | 2.7 | RARa ligand | 1.2 | 0.07 |
| RARb | 56.6 | 2.8 | RARb | 1.5 | 0.08 |
| RARb ligand | 51.1 | 3.6 | RARb ligand | 1.4 | 0.10 |
| RARg | 58.8 | 2.3 | RARg | 1.6 | 0.06 |
| RARg ligand | 58.6 | 5.8 | RARg ligand | 1.6 | 0.15 |
| PPARa | 55.6 | 14.3 | PPARa | 1.5 | 0.38 |
| PPARa ligand | 56.7 | 4.1 | PPARa ligand | 1.5 | 0.11 |
| PPARg | 66.0 | 3.4 | PPARg | 1.8 | 0.09 |
| PPARg ligand | 91.1 | 4.8 | PPARg ligand | 2.4 | 0.13 |
| PPARd | 48.7 | 2.0 | PPARd | 1.3 | 0.05 |
| PPARd ligand | 59.9 | 1.0 | PPARd ligand | 1.6 | 0.03 |
| LXRa | 60.5 | 2.5 | LXRa | 1.6 | 0.07 |
| LXRa ligand | 80.6 | 5.8 | LXRa ligand | 2.2 | 0.15 |
| LXRb | 46.8 | 1.7 | LXRb | 1.3 | 0.05 |
| LXRb ligand | 46.5 | 5.9 | LXRb ligand | 1.2 | 0.16 |
| FXR | 42.6 | 3.4 | FXR | 1.1 | 0.09 |
| FXR ligand | 50.4 | 6.6 | FXR ligand | 1.3 | 0.18 |
| FXRb | 61.0 | 3.1 | FXRb | 1.6 | 0.08 |
| FXRb ligand | 54.5 | 4.9 | FXRb ligand | 1.5 | 0.13 |
| VDR | 43.1 | 0.9 | VDR | 1.2 | 0.03 |
| VDR ligand | 36.3 | 5.1 | VDR ligand | 1.0 | 0.14 |
| PXR | 42.5 | 1.5 | PXR | 1.1 | 0.04 |
| PXR ligand | 41.5 | 7.6 | PXR ligand | 1.1 | 0.20 |
| CAR | 46.4 | 0.4 | CAR | 1.2 | 0.01 |
| CAR ligand | 47.7 | 0.9 | CAR ligand | 1.3 | 0.02 |
| control | 55.8 | 1.3 | control | 1.5 | 0.03 |
| RXRa | 45.6 | 4.5 | RXRa | 1.2 | 0.12 |
| RXRa ligand | 72.5 | 1.7 | RXRa ligand | 1.9 | 0.04 |
| RXRb | 23.1 | 2.1 | RXRb | 0.6 | 0.06 |
| RXRb ligand | 37.9 | 5.1 | RXRb ligand | 1.0 | 0.14 |
| RXRg | 43.7 | 4.7 | RXRg | 1.2 | 0.13 |
| RXRg ligand | 62.7 | 5.2 | RXRg ligand | 1.7 | 0.14 |
| RVRa | 45.9 | 5.4 | RVRa | 1.2 | 0.14 |
| RVRb | 55.5 | 10.9 | RVRb | 1.5 | 0.29 |
| RORa | 74.0 | 2.3 | RORa | 2.0 | 0.06 |
| RORb | 51.1 | 4.5 | RORb | 1.4 | 0.12 |
| RORg | 81.5 | 4.1 | RORg | 2.2 | 0.11 |
| HNF4a | 34.8 | 2.1 | HNF4a | 0.9 | 0.06 |
| HNF4g | 42.1 | 3.7 | HNF4g | 1.1 | 0.10 |
| TR2 | 45.5 | 3.1 | TR2 | 1.2 | 0.08 |
| TR4 | 66.2 | 4.6 | TR4 | 1.8 | 0.12 |
| TLX | 107.9 | 3.5 | TLX | 2.9 | 0.09 |
| PNR | 45.9 | 0.6 | PNR | 1.2 | 0.01 |
| Era | 64.4 | 5.0 | Era | 1.7 | 0.13 |
| Era ligand | 78.7 | 6.0 | Era ligand | 2.1 | 0.16 |
| Erb | 45.3 | 2.7 | Erb | 1.2 | 0.07 |
| Erb ligand | 44.1 | 3.4 | Erb ligand | 1.2 | 0.09 |
| ERR1 | 59.1 | 12.8 | ERR1 | 1.6 | 0.34 |
| ERR2 | 59.1 | 5.6 | ERR2 | 1.6 | 0.15 |
| ERR3 | 63.7 | 4.3 | ERR3 | 1.7 | 0.11 |
| CTF1 | 39.7 | 1.9 | CTF1 | 1.1 | 0.05 |
| CTF2 | 43.9 | 4.0 | CTF2 | 1.2 | 0.11 |
| CTF3 | 32.5 | 2.1 | CTF3 | 0.9 | 0.06 |
| SF-1 | 124.1 | 5.1 | SF-1 | 3.3 | 0.14 |
| control | 52.3 | 3.3 | control | 1.4 | 0.09 |
| GR | 22.3 | 1.2 | GR | 0.6 | 0.03 |
| GR ligand | 26.0 | 1.7 | GR ligand | 0.7 | 0.05 |
| hMR | 35.2 | 3.1 | hMR | 0.9 | 0.08 |
| hMR ligand | 28.8 | 0.1 | hMR ligand | 0.8 | 0.00 |
| PR | 45.4 | 9.4 | PR | 1.2 | 0.25 |
| PR ligand | 60.1 | 3.4 | PR ligand | 1.6 | 0.09 |
| AR | 41.5 | 3.9 | AR | 1.1 | 0.10 |
| AR ligand | 37.2 | 4.7 | AR ligand | 1.0 | 0.13 |
| NR4a1 | 77.6 | 2.4 | NR4a1 | 2.1 | 0.06 |
| NR4a2 | 41.1 | 2.0 | NR4a2 | 1.1 | 0.05 |
| NR4a3 | 43.4 | 2.1 | NR4a3 | 1.2 | 0.06 |
| LRH-1 | 90.6 | 6.1 | LRH-1 | 2.4 | 0.16 |
| GCNF | 46.1 | 4.1 | GCNF | 1.2 | 0.11 |
| DAX-1 | 46.0 | 3.1 | DAX-1 | 1.2 | 0.08 |
| SHP | 43.2 | 2.6 | SHP | 1.2 | 0.07 |
| control | 37.4 | 6.6 | control | 1.0 | 0.18 |

TABLE 17
Results for assay for listed components for MyoD.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 33.3 | 2.0 | TRa1 | 0.5 | 0.03 |
| TRa1 ligand | 32.5 | 3.3 | TRa1 ligand | 0.5 | 0.05 |
| TRa2 | 54.5 | 0.4 | TRa2 | 0.9 | 0.01 |
| TRa2 ligand | 47.8 | 2.6 | TRa2 ligand | 0.8 | 0.04 |
| TRb1 | 72.5 | 10.1 | TRb1 | 1.1 | 0.16 |
| TRb1 ligand | 46.9 | 0.2 | TRb1 ligand | 0.7 | 0.00 |
| TRb2 | 73.7 | 4.3 | TRb2 | 1.2 | 0.07 |
| TRb2 ligand | 65.9 | 5.3 | TRb2 ligand | 1.0 | 0.08 |
| RARa | 99.3 | 1.6 | RARa | 1.6 | 0.03 |
| RARa ligand | 88.5 | 13.6 | RARa ligand | 1.4 | 0.21 |
| RARb | 123.5 | 5.9 | RARb | 1.9 | 0.09 |
| RARb ligand | 134.7 | 2.1 | RARb ligand | 2.1 | 0.03 |
| RARg | 104.5 | 5.2 | RARg | 1.6 | 0.08 |
| RARg ligand | 110.4 | 2.2 | RARg ligand | 1.7 | 0.03 |
| PPARa | 63.7 | 3.9 | PPARa | 1.0 | 0.06 |
| PPARa ligand | 64.5 | 2.7 | PPARa ligand | 1.0 | 0.04 |
| PPARg | 74.5 | 10.7 | PPARg | 1.2 | 0.17 |
| PPARg ligand | 107.0 | 5.8 | PPARg ligand | 1.7 | 0.09 |
| PPARd | 59.6 | 8.8 | PPARd | 0.9 | 0.14 |
| PPARd ligand | 67.3 | 2.5 | PPARd ligand | 1.1 | 0.04 |
| LXRa | 60.1 | 3.7 | LXRa | 0.9 | 0.06 |
| LXRa ligand | 85.5 | 7.1 | LXRa ligand | 1.3 | 0.11 |
| LXRb | 54.6 | 1.2 | LXRb | 0.9 | 0.02 |
| LXRb ligand | 51.3 | 2.7 | LXRb ligand | 0.8 | 0.04 |
| FXR | 36.5 | 4.3 | FXR | 0.6 | 0.07 |
| FXR ligand | 76.3 | 5.2 | FXR ligand | 1.2 | 0.08 |
| FXRb | 68.8 | 2.1 | FXRb | 1.1 | 0.03 |
| FXRb ligand | 77.2 | 2.0 | FXRb ligand | 1.2 | 0.03 |
| VDR | 52.8 | 3.0 | VDR | 0.8 | 0.05 |
| VDR ligand | 50.3 | 5.0 | VDR ligand | 0.8 | 0.08 |
| PXR | 50.6 | 4.4 | PXR | 0.8 | 0.07 |
| PXR ligand | 49.9 | 4.5 | PXR ligand | 0.8 | 0.07 |
| CAR | 51.2 | 2.1 | CAR | 0.8 | 0.03 |
| CAR ligand | 46.6 | 3.4 | CAR ligand | 0.7 | 0.05 |
| control | 57.7 | 2.0 | control | 0.9 | 0.03 |
| RXRa | 51.2 | 1.3 | RXRa | 0.8 | 0.02 |
| RXRa ligand | 97.1 | 2.3 | RXRa ligand | 1.5 | 0.04 |
| RXRb | 54.3 | 2.0 | RXRb | 0.9 | 0.03 |
| RXRb ligand | 69.0 | 15.4 | RXRb ligand | 1.1 | 0.24 |
| RXRg | 67.6 | 4.7 | RXRg | 1.1 | 0.07 |
| RXRg ligand | 125.2 | 3.5 | RXRg ligand | 2.0 | 0.06 |
| RVRa | 75.0 | 5.6 | RVRa | 1.2 | 0.09 |
| RVRb | 80.9 | 4.5 | RVRb | 1.3 | 0.07 |
| RORa | 47.3 | 3.6 | RORa | 0.7 | 0.06 |
| RORb | 73.9 | 3.0 | RORb | 1.2 | 0.05 |
| RORg | 86.5 | 1.3 | RORg | 1.4 | 0.02 |
| HNF4a | 65.5 | 0.9 | HNF4a | 1.0 | 0.01 |
| HNF4g | 67.2 | 4.7 | HNF4g | 1.1 | 0.07 |
| TR2 | 83.1 | 3.8 | TR2 | 1.3 | 0.06 |
| TR4 | 213.9 | 26.1 | TR4 | 3.4 | 0.41 |
| TLX | 31.3 | 2.0 | TLX | 0.5 | 0.03 |
| PNR | 37.1 | 1.6 | PNR | 0.6 | 0.02 |
| Era | 80.8 | 3.9 | Era | 1.3 | 0.06 |
| Era ligand | 98.3 | 13.0 | Era ligand | 1.6 | 0.20 |
| Erb | 50.6 | 2.3 | Erb | 0.8 | 0.04 |
| Erb ligand | 51.6 | 5.3 | Erb ligand | 0.8 | 0.08 |
| ERR1 | 69.1 | 5.9 | ERR1 | 1.1 | 0.09 |
| ERR2 | 164.8 | 10.8 | ERR2 | 2.6 | 0.17 |
| ERR3 | 129.6 | 12.6 | ERR3 | 2.0 | 0.20 |
| CTF1 | 44.8 | 7.5 | CTF1 | 0.7 | 0.12 |
| CTF2 | 60.9 | 4.4 | CTF2 | 1.0 | 0.07 |
| CTF3 | 35.6 | 4.4 | CTF3 | 0.6 | 0.07 |
| SF-1 | 151.2 | 11.6 | SF-1 | 2.4 | 0.18 |
| control | 67.9 | 4.7 | control | 1.1 | 0.07 |
| GR | 26.4 | 1.4 | GR | 0.4 | 0.02 |
| GR ligand | 32.4 | 2.5 | GR ligand | 0.5 | 0.04 |
| hMR | 37.1 | 2.8 | hMR | 0.6 | 0.04 |
| hMR ligand | 30.6 | 1.7 | hMR ligand | 0.5 | 0.03 |
| PR | 70.4 | 3.4 | PR | 1.1 | 0.05 |
| PR ligand | 86.7 | 6.5 | PR ligand | 1.4 | 0.10 |
| AR | 57.5 | 2.5 | AR | 0.9 | 0.04 |
| AR ligand | 62.5 | 6.5 | AR ligand | 1.0 | 0.10 |
| NR4a1 | 152.5 | 53.5 | NR4a1 | 2.4 | 0.84 |
| NR4a2 | 51.9 | 5.9 | NR4a2 | 0.8 | 0.09 |
| NR4a3 | 56.1 | 4.3 | NR4a3 | 0.9 | 0.07 |
| LRH-1 | 120.8 | 8.2 | LRH-1 | 1.9 | 0.13 |
| GCNF | 50.5 | 1.7 | GCNF | 0.8 | 0.03 |
| DAX-1 | 61.3 | 2.6 | DAX-1 | 1.0 | 0.04 |
| SHP | 54.0 | 1.3 | SHP | 0.9 | 0.02 |
| control | 63.3 | 8.0 | control | 1.0 | 0.13 |

TABLE 18
Results for assay for listed components for Per1.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 59.5 | 5.6 | TRa1 | 0.4 | 0.04 |
| TRa1 ligand | 43.5 | 17.6 | TRa1 ligand | 0.3 | 0.12 |
| TRa2 | 71.7 | 17.7 | TRa2 | 0.5 | 0.12 |
| TRa2 ligand | 57.4 | 14.9 | TRa2 ligand | 0.4 | 0.10 |
| TRb1 | 113.7 | 5.6 | TRb1 | 0.8 | 0.04 |
| TRb1 ligand | 50.0 | 3.5 | TRb1 ligand | 0.3 | 0.02 |
| TRb2 | 104.7 | 11.3 | TRb2 | 0.7 | 0.08 |
| TRb2 ligand | 59.2 | 9.0 | TRb2 ligand | 0.4 | 0.06 |
| RARa | 85.4 | 31.6 | RARa | 0.6 | 0.22 |
| RARa ligand | 63.5 | 8.3 | RARa ligand | 0.4 | 0.06 |
| RARb | 89.3 | 12.2 | RARb | 0.6 | 0.08 |
| RARb ligand | 93.0 | 2.6 | RARb ligand | 0.6 | 0.02 |
| RARg | 120.3 | 19.6 | RARg | 0.8 | 0.14 |
| RARg ligand | 87.5 | 8.4 | RARg ligand | 0.6 | 0.06 |
| PPARa | 180.7 | 38.7 | PPARa | 1.3 | 0.27 |
| PPARa ligand | 189.7 | 20.8 | PPARa ligand | 1.3 | 0.14 |
| PPARg | 154.5 | 70.0 | PPARg | 1.1 | 0.49 |
| PPARg ligand | 240.1 | 14.8 | PPARg ligand | 1.7 | 0.10 |
| PPARd | 187.6 | 52.7 | PPARd | 1.3 | 0.37 |
| PPARd ligand | 166.1 | 29.4 | PPARd ligand | 1.2 | 0.20 |
| LXRa | 100.6 | 5.3 | LXRa | 0.7 | 0.04 |
| LXRa ligand | 96.3 | 6.0 | LXRa ligand | 0.7 | 0.04 |
| LXRb | 117.6 | 46.5 | LXRb | 0.8 | 0.32 |
| LXRb ligand | 85.6 | 5.0 | LXRb ligand | 0.6 | 0.03 |
| FXR | 98.0 | 29.5 | FXR | 0.7 | 0.20 |
| FXR ligand | 132.4 | 3.5 | FXR ligand | 0.9 | 0.02 |
| FXRb | 140.6 | 30.7 | FXRb | 1.0 | 0.21 |
| FXRb ligand | 122.7 | 21.2 | FXRb ligand | 0.9 | 0.15 |
| VDR | 97.1 | 15.6 | VDR | 0.7 | 0.11 |
| VDR ligand | 49.5 | 2.2 | VDR ligand | 0.3 | 0.02 |
| PXR | 186.7 | 24.4 | PXR | 1.3 | 0.17 |
| PXR ligand | 85.2 | 0.4 | PXR ligand | 0.6 | 0.00 |
| CAR | 86.6 | 11.8 | CAR | 0.6 | 0.08 |
| CAR ligand | 75.5 | 3.6 | CAR ligand | 0.5 | 0.02 |
| control | 130.4 | 9.6 | control | 0.9 | 0.07 |
| RXRa | 75.8 | 6.1 | RXRa | 0.5 | 0.04 |
| RXRa ligand | 97.1 | 16.6 | RXRa ligand | 0.7 | 0.12 |
| RXRb | 50.5 | 5.2 | RXRb | 0.4 | 0.04 |
| RXRb ligand | 83.0 | 21.6 | RXRb ligand | 0.6 | 0.15 |
| RXRg | 94.5 | 16.9 | RXRg | 0.7 | 0.12 |
| RXRg ligand | 125.4 | 17.9 | RXRg ligand | 0.9 | 0.12 |
| RVRa | 98.6 | 4.7 | RVRa | 0.7 | 0.03 |
| RVRb | 118.3 | 8.6 | RVRb | 0.8 | 0.06 |
| RORa | 107.9 | 19.8 | RORa | 0.7 | 0.14 |
| RORb | 112.0 | 11.3 | RORb | 0.8 | 0.08 |
| RORg | 176.3 | 25.1 | RORg | 1.2 | 0.17 |
| HNF4a | 93.1 | 5.5 | HNF4a | 0.6 | 0.04 |
| HNF4g | 116.1 | 9.9 | HNF4g | 0.8 | 0.07 |
| TR2 | 103.1 | 12.0 | TR2 | 0.7 | 0.08 |
| TR4 | 225.6 | 22.5 | TR4 | 1.6 | 0.16 |
| TLX | 217.6 | 22.9 | TLX | 1.5 | 0.16 |
| PNR | 93.4 | 21.3 | PNR | 0.6 | 0.15 |
| Era | 177.4 | 19.6 | Era | 1.2 | 0.14 |
| Era ligand | 279.7 | 63.3 | Era ligand | 1.9 | 0.44 |
| Erb | 79.1 | 3.5 | Erb | 0.5 | 0.02 |
| Erb ligand | 102.7 | 5.4 | Erb ligand | 0.7 | 0.04 |
| ERR1 | 197.1 | 11.3 | ERR1 | 1.4 | 0.08 |
| ERR2 | 328.2 | 43.5 | ERR2 | 2.3 | 0.30 |
| ERR3 | 226.8 | 53.1 | ERR3 | 1.6 | 0.37 |
| CTF1 | 283.8 | 22.6 | CTF1 | 2.0 | 0.16 |
| CTF2 | 346.6 | 16.3 | CTF2 | 2.4 | 0.11 |
| CTF3 | 159.0 | 10.6 | CTF3 | 1.1 | 0.07 |
| SF-1 | 536.5 | 81.4 | SF-1 | 3.7 | 0.57 |
| control | 138.8 | 7.3 | control | 1.0 | 0.05 |
| GR | 384.1 | 53.4 | GR | 2.7 | 0.37 |
| GR ligand | 186.9 | 7.1 | GR ligand | 1.3 | 0.05 |
| hMR | 351.9 | 20.5 | hMR | 2.4 | 0.14 |
| hMR ligand | 411.5 | 24.4 | hMR ligand | 2.9 | 0.17 |
| PR | 207.4 | 2.1 | PR | 1.4 | 0.01 |
| PR ligand | 209.5 | 12.5 | PR ligand | 1.5 | 0.09 |
| AR | 123.5 | 11.0 | AR | 0.9 | 0.08 |
| AR ligand | 139.5 | 12.5 | AR ligand | 1.0 | 0.09 |
| NR4a1 | 503.5 | 19.3 | NR4a1 | 3.5 | 0.13 |
| NR4a2 | 155.3 | 20.4 | NR4a2 | 1.1 | 0.14 |
| NR4a3 | 139.6 | 14.4 | NR4a3 | 1.0 | 0.10 |
| LRH-1 | 485.4 | 37.7 | LRH-1 | 3.4 | 0.26 |
| GCNF | 151.9 | 21.1 | GCNF | 1.1 | 0.15 |
| DAX-1 | 153.4 | 12.2 | DAX-1 | 1.1 | 0.09 |
| SHP | 130.3 | 7.1 | SHP | 0.9 | 0.05 |
| control | 144.0 | 2.5 | control | 1.0 | 0.02 |

TABLE 19
Results for assay for listed components for mUCP1.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 1.2 | 0.7 | TRa1 | 0.3 | 0.16 |
| TRa1 ligand | 1.3 | 0.2 | TRa1 ligand | 0.3 | 0.04 |
| TRa2 | 2.9 | 0.5 | TRa2 | 0.7 | 0.12 |
| TRa2 ligand | 2.8 | 0.4 | TRa2 ligand | 0.6 | 0.08 |
| TRb1 | 2.5 | 0.5 | TRb1 | 0.6 | 0.12 |
| TRb1 ligand | 1.8 | 0.4 | TRb1 ligand | 0.4 | 0.08 |
| TRb2 | 3.2 | 0.2 | TRb2 | 0.7 | 0.06 |
| TRb2 ligand | 2.5 | 0.4 | TRb2 ligand | 0.6 | 0.08 |
| RARa | 2.8 | 0.1 | RARa | 0.6 | 0.03 |
| RARa ligand | 13.9 | 0.7 | RARa ligand | 3.1 | 0.15 |
| RARb | 4.4 | 0.4 | RARb | 1.0 | 0.09 |
| RARb ligand | 10.2 | 1.1 | RARb ligand | 2.3 | 0.25 |
| RARg | 5.0 | 0.6 | RARg | 1.1 | 0.14 |
| RARg ligand | 11.7 | 2.4 | RARg ligand | 2.6 | 0.54 |
| PPARa | 2.6 | 0.2 | PPARa | 0.6 | 0.05 |
| PPARa ligand | 4.5 | 0.2 | PPARa ligand | 1.0 | 0.05 |
| PPARg | 2.9 | 0.9 | PPARg | 0.7 | 0.21 |
| PPARg ligand | 5.6 | 0.6 | PPARg ligand | 1.3 | 0.15 |
| PPARd | 3.5 | 0.7 | PPARd | 0.8 | 0.16 |
| PPARd ligand | 3.9 | 0.2 | PPARd ligand | 0.9 | 0.05 |
| LXRa | 3.1 | 0.2 | LXRa | 0.7 | 0.05 |
| LXRa ligand | 4.9 | 0.4 | LXRa ligand | 1.1 | 0.10 |
| LXRb | 17.2 | 0.5 | LXRb | 3.9 | 0.11 |
| LXRb ligand | 16.6 | 0.1 | LXRb ligand | 3.7 | 0.02 |
| FXR | 4.2 | 1.6 | FXR | 1.0 | 0.36 |
| FXR ligand | 3.9 | 0.3 | FXR ligand | 0.9 | 0.08 |
| FXRb | 4.2 | 0.5 | FXRb | 1.0 | 0.11 |
| FXRb ligand | 3.8 | 0.2 | FXRb ligand | 0.9 | 0.05 |
| VDR | 2.8 | 0.2 | VDR | 0.6 | 0.04 |
| VDR ligand | 2.1 | 0.1 | VDR ligand | 0.5 | 0.01 |
| PXR | 2.1 | 0.2 | PXR | 0.5 | 0.04 |
| PXR ligand | 3.0 | 0.2 | PXR ligand | 0.7 | 0.04 |
| CAR | 3.3 | 0.6 | CAR | 0.7 | 0.12 |
| CAR ligand | 3.9 | 0.2 | CAR ligand | 0.9 | 0.03 |
| control | 3.6 | 0.2 | control | 0.8 | 0.04 |
| RXRa | 2.9 | 0.4 | RXRa | 0.7 | 0.09 |
| RXRa ligand | 10.9 | 4.3 | RXRa ligand | 2.4 | 0.97 |
| RXRb | 0.9 | 0.2 | RXRb | 0.2 | 0.05 |
| RXRb ligand | 1.5 | 0.3 | RXRb ligand | 0.3 | 0.06 |
| RXRg | 2.5 | 0.2 | RXRg | 0.6 | 0.04 |
| RXRg ligand | 6.7 | 2.1 | RXRg ligand | 1.5 | 0.46 |
| RVRa | 3.8 | 0.3 | RVRa | 0.8 | 0.06 |
| RVRb | 4.3 | 0.3 | RVRb | 1.0 | 0.06 |
| RORa | 1.7 | 0.1 | RORa | 0.4 | 0.01 |
| RORb | 3.8 | 0.5 | RORb | 0.9 | 0.12 |
| RORg | 2.8 | 0.5 | RORg | 0.6 | 0.11 |
| HNF4a | 2.8 | 0.2 | HNF4a | 0.6 | 0.06 |
| HNF4g | 3.5 | 0.4 | HNF4g | 0.8 | 0.08 |
| TR2 | 8.1 | 1.5 | TR2 | 1.8 | 0.35 |
| TR4 | 26.4 | 1.2 | TR4 | 5.9 | 0.26 |
| TLX | 2.8 | 0.3 | TLX | 0.6 | 0.07 |
| PNR | 1.7 | 0.1 | PNR | 0.4 | 0.02 |
| Era | 5.7 | 0.7 | Era | 1.3 | 0.16 |
| Era ligand | 7.5 | 0.2 | Era ligand | 1.7 | 0.05 |
| Erb | 3.3 | 0.1 | Erb | 0.8 | 0.02 |
| Erb ligand | 2.8 | 0.3 | Erb ligand | 0.6 | 0.07 |
| ERR1 | 3.9 | 0.8 | ERR1 | 0.9 | 0.17 |
| ERR2 | 13.1 | 2.5 | ERR2 | 3.0 | 0.57 |
| ERR3 | 26.5 | 2.5 | ERR3 | 6.0 | 0.56 |
| CTF1 | 1.8 | 0.2 | CTF1 | 0.4 | 0.03 |
| CTF2 | 1.9 | 0.3 | CTF2 | 0.4 | 0.06 |
| CTF3 | 1.9 | 0.1 | CTF3 | 0.4 | 0.03 |
| SF-1 | 11.3 | 0.8 | SF-1 | 2.5 | 0.17 |
| control | 3.5 | 0.2 | control | 0.8 | 0.03 |
| GR | 1.9 | 0.1 | GR | 0.4 | 0.02 |
| GR ligand | 1.7 | 0.3 | GR ligand | 0.4 | 0.06 |
| hMR | 2.1 | 0.1 | hMR | 0.5 | 0.03 |
| hMR ligand | 1.7 | 0.1 | hMR ligand | 0.4 | 0.02 |
| PR | 5.4 | 0.2 | PR | 1.2 | 0.04 |
| PR ligand | 9.8 | 0.1 | PR ligand | 2.2 | 0.02 |
| AR | 3.3 | 0.2 | AR | 0.7 | 0.05 |
| AR ligand | 7.1 | 1.1 | AR ligand | 1.6 | 0.25 |
| NR4a1 | 7.6 | 0.9 | NR4a1 | 1.7 | 0.21 |
| NR4a2 | 4.4 | 0.6 | NR4a2 | 1.0 | 0.14 |
| NR4a3 | 3.8 | 0.3 | NR4a3 | 0.9 | 0.07 |
| LRH-1 | 8.5 | 0.8 | LRH-1 | 1.9 | 0.18 |
| GCNF | 3.8 | 0.5 | GCNF | 0.8 | 0.12 |
| DAX-1 | 6.2 | 1.0 | DAX-1 | 1.4 | 0.22 |
| SHP | 4.1 | 0.2 | SHP | 0.9 | 0.05 |
| control | 4.4 | 0.2 | control | 1.0 | 0.04 |

TABLE 20
Results for assay for listed components for mUCP2.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 102.2 | 15.5 | TRa1 | 0.9 | 0.14 |
| TRa1 ligand | 136.1 | 33.5 | TRa1 ligand | 1.2 | 0.31 |
| TRa2 | 165.2 | 12.2 | TRa2 | 1.5 | 0.11 |
| TRa2 ligand | 139.2 | 18.5 | TRa2 ligand | 1.3 | 0.17 |
| TRb1 | 122.7 | 106.2 | TRb1 | 1.1 | 0.97 |
| TRb1 ligand | 143.6 | 15.0 | TRb1 ligand | 1.3 | 0.14 |
| TRb2 | 167.6 | 9.0 | TRb2 | 1.5 | 0.08 |
| TRb2 ligand | 162.3 | 5.5 | TRb2 ligand | 1.5 | 0.05 |
| RARa | 232.0 | 4.9 | RARa | 2.1 | 0.04 |
| RARa ligand | 219.2 | 27.7 | RARa ligand | 2.0 | 0.25 |
| RARb | 277.3 | 23.0 | RARb | 2.5 | 0.21 |
| RARb ligand | 328.6 | 16.2 | RARb ligand | 3.0 | 0.15 |
| RARg | 242.5 | 30.6 | RARg | 2.2 | 0.28 |
| RARg ligand | 295.0 | 10.4 | RARg ligand | 2.7 | 0.09 |
| PPARa | 167.3 | 19.3 | PPARa | 1.5 | 0.18 |
| PPARa ligand | 202.5 | 10.9 | PPARa ligand | 1.8 | 0.10 |
| PPARg | 171.6 | 47.2 | PPARg | 1.6 | 0.43 |
| PPARg ligand | 248.4 | 67.6 | PPARg ligand | 2.3 | 0.61 |
| PPARd | 172.7 | 35.6 | PPARd | 1.6 | 0.32 |
| PPARd ligand | 168.4 | 40.3 | PPARd ligand | 1.5 | 0.37 |
| LXRa | 262.7 | 11.9 | LXRa | 2.4 | 0.11 |
| LXRa ligand | 339.0 | 57.1 | LXRa ligand | 3.1 | 0.52 |
| LXRb | 170.7 | 10.7 | LXRb | 1.6 | 0.10 |
| LXRb ligand | 190.3 | 42.2 | LXRb ligand | 1.7 | 0.38 |
| FXR | 111.6 | 11.6 | FXR | 1.0 | 0.11 |
| FXR ligand | 196.9 | 17.9 | FXR ligand | 1.8 | 0.16 |
| FXRb | 166.8 | 4.8 | FXRb | 1.5 | 0.04 |
| FXRb ligand | 152.1 | 12.7 | FXRb ligand | 1.4 | 0.12 |
| VDR | 136.2 | 6.4 | VDR | 1.2 | 0.06 |
| VDR ligand | 127.6 | 11.2 | VDR ligand | 1.2 | 0.10 |
| PXR | 119.1 | 4.2 | PXR | 1.1 | 0.04 |
| PXR ligand | 136.2 | 5.7 | PXR ligand | 1.2 | 0.05 |
| CAR | 151.6 | 47.3 | CAR | 1.4 | 0.43 |
| CAR ligand | 172.6 | 54.6 | CAR ligand | 1.6 | 0.50 |
| control | 141.5 | 18.3 | control | 1.3 | 0.17 |
| RXRa | 137.8 | 39.8 | RXRa | 1.3 | 0.36 |
| RXRa ligand | 321.8 | 81.6 | RXRa ligand | 2.9 | 0.74 |
| RXRb | 87.7 | 22.7 | RXRb | 0.8 | 0.21 |
| RXRb ligand | 151.1 | 7.0 | RXRb ligand | 1.4 | 0.06 |
| RXRg | 144.4 | 33.3 | RXRg | 1.3 | 0.30 |
| RXRg ligand | 247.5 | 41.8 | RXRg ligand | 2.3 | 0.38 |
| RVRa | 143.0 | 23.8 | RVRa | 1.3 | 0.22 |
| RVRb | 174.4 | 15.3 | RVRb | 1.6 | 0.14 |
| RORa | 104.0 | 25.5 | RORa | 0.9 | 0.23 |
| RORb | 176.2 | 14.1 | RORb | 1.6 | 0.13 |
| RORg | 169.5 | 25.7 | RORg | 1.5 | 0.23 |
| HNF4a | 136.4 | 7.3 | HNF4a | 1.2 | 0.07 |
| HNF4g | 114.8 | 29.0 | HNF4g | 1.0 | 0.26 |
| TR2 | 208.9 | 85.0 | TR2 | 1.9 | 0.77 |
| TR4 | 199.0 | 85.3 | TR4 | 1.8 | 0.78 |
| TLX | 111.9 | 8.4 | TLX | 1.0 | 0.08 |
| PNR | 104.4 | 15.1 | PNR | 1.0 | 0.14 |
| Era | 208.2 | 13.9 | Era | 1.9 | 0.13 |
| Era ligand | 324.8 | 19.3 | Era ligand | 3.0 | 0.18 |
| Erb | 114.4 | 10.1 | Erb | 1.0 | 0.09 |
| Erb ligand | 121.5 | 17.0 | Erb ligand | 1.1 | 0.15 |
| ERR1 | 121.6 | 3.3 | ERR1 | 1.1 | 0.03 |
| ERR2 | 185.1 | 44.5 | ERR2 | 1.7 | 0.40 |
| ERR3 | 193.4 | 9.2 | ERR3 | 1.8 | 0.08 |
| CTF1 | 67.1 | 19.4 | CTF1 | 0.6 | 0.18 |
| CTF2 | 90.4 | 9.2 | CTF2 | 0.8 | 0.08 |
| CTF3 | 54.4 | 12.0 | CTF3 | 0.5 | 0.11 |
| SF-1 | 449.3 | 9.4 | SF-1 | 4.1 | 0.09 |
| control | 93.9 | 30.0 | control | 0.9 | 0.27 |
| GR | 59.4 | 51.4 | GR | 0.5 | 0.47 |
| GR ligand | 175.3 | 82.5 | GR ligand | 1.6 | 0.75 |
| hMR | 58.8 | 18.3 | hMR | 0.5 | 0.17 |
| hMR ligand | 92.0 | 25.3 | hMR ligand | 0.8 | 0.23 |
| PR | 178.8 | 22.0 | PR | 1.6 | 0.20 |
| PR ligand | 338.5 | 12.4 | PR ligand | 3.1 | 0.11 |
| AR | 196.6 | 27.3 | AR | 1.8 | 0.25 |
| AR ligand | 161.2 | 53.8 | AR ligand | 1.5 | 0.49 |
| NR4a1 | 265.6 | 51.9 | NR4a1 | 2.4 | 0.47 |
| NR4a2 | 129.8 | 9.2 | NR4a2 | 1.2 | 0.08 |
| NR4a3 | 150.1 | 6.6 | NR4a3 | 1.4 | 0.06 |
| LRH-1 | 351.1 | 69.3 | LRH-1 | 3.2 | 0.63 |
| GCNF | 139.9 | 7.3 | GCNF | 1.3 | 0.07 |
| DAX-1 | 158.6 | 27.7 | DAX-1 | 1.4 | 0.25 |
| SHP | 164.1 | 8.7 | SHP | 1.5 | 0.08 |
| control | 109.9 | 10.0 | control | 1.0 | 0.09 |

TABLE 21
Results for assay for listed components for mUCP3.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 0.5 | 0.2 | TRa1 | 0.8 | 0.28 |
| TRa1 ligand | 0.6 | 0.0 | TRa1 ligand | 0.9 | 0.02 |
| TRa2 | 0.8 | 0.2 | TRa2 | 1.2 | 0.26 |
| TRa2 ligand | 0.9 | 0.1 | TRa2 ligand | 1.4 | 0.13 |
| TRb1 | 0.9 | 0.1 | TRb1 | 1.4 | 0.09 |
| TRb1 ligand | 1.0 | 0.1 | TRb1 ligand | 1.5 | 0.19 |
| TRb2 | 1.3 | 0.1 | TRb2 | 1.9 | 0.15 |
| TRb2 ligand | 1.3 | 0.2 | TRb2 ligand | 1.9 | 0.25 |
| RARa | 1.2 | 0.0 | RARa | 1.8 | 0.03 |
| RARa ligand | 1.1 | 0.1 | RARa ligand | 1.6 | 0.08 |
| RARb | 1.4 | 0.2 | RARb | 2.1 | 0.23 |
| RARb ligand | 1.5 | 0.1 | RARb ligand | 2.2 | 0.18 |
| RARg | 1.3 | 0.1 | RARg | 2.0 | 0.14 |
| RARg ligand | 1.3 | 0.1 | RARg ligand | 2.0 | 0.10 |
| PPARa | 1.5 | 0.3 | PPARa | 2.1 | 0.38 |
| PPARa ligand | 2.5 | 0.1 | PPARa ligand | 3.6 | 0.08 |
| PPARg | 1.2 | 0.7 | PPARg | 1.8 | 0.98 |
| PPARg ligand | 3.1 | 0.1 | PPARg ligand | 4.7 | 0.09 |
| PPARd | 1.1 | 0.1 | PPARd | 1.7 | 0.10 |
| PPARd ligand | 1.4 | 0.2 | PPARd ligand | 2.0 | 0.32 |
| LXRa | 1.1 | 0.1 | LXRa | 1.6 | 0.17 |
| LXRa ligand | 1.3 | 0.1 | LXRa ligand | 2.0 | 0.17 |
| LXRb | 1.2 | 0.1 | LXRb | 1.7 | 0.09 |
| LXRb ligand | 0.8 | 0.1 | LXRb ligand | 1.2 | 0.12 |
| FXR | 0.9 | 0.0 | FXR | 1.3 | 0.04 |
| FXR ligand | 1.4 | 0.1 | FXR ligand | 2.1 | 0.17 |
| FXRb | 1.3 | 0.0 | FXRb | 1.9 | 0.04 |
| FXRb ligand | 1.1 | 0.1 | FXRb ligand | 1.7 | 0.16 |
| VDR | 1.0 | 0.2 | VDR | 1.5 | 0.34 |
| VDR ligand | 0.6 | 0.0 | VDR ligand | 0.9 | 0.07 |
| PXR | 0.9 | 0.0 | PXR | 1.3 | 0.03 |
| PXR ligand | 0.8 | 0.1 | PXR ligand | 1.2 | 0.13 |
| CAR | 0.6 | 0.3 | CAR | 0.9 | 0.45 |
| CAR ligand | 0,6 | 0.3 | CAR ligand | 0.9 | 0.45 |
| control | 0.8 | 0.0 | control | 1.2 | 0.03 |
| RXRa | 0.9 | 0.1 | RXRa | 1.3 | 0.13 |
| RXRa ligand | 0.3 | 0.2 | RXRa ligand | 0.5 | 0.33 |
| RXRb | 0.6 | 0.1 | RXRb | 0.8 | 0.16 |
| RXRb ligand | 0.8 | 0.0 | RXRb ligand | 1.2 | 0.00 |
| RXRg | 1.0 | 0.1 | RXRg | 1.4 | 0.18 |
| RXRg ligand | 1.3 | 0.2 | RXRg ligand | 2.0 | 0.31 |
| RVRa | 0.8 | 0.2 | RVRa | 1.2 | 0.25 |
| RVRb | 1.3 | 0.3 | RVRb | 1.9 | 0.37 |
| RORa | 1.7 | 0.6 | RORa | 2.6 | 0.95 |
| RORb | 0.9 | 0.1 | RORb | 1.3 | 0.11 |
| RORg | 1.6 | 0.6 | RORg | 2.4 | 0.87 |
| HNF4a | 0.7 | 0.1 | HNF4a | 1.1 | 0.18 |
| HNF4g | 0.6 | 0.2 | HNF4g | 0.8 | 0.24 |
| TR2 | 1.4 | 0.2 | TR2 | 2.0 | 0.24 |
| TR4 | 2.2 | 0.3 | TR4 | 3.2 | 0.44 |
| TLX | 0.8 | 0.0 | TLX | 1.1 | 0.01 |
| PNR | 0.5 | 0.1 | PNR | 0.8 | 0.09 |
| Era | 1.1 | 0.0 | Era | 1.7 | 0.02 |
| Era ligand | 2.0 | 0.1 | Era ligand | 2.9 | 0.18 |
| Erb | 0.9 | 0.1 | Erb | 1.3 | 0.17 |
| Erb ligand | 0.8 | 0.1 | Erb ligand | 1.2 | 0.16 |
| ERR1 | 1.0 | 0.1 | ERR1 | 1.5 | 0.11 |
| ERR2 | 2.2 | 0.4 | ERR2 | 3.3 | 0.56 |
| ERR3 | 2.1 | 0.1 | ERR3 | 3.1 | 0.20 |
| CTF1 | 0.6 | 0.1 | CTF1 | 0.9 | 0.08 |
| CTF2 | 0.6 | 0.0 | CTF2 | 0.9 | 0.04 |
| CTF3 | 0.6 | 0.0 | CTF3 | 0.8 | 0.03 |
| SF-1 | 3.7 | 0.3 | SF-1 | 5.5 | 0.44 |
| control | 0.6 | 0.1 | control | 0.9 | 0.08 |
| GR | 0.59 | 0.16 | GR | 0.9 | 0.23 |
| GR ligand | 6.16 | 0.99 | GR ligand | 9.1 | 1.47 |
| hMR | 0.50 | 0.05 | hMR | 0.7 | 0.08 |
| hMR ligand | 0.36 | 0.03 | hMR ligand | 0.5 | 0.05 |
| PR | 0.86 | 0.04 | PR | 1.3 | 0.07 |
| PR ligand | 6.53 | 0.36 | PR ligand | 9.7 | 0.54 |
| AR | 1.69 | 0.20 | AR | 2.5 | 0.29 |
| AR ligand | 3.35 | 0.50 | AR ligand | 5.0 | 0.74 |
| NR4a1 | 1.40 | 0.14 | NR4a1 | 2.1 | 0.20 |
| NR4a2 | 0.68 | 0.09 | NR4a2 | 1.0 | 0.13 |
| NR4a3 | 0.81 | 0.06 | NR4a3 | 1.2 | 0.09 |
| LRH-1 | 2.87 | 0.11 | LRH-1 | 4.2 | 0.16 |
| GCNF | 0.66 | 0.03 | GCNF | 1.0 | 0.05 |
| DAX-1 | 0.89 | 0.12 | DAX-1 | 1.3 | 0.18 |
| SHP | 0.77 | 0.06 | SHP | 1.1 | 0.08 |
| control | 0.68 | 0.07 | control | 1.0 | 0.11 |

TABLE 22
Results for assay for listed components for MCP-1.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 151.1 | 14.2 | TRa1 | 1.4 | 0.13 |
| TRa1 ligand | 160.6 | 17.3 | TRa1 ligand | 1.5 | 0.16 |
| TRa2 | 166.7 | 3.5 | TRa2 | 1.6 | 0.03 |
| TRa2 ligand | 143.4 | 15.3 | TRa2 ligand | 1.3 | 0.14 |
| TRb1 | 188.1 | 3.3 | TRb1 | 1.8 | 0.03 |
| TRb1 ligand | 182.0 | 13.4 | TRb1 ligand | 1.7 | 0.13 |
| TRb2 | 239.3 | 10.0 | TRb2 | 2.2 | 0.09 |
| TRb2 ligand | 175.0 | 4.9 | TRb2 ligand | 1.6 | 0.05 |
| RARa | 182.3 | 8.3 | RARa | 1.7 | 0.08 |
| RARa ligand | 70.9 | 11.6 | RARa ligand | 0.7 | 0.11 |
| RARb | 197.0 | 24.0 | RARb | 1.8 | 0.22 |
| RARb ligand | 89.7 | 13.5 | RARb ligand | 0.8 | 0.13 |
| RARg | 167.8 | 7.0 | RARg | 1.6 | 0.07 |
| RARg ligand | 77.0 | 11.4 | RARg ligand | 0.7 | 0.11 |
| PPARa | 121.8 | 14.1 | PPARa | 1.1 | 0.13 |
| PPARa ligand | 113.5 | 7.6 | PPARa ligand | 1.1 | 0.07 |
| PPARg | 146.1 | 2.3 | PPARg | 1.4 | 0.02 |
| PPARg ligand | 167.7 | 19.4 | PPARg ligand | 1.6 | 0.18 |
| PPARd | 190.4 | 8.7 | PPARd | 1.8 | 0.08 |
| PPARd ligand | 143.9 | 11.6 | PPARd ligand | 1.3 | 0.11 |
| LXRa | 97.3 | 8.4 | LXRa | 0.9 | 0.08 |
| LXRa ligand | 89.8 | 7.5 | LXRa ligand | 0.8 | 0.07 |
| LXRb | 198.9 | 3.6 | LXRb | 1.9 | 0.03 |
| LXRb ligand | 188.8 | 20.4 | LXRb ligand | 1.8 | 0.19 |
| FXR | 124.1 | 4.5 | FXR | 1.2 | 0.04 |
| FXR ligand | 117.2 | 13.8 | FXR ligand | 1.1 | 0.13 |
| FXRb | 126.2 | 13.2 | FXRb | 1.2 | 0.12 |
| FXRb ligand | 129.7 | 19.7 | FXRb ligand | 1.2 | 0.18 |
| VDR | 215.8 | 18.7 | VDR | 2.0 | 0.17 |
| VDR ligand | 66.3 | 7.8 | VDR ligand | 0.6 | 0.07 |
| PXR | 209.7 | 4.8 | PXR | 2.0 | 0.05 |
| PXR ligand | 53.8 | 5.4 | PXR ligand | 0.5 | 0.05 |
| CAR | 115.7 | 11.0 | CAR | 1.1 | 0.10 |
| CAR ligand | 66.3 | 3.2 | CAR ligand | 0.6 | 0.03 |
| control | 165.3 | 4.9 | control | 1.5 | 0.05 |
| RXRa | 170.8 | 12.6 | RXRa | 1.6 | 0.12 |
| RXRa ligand | 102.7 | 4.0 | RXRa ligand | 1.0 | 0.04 |
| RXRb | | | RXRb | 0.0 | 0.00 |
| RXRb ligand | | | RXRb ligand | 0.0 | 0.00 |
| RXRg | 212.4 | 13.3 | RXRg | 2.0 | 0.12 |
| RXRg ligand | 153.4 | 9.6 | RXRg ligand | 1.4 | 0.09 |
| RVRa | 149.4 | 2.0 | RVRa | 1.4 | 0.02 |
| RVRb | 170.4 | 6.0 | RVRb | 1.6 | 0.06 |
| RORa | 150.7 | 35.9 | RORa | 1.4 | 0.33 |
| RORb | 176.3 | 9.2 | RORb | 1.6 | 0.09 |
| RORg | 301.2 | 18.0 | RORg | 2.8 | 0.17 |
| HNF4a | 78.0 | 10.4 | HNF4a | 0.7 | 0.10 |
| HNF4g | 128.6 | 15.2 | HNF4g | 1.2 | 0.14 |
| TR2 | 311.2 | 30.0 | TR2 | 2.9 | 0.28 |
| TR4 | 229.9 | 1.8 | TR4 | 2.1 | 0.02 |
| TLX | 60.9 | 2.1 | TLX | 0.6 | 0.02 |
| PNR | 116.3 | 11.4 | PNR | 1.1 | 0.11 |
| Era | 118.7 | 6.1 | Era | 1.1 | 0.06 |
| Era ligand | 113.7 | 3.4 | Era ligand | 1.1 | 0.03 |
| Erb | 146.9 | 13.0 | Erb | 1.4 | 0.12 |
| Erb ligand | 124.2 | 9.8 | Erb ligand | 1.2 | 0.09 |
| ERR1 | 237.3 | 5.9 | ERR1 | 2.2 | 0.05 |
| ERR2 | 946.7 | 19.2 | ERR2 | 8.8 | 0.18 |
| ERR3 | 487.3 | 37.3 | ERR3 | 4.6 | 0.35 |
| CTF1 | | | CTF1 | 0.0 | 0.00 |
| CTF2 | | | CTF2 | 0.0 | 0.00 |
| CTF3 | 175.5 | 13.3 | CTF3 | 1.6 | 0.12 |
| SF-1 | 217.9 | 6.0 | SF-1 | 2.0 | 0.06 |
| control | 128.6 | 10.2 | control | 1.2 | 0.10 |
| GR | 23.9 | 1.2 | GR | 0.2 | 0.01 |
| GR ligand | 15.7 | 0.3 | GR ligand | 0.1 | 0.00 |
| hMR | | | hMR | 0.0 | 0.00 |
| hMR ligand | | | hMR ligand | 0.0 | 0.00 |
| PR | 128.0 | 3.3 | PR | 1.2 | 0.03 |
| PR ligand | 126.8 | 6.7 | PR ligand | 1.2 | 0.06 |
| AR | 62.4 | 4.8 | AR | 0.6 | 0.04 |
| AR ligand | 114.2 | 4.7 | AR ligand | 1.1 | 0.04 |
| NR4a1 | 76.3 | 8.3 | NR4a1 | 0.7 | 0.08 |
| NR4a2 | 58.9 | 5.0 | NR4a2 | 0.6 | 0.05 |
| NR4a3 | 51.9 | 2.8 | NR4a3 | 0.5 | 0.03 |
| LRH-1 | 274.9 | 17.9 | LRH-1 | 2.6 | 0.17 |
| GCNF | | | GCNF | 0.0 | 0.00 |
| DAX-1 | 108.9 | 12.2 | DAX-1 | 1.0 | 0.11 |
| SHP | 130.4 | 6.6 | SHP | 1.2 | 0.06 |
| control | 107.0 | 12.9 | control | 1.0 | 0.12 |

TABLE 23
Results for assay for listed components for IRF7.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 15.2 | 2.0 | TRa1 | 0.6 | 0.08 |
| TRa1 ligand | 19.0 | 0.4 | TRa1 ligand | 0.7 | 0.01 |
| TRa2 | 25.8 | 0.7 | TRa2 | 1.0 | 0.03 |
| TRa2 ligand | 26.1 | 0.5 | TRa2 ligand | 1.0 | 0.02 |
| TRb1 | 28.7 | 1.4 | TRb1 | 1.1 | 0.05 |
| TRb1 ligand | 28.6 | 3.3 | TRb1 ligand | 1.1 | 0.12 |
| TRb2 | 35.4 | 2.1 | TRb2 | 1.3 | 0.08 |
| TRb2 ligand | 35.1 | 1.5 | TRb2 ligand | 1.3 | 0.06 |
| RARa | 40.6 | 4.1 | RARa | 1.5 | 0.16 |
| RARa ligand | 39.6 | 1.3 | RARa ligand | 1.5 | 0.05 |
| RARb | 47.2 | 1.3 | RARb | 1.8 | 0.05 |
| RARb ligand | 49.8 | 1.9 | RARb ligand | 1.9 | 0.07 |
| RARg | 47.5 | 4.5 | RARg | 1.8 | 0.17 |
| RARg ligand | 43.3 | 3.1 | RARg ligand | 1.6 | 0.12 |
| PPARa | 36.6 | 2.6 | PPARa | 1.4 | 0.10 |
| PPARa ligand | 39.8 | 2.0 | PPARa ligand | 1.5 | 0.08 |
| PPARg | 44.8 | 9.3 | PPARg | 1.7 | 0.35 |
| PPARg ligand | 65.3 | 4.9 | PPARg ligand | 2.5 | 0.18 |
| PPARd | 33.6 | 0.9 | PPARd | 1.3 | 0.04 |
| PPARd ligand | 41.8 | 2.1 | PPARd ligand | 1.6 | 0.08 |
| LXRa | 33.2 | 1.0 | LXRa | 1.3 | 0.04 |
| LXRa ligand | 50.5 | 4.4 | LXRa ligand | 1.9 | 0.17 |
| LXRb | 45.1 | 0.7 | LXRb | 1.7 | 0.03 |
| LXRb ligand | 39.0 | 1.5 | LXRb ligand | 1.5 | 0.06 |
| FXR | 41.8 | 7.2 | FXR | 1.6 | 0.27 |
| FXR ligand | 46.4 | 3.4 | FXR ligand | 1.8 | 0.13 |
| FXRb | 41.4 | 0.8 | FXRb | 1.6 | 0.03 |
| FXRb ligand | 40.9 | 4.0 | FXRb ligand | 1.6 | 0.15 |
| VDR | 30.2 | 2.2 | VDR | 1.1 | 0.08 |
| VDR ligand | 27.7 | 0.5 | VDR ligand | 1.1 | 0.02 |
| PXR | 36.3 | 1.9 | PXR | 1.4 | 0.07 |
| PXR ligand | 34.4 | 1.6 | PXR ligand | 1.3 | 0.06 |
| CAR | 37.3 | 7.3 | CAR | 1.4 | 0.28 |
| CAR ligand | 40.3 | 2.3 | CAR ligand | 1.5 | 0.09 |
| control | 36.5 | 1.8 | control | 1.4 | 0.07 |
| RXRa | 27.5 | 1.4 | RXRa | 1.0 | 0.05 |
| RXRa ligand | 40.5 | 6.5 | RXRa ligand | 1.5 | 0.25 |
| RXRb | 8.9 | 2.3 | RXRb | 0.3 | 0.09 |
| RXRb ligand | 13.1 | 0.7 | RXRb ligand | 0.5 | 0.03 |
| RXRg | 27.4 | 4.0 | RXRg | 1.0 | 0.15 |
| RXRg ligand | 38.0 | 1.3 | RXRg ligand | 1.4 | 0.05 |
| RVRa | 32.6 | 1.7 | RVRa | 1.2 | 0.06 |
| RVRb | 50.4 | 1.9 | RVRb | 1.9 | 0.07 |
| RORa | 39.9 | 2.4 | RORa | 1.5 | 0.09 |
| RORb | 40.9 | 11.2 | RORb | 1.6 | 0.43 |
| RORg | 44.4 | 3.0 | RORg | 1.7 | 0.11 |
| HNF4a | 36.0 | 2.0 | HNF4a | 1.4 | 0.08 |
| HNF4g | 31.7 | 0.6 | HNF4g | 1.2 | 0.02 |
| TR2 | 25.8 | 2.6 | TR2 | 1.0 | 0.10 |
| TR4 | 48.8 | 2.6 | TR4 | 1.9 | 0.10 |
| TLX | 55.0 | 1.9 | TLX | 2.1 | 0.07 |
| PNR | 27.5 | 1.0 | PNR | 1.0 | 0.04 |
| Era | 51.9 | 7.5 | Era | 2.0 | 0.29 |
| Era ligand | 89.6 | 5.8 | Era ligand | 3.4 | 0.22 |
| Erb | 37.5 | 1.4 | Erb | 1.4 | 0.05 |
| Erb ligand | 39.8 | 2.1 | Erb ligand | 1.5 | 0.08 |
| ERR1 | 31.3 | 2.6 | ERR1 | 1.2 | 0.10 |
| ERR2 | 60.5 | 2.1 | ERR2 | 2.3 | 0.08 |
| ERR3 | 55.2 | 3.0 | ERR3 | 2.1 | 0.11 |
| CTF1 | 24.8 | 2.3 | CTF1 | 0.9 | 0.09 |
| CTF2 | 25.6 | 2.9 | CTF2 | 1.0 | 0.11 |
| CTF3 | 25.5 | 2.5 | CTF3 | 1.0 | 0.09 |
| SF-1 | 65.5 | 4.2 | SF-1 | 2.5 | 0.16 |
| control | 33.6 | 1.0 | control | 1.3 | 0.04 |
| GR | 18.9 | 3.3 | GR | 0.7 | 0.13 |
| GR ligand | 28.4 | 4.4 | GR ligand | 1.1 | 0.17 |
| hMR | 21.1 | 0.6 | hMR | 0.8 | 0.02 |
| hMR ligand | 17.9 | 0.2 | hMR ligand | 0.7 | 0.01 |
| PR | 33.0 | 1.9 | PR | 1.3 | 0.07 |
| PR ligand | 41.2 | 0.8 | PR ligand | 1.6 | 0.03 |
| AR | 29.9 | 0.6 | AR | 1.1 | 0.02 |
| AR ligand | 32.8 | 2.8 | AR ligand | 1.2 | 0.11 |
| NR4a1 | 61.0 | 3.9 | NR4a1 | 2.3 | 0.15 |
| NR4a2 | 23.2 | 3.7 | NR4a2 | 0.9 | 0.14 |
| NR4a3 | 24.9 | 1.5 | NR4a3 | 0.9 | 0.06 |
| LRH-1 | 59.0 | 3.5 | LRH-1 | 2.2 | 0.13 |
| GCNF | 28.4 | 1.1 | GCNF | 1.1 | 0.04 |
| DAX-1 | 27.9 | 2.3 | DAX-1 | 1.1 | 0.09 |
| SHP | 29.1 | 1.5 | SHP | 1.1 | 0.06 |
| control | 26.4 | 2.6 | control | 1.0 | 0.10 |

TABLE 24
Results for assay for listed components for MDR1.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 0.1 | 0.0 | TRa1 | 0.4 | 0.13 |
| TRa1 ligand | 0.1 | 0.0 | TRa1 ligand | 0.4 | 0.02 |
| TRa2 | 0.1 | 0.0 | TRa2 | 0.4 | 0.03 |
| TRa2 ligand | 0.2 | 0.0 | TRa2 ligand | 0.5 | 0.09 |
| TRb1 | 0.2 | 0.0 | TRb1 | 0.7 | 0.04 |
| TRb1 ligand | 0.2 | 0.0 | TRb1 ligand | 0.5 | 0.07 |
| TRb2 | 0.2 | 0.0 | TRb2 | 0.6 | 0.03 |
| TRb2 ligand | 0.1 | 0.0 | TRb2 ligand | 0.5 | 0.02 |
| RARa | 0.2 | 0.0 | RARa | 0.7 | 0.04 |
| RARa ligand | 0.3 | 0.1 | RARa ligand | 0.8 | 0.26 |
| RARb | 0.3 | 0.1 | RARb | 1.0 | 0.34 |
| RARb ligand | 0.2 | 0.0 | RARb ligand | 0.7 | 0.10 |
| RARg | 0.3 | 0.0 | RARg | 0.8 | 0.04 |
| RARg ligand | 0.3 | 0.1 | RARg ligand | 0.9 | 0.26 |
| PPARa | 0.2 | 0.0 | PPARa | 0.5 | 0.04 |
| PPARa ligand | 0.2 | 0.0 | PPARa ligand | 0.5 | 0.09 |
| PPARg | 0.3 | 0.0 | PPARg | 0.8 | 0.12 |
| PPARg ligand | 0.3 | 0.0 | PPARg ligand | 0.9 | 0.03 |
| PPARd | 0.3 | 0.1 | PPARd | 0.9 | 0.18 |
| PPARd ligand | 0.2 | 0.0 | PPARd ligand | 0.7 | 0.06 |
| LXRa | 0.2 | 0.0 | LXRa | 0.5 | 0.03 |
| LXRa ligand | 0.2 | 0.0 | LXRa ligand | 0.6 | 0.07 |
| LXRb | 0.2 | 0.0 | LXRb | 0.8 | 0.14 |
| LXRb ligand | 0.3 | 0.1 | LXRb ligand | 1.0 | 0.17 |
| FXR | 0.2 | 0.0 | FXR | 0.6 | 0.11 |
| FXR ligand | 0.2 | 0.0 | FXR ligand | 0.7 | 0.11 |
| FXRb | 0.2 | 0.0 | FXRb | 0.7 | 0.10 |
| FXRb ligand | 0.2 | 0.0 | FXRb ligand | 0.8 | 0.06 |
| VDR | 0.3 | 0.0 | VDR | 0.9 | 0.15 |
| VDR ligand | 0.2 | 0.0 | VDR ligand | 0.6 | 0.11 |
| PXR | 0.3 | 0.1 | PXR | 1.1 | 0.46 |
| PXR ligand | 0.2 | 0.0 | PXR ligand | 0.7 | 0.06 |
| CAR | 0.2 | 0.1 | CAR | 0.7 | 0.24 |
| CAR ligand | 0.2 | 0.0 | CAR ligand | 0.6 | 0.05 |
| control | 0.2 | 0.0 | control | 0.7 | 0.10 |
| RXRa | 0.2 | 0.0 | RXRa | 0.5 | 0.08 |
| RXRa ligand | 0.2 | 0.0 | RXRa ligand | 0.7 | 0.06 |
| RXRb | 0.1 | 0.0 | RXRb | 0.3 | 0.07 |
| RXRb ligand | 0.1 | 0.0 | RXRb ligand | 0.4 | 0.01 |
| RXRg | 0.2 | 0.0 | RXRg | 0.7 | 0.08 |
| RXRg ligand | 0.3 | 0.0 | RXRg ligand | 0.8 | 0.06 |
| RVRa | 0.2 | 0.0 | RVRa | 0.6 | 0.03 |
| RVRb | 0.3 | 0.0 | RVRb | 0.9 | 0.04 |
| RORa | 0.1 | 0.0 | RORa | 0.3 | 0.04 |
| RORb | 0.2 | 0.0 | RORb | 0.6 | 0.06 |
| RORg | 0.2 | 0.1 | RORg | 0.5 | 0.17 |
| HNF4a | 0.2 | 0.1 | HNF4a | 0.8 | 0.36 |
| HNF4g | 0.2 | 0.1 | HNF4g | 0.8 | 0.17 |
| TR2 | 0.3 | 0.1 | TR2 | 1.0 | 0.25 |
| TR4 | 0.5 | 0.1 | TR4 | 1.6 | 0.48 |
| TLX | 0.2 | 0.0 | TLX | 0.7 | 0.01 |
| PNR | 0.2 | 0.1 | PNR | 0.5 | 0.25 |
| Era | 0.6 | 0.1 | Era | 1.8 | 0.41 |
| Era ligand | 1.1 | 0.2 | Era ligand | 3.5 | 0.55 |
| Erb | 0.3 | 0.1 | Erb | 1.1 | 0.27 |
| Erb ligand | 0.3 | 0.1 | Erb ligand | 1.1 | 0.35 |
| ERR1 | 0.4 | 0.1 | ERR1 | 1.2 | 0.17 |
| ERR2 | 0.4 | 0.0 | ERR2 | 1.2 | 0.05 |
| ERR3 | 0.2 | 0.0 | ERR3 | 0.8 | 0.15 |
| CTF1 | 0.3 | 0.1 | CTF1 | 0.9 | 0.30 |
| CTF2 | 0.3 | 0.1 | CTF2 | 1.0 | 0.33 |
| CTF3 | 0.4 | 0.0 | CTF3 | 1.4 | 0.10 |
| SF-1 | 0.7 | 0.1 | SF-1 | 2.4 | 0.31 |
| control | 0.2 | 0.0 | control | 0.6 | 0.07 |
| GR | 0.1 | 0.0 | GR | 0.4 | 0.05 |
| GR ligand | 0.1 | 0.0 | GR ligand | 0.4 | 0.04 |
| hMR | 0.1 | 0.0 | hMR | 0.3 | 0.05 |
| hMR ligand | 0.1 | 0.0 | hMR ligand | 0.3 | 0.04 |
| PR | 0.4 | 0.1 | PR | 1.3 | 0.41 |
| PR ligand | 0.3 | 0.1 | PR ligand | 1.1 | 0.18 |
| AR | 0.2 | 0.0 | AR | 0.6 | 0.08 |
| AR ligand | 0.4 | 0.1 | AR ligand | 1.2 | 0.36 |
| NR4a1 | 0.4 | 0.1 | NR4a1 | 1.3 | 0.26 |
| NR4a2 | 0.2 | 0.1 | NR4a2 | 0.7 | 0.20 |
| NR4a3 | 0.2 | 0.0 | NR4a3 | 0.7 | 0.02 |
| LRH-1 | 0.8 | 0.3 | LRH-1 | 2.7 | 1.10 |
| GCNF | 0.3 | 0.1 | GCNF | 0.8 | 0.23 |
| DAX-1 | 0.3 | 0.0 | DAX-1 | 0.9 | 0.07 |
| SHP | 0.3 | 0.0 | SHP | 0.8 | 0.03 |
| control | 0.3 | 0.1 | control | 1.0 | 0.31 |

TABLE 25
Results for assay for listed components for CYP3A4.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 1.1 | 0.7 | TRa1 | 0.3 | 0.16 |
| TRa1 ligand | 0.7 | 0.1 | TRa1 ligand | 0.2 | 0.02 |
| TRa2 | 2.4 | 1.0 | TRa2 | 0.5 | 0.23 |
| TRa2 ligand | 2.3 | 0.6 | TRa2 ligand | 0.5 | 0.12 |
| TRb1 | 2.9 | 0.4 | TRb1 | 0.6 | 0.08 |
| TRb1 ligand | 1.7 | 0.4 | TRb1 ligand | 0.4 | 0.09 |
| TRb2 | 3.2 | 0.3 | TRb2 | 0.7 | 0.07 |
| TRb2 ligand | 2.3 | 0.4 | TRb2 ligand | 0.5 | 0.09 |
| RARa | 4.2 | 0.6 | RARa | 0.9 | 0.14 |
| RARa ligand | 3.6 | 0.6 | RARa ligand | 0.8 | 0.15 |
| RARb | 4.6 | 0.8 | RARb | 1.0 | 0.17 |
| RARb ligand | 3.4 | 0.3 | RARb ligand | 0.8 | 0.07 |
| RARg | 4.0 | 0.4 | RARg | 0.9 | 0.10 |
| RARg ligand | 3.6 | 0.7 | RARg ligand | 0.8 | 0.16 |
| PPARa | 3.4 | 0.6 | PPARa | 0.8 | 0.14 |
| PPARa ligand | 3.2 | 1.1 | PPARa ligand | 0.7 | 0.26 |
| PPARg | 4.7 | 2.7 | PPARg | 1.1 | 0.60 |
| PPARg ligand | 6.7 | 0.2 | PPARg ligand | 1.5 | 0.04 |
| PPARd | 5.0 | 0.7 | PPARd | 1.1 | 0.15 |
| PPARd ligand | 4.2 | 0.6 | PPARd ligand | 0.9 | 0.14 |
| LXRa | 4.1 | 0.5 | LXRa | 0.9 | 0.11 |
| LXRa ligand | 5.1 | 1.3 | LXRa ligand | 1.1 | 0.30 |
| LXRb | 4.8 | 0.6 | LXRb | 1.1 | 0.13 |
| LXRb ligand | 3.4 | 0.8 | LXRb ligand | 0.8 | 0.19 |
| FXR | 4.2 | 0.2 | FXR | 0.9 | 0.05 |
| FXR ligand | 7.2 | 2.3 | FXR ligand | 1.6 | 0.51 |
| FXRb | 7.1 | 1.5 | FXRb | 1.6 | 0.35 |
| FXRb ligand | 6.8 | 1.8 | FXRb ligand | 1.5 | 0.40 |
| VDR | 5.1 | 1.0 | VDR | 1.2 | 0.22 |
| VDR ligand | 2.9 | 1.2 | VDR ligand | 0.6 | 0.26 |
| PXR | 8.8 | 3.2 | PXR | 2.0 | 0.73 |
| PXR ligand | 2.9 | 1.1 | PXR ligand | 0.6 | 0.24 |
| CAR | 3.1 | 1.1 | CAR | 0.7 | 0.25 |
| CAR ligand | 2.6 | 0.2 | CAR ligand | 0.6 | 0.05 |
| control | 5.1 | 0.5 | control | 1.1 | 0.12 |
| RXRa | 1.5 | 0.2 | RXRa | 0.3 | 0.05 |
| RXRa ligand | 1.6 | 0.2 | RXRa ligand | 0.4 | 0.04 |
| RXRb | 0.3 | 0.0 | RXRb | 0.1 | 0.01 |
| RXRb ligand | 0.6 | 0.2 | RXRb ligand | 0.1 | 0.04 |
| RXRg | 0.9 | 0.2 | RXRg | 0.2 | 0.04 |
| RXRg ligand | 1.7 | 0.5 | RXRg ligand | 0.4 | 0.12 |
| RVRa | 2.2 | 0.2 | RVRa | 0.5 | 0.04 |
| RVRb | 4.5 | 1.3 | RVRb | 1.0 | 0.28 |
| RORa | 1.6 | 0.3 | RORa | 0.4 | 0.06 |
| RORb | 2.5 | 0.3 | RORb | 0.6 | 0.07 |
| RORg | 3.4 | 0.2 | RORg | 0.8 | 0.05 |
| HNF4a | 1.7 | 0.3 | HNF4a | 0.4 | 0.06 |
| HNF4g | 1.8 | 0.1 | HNF4g | 0.4 | 0.02 |
| TR2 | 2.0 | 0.5 | TR2 | 0.4 | 0.12 |
| TR4 | 7.7 | 0.9 | TR4 | 1.7 | 0.21 |
| TLX | 4.0 | 0.6 | TLX | 0.9 | 0.12 |
| PNR | 2.2 | 0.4 | PNR | 0.5 | 0.09 |
| Era | 3.5 | 0.3 | Era | 0.8 | 0.07 |
| Era ligand | 4.6 | 0.5 | Era ligand | 1.0 | 0.11 |
| Erb | 6.0 | 1.1 | Erb | 1.3 | 0.25 |
| Erb ligand | 4.0 | 0.9 | Erb ligand | 0.9 | 0.21 |
| ERR1 | 4.5 | 0.2 | ERR1 | 1.0 | 0.05 |
| ERR2 | 15.5 | 1.6 | ERR2 | 3.5 | 0.37 |
| ERR3 | 4.5 | 0.3 | ERR3 | 1.0 | 0.07 |
| CTF1 | 2.6 | 0.9 | CTF1 | 0.6 | 0.21 |
| CTF2 | 2.7 | 0.5 | CTF2 | 0.6 | 0.11 |
| CTF3 | 6.1 | 2.0 | CTF3 | 1.4 | 0.45 |
| SF-1 | 10.6 | 1.8 | SF-1 | 2.4 | 0.40 |
| control | 3.7 | 0.8 | control | 0.8 | 0.17 |
| GR | 2.0 | 0.5 | GR | 0.5 | 0.10 |
| GR ligand | 3.2 | 0.5 | GR ligand | 0.7 | 0.10 |
| hMR | 2.6 | 0.2 | hMR | 0.6 | 0.05 |
| hMR ligand | 1.9 | 0.2 | hMR ligand | 0.4 | 0.05 |
| PR | 6.5 | 0.6 | PR | 1.5 | 0.14 |
| PR ligand | 13.8 | 0.5 | PR ligand | 3.1 | 0.11 |
| AR | 3.9 | 0.2 | AR | 0.9 | 0.04 |
| AR ligand | 9.3 | 0.9 | AR ligand | 2.1 | 0.20 |
| NR4a1 | 6.2 | 0.9 | NR4a1 | 1.4 | 0.20 |
| NR4a2 | 3.5 | 0.6 | NR4a2 | 0.8 | 0.13 |
| NR4a3 | 4.2 | 0.5 | NR4a3 | 0.9 | 0.11 |
| LRH-1 | 10.9 | 1.0 | LRH-1 | 2.4 | 0.22 |
| GCNF | 4.5 | 0.4 | GCNF | 1.0 | 0.08 |
| DAX-1 | 5.7 | 0.4 | DAX-1 | 1.3 | 0.10 |
| SHP | 4.6 | 0.2 | SHP | 1.0 | 0.05 |
| control | 4.4 | 0.6 | control | 1.0 | 0.12 |

TABLE 26
Results for assay for listed components for ADRP.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 421.3 | 29.1 | TRa1 | 0.8 | 0.06 |
| TRa1 ligand | 420.0 | 37.4 | TRa1 ligand | 0.8 | 0.08 |
| TRa2 | 820.6 | 87.5 | TRa2 | 1.6 | 0.18 |
| TRa2 ligand | 682.6 | 28.7 | TRa2 ligand | 1.4 | 0.06 |
| TRb1 | 668.9 | 45.5 | TRb1 | 1.3 | 0.09 |
| TRb1 ligand | 422.3 | 28.9 | TRb1 ligand | 0.8 | 0.06 |
| TRb2 | 791.7 | 105.5 | TRb2 | 1.6 | 0.21 |
| TRb2 ligand | 701.9 | 76.9 | TRb2 ligand | 1.4 | 0.15 |
| RARa | 628.8 | 29.7 | RARa | 1.3 | 0.06 |
| RARa ligand | 1283.5 | 111.7 | RARa ligand | 2.6 | 0.22 |
| RARb | 799.4 | 56.9 | RARb | 1.6 | 0.11 |
| RARb ligand | 1655.8 | 249.6 | RARb ligand | 3.3 | 0.50 |
| RARg | 765.4 | 43.6 | RARg | 1.5 | 0.09 |
| RARg ligand | 1030.4 | 48.5 | RARg ligand | 2.1 | 0.10 |
| PPARa | 1497.1 | 141.3 | PPARa | 3.0 | 0.28 |
| PPARa ligand | 3064.8 | 249.9 | PPARa ligand | 6.2 | 0.50 |
| PPARg | 891.4 | 92.3 | PPARg | 1.8 | 0.19 |
| PPARg ligand | 1774.9 | 21.3 | PPARg ligand | 3.6 | 0.04 |
| PPARd | 694.0 | 69.1 | PPARd | 1.4 | 0.14 |
| PPARd ligand | 1447.7 | 151.9 | PPARd ligand | 2.9 | 0.31 |
| LXRa | 1095.7 | 86.6 | LXRa | 2.2 | 0.17 |
| LXRa ligand | 1518.1 | 121.1 | LXRa ligand | 3.1 | 0.24 |
| LXRb | 1191.8 | 121.4 | LXRb | 2.4 | 0.24 |
| LXRb ligand | 1489.9 | 354.7 | LXRb ligand | 3.0 | 0.71 |
| FXR | 658.3 | 93.0 | FXR | 1.3 | 0.19 |
| FXR ligand | 1164.8 | 105.8 | FXR ligand | 2.3 | 0.21 |
| FXRb | 993.6 | 81.5 | FXRb | 2.0 | 0.16 |
| FXRb ligand | 1089.3 | 34.8 | FXRb ligand | 2.2 | 0.07 |
| VDR | 766.6 | 87.0 | VDR | 1.5 | 0.17 |
| VDR ligand | 460.1 | 38.4 | VDR ligand | 0.9 | 0.08 |
| PXR | 1021.2 | 102.5 | PXR | 2.1 | 0.21 |
| PXR ligand | 794.4 | 54.2 | PXR ligand | 1.6 | 0.11 |
| CAR | 623.0 | 29.4 | CAR | 1.3 | 0.06 |
| CAR ligand | 692.5 | 60.8 | CAR ligand | 1.4 | 0.12 |
| control | 911.0 | 28.6 | control | 1.8 | 0.06 |
| RXRa | 783.2 | 56.6 | RXRa | 1.6 | 0.11 |
| RXRa ligand | 1753.8 | 142.4 | RXRa ligand | 3.5 | 0.29 |
| RXRb | 676.1 | 113.7 | RXRb | 1.4 | 0.23 |
| RXRb ligand | 1081.6 | 22.7 | RXRb ligand | 2.2 | 0.05 |
| RXRg | 665.8 | 77.0 | RXRg | 1.3 | 0.15 |
| RXRg ligand | 1234.8 | 126.4 | RXRg ligand | 2.5 | 0.25 |
| RVRa | 522.2 | 64.1 | RVRa | 1.0 | 0.13 |
| RVRb | 353.2 | 46.1 | RVRb | 0.7 | 0.09 |
| RORa | 976.2 | 131.3 | RORa | 2.0 | 0.26 |
| RORb | 685.3 | 42.7 | RORb | 1.4 | 0.09 |
| RORg | 929.8 | 95.2 | RORg | 1.9 | 0.19 |
| HNF4a | 729.1 | 50.1 | HNF4a | 1.5 | 0.10 |
| HNF4g | 511.7 | 16.6 | HNF4g | 1.0 | 0.03 |
| TR2 | 684.7 | 35.4 | TR2 | 1.4 | 0.07 |
| TR4 | 1003.3 | 77.8 | TR4 | 2.0 | 0.16 |
| TLX | 259.2 | 23.7 | TLX | 0.5 | 0.05 |
| PNR | 381.7 | 43.0 | PNR | 0.8 | 0.09 |
| Era | 650.8 | 94.2 | Era | 1.3 | 0.19 |
| Era ligand | 552.7 | 71.9 | Era ligand | 1.1 | 0.14 |
| Erb | 536.9 | 7.9 | Erb | 1.1 | 0.02 |
| Erb ligand | 440.0 | 17.1 | Erb ligand | 0.9 | 0.03 |
| ERR1 | 767.6 | 32.7 | ERR1 | 1.5 | 0.07 |
| ERR2 | 874.7 | 107.6 | ERR2 | 1.8 | 0.22 |
| ERRS | 1678.4 | 112.3 | ERRS | 3.4 | 0.23 |
| CTF1 | 393.3 | 40.0 | CTF1 | 0.8 | 0.08 |
| CTF2 | 893.8 | 55.8 | CTF2 | 1.8 | 0.11 |
| CTF3 | 462.7 | 49.1 | CTF3 | 0.9 | 0.10 |
| SF-1 | 1864.1 | 115.3 | SF-1 | 3.7 | 0.23 |
| control | 881.3 | 79.8 | control | 1.8 | 0.16 |
| GR | 238.1 | 9.7 | GR | 0.5 | 0.02 |
| GR ligand | 312.2 | 29.0 | GR ligand | 0.6 | 0.06 |
| hMR | 306.4 | 10.3 | hMR | 0.6 | 0.02 |
| hMR ligand | 295.9 | 13.1 | hMR ligand | 0.6 | 0.03 |
| PR | 497.2 | 8.8 | PR | 1.0 | 0.02 |
| PR ligand | 490.6 | 43.3 | PR ligand | 1.0 | 0.09 |
| AR | 600.8 | 16.5 | AR | 1.2 | 0.03 |
| AR ligand | 545.6 | 20.6 | AR ligand | 1.1 | 0.04 |
| NR4a1 | 1029.3 | 54.4 | NR4a1 | 2.1 | 0.11 |
| NR4a2 | 382.8 | 16.1 | NR4a2 | 0.8 | 0.03 |
| NR4a3 | 351.6 | 9.6 | NR4a3 | 0.7 | 0.02 |
| LRH-1 | 1106.2 | 106.7 | LRH-1 | 2.2 | 0.21 |
| GCNF | 523.7 | 37.1 | GCNF | 1.1 | 0.07 |
| DAX-1 | 419.9 | 4.9 | DAX-1 | 0.8 | 0.01 |
| SHP | 421.4 | 5.2 | SHP | 0.8 | 0.01 |
| control | 497.6 | 21.1 | control | 1.0 | 0.04 |

TABLE 27
Results for assay for listed components for Adiponectin.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 35.0 | 17.7 | TRa1 | 0.6 | 0.28 |
| TRa1 ligand | 69.4 | 4.8 | TRa1 ligand | 1.1 | 0.08 |
| TRa2 | 58.4 | 4.4 | TRa2 | 0.9 | 0.07 |
| TRa2 ligand | 50.5 | 1.7 | TRa2 ligand | 0.8 | 0.03 |
| TRb1 | 66.8 | 8.4 | TRb1 | 1.1 | 0.13 |
| TRb1 ligand | 64.0 | 2.5 | TRb1 ligand | 1.0 | 0.04 |
| TRb2 | 73.8 | 4.8 | TRb2 | 1.2 | 0.08 |
| TRb2 ligand | 94.7 | 5.4 | TRb2 ligand | 1.5 | 0.09 |
| RARa | 78.6 | 15.0 | RARa | 1.3 | 0.24 |
| RARa ligand | 52.7 | 2.3 | RARa ligand | 0.8 | 0.04 |
| RARb | 81.2 | 1.4 | RARb | 1.3 | 0.02 |
| RARb ligand | 62.9 | 1.4 | RARb ligand | 1.0 | 0.02 |
| RARg | 62.6 | 3.0 | RARg | 1.0 | 0.05 |
| RARg ligand | 50.9 | 1.6 | RARg ligand | 0.8 | 0.03 |
| PPARa | 40.4 | 6.8 | PPARa | 0.6 | 0.11 |
| PPARa ligand | 42.7 | 0.7 | PPARa ligand | 0.7 | 0.01 |
| PPARg | 80.6 | 22.9 | PPARg | 1.3 | 0.36 |
| PPARg ligand | 125.9 | 8.2 | PPARg ligand | 2.0 | 0.13 |
| PPARd | 89.4 | 10.4 | PPARd | 1.4 | 0.17 |
| PPARd ligand | 86.3 | 7.2 | PPARd ligand | 1.4 | 0.11 |
| LXRa | 60.7 | 4.0 | LXRa | 1.0 | 0.06 |
| LXRa ligand | 79.0 | 6.1 | LXRa ligand | 1.3 | 0.10 |
| LXRb | 61.7 | 7.8 | LXRb | 1.0 | 0.12 |
| LXRb ligand | 64.5 | 1.2 | LXRb ligand | 1.0 | 0.02 |
| FXR | 62.6 | 5.8 | FXR | 1.0 | 0.09 |
| FXR ligand | 75.8 | 4.7 | FXR ligand | 1.2 | 0.07 |
| FXRb | 68.6 | 8.8 | FXRb | 1.1 | 0.14 |
| FXRb ligand | 73.2 | 6.9 | FXRb ligand | 1.2 | 0.11 |
| VDR | 57.4 | 24.3 | VDR | 0.9 | 0.39 |
| VDR ligand | 41.9 | 1.6 | VDR ligand | 0.7 | 0.02 |
| PXR | 97.1 | 30.6 | PXR | 1.5 | 0.49 |
| PXR ligand | 62.8 | 3.8 | PXR ligand | 1.0 | 0.06 |
| CAR | 46.8 | 4.9 | CAR | 0.7 | 0.08 |
| CAR ligand | 42.1 | 1.5 | CAR ligand | 0.7 | 0.02 |
| control | 68.2 | 7.0 | control | 1.1 | 0.11 |
| RXRa | 57.3 | 1.7 | RXRa | 0.9 | 0.03 |
| RXRa ligand | 54.1 | 4.3 | RXRa ligand | 0.9 | 0.07 |
| RXRb | 71.8 | 4.1 | RXRb | 1.1 | 0.06 |
| RXRb ligand | 83.5 | 2.4 | RXRb ligand | 1.3 | 0.04 |
| RXRg | 69.4 | 11.0 | RXRg | 1.1 | 0.18 |
| RXRg ligand | 68.1 | 3.3 | RXRg ligand | 1.1 | 0.05 |
| RVRa | 55.2 | 4.6 | RVRa | 0.9 | 0.07 |
| RVRb | 66.3 | 3.5 | RVRb | 1.1 | 0.06 |
| RORa | 80.0 | 8.3 | RORa | 1.3 | 0.13 |
| RORb | 82.7 | 1.4 | RORb | 1.3 | 0.02 |
| RORg | 133.3 | 12.3 | RORg | 2.1 | 0.20 |
| HNF4a | 25.4 | 0.8 | HNF4a | 0.4 | 0.01 |
| HNF4g | 45.4 | 1.9 | HNF4g | 0.7 | 0.03 |
| TR2 | 37.5 | 3.8 | TR2 | 0.6 | 0.06 |
| TR4 | 296.1 | 43.7 | TR4 | 4.7 | 0.70 |
| TLX | 78.4 | 5.5 | TLX | 1.2 | 0.09 |
| PNR | 70.7 | 2.0 | PNR | 1.1 | 0.03 |
| Era | 96.5 | 9.7 | Era | 1.5 | 0.15 |
| Era ligand | 127.6 | 6.0 | Era ligand | 2.0 | 0.09 |
| Erb | 68.6 | 4.0 | Erb | 1.1 | 0.06 |
| Erb ligand | 55.0 | 1.8 | Erb ligand | 0.9 | 0.03 |
| ERR1 | 49.2 | 3.5 | ERR1 | 0.8 | 0.06 |
| ERR2 | 55.3 | 3.8 | ERR2 | 0.9 | 0.06 |
| ERR3 | 69.7 | 2.8 | ERR3 | 1.1 | 0.04 |
| CTF1 | 118.7 | 20.1 | CTF1 | 1.9 | 0.32 |
| CTF2 | 75.1 | 4.4 | CTF2 | 1.2 | 0.07 |
| CTF3 | 71.0 | 7.5 | CTF3 | 1.1 | 0.12 |
| SF-1 | 35.0 | 2.7 | SF-1 | 0.6 | 0.04 |
| control | 63.9 | 4.2 | control | 1.0 | 0.07 |
| GR | 33.2 | 4.2 | GR | 0.5 | 0.07 |
| GR ligand | 206.6 | 48.3 | GR ligand | 3.3 | 0.77 |
| hMR | 32.3 | 3.0 | hMR | 0.5 | 0.05 |
| hMR ligand | 29.6 | 3.3 | hMR ligand | 0.5 | 0.05 |
| PR | 52.9 | 1.9 | PR | 0.8 | 0.03 |
| PR ligand | 100.4 | 15.7 | PR ligand | 1.6 | 0.25 |
| AR | 82.7 | 1.0 | AR | 1.3 | 0.02 |
| AR ligand | 101.9 | 16.8 | AR ligand | 1.6 | 0.27 |
| NR4a1 | 85.6 | 7.0 | NR4a1 | 1.4 | 0.11 |
| NR4a2 | 35.8 | 6.1 | NR4a2 | 0.6 | 0.10 |
| NR4a3 | 35.7 | 5.0 | NR4a3 | 0.6 | 0.08 |
| LRH-1 | 29.7 | 2.5 | LRH-1 | 0.5 | 0.04 |
| GCNF | 63.1 | 7.0 | GCNF | 1.0 | 0.11 |
| DAX-1 | 45.6 | 5.3 | DAX-1 | 0.7 | 0.08 |
| SHP | 46.1 | 3.8 | SHP | 0.7 | 0.06 |
| control | 62.8 | 4.0 | control | 1.0 | 0.06 |

TABLE 28
Results for assay for listed components for Dio1.

| | | | | Normalized | |
|---|---|---|---|---|---|
| | Luc. act., | | | Luc. act., | |
| HR/ligand | normalized | | HR/ligand | normalized | |
| component | to lacZ | SD | component | to control | SD |
| TRa1 | 4.7 | 0.1 | TRa1 | 1.0 | 0.03 |
| TRa1 ligand | 1.6 | 0.1 | TRa1 ligand | 0.4 | 0.02 |
| TRa2 | 5.5 | 0.7 | TRa2 | 1.2 | 0.15 |
| TRa2 ligand | 5.8 | 0.1 | TRa2 ligand | 1.3 | 0.01 |
| TRb1 | 7.6 | 0.4 | TRb1 | 1.7 | 0.08 |
| TRb1 ligand | 2.9 | 0.2 | TRb1 ligand | 0.6 | 0.04 |
| TRb2 | 8.3 | 0.3 | TRb2 | 1.9 | 0.07 |
| TRb2 ligand | 4.0 | 0.4 | TRb2 ligand | 0.9 | 0.10 |
| RARa | 7.4 | 0.3 | RARa | 1.7 | 0.07 |
| RARa ligand | 3.1 | 0.2 | RARa ligand | 0.7 | 0.05 |
| RARb | 6.8 | 0.6 | RARb | 1.5 | 0.13 |
| RARb ligand | 3.6 | 0.2 | RARb ligand | 0.8 | 0.05 |
| RARg | 7.2 | 1.0 | RARg | 1.6 | 0.23 |
| RARg ligand | 3.5 | 0.1 | RARg ligand | 0.8 | 0.02 |
| PPARa | 4.7 | 0.4 | PPARa | 1.1 | 0.08 |
| PPARa ligand | 3.3 | 0.2 | PPARa ligand | 0.7 | 0.04 |
| PPARg | 9.9 | 3.1 | PPARg | 2.2 | 0.69 |
| PPARg ligand | 12.7 | 0.6 | PPARg ligand | 2.8 | 0.13 |
| PPARd | 10.0 | 0.9 | PPARd | 2.2 | 0.21 |
| PPARd ligand | 8.2 | 1.0 | PPARd ligand | 1.8 | 0.21 |
| LXRa | 4.7 | 0.2 | LXRa | 1.1 | 0.04 |
| LXRa ligand | 7.5 | 0.5 | LXRa ligand | 1.7 | 0.12 |
| LXRb | 9.8 | 0.5 | LXRb | 2.2 | 0.11 |
| LXRb ligand | 5.3 | 0.7 | LXRb ligand | 1.2 | 0.15 |
| FXR | 7.2 | 0.5 | FXR | 1.6 | 0.11 |
| FXR ligand | 8.9 | 0.8 | FXR ligand | 2.0 | 0.18 |
| FXRb | 8.6 | 0.2 | FXRb | 1.9 | 0.05 |
| FXRb ligand | 8.2 | 0.7 | FXRb ligand | 1.8 | 0.16 |
| VDR | 7.6 | 0.2 | VDR | 1.7 | 0.05 |
| VDR ligand | 2.3 | 0.2 | VDR ligand | 0.5 | 0.04 |
| PXR | 11.3 | 0.7 | PXR | 2.5 | 0.15 |
| PXR ligand | 3.4 | 0.2 | PXR ligand | 0.8 | 0.06 |
| CAR | 4.5 | 0.3 | CAR | 1.0 | 0.06 |
| CAR ligand | 2.9 | 0.1 | CAR ligand | 0.6 | 0.03 |
| control | 6.1 | 0.0 | control | 1.4 | 0.01 |
| RXRa | 5.5 | 0.1 | RXRa | 1.2 | 0.01 |
| RXRa ligand | 4.9 | 0.8 | RXRa ligand | 1.1 | 0.18 |
| RXRb | 4.4 | 0.3 | RXRb | 1.0 | 0.07 |
| RXRb ligand | 4.4 | 0.8 | RXRb ligand | 1.0 | 0.18 |
| RXRg | 6.6 | 0.2 | RXRg | 1.5 | 0.06 |
| RXRg ligand | 6.4 | 1.0 | RXRg ligand | 1.4 | 0.22 |
| RVRa | 5.7 | 0.1 | RVRa | 1.3 | 0.02 |
| RVRb | 8.8 | 0.2 | RVRb | 2.0 | 0.05 |
| RORa | 2.1 | 0.1 | RORa | 0.5 | 0.02 |
| RORb | 6.4 | 0.6 | RORb | 1.4 | 0.14 |
| RORg | 5.7 | 0.4 | RORg | 1.3 | 0.08 |
| HNF4a | 10.0 | 0.9 | HNF4a | 2.3 | 0.19 |
| HNF4g | 15.6 | 2.6 | HNF4g | 3.5 | 0.57 |
| TR2 | 14.8 | 1.7 | TR2 | 3.3 | 0.37 |
| TR4 | 56.0 | 5.7 | TR4 | 12.6 | 1.27 |
| TLX | 8.4 | 1.0 | TLX | 1.9 | 0.23 |
| PNR | 6.4 | 0.5 | PNR | 1.4 | 0.10 |
| Era | 10.1 | 0.2 | Era | 2.3 | 0.05 |
| Era ligand | 7.9 | 0.2 | Era ligand | 1.8 | 0.04 |
| Erb | 9.3 | 0.9 | Erb | 2.1 | 0.20 |
| Erb ligand | 8.2 | 2.1 | Erb ligand | 1.8 | 0.46 |
| ERR1 | 6.2 | 0.4 | ERR1 | 1.4 | 0.08 |
| ERR2 | 13.6 | 1.1 | ERR2 | 3.1 | 0.24 |
| ERR3 | 5.9 | 0.3 | ERR3 | 1.3 | 0.07 |
| CTF1 | 17.3 | 2.1 | CTF1 | 3.9 | 0.46 |
| CTF2 | 20.9 | 1.0 | CTF2 | 4.7 | 0.22 |
| CTF3 | 10.0 | 0.2 | CTF3 | 2.2 | 0.05 |
| SF-1 | 19.8 | 1.7 | SF-1 | 4.5 | 0.37 |
| control | 5.2 | 0.3 | control | 1.2 | 0.06 |
| GR | 2.5 | 0.2 | GR | 0.6 | 0.05 |
| GR ligand | 2.1 | 0.0 | GR ligand | 0.5 | 0.01 |
| hMR | 2.4 | 0.1 | hMR | 0.5 | 0.02 |
| hMR ligand | 1.8 | 0.2 | hMR ligand | 0.4 | 0.04 |
| PR | 7.8 | 0.8 | PR | 1.8 | 0.17 |
| PR ligand | 4.5 | 0.4 | PR ligand | 1.0 | 0.09 |
| AR | 6.4 | 0.6 | AR | 1.4 | 0.13 |
| AR ligand | 7.9 | 1.8 | AR ligand | 1.8 | 0.40 |
| NR4a1 | 10.9 | 0.3 | NR4a1 | 2.4 | 0.06 |
| NR4a2 | 6.3 | 0.6 | NR4a2 | 1.4 | 0.13 |
| NR4a3 | 6.6 | 0.5 | NR4a3 | 1.5 | 0.11 |
| LRH-1 | 14.7 | 0.9 | LRH-1 | 3.3 | 0.21 |
| GCNF | 5.1 | 0.3 | GCNF | 1.1 | 0.07 |
| DAX-1 | 8.9 | 1.0 | DAX-1 | 2.0 | 0.23 |
| SHP | 4.8 | 0.2 | SHP | 1.1 | 0.03 |
| control | 4.5 | 0.3 | control | 1.0 | 0.06 |

TABLE 29
Results for assay for listed components for Dio2.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 9.2 | 1.5 | TRa1 | 0.6 | 0.10 |
| TRa1 ligand | 19.0 | 0.4 | TRa1 ligand | 1.2 | 0.03 |
| TRa2 | 18.2 | 0.6 | TRa2 | 1.2 | 0.04 |
| TRa2 ligand | 18.2 | 0.4 | TRa2 ligand | 1.2 | 0.03 |
| TRb1 | 21.4 | 2.2 | TRb1 | 1.4 | 0.14 |
| TRb1 ligand | 21.7 | 3.1 | TRb1 ligand | 1.4 | 0.20 |
| TRb2 | 26.7 | 1.4 | TRb2 | 1.7 | 0.09 |
| TRb2 ligand | 26.8 | 0.9 | TRb2 ligand | 1.7 | 0.06 |
| RARa | 40.3 | 13.7 | RARa | 2.6 | 0.87 |
| RARa ligand | 13.8 | 1.6 | RARa ligand | 0.9 | 0.10 |
| RARb | 32.7 | 2.1 | RARb | 2.1 | 0.13 |
| RARb ligand | 28.5 | 0.4 | RARb ligand | 1.8 | 0.03 |
| RARg | 35.2 | 2.9 | RARg | 2.2 | 0.18 |
| RARg ligand | 28.3 | 1.1 | RARg ligand | 1.8 | 0.07 |
| PPARa | 23.0 | 2.1 | PPARa | 1.5 | 0.14 |
| PPARa ligand | 31.0 | 4.4 | PPARa ligand | 2.0 | 0.28 |
| PPARg | 35.5 | 8.1 | PPARg | 2.3 | 0.51 |
| PPARg ligand | 100.0 | 6.4 | PPARg ligand | 6.4 | 0.41 |
| PPARd | 19.1 | 1.3 | PPARd | 1.2 | 0.08 |
| PPARd ligand | 29.2 | 5.0 | PPARd ligand | 1.9 | 0.32 |
| LXRa | 19.0 | 0.6 | LXRa | 1.2 | 0.04 |
| LXRa ligand | 26.2 | 3.3 | LXRa ligand | 1.7 | 0.21 |
| LXRb | 18.1 | 1.7 | LXRb | 1.2 | 0.11 |
| LXRb ligand | 16.7 | 2.0 | LXRb ligand | 1.1 | 0.13 |
| FXR | 20.2 | 1.9 | FXR | 1.3 | 0.12 |
| FXR ligand | 39.2 | 1.9 | FXR ligand | 2.5 | 0.12 |
| FXRb | 30.2 | 0.3 | FXRb | 1.9 | 0.02 |
| FXRb ligand | 27.2 | 2.6 | FXRb ligand | 1.7 | 0.17 |
| VDR | 23.7 | 1.7 | VDR | 1.5 | 0.11 |
| VDR ligand | 9.0 | 0.8 | VDR ligand | 0.6 | 0.05 |
| PXR | 32.7 | 0.8 | PXR | 2.1 | 0.05 |
| PXR ligand | 8.5 | 0.4 | PXR ligand | 0.5 | 0.03 |
| CAR | 18.4 | 3.1 | CAR | 1.2 | 0.20 |
| CAR ligand | 18.9 | 0.3 | CAR ligand | 1.2 | 0.02 |
| control | 24.4 | 0.3 | control | 1.6 | 0.02 |
| RXRa | 18.6 | 1.3 | RXRa | 1.2 | 0.08 |
| RXRa ligand | 20.9 | 1.6 | RXRa ligand | 1.3 | 0.10 |
| RXRb | 22.8 | 1.0 | RXRb | 1.5 | 0.06 |
| RXRb ligand | 23.1 | 2.0 | RXRb ligand | 1.5 | 0.12 |
| RXRg | 27.8 | 4.6 | RXRg | 1.8 | 0.30 |
| RXRg ligand | 25.4 | 6.7 | RXRg ligand | 1.6 | 0.43 |
| RVRa | 21.5 | 2.4 | RVRa | 1.4 | 0.15 |
| RVRb | 19.7 | 2.1 | RVRb | 1.3 | 0.14 |
| RORa | 47.2 | 8.0 | RORa | 3.0 | 0.51 |
| RORb | 23.1 | 5.8 | RORb | 1.5 | 0.37 |
| RORg | 58.7 | 4.0 | RORg | 3.7 | 0.26 |
| HNF4a | 33.6 | 4.1 | HNF4a | 2.1 | 0.26 |
| HNF4g | 18.0 | 1.6 | HNF4g | 1.1 | 0.10 |
| TR2 | 33.8 | 5.2 | TR2 | 2.2 | 0.33 |
| TR4 | 51.9 | 5.0 | TR4 | 3.3 | 0.32 |
| TLX | 9.5 | 0.3 | TLX | 0.6 | 0.02 |
| PNR | 14.0 | 0.1 | PNR | 0.9 | 0.01 |
| Era | 29.9 | 4.1 | Era | 1.9 | 0.26 |
| Era ligand | 46.2 | 5.8 | Era ligand | 2.9 | 0.37 |
| Erb | 19.9 | 1.5 | Erb | 1.3 | 0.10 |
| Erb ligand | 16.4 | 0.4 | Erb ligand | 1.0 | 0.02 |
| ERR1 | 34.6 | 4.0 | ERR1 | 2.2 | 0.25 |
| ERR2 | 39.5 | 2.4 | ERR2 | 2.5 | 0.15 |
| ERR3 | 85.6 | 9.2 | ERR3 | 5.4 | 0.58 |
| CTF1 | 15.7 | 1.8 | CTF1 | 1.0 | 0.11 |
| CTF2 | 18.8 | 1.6 | CTF2 | 1.2 | 0.10 |
| CTF3 | 15.3 | 0.2 | CTF3 | 1.0 | 0.01 |
| SF-1 | 63.2 | 1.6 | SF-1 | 4.0 | 0.10 |
| control | 20.3 | 1.5 | control | 1.3 | 0.10 |
| GR | 13.2 | 1.3 | GR | 0.8 | 0.08 |
| GR ligand | 64.5 | 5.5 | GR ligand | 4.1 | 0.35 |
| hMR | 12.7 | 1.1 | hMR | 0.8 | 0.07 |
| hMR ligand | 7.9 | 0.4 | hMR ligand | 0.5 | 0.02 |
| PR | 21.4 | 1.8 | PR | 1.4 | 0.12 |
| PR ligand | 22.1 | 1.5 | PR ligand | 1.4 | 0.09 |
| AR | 19.7 | 0.8 | AR | 1.3 | 0.05 |
| AR ligand | 22.2 | 2.0 | AR ligand | 1.4 | 0.12 |
| NR4a1 | 21.8 | 2.3 | NR4a1 | 1.4 | 0.15 |
| NR4a2 | 12.4 | 0.8 | NR4a2 | 0.8 | 0.05 |
| NR4a3 | 14.8 | 0.7 | NR4a3 | 0.9 | 0.04 |
| LRH-1 | 60.5 | 6.4 | LRH-1 | 3.9 | 0.41 |
| GCNF | 22.7 | 3.4 | GCNF | 1.4 | 0.21 |
| DAX-1 | 18.7 | 0.7 | DAX-1 | 1.2 | 0.04 |
| SHP | 18.4 | 2.2 | SHP | 1.2 | 0.14 |
| control | 15.7 | 1.0 | control | 1.0 | 0.07 |

TABLE 30
Results for assay for listed components for Bmal1.

| | | | | Normalized | |
|---|---|---|---|---|---|
| | Luc. act., | | | Luc. act., | |
| HR/ligand | normalized | | HR/ligand | normalized | |
| component | to lacZ | SD | component | to control | SD |
| TRa1 | 11.9 | 0.5 | TRa1 | 0.8 | 0.03 |
| TRa1 ligand | 12.3 | 1.3 | TRa1 ligand | 0.8 | 0.08 |
| TRa2 | 11.7 | 2.1 | TRa2 | 0.7 | 0.13 |
| TRa2 ligand | 13.0 | 1.2 | TRa2 ligand | 0.8 | 0.08 |
| TRb1 | 17.2 | 0.6 | TRb1 | 1.1 | 0.04 |
| TRb1 ligand | 10.4 | 1.2 | TRb1 ligand | 0.7 | 0.08 |
| TRb2 | 24.9 | 2.0 | TRb2 | 1.6 | 0.13 |
| TRb2 ligand | 11.4 | 1.8 | TRb2 ligand | 0.7 | 0.12 |
| RARa | 18.9 | 1.2 | RARa | 1.2 | 0.07 |
| RARa ligand | 8.3 | 1.0 | RARa ligand | 0.5 | 0.06 |
| RARb | 15.6 | 1.8 | RARb | 1.0 | 0.11 |
| RARb ligand | 9.1 | 0.9 | RARb ligand | 0.6 | 0.06 |
| RARg | 19.1 | 1.5 | RARg | 1.2 | 0.10 |
| RARg ligand | 10.1 | 1.4 | RARg ligand | 0.6 | 0.09 |
| PPARa | 8.1 | 1.0 | PPARa | 0.5 | 0.07 |
| PPARa ligand | 6.1 | 0.6 | PPARa ligand | 0.4 | 0.04 |
| PPARg | 13.8 | 3.3 | PPARg | 0.9 | 0.21 |
| PPARg ligand | 10.3 | 0.3 | PPARg ligand | 0.7 | 0.02 |
| PPARd | 11.2 | 1.8 | PPARd | 0.7 | 0.11 |
| PPARd ligand | 11.1 | 1.8 | PPARd ligand | 0.7 | 0.12 |
| LXRa | 19.7 | 1.4 | LXRa | 1.3 | 0.09 |
| LXRa ligand | 17.4 | 0.8 | LXRa ligand | 1.1 | 0.05 |
| LXRb | 17.4 | 0.8 | LXRb | 1.1 | 0.05 |
| LXRb ligand | 15.1 | 2.5 | LXRb ligand | 1.0 | 0.16 |
| FXR | 15.6 | 2.1 | FXR | 1.0 | 0.14 |
| FXR ligand | 17.9 | 1.3 | FXR ligand | 1.1 | 0.08 |
| FXRb | 14.3 | 1.1 | FXRb | 0.9 | 0.07 |
| FXRb ligand | 14.2 | 1.1 | FXRb ligand | 0.9 | 0.07 |
| VDR | 22.0 | 0.6 | VDR | 1.4 | 0.04 |
| VDR ligand | 12.4 | 1.1 | VDR ligand | 0.8 | 0.07 |
| PXR | 31.2 | 2.9 | PXR | 2.0 | 0.19 |
| PXR ligand | 16.0 | 2.1 | PXR ligand | 1.0 | 0.13 |
| CAR | 16.4 | 2.7 | CAR | 1.1 | 0.17 |
| CAR ligand | 12.0 | 0.8 | CAR ligand | 0.8 | 0.05 |
| control | 14.6 | 1.0 | control | 0.9 | 0.06 |
| RXRa | 11.8 | 0.7 | RXRa | 0.8 | 0.04 |
| RXRa ligand | 10.2 | 1.3 | RXRa ligand | 0.7 | 0.08 |
| RXRb | 12.5 | 0.9 | RXRb | 0.8 | 0.06 |
| RXRb ligand | 10.8 | 0.5 | RXRb ligand | 0.7 | 0.03 |
| RXRg | 12.7 | 0.9 | RXRg | 0.8 | 0.06 |
| RXRg ligand | 13.7 | 0.5 | RXRg ligand | 0.9 | 0.03 |
| RVRa | 2.5 | 0.0 | RVRa | 0.2 | 0.00 |
| RVRb | 0.8 | 0.1 | RVRb | 0.1 | 0.00 |
| RORa | 115.6 | 8.9 | RORa | 7.4 | 0.57 |
| RORb | 16.5 | 1.5 | RORb | 1.1 | 0.10 |
| RORg | 58.9 | 7.9 | RORg | 3.8 | 0.50 |
| HNF4a | 10.1 | 0.4 | HNF4a | 0.6 | 0.03 |
| HNF4g | 11.5 | 0.8 | HNF4g | 0.7 | 0.05 |
| TR2 | 10.8 | 1.3 | TR2 | 0.7 | 0.08 |
| TR4 | 22.5 | 1.8 | TR4 | 1.4 | 0.11 |
| TLX | 12.2 | 1.9 | TLX | 0.8 | 0.12 |
| PNR | 7.6 | 0.7 | PNR | 0.5 | 0.04 |
| Era | 15.6 | 0.7 | Era | 1.0 | 0.04 |
| Era ligand | 29.7 | 1.7 | Era ligand | 1.9 | 0.11 |
| Erb | 17.0 | 1.8 | Erb | 1.1 | 0.11 |
| Erb ligand | 16.6 | 1.1 | Erb ligand | 1.1 | 0.07 |
| ERR1 | 13.6 | 0.8 | ERR1 | 0.9 | 0.05 |
| ERR2 | 10.6 | 0.2 | ERR2 | 0.7 | 0.01 |
| ERR3 | 9.5 | 1.0 | ERR3 | 0.6 | 0.06 |
| CTF1 | 26.1 | 3.2 | CTF1 | 1.7 | 0.20 |
| CTF2 | 29.5 | 1.7 | CTF2 | 1.9 | 0.11 |
| CTF3 | 21.2 | 1.4 | CTF3 | 1.4 | 0.09 |
| SF-1 | 11.4 | 0.7 | SF-1 | 0.7 | 0.05 |
| control | 17.5 | 2.5 | control | 1.1 | 0.16 |
| GR | 13.2 | 1.5 | GR | 0.8 | 0.10 |
| GR ligand | 33.1 | 5.4 | GR ligand | 2.1 | 0.34 |
| hMR | 18.2 | 0.3 | hMR | 1.2 | 0.02 |
| hMR ligand | 15.7 | 0.7 | hMR ligand | 1.0 | 0.04 |
| PR | 17.9 | 0.5 | PR | 1.1 | 0.03 |
| PR ligand | 23.5 | 2.0 | PR ligand | 1.5 | 0.13 |
| AR | 13.5 | 0.9 | AR | 0.9 | 0.06 |
| AR ligand | 22.6 | 1.5 | AR ligand | 1.4 | 0.10 |
| NR4a1 | 15.7 | 0.9 | NR4a1 | 1.0 | 0.05 |
| NR4a2 | 8.1 | 0.3 | NR4a2 | 0.5 | 0.02 |
| NR4a3 | 7.5 | 0.4 | NR4a3 | 0.5 | 0.03 |
| LRH-1 | 8.8 | 0.5 | LRH-1 | 0.6 | 0.03 |
| GCNF | 13.7 | 1.5 | GCNF | 0.9 | 0.10 |
| DAX-1 | 19.6 | 0.9 | DAX-1 | 1.3 | 0.06 |
| SHP | 14.0 | 0.9 | SHP | 0.9 | 0.06 |
| control | 15.6 | 0.6 | control | 1.0 | 0.04 |

TABLE 31
Results for assay for listed components for Bmal1.

| | | | |
|---|---|---|---|
| TRa1 | 0.8 | 0.03 | −1.31616 |
| TRa1 ligand | 0.8 | 0.08 | −1.27456 |
| TRa2 | 0.7 | 0.13 | −1.33391 |
| TRa2 ligand | 0.8 | 0.08 | −1.20607 |
| TRb1 | 1.1 | 0.04 | |
| TRb1 ligand | 0.7 | 0.08 | −1.50592 |
| TRb2 | 1.6 | 0.13 | |
| TRb2 ligand | 0.7 | 0.12 | −1.37491 |
| RARa | 1.2 | 0.07 | |
| RARa ligand | 0.5 | 0.06 | −1.88258 |
| RARb | 1.0 | 0.11 | −1.00183 |
| RARb ligand | 0.6 | 0.06 | −1.71379 |
| RARg | 1.2 | 0.10 | |
| RARg ligand | 0.6 | 0.09 | −1.55144 |
| PPARa | 0.5 | 0.07 | −1.93385 |
| PPARa ligand | 0.4 | 0.04 | −2.56132 |
| PPARg | 0.9 | 0.21 | −1.13065 |
| PPARg ligand | 0.7 | 0.02 | −1.51075 |
| PPARd | 0.7 | 0.11 | −1.39569 |
| PPARd ligand | 0.7 | 0.12 | −1.40972 |
| LXRa | 1.3 | 0.09 | |
| LXRa ligand | 1.1 | 0.05 | |
| LXRb | 1.1 | 0.05 | |
| LXRb ligand | 1.0 | 0.16 | −1.03535 |
| FXR | 1.0 | 0.14 | −1.00336 |
| FXR ligand | 1.1 | 0.08 | |
| FXRb | 0.9 | 0.07 | −1.08936 |
| FXRb ligand | 0.9 | 0.07 | −1.1028 |
| VDR | 1.4 | 0.04 | |
| VDR ligand | 0.8 | 0.07 | −1.26406 |
| PXR | 2.0 | 0.19 | |
| PXR ligand | 1.0 | 0.13 | |
| CAR | 1.1 | 0.17 | |
| CAR ligand | 0.8 | 0.05 | −1.30572 |
| control | 0.9 | 0.06 | −1.06737 |
| RXRa | 0.8 | 0.04 | −1.3294 |
| RXRa ligand | 0.7 | 0.08 | −1.53458 |
| RXRb | 0.8 | 0.06 | −1.24718 |
| RXRb ligand | 0.7 | 0.03 | −1.44585 |
| RXRg | 0.8 | 0.06 | −1.23235 |
| RXRg ligand | 0.9 | 0.03 | −1.14203 |
| RVRa | 0.2 | 0.00 | −6.33755 |
| RVRb | 0.1 | 0.00 | −19.8758 |
| RORa | 7.4 | 0.57 | |
| RORb | 1.1 | 0.10 | |
| RORg | 3.8 | 0.50 | |
| HNF4a | 0.6 | 0.03 | −1.5426 |
| HNF4g | 0.7 | 0.05 | −1.36105 |
| TR2 | 0.7 | 0.08 | −1.44175 |
| TR4 | 1.4 | 0.11 | |
| TLX | 0.8 | 0.12 | −1.28037 |
| PNR | 0.5 | 0.04 | −2.05453 |
| Era | 1.0 | 0.04 | −1.00332 |
| Era ligand | 1.9 | 0.11 | |
| Erb | 1.1 | 0.11 | |
| Erb ligand | 1.1 | 0.07 | |
| ERR1 | 0.9 | 0.05 | −1.1476 |
| ERR2 | 0.7 | 0.01 | −1.47589 |
| ERR3 | 0.6 | 0.06 | −1.6432 |
| CTF1 | 1.7 | 0.20 | |
| CTF2 | 1.9 | 0.11 | |
| CTF3 | 1.4 | 0.09 | |
| SF-1 | 0.7 | 0.05 | −1.37541 |
| control | 1.1 | 0.16 | |
| GR | 0.8 | 0.10 | −1.1881 |
| GR ligand | 2.1 | 0.34 | |
| hMR | 1.2 | 0.02 | |
| hMR ligand | 1.0 | 0.04 | |
| PR | 1.1 | 0.03 | |
| PR ligand | 1.5 | 0.13 | |
| AR | 0.9 | 0.06 | −1.16187 |
| AR ligand | 1.4 | 0.10 | |
| NR4a1 | 1.0 | 0.05 | |
| NR4a2 | 0.5 | 0.02 | −1.92743 |
| NR4a3 | 0.5 | 0.03 | −2.09618 |
| LRH-1 | 0.6 | 0.03 | −1.7709 |
| GCNF | 0.9 | 0.10 | −1.14118 |
| DAX-1 | 1.3 | 0.06 | |
| SHP | 0.9 | 0.06 | −1.11879 |
| control | 1.0 | 0.04 | |

TABLE 32
Results for assay for listed components for RVRa.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 33.4 | 2.4 | TRa1 | 1.2 | 0.09 |
| TRa1 ligand | 168.6 | 5.4 | TRa1 ligand | 6.0 | 0.19 |
| TRa2 | 35.8 | 1.0 | TRa2 | 1.3 | 0.03 |
| TRa2 ligand | 18.9 | 2.3 | TRa2 ligand | 0.7 | 0.08 |
| TRb1 | 21.3 | 0.3 | TRb1 | 0.8 | 0.01 |
| TRb1 ligand | 127.2 | 3.8 | TRb1 ligand | 4.5 | 0.13 |
| TRb2 | 32.6 | 1.2 | TRb2 | 1.2 | 0.04 |
| TRb2 ligand | 49.2 | 6.9 | TRb2 ligand | 1.8 | 0.25 |
| RARa | 34.6 | 1.5 | RARa | 1.2 | 0.05 |
| RARa ligand | 30.7 | 3.2 | RARa ligand | 1.1 | 0.12 |
| RARb | 45.6 | 0.9 | RARb | 1.6 | 0.03 |
| RARb ligand | 38.3 | 5.9 | RARb ligand | 1.4 | 0.21 |
| RARg | 39.6 | 9.9 | RARg | 1.4 | 0.35 |
| RARg ligand | 46.4 | 3.6 | RARg ligand | 1.7 | 0.13 |
| PPARa | 52.1 | 0.3 | PPARa | 1.9 | 0.01 |
| PPARa ligand | 85.9 | 3.8 | PPARa ligand | 3.1 | 0.13 |
| PPARg | 40.6 | 2.9 | PPARg | 1.5 | 0.10 |
| PPARg ligand | 98.6 | 1.2 | PPARg ligand | 3.5 | 0.04 |
| PPARd | 25.3 | 1.0 | PPARd | 0.9 | 0.04 |
| PPARd ligand | 36.2 | 2.5 | PPARd ligand | 1.3 | 0.09 |
| LXRa | 39.1 | 2.5 | LXRa | 1.4 | 0.09 |
| LXRa ligand | 46.9 | 0.8 | LXRa ligand | 1.7 | 0.03 |
| LXRb | 30.9 | 1.3 | LXRb | 1.1 | 0.05 |
| LXRb ligand | 39.6 | 0.4 | LXRb ligand | 1.4 | 0.02 |
| FXR | 31.7 | 0.8 | FXR | 1.1 | 0.03 |
| FXR ligand | 34.6 | 1.4 | FXR ligand | 1.2 | 0.05 |
| FXRb | 30.9 | 2.9 | FXRb | 1.1 | 0.10 |
| FXRb ligand | 29.5 | 2.0 | FXRb ligand | 1.1 | 0.07 |
| VDR | 27.5 | 0.4 | VDR | 1.0 | 0.01 |
| VDR ligand | 46.9 | 1.5 | VDR ligand | 1.7 | 0.05 |
| PXR | 42.5 | 3.5 | PXR | 1.5 | 0.13 |
| PXR ligand | 41.2 | 3.9 | PXR ligand | 1.5 | 0.14 |
| CAR | 40.00 | 5.00 | CAR | 1.4 | 0.18 |
| CAR ligand | 37.00 | 3.00 | CAR ligand | 1.3 | 0.11 |
| control | 28.00 | 2.00 | control | 1.0 | 0.07 |
| RXRa | 26.26 | 2.04 | RXRa | 0.9 | 0.07 |
| RXRa ligand | 33.40 | 7.06 | RXRa ligand | 1.2 | 0.25 |
| RXRb | 17.38 | 5.17 | RXRb | 0.6 | 0.18 |
| RXRb ligand | 22.40 | 4.01 | RXRb ligand | 0.8 | 0.14 |
| RXRg | 24.64 | 2.52 | RXRg | 0.9 | 0.09 |
| RXRg ligand | 31.96 | 1.24 | RXRg ligand | 1.1 | 0.04 |
| RVRa | 9.76 | 0.46 | RVRa | 0.3 | 0.02 |
| RVRb | 2.06 | 0.23 | RVRb | 0.1 | 0.01 |
| RORa | 86.91 | 8.21 | RORa | 3.1 | 0.29 |
| RORb | 29.93 | 9.91 | RORb | 1.1 | 0.35 |
| RORg | 67.79 | 1.76 | RORg | 2.4 | 0.06 |
| HNF4a | 30.15 | 3.24 | HNF4a | 1.1 | 0.12 |
| HNF4g | 28.15 | 4.01 | HNF4g | 1.0 | 0.14 |
| TR2 | 52.3 | 4.3 | TR2 | 1.9 | 0.15 |
| TR4 | 26.5 | 1.3 | TR4 | 0.9 | 0.05 |
| TLX | 13.5 | 0.9 | TLX | 0.5 | 0.03 |
| PNR | 7.1 | 1.0 | PNR | 0.3 | 0.03 |
| Era | 20.7 | 1.2 | Era | 0.7 | 0.04 |
| Era ligand | 31.8 | 1.4 | Era ligand | 1.1 | 0.05 |
| Erb | 20.0 | 1.8 | Erb | 0.7 | 0.07 |
| Erb ligand | 18.8 | 1.2 | Erb ligand | 0.7 | 0.04 |
| ERR1 | 33.3 | 1.6 | ERR1 | 1.2 | 0.06 |
| ERR2 | 42.3 | 3.0 | ERR2 | 1.5 | 0.11 |
| ERR3 | 123.1 | 13.8 | ERR3 | 4.4 | 0.49 |
| CTF1 | 18.5 | 0.5 | CTF1 | 0.7 | 0.02 |
| CTF2 | 27.2 | 1.5 | CTF2 | 1.0 | 0.05 |
| CTF3 | 19.1 | 0.8 | CTF3 | 0.7 | 0.03 |
| SF-1 | 125.0 | 11.1 | SF-1 | 4.5 | 0.40 |
| control | 27.3 | 3.2 | control | 1.0 | 0.11 |
| GR | 12.3 | 1.9 | GR | 0.4 | 0.07 |
| GR ligand | 27.9 | 2.0 | GR ligand | 1.0 | 0.07 |
| hMR | 13.7 | 0.6 | hMR | 0.5 | 0.02 |
| hMR ligand | 12.4 | 0.9 | hMR ligand | 0.4 | 0.03 |
| PR | 24.1 | 1.4 | PR | 0.9 | 0.05 |
| PR ligand | 34.3 | 8.1 | PR ligand | 1.2 | 0.29 |
| AR | 13.5 | 1.4 | AR | 0.5 | 0.05 |
| AR ligand | 10.1 | 0.7 | AR ligand | 0.4 | 0.02 |
| NR4a1 | 24.6 | 3.3 | NR4a1 | 0.9 | 0.12 |
| NR4a2 | 20.6 | 4.0 | NR4a2 | 0.7 | 0.14 |
| NR4a3 | 14.7 | 0.5 | NR4a3 | 0.5 | 0.02 |
| LRH-1 | 66.8 | 2.3 | LRH-1 | 2.4 | 0.08 |
| GCNF | 25.7 | 2.4 | GCNF | 0.9 | 0.09 |
| DAX-1 | 29.4 | 5.4 | DAX-1 | 1.1 | 0.19 |
| SHP | 22.7 | 1.9 | SHP | 0.8 | 0.07 |
| control | 28.0 | 2.9 | control | 1.0 | 0.11 |

TABLE 33
Results for assay for listed components for RVRa.

| | | | | |
|---|---|---|---|---|
| TRa1 | 1.20 | 0.09 | | 0.08 |
| TRa1 ligand | 6.03 | 0.19 | | 0.78 |
| TRa2 | 1.28 | 0.03 | | 0.11 |
| TRa2 ligand | 0.67 | 0.08 | −1.48 | −0.17 |
| TRb1 | 0.76 | 0.01 | −1.31566 | −0.12 |
| TRb1 ligand | 4.55 | 0.13 | | 0.66 |
| TRb2 | 1.17 | 0.04 | | 0.07 |
| TRb2 ligand | 1.76 | 0.25 | | 0.25 |
| RARa | 1.24 | 0.05 | | 0.09 |
| RARa ligand | 1.10 | 0.12 | | 0.04 |
| RARb | 1.63 | 0.03 | | 0.21 |
| RARb ligand | 1.37 | 0.21 | | 0.14 |
| RARg | 1.42 | 0.35 | | 0.15 |
| RARg ligand | 1.66 | 0.13 | | 0.22 |
| PPARa | 1.86 | 0.01 | | 0.27 |
| PPARa ligand | 3.07 | 0.13 | | 0.49 |
| PPARg | 1.45 | 0.10 | | 0.16 |
| PPARg ligand | 3.53 | 0.04 | | 0.55 |
| PPARd | 0.90 | 0.04 | −1.10605 | −0.04 |
| PPARd ligand | 1.29 | 0.09 | | 0.11 |
| LXRa | 1.40 | 0.09 | | 0.15 |
| LXRa ligand | 1.68 | 0.03 | | 0.22 |
| LXRb | 1.10 | 0.05 | | 0.04 |
| LXRb ligand | 1.42 | 0.02 | | 0.15 |
| FXR | 1.13 | 0.03 | | 0.05 |
| FXR ligand | 1.24 | 0.05 | | 0.09 |
| FXRb | 1.11 | 0.10 | | 0.04 |
| FXRb ligand | 1.06 | 0.07 | | 0.02 |
| VDR | 0.98 | 0.01 | −1.01836 | −0.01 |
| VDR ligand | 1.68 | 0.05 | | 0.22 |
| PXR | 1.52 | 0.13 | | 0.18 |
| PXR ligand | 1.47 | 0.14 | | 0.17 |
| CAR | 1.43 | 0.18 | | 0.16 |
| CAR ligand | 1.32 | 0.11 | | 0.12 |
| control | 1.00 | 0.07 | | 0.00 |
| RXRa | 0.94 | 0.07 | −1.06496 | −0.03 |
| RXRa ligand | 1.19 | 0.25 | | 0.08 |
| RXRb | 0.62 | 0.18 | −1.60868 | −0.21 |
| RXRb ligand | 0.80 | 0.14 | −1.24838 | −0.10 |
| RXRg | 0.88 | 0.09 | −1.13478 | −0.05 |
| RXRg ligand | 1.14 | 0.04 | | 0.06 |
| RVRa | 0.35 | 0.02 | −2.86452 | −0.46 |
| RVRb | 0.07 | 0.01 | −13.5606 | −1.13 |
| RORa | 3.11 | 0.29 | | 0.49 |
| RORb | 1.07 | 0.35 | | 0.03 |
| RORg | 2.42 | 0.06 | | 0.38 |
| HNF4a | 1.08 | 0.12 | | 0.03 |
| HNF4g | 1.01 | 0.14 | | 0.00 |
| TR2 | 1.87 | 0.15 | | 0.27 |
| TR4 | 0.95 | 0.05 | −1.05389 | −0.02 |
| TLX | 0.48 | 0.03 | −2.07887 | −0.32 |
| PNR | 0.25 | 0.03 | −3.93573 | −0.60 |
| Era | 0.74 | 0.04 | −1.35282 | −0.13 |
| Era ligand | 1.14 | 0.05 | | 0.06 |
| Erb | 0.72 | 0.07 | −1.39682 | −0.15 |
| Erb ligand | 0.67 | 0.04 | −1.48764 | −0.17 |
| ERR1 | 1.19 | 0.06 | | 0.08 |
| ERR2 | 1.51 | 0.11 | | 0.18 |
| ERR3 | 4.40 | 0.49 | | 0.64 |
| CTF1 | 0.66 | 0.02 | −1.50967 | −0.18 |
| CTF2 | 0.97 | 0.05 | −1.02677 | −0.01 |
| CTF3 | 0.68 | 0.03 | −1.46657 | −0.17 |
| SF-1 | 4.47 | 0.40 | | 0.65 |
| control | 0.98 | 0.11 | −1.02359 | −0.01 |
| GR | 0.44 | 0.07 | −2.26921 | −0.36 |
| GR ligand | 1.00 | 0.07 | −1.00144 | 0.00 |
| hMR | 0.49 | 0.02 | −2.03582 | −0.31 |
| hMR ligand | 0.44 | 0.03 | −2.25528 | −0.35 |
| PR | 0.86 | 0.05 | −1.15998 | −0.06 |
| PR ligand | 1.23 | 0.29 | | 0.09 |
| AR | 0.48 | 0.05 | −2.06525 | −0.31 |
| AR ligand | 0.36 | 0.02 | −2.77808 | −0.44 |
| NR4a1 | 0.88 | 0.12 | −1.1361 | −0.06 |
| NR4a2 | 0.74 | 0.14 | −1.35711 | −0.13 |
| NR4a3 | 0.53 | 0.02 | −1.90031 | −0.28 |
| LRH-1 | 2.39 | 0.08 | | 0.38 |
| GCNF | 0.92 | 0.09 | −1.08741 | −0.04 |
| DAX-1 | 1.05 | 0.19 | | 0.02 |
| SHP | 0.81 | 0.07 | −1.22929 | −0.09 |
| control | 1.00 | 0.11 | | 0.00 |

TABLE 34
Results for assay for listed components for TNFa.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 346.3 | 55.2 | TRa1 | 0.4 | 0.06 |
| TRa1 ligand | 609.5 | 28.2 | TRa1 ligand | 0.6 | 0.03 |
| TRa2 | 761.3 | 13.5 | TRa2 | 0.8 | 0.01 |
| TRa2 ligand | 766.8 | 23.4 | TRa2 ligand | 0.8 | 0.02 |
| TRb1 | 837.9 | 44.0 | TRb1 | 0.9 | 0.04 |
| TRb1 ligand | 794.5 | 92.5 | TRb1 ligand | 0.8 | 0.09 |
| TRb2 | 1009.3 | 45.9 | TRb2 | 1.0 | 0.05 |
| TRb2 ligand | 1024.0 | 46.0 | TRb2 ligand | 1.0 | 0.05 |
| RARa | 1363.2 | 76.3 | RARa | 1.4 | 0.08 |
| RARa ligand | 1173.1 | 99.7 | RARa ligand | 1.2 | 0.10 |
| RARb | 1854.5 | 127.7 | RARb | 1.9 | 0.13 |
| RARb ligand | 1805.3 | 121.3 | RARb ligand | 1.8 | 0.12 |
| RARg | 1458.6 | 65.0 | RARg | 1.5 | 0.07 |
| RARg ligand | 1660.0 | 55.5 | RARg ligand | 1.7 | 0.06 |
| PPARa | 1107.9 | 15.7 | PPARa | 1.1 | 0.02 |
| PPARa ligand | 1254.7 | 62.0 | PPARa ligand | 1.3 | 0.06 |
| PPARg | 1345.4 | 290.1 | PPARg | 1.4 | 0.30 |
| PPARg ligand | 3367.3 | 138.1 | PPARg ligand | 3.4 | 0.14 |
| PPARd | 1138.3 | 142.3 | PPARd | 1.2 | 0.14 |
| PPARd ligand | 1550.0 | 189.7 | PPARd ligand | 1.6 | 0.19 |
| LXRa | 994.6 | 45.6 | LXRa | 1.0 | 0.05 |
| LXRa ligand | 1596.5 | 96.8 | LXRa ligand | 1.6 | 0.10 |
| LXRb | 866.1 | 92.4 | LXRb | 0.9 | 0.09 |
| LXRb ligand | 781.3 | 84.2 | LXRb ligand | 0.8 | 0.09 |
| FXR | 974.6 | 104.7 | FXR | 1.0 | 0.11 |
| FXR ligand | 1273.9 | 48.5 | FXR ligand | 1.3 | 0.05 |
| FXRb | 1159.8 | 104.6 | FXRb | 1.2 | 0.11 |
| FXRb ligand | 1093.8 | 15.5 | FXRb ligand | 1.1 | 0.02 |
| VDR | 986.3 | 112.0 | VDR | 1.0 | 0.11 |
| VDR ligand | 567.6 | 42.4 | VDR ligand | 0.6 | 0.04 |
| PXR | 1152.4 | 69.7 | PXR | 1.2 | 0.07 |
| PXR ligand | 765.8 | 43.0 | PXR ligand | 0.8 | 0.04 |
| CAR | 908.2 | 148.3 | CAR | 0.9 | 0.15 |
| CAR ligand | 811.3 | 34.3 | CAR ligand | 0.8 | 0.03 |
| control | 1120.8 | 86.6 | control | 1.1 | 0.09 |
| RXRa | 954.8 | 80.3 | RXRa | 1.0 | 0.08 |
| RXRa ligand | 1248.2 | 150.3 | RXRa ligand | 1.3 | 0.15 |
| RXRb | 1036.3 | 27.9 | RXRb | 1.1 | 0.03 |
| RXRb ligand | 979.2 | 49.1 | RXRb ligand | 1.0 | 0.05 |
| RXRg | 1025.0 | 38.4 | RXRg | 1.0 | 0.04 |
| RXRg ligand | 1276.7 | 67.5 | RXRg ligand | 1.3 | 0.07 |
| RVRa | 1069.4 | 66.2 | RVRa | 1.1 | 0.07 |
| RVRb | 1017.6 | 24.2 | RVRb | 1.0 | 0.02 |
| RORa | 607.5 | 22.7 | RORa | 0.6 | 0.02 |
| RORb | 1029.5 | 41.3 | RORb | 1.0 | 0.04 |
| RORg | 1152.0 | 49.2 | RORg | 1.2 | 0.05 |
| HNF4a | 852.9 | 51.8 | HNF4a | 0.9 | 0.05 |
| HNF4g | 859.3 | 70.9 | HNF4g | 0.9 | 0.07 |
| TR2 | 1038.2 | 20.9 | TR2 | 1.1 | 0.02 |
| TR4 | 1189.6 | 77.9 | TR4 | 1.2 | 0.08 |
| TLX | 1085.1 | 32.9 | TLX | 1.1 | 0.03 |
| PNR | 558.4 | 10.3 | PNR | 0.6 | 0.01 |
| Era | 816.8 | 60.9 | Era | 0.8 | 0.06 |
| Era ligand | 1206.9 | 98.0 | Era ligand | 1.2 | 0.10 |
| Erb | 811.5 | 72.6 | Erb | 0.8 | 0.07 |
| Erb ligand | 665.2 | 27.5 | Erb ligand | 0.7 | 0.03 |
| ERR1 | 1234.7 | 107.3 | ERR1 | 1.3 | 0.11 |
| ERR2 | 1655.6 | 142.1 | ERR2 | 1.7 | 0.14 |
| ERR3 | 2705.8 | 203.3 | ERR3 | 2.8 | 0.21 |
| CTF1 | 728.5 | 12.1 | CTF1 | 0.7 | 0.01 |
| CTF2 | 1014.3 | 21.0 | CTF2 | 1.0 | 0.02 |
| CTF3 | 932.4 | 13.2 | CTF3 | 0.9 | 0.01 |
| SF-1 | 1900.9 | 225.8 | SF-1 | 1.9 | 0.23 |
| control | 1061.4 | 58.3 | control | 1.1 | 0.06 |
| GR | 463.3 | 26.4 | GR | 0.5 | 0.03 |
| GR ligand | 1003.8 | 61.3 | GR ligand | 1.0 | 0.06 |
| hMR | 614.3 | 33.5 | hMR | 0.6 | 0.03 |
| hMR ligand | 583.3 | 17.2 | hMR ligand | 0.6 | 0.02 |
| PR | 1214.8 | 86.0 | PR | 1.2 | 0.09 |
| PR ligand | 952.3 | 62.6 | PR ligand | 1.0 | 0.06 |
| AR | 1019.9 | 414.7 | AR | 1.0 | 0.42 |
| AR ligand | 902.7 | 97.0 | AR ligand | 0.9 | 0.10 |
| NR4a1 | 1575.8 | 142.4 | NR4a1 | 1.6 | 0.14 |
| NR4a2 | 735.5 | 127.0 | NR4a2 | 0.7 | 0.13 |
| NR4a3 | 691.0 | 33.4 | NR4a3 | 0.7 | 0.03 |
| LRH-1 | 2062.5 | 129.8 | LRH-1 | 2.1 | 0.13 |
| GCNF | 1203.7 | 210.9 | GCNF | 1.2 | 0.21 |
| DAX-1 | 854.8 | 66.4 | DAX-1 | 0.9 | 0.07 |
| SHP | 914.4 | 109.4 | SHP | 0.9 | 0.11 |
| control | 983.1 | 38.9 | control | 1.0 | 0.04 |

TABLE 35
Results for assay for listed components for IFNg.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 15.1 | 1.3 | TRa1 | 0.9 | 0.08 |
| TRa1 ligand | 14.1 | 2.7 | TRa1 ligand | 0.9 | 0.17 |
| TRa2 | 13.6 | 0.3 | TRa2 | 0.9 | 0.02 |
| TRa2 ligand | 11.8 | 0.7 | TRa2 ligand | 0.7 | 0.05 |
| TRb1 | 17.8 | 1.8 | TRb1 | 1.1 | 0.11 |
| TRb1 ligand | 15.7 | 1.0 | TRb1 ligand | 1.0 | 0.06 |
| TRb2 | 19.1 | 1.0 | TRb2 | 1.2 | 0.06 |
| TRb2 ligand | 16.9 | 0.9 | TRb2 ligand | 1.1 | 0.05 |
| RARa | 22.0 | 2.3 | RARa | 1.4 | 0.15 |
| RARa ligand | 17.7 | 0.3 | RARa ligand | 1.1 | 0.02 |
| RARb | 24.4 | 5.1 | RARb | 1.5 | 0.32 |
| RARb ligand | 20.6 | 1.5 | RARb ligand | 1.3 | 0.09 |
| RARg | 22.8 | 2.9 | RARg | 1.4 | 0.18 |
| RARg ligand | 22.6 | 1.1 | RARg ligand | 1.4 | 0.07 |
| PPARa | 11.3 | 1.5 | PPARa | 0.7 | 0.10 |
| PPARa ligand | 12.9 | 1.2 | PPARa ligand | 0.8 | 0.07 |
| PPARg | 24.04 | 12.74 | PPARg | 1.5 | 0.80 |
| PPARg ligand | 35.88 | 4.35 | PPARg ligand | 2.3 | 0.27 |
| PPARd | 19.72 | 3.80 | PPARd | 1.2 | 0.24 |
| PPARd ligand | 23.63 | 5.77 | PPARd ligand | 1.5 | 0.36 |
| LXRa | 24.59 | 5.13 | LXRa | 1.5 | 0.32 |
| LXRa ligand | 45.42 | 3.78 | LXRa ligand | 2.9 | 0.24 |
| LXRb | 19.35 | 2.40 | LXRb | 1.2 | 0.15 |
| LXRb ligand | 15.52 | 0.60 | LXRb ligand | 1.0 | 0.04 |
| FXR | 17.12 | 2.47 | FXR | 1.1 | 0.16 |
| FXR ligand | 24.95 | 1.91 | FXR ligand | 1.6 | 0.12 |
| FXRb | 19.33 | 1.77 | FXRb | 1.2 | 0.11 |
| FXRb ligand | 19.05 | 0.33 | FXRb ligand | 1.2 | 0.02 |
| VDR | 16.06 | 0.66 | VDR | 1.0 | 0.04 |
| VDR ligand | 11.46 | 1.85 | VDR ligand | 0.7 | 0.12 |
| PXR | 23.93 | 4.10 | PXR | 1.5 | 0.26 |
| PXR ligand | 14.20 | 0.89 | PXR ligand | 0.9 | 0.06 |
| CAR | 19.0 | 2.5 | CAR | 1.2 | 0.15 |
| CAR ligand | 17.2 | 1.1 | CAR ligand | 1.1 | 0.07 |
| control | 18.9 | 2.5 | control | 1.2 | 0.16 |
| RXRa | 13.1 | 1.0 | RXRa | 0.8 | 0.06 |
| RXRa ligand | 22.0 | 4.0 | RXRa ligand | 1.4 | 0.25 |
| RXRb | 20.0 | 3.6 | RXRb | 1.3 | 0.23 |
| RXRb ligand | 20.6 | 2.0 | RXRb ligand | 1.3 | 0.13 |
| RXRg | 15.2 | 0.2 | RXRg | 1.0 | 0.02 |
| RXRg ligand | 26.8 | 3.1 | RXRg ligand | 1.7 | 0.20 |
| RVRa | 17.9 | 4.5 | RVRa | 1.1 | 0.28 |
| RVRb | 19.5 | 1.2 | RVRb | 1.2 | 0.07 |
| RORa | 8.8 | 1.9 | RORa | 0.6 | 0.12 |
| RORb | 22.2 | 4.4 | RORb | 1.4 | 0.28 |
| RORg | 17.9 | 1.1 | RORg | 1.1 | 0.07 |
| HNF4a | 8.7 | 0.3 | HNF4a | 0.5 | 0.02 |
| HNF4g | 13.3 | 1.4 | HNF4g | 0.8 | 0.09 |
| TR2 | 13.6 | 3.5 | TR2 | 0.9 | 0.22 |
| TR4 | 42.5 | 13.8 | TR4 | 2.7 | 0.87 |
| TLX | 28.0 | 4.2 | TLX | 1.8 | 0.27 |
| PNR | 11.3 | 2.8 | PNR | 0.7 | 0.18 |
| Era | 37.8 | 17.8 | Era | 2.4 | 1.12 |
| Era ligand | 88.0 | 28.8 | Era ligand | 5.5 | 1.81 |
| Erb | 22.0 | 1.7 | Erb | 1.4 | 0.11 |
| Erb ligand | 20.3 | 1.0 | Erb ligand | 1.3 | 0.06 |
| ERR1 | 18.5 | 2.4 | ERR1 | 1.2 | 0.15 |
| ERR2 | 58.9 | 4.6 | ERR2 | 3.7 | 0.29 |
| ERR3 | 27.9 | 2.4 | ERR3 | 1.8 | 0.15 |
| CTF1 | 31.8 | 2.8 | CTF1 | 2.0 | 0.17 |
| CTF2 | 35.0 | 6.3 | CTF2 | 2.2 | 0.39 |
| CTF3 | 28.5 | 8.8 | CTF3 | 1.8 | 0.55 |
| SF-1 | 46.3 | 4.3 | SF-1 | 2.9 | 0.27 |
| control | 14.8 | 1.1 | control | 0.9 | 0.07 |
| GR | 8.9 | 0.3 | GR | 0.6 | 0.02 |
| GR ligand | 106.1 | 11.3 | GR ligand | 6.7 | 0.71 |
| hMR | 10.4 | 0.2 | hMR | 0.7 | 0.01 |
| hMR ligand | 8.4 | 0.9 | hMR ligand | 0.5 | 0.06 |
| PR | 22.6 | 1.4 | PR | 1.4 | 0.09 |
| PR ligand | 148.5 | 34.0 | PR ligand | 9.3 | 2.14 |
| AR | 31.4 | 2.4 | AR | 2.0 | 0.15 |
| AR ligand | 39.3 | 5.8 | AR ligand | 2.5 | 0.37 |
| NR4a1 | 35.6 | 1.5 | NR4a1 | 2.2 | 0.09 |
| NR4a2 | 24.3 | 7.5 | NR4a2 | 1.5 | 0.47 |
| NR4a3 | 16.4 | 0.6 | NR4a3 | 1.0 | 0.04 |
| LRH-1 | 46.9 | 1.1 | LRH-1 | 2.9 | 0.07 |
| GCNF | 18.4 | 1.6 | GCNF | 1.2 | 0.10 |
| DAX-1 | 24.7 | 1.1 | DAX-1 | 1.6 | 0.07 |
| SHP | 16.0 | 1.1 | SHP | 1.0 | 0.07 |
| control | 15.9 | 1.9 | control | 1.0 | 0.12 |

TABLE 36
Results for assay for listed components for SREBP1c.

| | | | | Normal- | |
|---|---|---|---|---|---|
| | | | | ized | |
| | Luc. act., | | | Luc. act., | |
| | normal- | | | normal- | |
| HR/ligand | ized | | HR/ligand | ized | |
| component | to lacZ | SD | component | to control | SD |
| TRa1 | 268.2 | 97.3 | TRa1 | 0.8 | 0.30 |
| TRa1 ligand | 747.2 | 54.7 | TRa1 ligand | 2.3 | 0.17 |
| TRa2 | 952.2 | 55.7 | TRa2 | 3.0 | 0.17 |
| TRa2 ligand | 952.6 | 31.3 | TRa2 ligand | 3.0 | 0.10 |
| TRb1 | 833.0 | 181.3 | TRb1 | 2.6 | 0.56 |
| TRb1 ligand | 767.2 | 200.1 | TRb1 ligand | 2.4 | 0.62 |
| TRb2 | 1244.1 | 109.9 | TRb2 | 3.9 | 0.34 |
| TRb2 ligand | 695.4 | 30.6 | TRb2 ligand | 2.2 | 0.10 |
| RARa | 854.2 | 73.6 | RARa | 2.7 | 0.23 |
| RARa ligand | 1352.6 | 154.4 | RARa ligand | 4.2 | 0.48 |
| RARb | 1056.4 | 28.3 | RARb | 3.3 | 0.09 |
| RARb ligand | 1172.9 | 202.8 | RARb ligand | 3.6 | 0.63 |
| RARg | 1052.4 | 90.6 | RARg | 3.3 | 0.28 |
| RARg ligand | 942.4 | 49.8 | RARg ligand | 2.9 | 0.15 |
| PPARa | 935.6 | 76.2 | PPARa | 2.9 | 0.24 |
| PPARa ligand | 1129.8 | 633.3 | PPARa ligand | 3.5 | 1.97 |
| PPARg | 795.8 | 283.7 | PPARg | 2.5 | 0.88 |
| PPARg ligand | 2130.4 | 660.1 | PPARg ligand | 6.6 | 2.05 |
| PPARd | 658.7 | 248.0 | PPARd | 2.0 | 0.77 |
| PPARd ligand | 847.2 | 144.3 | PPARd ligand | 2.6 | 0.45 |
| LXRa | 5951.9 | 1125.3 | LXRa | 18.5 | 3.49 |
| LXRa ligand | 10000.2 | 3787.0 | LXRa ligand | 31.0 | 11.76 |
| LXRb | 4020.7 | 974.0 | LXRb | 12.5 | 3.02 |
| LXRb ligand | 3203.0 | 607.4 | LXRb ligand | 9.9 | 1.89 |
| FXR | 551.0 | 39.7 | FXR | 1.7 | 0.12 |
| FXR ligand | 1045.1 | 296.8 | FXR ligand | 3.2 | 0.92 |
| FXRb | 671.5 | 24.1 | FXRb | 2.1 | 0.07 |
| FXRb ligand | 817.9 | 226.0 | FXRb ligand | 2.5 | 0.70 |
| VDR | 460.1 | 35.6 | VDR | 1.4 | 0.11 |
| VDR ligand | 327.1 | 6.2 | VDR ligand | 1.0 | 0.02 |
| PXR | 486.8 | 155.7 | PXR | 1.5 | 0.48 |
| PXR ligand | 1259.2 | 62.3 | PXR ligand | 3.9 | 0.19 |
| CAR | 312.9 | 76.6 | CAR | 1.0 | 0.24 |
| CAR ligand | 463.3 | 70.4 | CAR ligand | 1.4 | 0.22 |
| control | 439.1 | 9.0 | control | 1.4 | 0.03 |
| RXRa | 521.9 | 29.7 | RXRa | 1.6 | 0.09 |
| RXRa ligand | 1678.2 | 81.8 | RXRa ligand | 5.2 | 0.25 |
| RXRb | 544.4 | 176.8 | RXRb | 1.7 | 0.55 |
| RXRb ligand | 1169.6 | 63.2 | RXRb ligand | 3.6 | 0.20 |
| RXRg | 999.7 | 358.9 | RXRg | 3.1 | 1.11 |
| RXRg ligand | 1720.4 | 44.1 | RXRg ligand | 5.3 | 0.14 |
| RVRa | 574.4 | 187.0 | RVRa | 1.8 | 0.58 |
| RVRb | 721.7 | 40.1 | RVRb | 2.2 | 0.12 |
| RORa | 410.8 | 202.1 | RORa | 1.3 | 0.63 |
| RORb | 442.5 | 13.2 | RORb | 1.4 | 0.04 |
| RORg | 644.8 | 65.9 | RORg | 2.0 | 0.20 |
| HNF4a | 263.6 | 36.5 | HNF4a | 0.8 | 0.11 |
| HNF4g | 296.9 | 61.8 | HNF4g | 0.9 | 0.19 |
| TR2 | 102.9 | 48.3 | TR2 | 0.3 | 0.15 |
| TR4 | 477.6 | 303.9 | TR4 | 1.5 | 0.94 |
| TLX | 352.4 | 290.9 | TLX | 1.1 | 0.90 |
| PNR | 265.7 | 153.9 | PNR | 0.8 | 0.48 |
| Era | 471.1 | 303.4 | Era | 1.5 | 0.94 |
| Era ligand | 532.1 | 327.5 | Era ligand | 1.7 | 1.02 |
| Erb | 249.2 | 161.7 | Erb | 0.8 | 0.50 |
| Erb ligand | 263.1 | 25.2 | Erb ligand | 0.8 | 0.08 |
| ERR1 | 316.8 | 201.0 | ERR1 | 1.0 | 0.62 |
| ERR2 | 347.9 | 44.2 | ERR2 | 1.1 | 0.14 |
| ERR3 | 406.7 | 109.8 | ERR3 | 1.3 | 0.34 |
| CTF1 | 205.9 | 4.4 | CTF1 | 0.6 | 0.01 |
| CTF2 | 455.6 | 313.0 | CTF2 | 1.4 | 0.97 |
| CTF3 | 230.3 | 14.3 | CTF3 | 0.7 | 0.04 |
| SF-1 | 916.0 | 26.5 | SF-1 | 2.8 | 0.08 |
| control | 466.0 | 317.5 | control | 1.4 | 0.99 |
| GR | 150.3 | 36.5 | GR | 0.5 | 0.11 |
| GR ligand | 88.0 | 18.8 | GR ligand | 0.3 | 0.06 |
| hMR | 223.2 | 63.0 | hMR | 0.7 | 0.20 |
| hMR ligand | 197.4 | 37.8 | hMR ligand | 0.6 | 0.12 |
| PR | 466.4 | 185.4 | PR | 1.4 | 0.58 |
| PR ligand | 595.3 | 256.6 | PR ligand | 1.8 | 0.80 |
| AR | 418.4 | 42.3 | AR | 1.3 | 0.13 |
| AR ligand | 316.6 | 21.1 | AR ligand | 1.0 | 0.07 |
| NR4a1 | 408.2 | 78.6 | NR4a1 | 1.3 | 0.24 |
| NR4a2 | 456.2 | 199.4 | NR4a2 | 1.4 | 0.62 |
| NR4a3 | 358.6 | 101.1 | NR4a3 | 1.1 | 0.31 |
| LRH-1 | 831.3 | 303.6 | LRH-1 | 2.6 | 0.94 |
| GCNF | 368.2 | 46.2 | GCNF | 1.1 | 0.14 |
| DAX-1 | 497.8 | 207.6 | DAX-1 | 1.5 | 0.64 |
| SHP | 350.6 | 81.7 | SHP | 1.1 | 0.25 |
| control | 322.1 | 24.0 | control | 1.0 | 0.07 |

TABLE 37
Results for assay for listed components for SREBP1c.

| | | |
|---|---|---|
| TRa1 | 0.832702 | 0.302202 |
| TRa1 ligand | 2.319781 | 0.169767 |
| TRa2 | 2.955924 | 0.172981 |
| TRa2 ligand | 2.957169 | 0.097074 |
| TRb1 | 2.585887 | 0.562683 |
| TRb1 ligand | 2.381769 | 0.621257 |
| TRb2 | 3.862314 | 0.341095 |
| TRb2 ligand | 2.15885 | 0.095056 |
| RARa | 2.651778 | 0.228458 |
| RARa ligand | 4.198993 | 0.479288 |
| RARb | 3.279674 | 0.087879 |
| RARb ligand | 3.641153 | 0.629669 |
| RARg | 3.267099 | 0.281326 |
| RARg ligand | 2.92552 | 0.154544 |
| PPARa | 2.904374 | 0.23671 |
| PPARa ligand | 3.507295 | 1.966112 |
| PPARg | 2.470423 | 0.880623 |
| PPARg ligand | 6.613569 | 2.049273 |
| PPARd | 2.04479 | 0.77001 |
| PPARd ligand | 2.63009 | 0.447966 |
| LXRa | 18.47733 | 3.493337 |
| LXRa ligand | 31.0449 | 11.75642 |
| LXRb | 12.48197 | 3.023787 |
| LXRb ligand | 9.943479 | 1.885576 |
| FXR | 1.710523 | 0.123368 |
| FXR ligand | 3.244584 | 0.921513 |
| FXRb | 2.084614 | 0.074883 |
| FXRb ligand | 2.539228 | 0.70158 |
| VDR | 1.428247 | 0.110668 |
| VDR ligand | 1.015355 | 0.01913 |
| PXR | 1.511312 | 0.483229 |
| PXR ligand | 3.909072 | 0.193544 |
| CAR | 0.971327 | 0.237745 |
| CAR ligand | 1.438349 | 0.218552 |
| control | 1.363153 | 0.028036 |
| RXRa | 1.6203 | 0.092318 |
| RXRa ligand | 5.209824 | 0.253803 |
| RXRb | 1.689947 | 0.548796 |
| RXRb ligand | 3.630881 | 0.196109 |
| RXRg | 3.103639 | 1.11419 |
| RXRg ligand | 5.340822 | 0.136771 |
| RVRa | 1.783309 | 0.580557 |
| RVRb | 2.240456 | 0.124489 |
| RORa | 1.275269 | 0.627303 |
| RORb | 1.373606 | 0.040838 |
| RORg | 2.001582 | 0.204575 |
| HNF4a | 0.818241 | 0.113269 |
| HNF4g | 0.921664 | 0.191836 |
| TR2 | 0.319372 | 0.149994 |
| TR4 | 1.482793 | 0.943284 |
| TLX | 1.094128 | 0.903126 |
| PNR | 0.824767 | 0.477782 |
| Era | 1.46237 | 0.94201 |
| Era ligand | 1.651987 | 1.016731 |
| Erb | 0.773706 | 0.50214 |
| Erb ligand | 0.816847 | 0.078143 |
| ERR1 | 0.983552 | 0.624123 |
| ERR2 | 1.080018 | 0.137106 |
| ERR3 | 1.262713 | 0.340723 |
| CTF1 | 0.639157 | 0.013549 |
| CTF2 | 1.414479 | 0.971604 |
| CTF3 | 0.71494 | 0.044378 |
| SF-1 | 2.843766 | 0.082237 |
| control | 1.44668 | 0.98581 |
| GR | 0.466489 | 0.113464 |
| GR ligand | 0.273169 | 0.058442 |
| hMR | 0.692813 | 0.195525 |
| hMR ligand | 0.612877 | 0.117231 |
| PR | 1.447996 | 0.575618 |
| PR ligand | 1.847986 | 0.796478 |
| AR | 1.298936 | 0.131393 |
| AR ligand | 0.982919 | 0.065634 |
| NR4a1 | 1.267089 | 0.244089 |
| NR4a2 | 1.416197 | 0.619035 |
| NR4a3 | 1.113103 | 0.313768 |
| LRH-1 | 2.58073 | 0.942632 |
| GCNF | 1.143023 | 0.143343 |
| DAX-1 | 1.545333 | 0.644587 |
| SHP | 1.088556 | 0.253749 |
| control | 1 | 0.074472 |

TABLE 38
Results for assay for listed components for ABCA1.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 6.1 | 0.5 | TRa1 | 1.1 | 0.08 |
| TRa1 ligand | 8.8 | 0.8 | TRa1 ligand | 1.6 | 0.14 |
| TRa2 | 9.6 | 0.9 | TRa2 | 1.7 | 0.17 |
| TRa2 ligand | 8.7 | 0.3 | TRa2 ligand | 1.6 | 0.06 |
| TRb1 | 11.5 | 1.3 | TRb1 | 2.1 | 0.23 |
| TRb1 ligand | 11.1 | 3.0 | TRb1 ligand | 2.0 | 0.53 |
| TRb2 | 13.0 | 1.8 | TRb2 | 2.3 | 0.32 |
| TRb2 ligand | 18.3 | 3.0 | TRb2 ligand | 3.3 | 0.53 |
| RARa | 24.6 | 2.4 | RARa | 4.4 | 0.43 |
| RARa ligand | 46.3 | 15.1 | RARa ligand | 8.3 | 2.68 |
| RARb | 36.8 | 5.6 | RARb | 6.6 | 1.00 |
| RARb ligand | 33.0 | 4.9 | RARb ligand | 5.9 | 0.87 |
| RARg | 26.4 | 2.8 | RARg | 4.7 | 0.50 |
| RARg ligand | 29.4 | 2.3 | RARg ligand | 5.2 | 0.41 |
| PPARa | 10.7 | 1.3 | PPARa | 1.9 | 0.23 |
| PPARa ligand | 11.3 | 0.5 | PPARa ligand | 2.0 | 0.10 |
| PPARg | 14.4 | 3.3 | PPARg | 2.6 | 0.59 |
| PPARg ligand | 18.6 | 2.0 | PPARg ligand | 3.3 | 0.36 |
| PPARd | 13.8 | 1.5 | PPARd | 2.5 | 0.27 |
| PPARd ligand | 14.5 | 0.8 | PPARd ligand | 2.6 | 0.15 |
| LXRa | 93.0 | 6.3 | LXRa | 16.6 | 1.13 |
| LXRa ligand | 221.5 | 9.3 | LXRa ligand | 39.4 | 1.65 |
| LXRb | 46.3 | 7.3 | LXRb | 8.3 | 1.29 |
| LXRb ligand | 60.2 | 10.1 | LXRb ligand | 10.7 | 1.79 |
| FXR | 14.0 | 3.8 | FXR | 2.5 | 0.67 |
| FXR ligand | 16.0 | 3.9 | FXR ligand | 2.9 | 0.69 |
| FXRb | 14.3 | 3.2 | FXRb | 2.5 | 0.56 |
| FXRb ligand | 12.2 | 1.5 | FXRb ligand | 2.2 | 0.27 |
| VDR | 15.2 | 0.4 | VDR | 2.7 | 0.06 |
| VDR ligand | 15.8 | 3.6 | VDR ligand | 2.8 | 0.64 |
| PXR | 15.2 | 4.8 | PXR | 2.7 | 0.86 |
| PXR ligand | 9.3 | 0.8 | PXR ligand | 1.7 | 0.15 |
| CAR | 6.1 | 0.5 | CAR | 1.1 | 0.08 |
| CAR ligand | 8.8 | 0.8 | CAR ligand | 1.6 | 0.14 |
| control | 9.6 | 0.9 | control | 1.7 | 0.17 |
| RXRa | 8.7 | 0.3 | RXRa | 1.6 | 0.06 |
| RXRa ligand | 11.5 | 1.3 | RXRa ligand | 2.1 | 0.23 |
| RXRb | 11.1 | 3.0 | RXRb | 2.0 | 0.53 |
| RXRb ligand | 13.0 | 1.8 | RXRb ligand | 2.3 | 0.32 |
| RXRg | 18.3 | 3.0 | RXRg | 3.3 | 0.53 |
| RXRg ligand | 24.6 | 2.4 | RXRg ligand | 4.4 | 0.43 |
| RVRa | 46.3 | 15.1 | RVRa | 8.3 | 2.68 |
| RVRb | 36.8 | 5.6 | RVRb | 6.6 | 1.00 |
| RORa | 33.0 | 4.9 | RORa | 5.9 | 0.87 |
| RORb | 26.4 | 2.8 | RORb | 4.7 | 0.50 |
| RORg | 29.4 | 2.3 | RORg | 5.2 | 0.41 |
| HNF4a | 10.7 | 1.3 | HNF4a | 1.9 | 0.23 |
| HNF4g | 11.3 | 0.5 | HNF4g | 2.0 | 0.10 |
| TR2 | 31.2 | 6.8 | TR2 | 5.6 | 1.22 |
| TR4 | 36.4 | 5.3 | TR4 | 6.5 | 0.94 |
| TLX | 21.8 | 0.9 | TLX | 3.9 | 0.17 |
| PNR | 9.9 | 0.6 | PNR | 1.8 | 0.11 |
| Era | 19.0 | 1.2 | Era | 3.4 | 0.21 |
| Era ligand | 20.8 | 7.3 | Era ligand | 3.7 | 1.31 |
| Erb | 12.4 | 0.3 | Erb | 2.2 | 0.05 |
| Erb ligand | 7.9 | 0.4 | Erb ligand | 1.4 | 0.08 |
| ERR1 | 8.2 | 0.0 | ERR1 | 1.5 | 0.00 |
| ERR2 | 33.0 | 9.7 | ERR2 | 5.9 | 1.72 |
| ERR3 | 11.4 | 0.7 | ERR3 | 2.0 | 0.13 |
| CTF1 | 5.5 | 0.7 | CTF1 | 1.0 | 0.12 |
| CTF2 | 4.7 | 0.5 | CTF2 | 0.8 | 0.09 |
| CTF3 | 5.6 | 1.2 | CTF3 | 1.0 | 0.21 |
| SF-1 | 34.4 | 0.6 | SF-1 | 6.1 | 0.10 |
| control | 6.4 | 0.6 | control | 1.1 | 0.10 |
| GR | 8.5 | 1.2 | GR | 1.5 | 0.22 |
| GR ligand | 8.4 | 0.8 | GR ligand | 1.5 | 0.15 |
| hMR | 6.8 | 0.5 | hMR | 1.2 | 0.08 |
| hMR ligand | 5.6 | 0.4 | hMR ligand | 1.0 | 0.07 |
| PR | 8.9 | 0.8 | PR | 1.6 | 0.15 |
| PR ligand | 9.1 | 0.4 | PR ligand | 1.6 | 0.07 |
| AR | 8.3 | 0.9 | AR | 1.5 | 0.15 |
| AR ligand | 9.7 | 1.4 | AR ligand | 1.7 | 0.25 |
| NR4a1 | 11.4 | 1.0 | NR4a1 | 2.0 | 0.18 |
| NR4a2 | 6.2 | 0.8 | NR4a2 | 1.1 | 0.14 |
| NR4a3 | 6.8 | 0.1 | NR4a3 | 1.2 | 0.02 |
| LRH-1 | 18.6 | 1.8 | LRH-1 | 3.3 | 0.32 |
| GCNF | 7.6 | 0.4 | GCNF | 1.4 | 0.07 |
| DAX-1 | 5.8 | 0.5 | DAX-1 | 1.0 | 0.09 |
| SHP | 6.8 | 0.3 | SHP | 1.2 | 0.06 |
| control | 5.6 | 0.5 | control | 1.0 | 0.09 |

TABLE 39
Results for assay for listed components for PPARG1.

| | Luc. act., | | | Normalized | |
|---|---|---|---|---|---|
| | normal- | | | Luc. act., | |
| HR/ligand | ized | | HR/ligand | normalized | |
| component | to lacZ | SD | component | to control | SD |
| TRa1 | 20.3 | 0.7 | TRa1 | 0.3 | 0.01 |
| TRa1 ligand | 18.1 | 1.2 | TRa1 ligand | 0.3 | 0.02 |
| TRa2 | 51.3 | 4.6 | TRa2 | 0.7 | 0.07 |
| TRa2 ligand | 44.0 | 1.5 | TRa2 ligand | 0.6 | 0.02 |
| TRb1 | 41.6 | 2.9 | TRb1 | 0.6 | 0.04 |
| TRb1 ligand | 38.3 | 1.8 | TRb1 ligand | 0.6 | 0.03 |
| TRb2 | 76.0 | 7.1 | TRb2 | 1.1 | 0.10 |
| TRb2 ligand | 62.9 | 1.3 | TRb2 ligand | 0.9 | 0.02 |
| RARa | 86.6 | 7.9 | RARa | 1.3 | 0.11 |
| RARa ligand | 74.5 | 7.6 | RARa ligand | 1.1 | 0.11 |
| RARb | 100.6 | 4.4 | RARb | 1.5 | 0.06 |
| RARb ligand | 87.8 | 2.6 | RARb ligand | 1.3 | 0.04 |
| RARg | 80.1 | 3.1 | RARg | 1.2 | 0.05 |
| RARg ligand | 74.6 | 11.2 | RARg ligand | 1.1 | 0.16 |
| PPARa | 57.6 | 3.4 | PPARa | 0.8 | 0.05 |
| PPARa ligand | 59.2 | 0.5 | PPARa ligand | 0.9 | 0.01 |
| PPARg | 75.7 | 9.7 | PPARg | 1.1 | 0.14 |
| PPARg ligand | 97.8 | 2.1 | PPARg ligand | 1.4 | 0.03 |
| PPARd | 46.0 | 1.1 | PPARd | 0.7 | 0.02 |
| PPARd ligand | 51.3 | 5.2 | PPARd ligand | 0.7 | 0.08 |
| LXRa | 80.8 | 11.9 | LXRa | 1.2 | 0.17 |
| LXRa ligand | 145.4 | 4.3 | LXRa ligand | 2.1 | 0.06 |
| LXRb | 37.9 | 2.1 | LXRb | 0.5 | 0.03 |
| LXRb ligand | 44.4 | 9.1 | LXRb ligand | 0.6 | 0.13 |
| FXR | 54.8 | 2.6 | FXR | 0.8 | 0.04 |
| FXR ligand | 70.2 | 15.0 | FXR ligand | 1.0 | 0.22 |
| FXRb | 73.5 | 1.7 | FXRb | 1.1 | 0.02 |
| FXRb ligand | 67.6 | 3.9 | FXRb ligand | 1.0 | 0.06 |
| VDR | 38.1 | 0.8 | VDR | 0.6 | 0.01 |
| VDR ligand | 52.1 | 5.1 | VDR ligand | 0.8 | 0.07 |
| PXR | 63.3 | 1.6 | PXR | 0.9 | 0.02 |
| PXR ligand | 61.7 | 6.2 | PXR ligand | 0.9 | 0.09 |
| CAR | 46.4 | 0.4 | CAR | 0.7 | 0.01 |
| CAR ligand | 47.7 | 0.9 | CAR ligand | 0.7 | 0.01 |
| control | 55.8 | 1.3 | control | 0.8 | 0.02 |
| RXRa | 45.6 | 4.5 | RXRa | 0.7 | 0.06 |
| RXRa ligand | 72.5 | 1.7 | RXRa ligand | 1.1 | 0.02 |
| RXRb | 23.1 | 2.1 | RXRb | 0.3 | 0.03 |
| RXRb ligand | 37.9 | 5.1 | RXRb ligand | 0.5 | 0.07 |
| RXRg | 43.7 | 4.7 | RXRg | 0.6 | 0.07 |
| RXRg ligand | 62.7 | 5.2 | RXRg ligand | 0.9 | 0.08 |
| RVRa | 45.9 | 5.4 | RVRa | 0.7 | 0.08 |
| RVRb | 55.5 | 10.9 | RVRb | 0.8 | 0.16 |
| RORa | 74.0 | 2.3 | RORa | 1.1 | 0.03 |
| RORb | 51.1 | 4.5 | RORb | 0.7 | 0.07 |
| RORg | 81.5 | 4.1 | RORg | 1.2 | 0.06 |
| HNF4a | 34.8 | 2.1 | HNF4a | 0.5 | 0.03 |
| HNF4g | 42.1 | 3.7 | HNF4g | 0.6 | 0.05 |
| TR2 | 45.5 | 3.1 | TR2 | 0.7 | 0.04 |
| TR4 | 66.2 | 4.6 | TR4 | 1.0 | 0.07 |
| TLX | 107.9 | 3.5 | TLX | 1.6 | 0.05 |
| PNR | 45.9 | 0.6 | PNR | 0.7 | 0.01 |
| Era | 64.4 | 5.0 | Era | 0.9 | 0.07 |
| Era ligand | 78.7 | 6.0 | Era ligand | 1.1 | 0.09 |
| Erb | 45.3 | 2.7 | Erb | 0.7 | 0.04 |
| Erb ligand | 44.1 | 3.4 | Erb ligand | 0.6 | 0.05 |
| ERR1 | 59.1 | 12.8 | ERR1 | 0.9 | 0.19 |
| ERR2 | 59.1 | 5.6 | ERR2 | 0.9 | 0.08 |
| ERR3 | 63.7 | 4.3 | ERR3 | 0.9 | 0.06 |
| CTF1 | 39.7 | 1.9 | CTF1 | 0.6 | 0.03 |
| CTF2 | 43.9 | 4.0 | CTF2 | 0.6 | 0.06 |
| CTF3 | 32.5 | 2.1 | CTF3 | 0.5 | 0.03 |
| SF-1 | 124.1 | 5.1 | SF-1 | 1.8 | 0.07 |
| control | 52.3 | 3.3 | control | 0.8 | 0.05 |
| GR | 37.2 | 4.4 | GR | 0.5 | 0.06 |
| GR ligand | 48.1 | 3.7 | GR ligand | 0.7 | 0.05 |
| hMR | 56.4 | 1.0 | hMR | 0.8 | 0.01 |
| hMR ligand | 41.2 | 1.2 | hMR ligand | 0.6 | 0.02 |
| PR | 81.3 | 6.2 | PR | 1.2 | 0.09 |
| PR ligand | 100.5 | 7.0 | PR ligand | 1.5 | 0.10 |
| AR | 90.6 | 5.4 | AR | 1.3 | 0.08 |
| AR ligand | 65.3 | 16.8 | AR ligand | 0.9 | 0.24 |
| NR4a1 | 129.6 | 3.8 | NR4a1 | 1.9 | 0.06 |
| NR4a2 | 58.8 | 2.2 | NR4a2 | 0.9 | 0.03 |
| NR4a3 | 61.0 | 2.5 | NR4a3 | 0.9 | 0.04 |
| LRH-1 | 138.2 | 11.7 | LRH-1 | 2.0 | 0.17 |
| GCNF | 88.6 | 13.2 | GCNF | 1.3 | 0.19 |
| DAX-1 | 67.5 | 7.4 | DAX-1 | 1.0 | 0.11 |
| SHP | 67.9 | 5.3 | SHP | 1.0 | 0.08 |
| control | 68.9 | 4.0 | control | 1.0 | 0.06 |

TABLE 40
Results for assay for listed components for PPARG2.

| | | | | Normalized | |
|---|---|---|---|---|---|
| | Luc. act., | | | Luc. act., | |
| HR/ligand | normalized | | HR/ligand | normalized | |
| component | to lacZ | SD | component | to control | SD |
| TRa1 | 1.0 | 0.3 | TRa1 | 0.5 | 0.14 |
| TRa1 ligand | 1.1 | 0.1 | TRa1 ligand | 0.5 | 0.04 |
| TRa2 | 1.5 | 0.1 | TRa2 | 0.7 | 0.06 |
| TRa2 ligand | 1.4 | 0.1 | TRa2 ligand | 0.7 | 0.04 |
| TRb1 | 2.1 | 0.9 | TRb1 | 1.1 | 0.43 |
| TRb1 ligand | 1.6 | 0.3 | TRb1 ligand | 0.8 | 0.15 |
| TRb2 | 1.8 | 0.1 | TRb2 | 0.9 | 0.05 |
| TRb2 ligand | 1.8 | 0.2 | TRb2 ligand | 0.9 | 0.09 |
| RARa | 3.5 | 1.3 | RARa | 1.7 | 0.66 |
| RARa ligand | 3.7 | 0.3 | RARa ligand | 1.9 | 0.17 |
| RARb | 3.4 | 0.4 | RARb | 1.7 | 0.20 |
| RARb ligand | 3.8 | 0.4 | RARb ligand | 1.9 | 0.19 |
| RARg | 3.0 | 0.2 | RARg | 1.5 | 0.09 |
| RARg ligand | 3.8 | 0.5 | RARg ligand | 1.9 | 0.23 |
| PPARa | 2.4 | 0.5 | PPARa | 1.2 | 0.24 |
| PPARa ligand | 1.2 | 0.3 | PPARa ligand | 0.6 | 0.13 |
| PPARg | 2.2 | 0.1 | PPARg | 1.1 | 0.07 |
| PPARg ligand | 3.6 | 0.1 | PPARg ligand | 1.8 | 0.06 |
| PPARd | 2.5 | 0.7 | PPARd | 1.2 | 0.33 |
| PPARd ligand | 2.1 | 0.1 | PPARd ligand | 1.0 | 0.06 |
| LXRa | 1.3 | 0.0 | LXRa | 0.6 | 0.02 |
| LXRa ligand | 1.7 | 0.1 | LXRa ligand | 0.9 | 0.03 |
| LXRb | 2.4 | 0.2 | LXRb | 1.2 | 0.12 |
| LXRb ligand | 2.0 | 0.2 | LXRb ligand | 1.0 | 0.12 |
| FXR | 1.8 | 0.2 | FXR | 0.9 | 0.12 |
| FXR ligand | 2.3 | 0.2 | FXR ligand | 1.1 | 0.10 |
| FXRb | 2.4 | 0.5 | FXRb | 1.2 | 0.23 |
| FXRb ligand | 1.8 | 0.0 | FXRb ligand | 0.9 | 0.02 |
| VDR | 2.1 | 0.3 | VDR | 1.0 | 0.14 |
| VDR ligand | 1.9 | 0.2 | VDR ligand | 0.9 | 0.08 |
| PXR | 1.8 | 0.1 | PXR | 0.9 | 0.05 |
| PXR ligand | 1.4 | 0.1 | PXR ligand | 0.7 | 0.07 |
| CAR | 1.3 | 0.3 | CAR | 0.6 | 0.14 |
| CAR ligand | 1.2 | 0.0 | CAR ligand | 0.6 | 0.02 |
| control | 1.8 | 0.0 | control | 0.9 | 0.02 |
| RXRa | 1.3 | 0.0 | RXRa | 0.7 | 0.02 |
| RXRa ligand | 3.9 | 0.2 | RXRa ligand | 1.9 | 0.12 |
| RXRb | 1.5 | 0.4 | RXRb | 0.8 | 0.22 |
| RXRb ligand | 1.6 | 0.0 | RXRb ligand | 0.8 | 0.01 |
| RXRg | 1.5 | 0.1 | RXRg | 0.7 | 0.07 |
| RXRg ligand | 3.3 | 0.7 | RXRg ligand | 1.7 | 0.35 |
| RVRa | 1.5 | 0.1 | RVRa | 0.8 | 0.04 |
| RVRb | 1.0 | 0.0 | RVRb | 0.5 | 0.00 |
| RORa | 8.4 | 0.9 | RORa | 4.2 | 0.45 |
| RORb | 1.8 | 0.4 | RORb | 0.9 | 0.20 |
| RORg | 19.2 | 2.8 | RORg | 9.6 | 1.40 |
| HNF4a | 2.0 | 0.4 | HNF4a | 1.0 | 0.19 |
| HNF4g | 1.5 | 0.1 | HNF4g | 0.8 | 0.03 |
| TR2 | 1.9 | 0.0 | TR2 | 1.0 | 0.02 |
| TR4 | 3.3 | 0.2 | TR4 | 1.6 | 0.08 |
| TLX | 0.9 | 0.2 | TLX | 0.4 | 0.12 |
| PNR | 1.0 | 0.0 | PNR | 0.5 | 0.02 |
| Era | 2.0 | 0.2 | Era | 1.0 | 0.10 |
| Era ligand | 3.5 | 0.3 | Era ligand | 1.8 | 0.15 |
| Erb | 2.3 | 0.5 | Erb | 1.1 | 0.27 |
| Erb ligand | 1.3 | 0.1 | Erb ligand | 0.6 | 0.04 |
| ERR1 | 1.7 | 0.1 | ERR1 | 0.8 | 0.05 |
| ERR2 | 3.2 | 0.1 | ERR2 | 1.6 | 0.07 |
| ERR3 | 2.1 | 0.1 | ERR3 | 1.0 | 0.06 |
| CTF1 | 1.4 | 0.1 | CTF1 | 0.7 | 0.06 |
| CTF2 | 1.5 | 0.2 | CTF2 | 0.8 | 0.08 |
| CTF3 | 1.7 | 0.2 | CTF3 | 0.8 | 0.08 |
| SF-1 | 2.2 | 0.3 | SF-1 | 1.1 | 0.15 |
| control | 1.8 | 0.3 | control | 0.9 | 0.13 |
| GR | 2.3 | 0.0 | GR | 1.1 | 0.02 |
| GR ligand | 16.4 | 1.7 | GR ligand | 8.2 | 0.83 |
| hMR | 1.0 | 0.1 | hMR | 0.5 | 0.07 |
| hMR ligand | 0.9 | 0.1 | hMR ligand | 0.4 | 0.05 |
| PR | 1.8 | 0.1 | PR | 0.9 | 0.06 |
| PR ligand | 38.1 | 0.8 | PR ligand | 19.1 | 0.39 |
| AR | 2.7 | 0.1 | AR | 1.3 | 0.05 |
| AR ligand | 5.2 | 0.2 | AR ligand | 2.6 | 0.09 |
| NR4a1 | 1.6 | 0.1 | NR4a1 | 0.8 | 0.06 |
| NR4a2 | 1.4 | 0.4 | NR4a2 | 0.7 | 0.20 |
| NR4a3 | 1.1 | 0.1 | NR4a3 | 0.6 | 0.07 |
| LRH-1 | 2.8 | 0.3 | LRH-1 | 1.4 | 0.17 |
| GCNF | 1.4 | 0.1 | GCNF | 0.7 | 0.04 |
| DAX-1 | 1.9 | 0.0 | DAX-1 | 0.9 | 0.02 |
| SHP | 1.9 | 0.2 | SHP | 0.9 | 0.11 |
| control | 2.0 | 0.1 | control | 1.0 | 0.07 |

TABLE 41
Partial list of responsive promoters for genes whose
gene products comprise the human FGF Family.

| Name | ACCESSION | Transcript variant | Description |
|---|---|---|---|
| FGF1.1 | NM_000800 | Transcript variant 1 | Acidic growth factor |
| FGF1.2 | NM_033136 | Transcript variant 2 | ″ |
| FGF1.3 | NM_033137 | Transcript variant 3 | ″ |
| FGF1.4 | NM_001144892 | Transcript variant 4 | ″ |
| FGF1.5 | NM_001144934 | Transcript variant 5 | ″ |
| FGF1.6 | NM_001144935 | Transcript variant 6 | ″ |
| FGF1.7 | NR_026695 | Transcript variant 7 | ″ |
| FGF1.8 | NR_026696 | Transcript variant 8 | ″ |
| FGF2 | NM_002006 | | Basic growth factor |
| FGF3 | NM_005247 | | |
| FGF4 | NM_002007 | | |
| FGF5.1 | NM_004464 | Transcript variant 1 | |
| FGF5.2 | NM_033143 | Transcript variant 2 | |
| FGF6 | NM_020996 | | |
| FGF7 | NM_002009 | | Keratinocyte |
| | | | growth factor |
| FGF8A | NM_033165 | Transcript variant A | Androgen |
| | | | induced growth f. |
| FGF8B | NM_006119 | Transcript variant B | Androgen |
| | | | induced growth f. |
| FGF8E | NM_033164 | Transcript variant E | Androgen |
| | | | induced growth f. |
| FGF8F | NM_033163 | Transcript variant F | Androgen |
| | | | induced growth f. |
| FGF9 | NM_002010 | | Glia activating |
| | | | factor |
| FGF10 | NM_004465 | | |
| FGF11 | NM_004112 | | |
| FGF12.1 | NM_021032 | Transcript variant 1 | |
| FGF12.2 | NM_004113 | Transcript variant 2 | |
| FGF13.1 | NM_004114 | Transcript variant 1 | |
| FGF13.2 | NM_001139500 | Transcript variant 2 | |
| FGF13.3 | NM_001139501 | Transcript variant 3 | |
| FGF13.4 | NM_001139498 | Transcript variant 4 | |
| FGF13.5 | NM_001139502 | Transcript variant 5 | |
| FGF13.6 | NM_033642 | Transcript variant 6 | |
| FGF14.1 | NM_004115 | Transcript variant 1 | |
| FGF14.2 | NM_175929 | Transcript variant 2 | |
| FGF16 | NM_003868 | | |
| FGF17 | NM_003867 | | |
| FGF18 | NM_003862 | | |
| FGF19 | NM_005117 | | |
| FGF20 | NM_019851 | | |
| FGF21 | NM_019113 | | |
| FGF22 | NM_020637 | | |
| FGF23 | NM_020638 | | |

TABLE 42
Partial list of responsive promoters for genes whose gene
products comprise the human FGF receptor (FGFR) family.

| Name | ACCESSION | Transcript variant |
|---|---|---|
| FGFR1.1 | FJ809917 | Transcript variant 1 |
| FGFR1.3 | FJ809916 | Transcript variant 3 |
| FGFR2.1 | NM_000141 | Transcript variant 1 |
| FGFR2.2 | NM_022970 | Transcript variant 2 |
| FGFR2.3 | NM_001144913 | Transcript variant 3 |
| FGFR2.4 | NM_001144914 | Transcript variant 4 |
| FGFR2.5 | NM_001144915 | Transcript variant 5 |
| FGFR2.6 | NM_001144916 | Transcript variant 6 |
| FGFR2.7 | NM_001144917 | Transcript variant 7 |
| FGFR2.8 | NM_001144918 | Transcript variant 8 |
| FGFR2.9 | NM_001144919 | Transcript variant 9 |
| FGFR3.1 | NM_000142 | Transcript variant 1 |
| FGFR3.2 | NM_022965 | Transcript variant 2 |
| FGFR4.1 | NM_002011 | Transcript variant 1 |
| FGFR4.2 | NM_022963 | Transcript variant 2 |
| FGFR4.3 | NM_213647 | Transcript variant 3 |

What is claimed is:

1. A method of identifying a functional characteristic of a nucleic acid promoter sequence, said method comprising:
(i) transfecting a plurality of reporter cells with a nucleic acid promoter sequence linked to a nucleic acid reporter sequence;
(ii) transfecting said plurality of reporter cells with a nucleic acid driver sequence encoding a transcription modifying protein of known function, wherein each of said plurality of reporter cells is transfected with a different nucleic acid driver sequence encoding a transcription modifying protein of known function; and
(iii) detecting transcription of said nucleic acid reporter sequence in at least one of said plurality of reporter cells thereby identifying said functional characteristic of said nucleic acid promoter sequence.

2. A method of identifying a functional characteristic of a nucleic acid promoter sequence, said method comprising:
(i) transfecting a plurality of reporter cells with a nucleic acid promoter sequence linked to a nucleic acid reporter sequence;
(ii) transfecting said plurality of reporter cells with a nucleic acid driver sequence encoding a transcription modifying protein, wherein each of said plurality of reporter cells is transfected with a different nucleic acid driver sequence encoding a transcription modifying protein;
(iii) detecting transcription of said nucleic acid reporter sequence in at least one of said plurality of reporter cells thereby obtaining a transcription modifying protein interaction profile for said nucleic acid promoter sequence; and
(iv) comparing said transcription modifying protein interaction profile for said nucleic acid promoter sequence to a plurality of transcription modifying protein interaction profiles for a plurality of nucleic acid promoter sequences of known function thereby identifying a functional characteristic of said nucleic acid promoter sequence.

3. A method of identifying a functional characteristic of a transcription modifying protein, said method comprising:
(i) transfecting a plurality of reporter cells with a nucleic acid driver sequence encoding a transcription modifying protein;
(ii) transfecting said plurality of reporter cells with a nucleic acid promoter sequence of known function linked to a nucleic acid reporter sequence, wherein each of said plurality of reporter cells is transfected with a different nucleic acid promoter sequence of known function; and
(iii) detecting transcription of said nucleic acid reporter sequence in at least one of said plurality of reporter cells thereby identifying said functional characteristic of said transcription modifying protein.

4. A method of identifying a functional characteristic of a transcription modifying protein, said method comprising:
(i) transfecting a plurality of reporter cells with a nucleic acid driver sequence encoding a transcription modifying protein;
(ii) transfecting said plurality of reporter cells with a nucleic acid promoter sequence linked to a nucleic acid reporter sequence, wherein each of said plurality of reporter cells is transfected with a different nucleic acid promoter sequence;
(iii) detecting transcription of said nucleic acid reporter sequence in at least one of said plurality of reporter cells thereby obtaining a nucleic acid promoter sequence interaction profile for said transcription modifying protein; and
(iv) comparing said t nucleic acid promoter sequence interaction profile for said transcription modifying protein to a plurality of nucleic acid promoter sequence interaction profiles for a plurality of transcription modifying proteins of known function thereby identifying a functional characteristic of said transcription modifying protein.

5. A method of identifying a transcription modulating agent, said method comprising:
(i) transfecting a plurality of reporter cells with a nucleic acid promoter sequence linked to a nucleic acid reporter sequence;
(ii) transfecting said plurality of reporter cells with a nucleic acid driver sequence encoding a transcription modifying protein, wherein each of said plurality of reporter cells is transfected with a different
(a) nucleic acid promoter sequence; or
(b) nucleic acid driver sequences
(iii) contacting said reporter cell with a test transcription modulating agent;
(iv) detecting a modulation of an amount of transcription of at least one of said plurality of nucleic acid reporter sequences relative to an amount of transcription of said nucleic acid reporter sequence wherein said modulator agent is absent under otherwise similar test conditions, thereby identifying a transcription modulator.

6. The method of one of claims 1-5, wherein said plurality of reporter cells are transfected with said nucleic acid promoter sequence and said nucleic acid driver sequence in a ratio of about one nucleic acid promoter sequence to about one nucleic acid driver sequence.

7. The method of one of claims 1-5, wherein said reporter cells are transfected using reverse transfection.

8. The method of one of claims 1-5, wherein each of said plurality of reporter cells transfected with a different nucleic acid driver sequence or nucleic acid promoter sequence are present in a different container.

9. The method of claim 8, wherein said different container is a well of a multi-well plate.

10. The method of claim 9, wherein said multi-well plate comprises from about 50 to about 1000 wells.

11. The method of claim 8, wherein each of said different containers comprise about 3000 to about 5000 reporter cells.

12. A kit for identifying a functional characteristic of a transcription modifying protein or a functional characteristic of a nucleic acid promoter sequence, said kit comprising:
(i) a multi-well plate;
(ii) a plurality of reporter cells; and
(iii) a library of nucleic acid promoter sequences linked to a nucleic acid reporter sequence or a library of nucleic acid driver sequence encoding a transcription modifying protein.

13. The kit of claim 12, wherein said multi-well plate from 50 to 1000 wells.

14. The kit of claim 12 comprising said library of nucleic acid promoter sequences linked to a nucleic acid reporter sequence and said library of nucleic acid driver sequences encoding a transcription modifying protein.


SEQUENCE LISTING (58 sequences)

SEQ ID NO: 1 - DNA, 2812 bp, Homo sapiens
ggaaagtaggttagtggtgcgacatttagggaaggcagaaagtaggtcagggacggaggtgcctgtttacccgcgccggactcaccgccgccgccgccgcgggatccgagtgcgggcgcgggcgcgggcgctcccggcgagccacggtggtgctggctagagtgtatacgtttggacccaagcttaacttttccaatgtggaatcctgggccttcattggttccgatgtcataggaatctacgctagagggcttcctgtgtgccgggcactgtggtttttggaagaagctgaccgcctgaaaagaaattataaaacatgaaaatcgctttgaggtgaccaagtccagaggcccctaactcctcccaagctggatctggggtgtaagaactgtgacttcagatcatccaatggcagaccagagaatggacatttcttcaaccatcagtgatttcatgtccccgggccccaccgacctgctttccagctctcttggtaccagtggtgtggattgcaaccgcaaacggaaaggcagctccactgactaccaagaaagcatggacacagacaaagatgaccctcatggaaggttagaatatacagaacaccaaggaaggataaaaaatgcaagggaagctcacagtcagattgaaaagcggcgtcgggataaaatgaacagttttatagatgaattggcttctttggtaccaacatgcaacgcaatgtccaggaaattagataaacttactgtgctaaggatggctgttcagcacatgaaaacattaagaggtgccaccaatccatacacagaagcaaactacaaaccaacttttctatcagacgatgaattgaaacacctcattctcagggcagcagatggatttttgtttgtcgtaggatgtgaccgagggaagatactctttgtctcagagtctgtcttcaagatcctcaactacagccagaatgatctgattggtcagagtttgtttgactacctgcatcctaaagatattgccaaagtcaaggagcagctctcctcctctgacaccgcaccccgggagcggctcatagatgcaaaaactggacttccagttaaaacagatataacccctgggccatctcgattatgttctggagcacgacgttctttcttctgtaggatgaagtgtaacaggccttcagtaaaggttgaagacaaggacttcccctctacctgctcaaagaaaaaagatcgaaaaagcttctgcacaatccacagcacaggctatttgaaaagctggccacccacaaagatggggctggatgaagacaacgaaccagacaatgaggggtgtaacctcagctgcctcgtcgcaattggacgactgcattctcatgtagttccacaaccagtgaacggggaaatcagggtgaaatctatggaatatgtttctcggcacgcgatagatggaaagtttgtttttgtagaccagagggcaacagctattttggcatatttaccacaagaacttctaggcacatcgtgttatgaatattttcaccaagatgacataggacatcttgcagaatgtcataggcaagttttacagacgagagaaaaaattacaactaattgctataaatttaaaatcaaagatggttcttttatcacactacggagtcgatggttcagtttcatgaacccttggaccaaggaagtagaatatattgtctcaactaacactgttgttttagccaacgtcctggaaggcggggacccaaccttcccacagctcacagcatccccccacagcatggacagcatgctgccctctggagaaggtggcccaaagaggacccaccccactgttccagggattccagggggaacccgggctggggcaggaaaaataggccgaatgattgctgaggaaatcatggaaatccacaggataagagggtcatcgccttctagctgtggctccagcccattgaacatcacgagtacgcctccccctgatgcctcttctccaggaggcaagaagattttaaatggagggactccagacattccttccagtggcctactatcaggccaggctcaggagaacccaggttatccatattctgatagttcttctattcttggtgagaacccccacataggtatagacatgattgacaacgaccaaggatcaagtagtcccagtaatgatgaggcagcaatggctgtcatcatgagcctcttggaagcagatgctggactgggtggccctgttgactttagtgacttgccatggccgctgtaaacactacatgttgctttggcaacagctatagtatcaaagtgcattactggtggagttttacagtctgtgaagcttactggataaggagagaatagcttttatgtactgacttcataaaagccatctcagagccattgatacaagtcaatcttactatatgtaacttcagacaaagtggaactaagcctgctccagtgtttcctcatcattgattattgggctagctgtggatagcttgcattaattgtatattttggattctgtttgtgttgaattttttaatcattgtgcacagaagcatcattggtagcttttatatgcaaatggtcatttcagatgtatggtgtttttacactacaaagaagtcccccatgtggatatttcttatactaattgtatcataaagccgtttattcttccttgtaagaatcctttactataaatatgggttaaagtataatgtactagacagttaaatatttttaataaatgtttcccttgttctataaaaaaaaaaaaaaaaaaa

SEQ ID NO: 2 - DNA, 5801 bp, Homo sapiens
gagcgagagcgcgaaggaaatctggccgccgccgccgcgagcgctcccgaatttttacttgttcctgcaaagctgctggagctcagaagctgattctatcacattgtaagatgcctttggataattctacagtcctcttaaatgaatctttagaacttggcaagtctcactagataccttcaatcatcattttgagctcaaagaattctgagacttatggttggtcatatagaagagtaccttgaacctatagtttcctgaagaatcagtttaaaagatccaaggagtacaaaaggagaagtacaaatgtctactacaagacgaaaacgtagtatgttatgttgtttaccgtaagctgtagtaaaatgagctcgattgttgacagagatgacagtagtatttttgatgggttggtggaagaagatgacaaggacaaagcgaaaagagtatctagaaacaaatctgaaaagaaacgtagagatcaatttaatgttctcattaaagaactgggatccatgcttcctggtaatgctagaaagatggacaaatctactgttctgcagaaaagcattgattttttacgaaaacataaagaaatcactgcacagtcagatgctagtgaaattcgacaggactggaaacctacattccttagtaatgaagagtttacacaattaatgttagaggctcttgatggtttttttttagcaatcatgacagatggaagcataatatatgtgtctgagagtgtaacttcattacttgaacatttaccatctgatcttgtggatcaaagtatatttaattttatcccagaaggggaacattcagaggtttataaaatactctctactcatctgctggaaagtgattcattaaccccagaatatttaaaatcaaaaaatcagttagaattctgttgtcacatgctgcgaggaacaatagacccaaaggagccatctacctatgaatatgtaaaatttataggaaatttcaaatctttaaacagtgtatcctcttcagcacacaatggttttgaaggaactatacaacgcacacataggccatcttatgaagatagagtttgttttgtagctactgtcaggttagctacacctcagttcatcaaggaaatgtgcactgttgaagaacccaatgaagagtttacatctagacatagtttagaatggaagtttctgtttctagatcacagggcaccacccataatagggtatttgccatttgaagttctgggaacatcaggctatgattactatcatgtggatgacctagaaaatttggcaaaatgtcatgagcacttaatgcaatatgggaaaggcaaatcatgttattataggttcctgactaaggggcaacagtggatttggcttcagactcattattatatcacttaccatcagtggaattcaaggccagagtttattgtttgtactcacactgtagtaagttatgcagaagttagggctgaaagacgacgagaacttggcattgaagagtctcttcctgagacagctgctgacaaaagccaagattctgggtcagataatcgtataaacacagtcagtctcaaggaagcattggaaaggtttgatcacagcccaaccccttctgcctcttctcggagttcaagaaaatcatctcacacggccgtctcagacccttcctcaacaccaaccaagatcccgacggatacgagcactccacccaggcagcatttaccagctcatgagaagatggtgcaaagaaggtcatcatttagtagtcagtccataaattcccagtctgttggttcatcattaacacagccagtgatgtctcaagctacaaatttaccaattccacaaggcatgtcccagtttcagttttcagctcaattaggagccatgcaacatctgaaagaccaattggaacaacggacacgcatgatagaagcaaatattcatcggcaacaagaagaactaagaaaaattcaagaacaacttcagatggtccatggtcaggggctgcagatgtttttgcaacaatcaaatcctgggttgaattttggttccgttcaactttcttctggaaattcatctaacatccagcaacttgcacctataaatatgcaaggccaagttgttcctactaaccagattcaaagtggaatgaatactggacacattggcacaactcagcacatgatacaacaacagactttacagagtacatcaactcagagtcaacaaaatgtactgagtgggcacagtcagcaaacatctctacccagtcagacacagagcactcttacagccccactgtataacactatggtgatttctcagcctgcagccggaagcatggtccagattccatctagtatgccacaaaacagcacccagagtgctgcagtaactacattcactcaggacaggcagataagattttctcaaggtcaacaacttgtgaccaaattagtgactgctcctgtagcttgtggggcagtcatggtacctagtactatgcttatgggccaggtggtgactgcatatcctacttttgctacacaacagcaacagtcacagacattgtcagtaacgcagcagcagcagcagcagagctcccaggagcagcagctcacttcagttcagcaaccatctcaggctcagctgacccagccaccgcaacaatttttacagacttctaggttgctccatgggaatccctcaactcaactcattctctctgctgcatttcctctacaacagagcaccttccctcagtcacatcaccagcaacatcagtctcagcaacagcagcaactcagccggcacaggactgacagcttgcccgacccttccaaggttcaaccacagtagcacacgtgcttcctctcttgacatcaagggaggaaggggatggcccattaagagttactcagatgacctgaggaaaggagggaaagttccagcagtttcatgagatgcagtattgagtgttctagttcctggaattagttggcagagaaaatgctgcctagtgctacagatgtacattaaataccagccagcaggaggtgatcataggggcatagccagttctgacagtgttttaggtgcctggatattttttgatggaaaaagaatatattgccaaatattaagaagctcagctatgaaatgacctccagggaatcagaaaggcactaatgatgttagtaacttttagtggttctgtgcctcttatcaagtgttacagaggacataccactgccatgtcaggggtttgcttacagtgatgccatgaagacagtccagtagacttggtagcgaccccctcccccaacccctctcccttttcagataatgatggaacagtaattactttcagaatgttgtgtgggttcaaattctctatgtacagatgatgtaaaaatatgtatatgtctagataaaaggagagaaagcaaaacattttgtatgctgcatgaaagcgttatctcttccttacaggtgtgagcacctttcctgaaattctgacaccatgtgcaaactgatccatcctgtttttccttttgtttacaacacagtagtgttctgttcacttttccggggcacaagtttttttgttcatactttggctgtgatgtcacagtttgttcagtgaggtatgatgtgctgctgggaatggattttttttttcaggttaaattattgatacaacaggattttcaagttattcagaaatatccctcatttcattatttttcaattatgtttgaaaataggatttgcactgctttattttaggtggctgggagttttgattgcatattttgttatagttcatagttggaaatatttgcgtaaatggttttcaacaagcctgaaagtaatttcaagaatgtttcagttatagaggtaaaatttgcacacaaaacatcttaggcactttttaacattctcaatcatgggaattttaacttttgggatttgttgaaatcttttttattatccttcacaatttcaatgcttcttttagtcagaaatgattcagggttatttgaggggaaaaaaccccatagtgccttgattttaattcaggtgataactcaccatcttgaagtcattgtccggtttccgtagcagttttgaaaccttagtacctttttaacagcatgtgggtgtcagtgtcattattagtctcctaataagttcctctgaagactgctatcagtctcttggactggaggtacaaataatttagaaataaaagatgataacctaacactatcatagttattaatgtgatcctaaaattgtttcctaaatcagcatttttctttagtcatttaagaatttaccagaaatatttgctcaatatgatcttgatattcctacaaagaaaaaagaaggggtagggatttggctatgccttcactacaacattagaatattgtaactcacatgccttctaaacgtgaactaagatttcctttggcaatatcatattctaaaagtaataaattccaatacaagttacatacatttaaaaaacattttacagattttatggtactaatgaaatttacagtgatagaacaaaagaggattagtagaaaatacattattagaatataaaaaatgttattactgaggaaagggaggagaggacaagtgtaataaatcaaaattgacctcaaaagaaaatgtgtaacagagttgaggttgttaaaacagaaaaggttctgaataatgaagattaacctaatgcagaattgctaggtaaagaggtcaggggaatgctaagccagttcttaagacttctctgtcctctgctttgctgttatccttaaggcatatactttgtctttctgcagaaaattctacctggctacaattactttgaacattaatgttgaaaaagaaaacaaccaaagaaaattggtacttacccttctacaaaagaagtgtgactagatatcaatcagtaattaacatatcaaggagctcttctagctaaatgaccatccagtagagatttcccacattcccatgaatatcaagaatagttgtcagaatatgtatgtacctgagcatatgtacacagacaagggggatgttgtggaatatggcaatagcattgttcttctcccctttcaaattgcctttcttgaccttatgccattccatatatatctgagttgtgcctcatttatttattggcaatacctagtgatacggatttagctaacaaaagatatgaagaactattatattgaggcctgtcctctacataccacacttaaaagatggtgaactgtgagtactacttaggttgacagcaacaaagcataagacaagccccaggtaaacgtctaaactgtttactcacattgtcctactccagccccttcaattatttcccatctccacaaatagtcgggggaaaaaattaaaattttcctttatgattcttactgttcttcgcagctcatcttttcctgcttagaattaaccattgctaatttaaaggagcagctagctgcttttctgtcagtctgaagcgtagtagtggaagaggtagtaagcaccagctgcctctttgctgctttgttttcctcctgattctcttaaatttgggttgcaaagctatcccgccccccaccctgccccatgaaacttgagcattcaaatgaagattcagcagtgtctgttcttcatttctatagccaaagctgttagttaaaatcccaaatctatagcatttaaagataccaaatagaaacaccttccagcttt

SEQ ID NO: 3 - DNA, 4004 bp, Homo sapiens
gtttgccgcgcgagcagccggcctctcgcaggagccgagggacccgcgcggctgcggcccaggagcggcggccgcggagcccggagacccgcagccgcggcggcggcggcggcggcggcagcagctagagcagcgcctcccgccgccgcccgggaggagctcgccgcgcccgctcgccgcctcgtctcccagcggcggcgggaggcgcgtctccccggcccagtccgcgcccggccccgcggggccgctccggcccgctccgaggaaaaactgcatagaaaatctaatggatgaagatgagaaagacagagccaagagagcttctcgaaacaagtctgagaagaagcgtcgggaccagttcaatgttctcatcaaagagctcagttccatgctccctggcaacacgcggaaaatggacaaaaccaccgtgttggaaaaggtcatcggatttttgcagaaacacaatgaagtctcagcgcaaacggaaatctgtgacattcagcaagactggaagccttcattcctcagtaatgaagaattcacccagctgatgttggaggcattagatggcttcattatcgcagtgacaacagacggcagcatcatctatgtctctgacagtatcacgcctctccttgggcatttaccgtcggatgtcatggatcagaatttgttaaatttcctcccagaacaagaacattcagaagtttataaaatcctttcttcccatatgcttgtgacggattccccctccccagaatacttaaaatctgacagcgatttagagttttattgccatcttctcagaggcagcttgaacccaaaggaatttccaacttatgaatacataaaatttgtaggaaattttcgctcttacaacaatgtgcctagcccctcctgtaatggttttgacaacaccctttcaagaccttgccgggtgccactaggaaaggaggtttgcttcattgccaccgttcgtctggcaacaccacaattcttaaaggaaatgtgcatagttgacgaacctttagaggaattcacttcaaggcatagcttggaatggaaatttttatttctggatcacagagcacctccaatcataggatacctgccttttgaagtgctgggaacctcaggctatgactactaccacattgatgacctggagctcctggccaggtgtcaccagcacctgatgcagtttggcaaagggaagtcgtgttgctaccggtttctgaccaaaggtcagcagtggatctggctgcagactcactactacatcacctaccatcagtggaactccaagcccgagttcatcgtgtgcacacactcggtggtcagttacgcagatgtccgggtggaaaggaggcaggagctggctctggaagacccgccatccgaggccctccactcctcagcactaaaggacaagggctcaagcctggaacctcggcagcactttaacacactcgacgtgggtgcctcgggccttaataccagtcattcgccatcggcgtcctcaagaagttcccacaaatcctcgcacacagccatgtcagaacccacctccactcccaccaagctgatggcagaggccagcaccccggctttgccaagatcagccaccctgccccaagagttacctgtccccgggctcagccaggcagccaccatgccggcccctctgccttccccatcgtcctgcgacctcacacagcagctcctgcctcagaccgttctgcagagcacgcccgctcccatggcacagttttcggcacagttcagcatgttccagaccatcaaagaccagctagagcagcggacgcggatcctgcaggccaatatccggtggcaacaggaagagctccacaagatccaggagcagctctgcctggtccaggactccaacgtccagatgttcctgcagcagccagctgtatccctgagcttcagcagcacccagcgacctgaggctcagcagcagctacagcaaaggtcagctgcagtgactcagccccagctcggggcgggcccccaacttccagggcagatctcctctgcccaggtcacaagccagcacctgctcagagaatcaagtgtgatatcaacccagggtccaaagccaatgagaagctcacagctaatgcagagcagcggccgctctggaagcagcctagtgtccccgttcagcagcgccacagctgcgctcccgccaagtctgaatctgaccacacctgcttccacctcccaggatgccagccagtgccagcccagcccagacttcagccatgatcggcagctcaggctgttgctgagccagcccatccagcccatgatgcccgggtcctgtgacgcaaggcagccctcggaagtcagcaggacgggacggcaagtcaagtacgcccagagccagaccgtgtttcaaaatccagacgcacaccccgccaacagcagcagcgccccgatgcccgtcctgctgatggggcaggcggtgctccaccccagcttccctgcctcccaaccatcgcccctgcagcctgcacaggcccggcagcagccaccgcagcactacctgcaggtacaggcaccaacctctttgcacagtgagcagcaggactcgctacttctctccacctactcacaacagccagggaccctgggctacccccaaccacccccagcacagccccagcccctacgtcctccccgaagggtcagcagtctgtctgagtcgtcaggcctccagcagccgccccgataatgccccggcactgaagtcgggacacaatcagctttaaccaatggatgaggggggtggccacaggagatggggagaggagtctgaactaaacccctggcttttgtgcacactgcatacgtttcagaactcctggatggtaaccatctctggagtgcagcgcttgctgcagtggaaatgatcaggaatactgaccgtgtttctcttgcctccgaggttcttgggcacactctatagccatactggacaggaaccaggtgccccgtgtaggcatcgtcggtcggtttgccgtcagagatggcgcatctcgctgcatcccccgagagtacaccggttgctctagccacctgcggcccgcccatctgcgctagctggccttcacgctcttgatcgtctttcctttgtattggagaaggactgggtcagagatctgttggagagagagaataaagagattatttttcattatttttaaatggttgtttttgttttaatttgcacagctacacagaggaaataacttaggcactttctgttttttttaaaaaaataataaggtctcatggcttcatttagagaccacagtaacaacagcagcccaccaatcagagaagctggttgttattaaccaagctacagattcacactttctggcctaaaccctaatgggatgaggcttttcaccccaggccatgctggtggtgattttttagcccctaaataaaacactggactatttcctgtttacttcattgattgcaactacaaaggtggactcaaagcaaagcacaatcatgccagccaacattccagaattctgctgagaactccaagtctgtgaggggagaggttttacaagccagacaggcctgggggactgcagtccccaaggagaccctgccacatgctggccctttgagtgagaatgctgcatctttctacatatcttcatgagaatactgagaattggattttccttttcaaaatgcactttgctttttttgtatgttttgttatgttgagatgtttctaaagaaaagattttatgtaattataagatgaagcgtagtgaattgtacagctgttgtaataatgacctatttctatataaaataaaattgtatggcttatgtgtaaattattttgtatctgagataccagttccttttcccaaatataaaagtataaaagttttcttgtgtttttctgtgagtgaaaattttgtaataaattaacaaatttgtac

SEQ ID NO: 4 - DNA, 4656 bp, Homo sapiens
ggctggagcggcggcgggcaggcgtgcggaggacactcctgcgaccaggtactggctgtgatcgaacttctcaaccctcagagacttagatcttccacctcactccctcagccaagcctccaggccccctcgtgcatccgtggtggcctctctgccttctctgttctgttctccccatggcccagacatgagtggccccctagaaggggctgatgggggaggggaccccaggcctggggaatcattttgtcctgggggcgtcccatcccctgggcccccacagcaccggccttgcccaggccccagcctggccgatgacaccgatgccaacagcaatggttcaagtggcaatgagtccaacgggcatgagtctagaggcgcatctcagcggagctcacacagctcctcctcaggcaacggcaaggactcagccctgctggagaccactgagagcagcaagagcacaaactctcagagcccatccccacccagcagttccattgcctacagcctcctgagtgccagctcagagcaggacaacccgtccaccagtggctgcagcagtgaacagtcagcccgggcaaggactcagaaggaactcatgacagcacttcgagagctcaagcttcgactgccgccagagcgccggggcaagggccgctctgggaccctggccacgctgcagtacgcactggcctgtgtcaagcaggtgcaggccaaccaggaatactaccagcagtggagcctggaggagggcgagccttgctccatggacatgtccacctataccctggaggagctggagcacatcacgtctgagtacacacttcagaaccaggataccttctcagtggctgtctccttcctgacgggccgaatcgtctacatttcggagcaggcagccgtcctgctgcgttgcaagcgggacgtgttccggggtacccgcttctctgagctcctggctccccaggatgtgggagtcttctatggttccactgctccatctcgcctgcccacctggggcacaggggcctcagcaggttcaggcctcagggactttacccaggagaagtccgtcttctgccgtatcagaggaggtcctgaccgggatccagggcctcggtaccagccattccgcctaaccccgtatgtgaccaagatccgggtctcagatggggcccctgcacagccgtgctgcctgctgattgcagagcgcatccattcgggttacgaagctccccggataccccctgacaagaggattttcactacgcggcacacacccagctgcctcttccaggatgtggatgaaagggctgcccccctgctgggctacctgccccaggacctcctgggggccccagtgctcctgttcctgcatcctgaggaccgacccctcatgctggctatccacaagaagattctgcagttggcgggccagccctttgaccactcccctatccgcttctgtgcccgcaacggggagtatgtcaccatggacaccagctgggctggctttgtgcacccctggagccgcaaggtagccttcgtgttgggccgccacaaagtacgcacggcccccctgaatgaggacgtgttcactcccccggcccccagcccagctccctccctggacactgatatccaggagctgtcagagcagatccaccggctgctgctgcagcccgtccacagccccagccccacgggactctgtggagtcggcgccgtgacatccccaggccctctccacagccctgggtcctccagtgatagcaacgggggtgatgcagaggggcctgggcctcctgcgccagtgactttccaacagatctgtaaggatgtgcatctggtgaagcaccagggccagcagctttttattgagtctcgggcccggcctcagtcccggccccgcctccctgctacaggcacgttcaaggccaaggcccttccctgccaatccccagacccagagctggaggcgggttctgctcccgtccaggccccactagccttggtccctgaggaggccgagaggaaagaagcctccagctgctcctaccagcagatcaactgcctggacagcatcctcaggtacctggagagctgcaacctccccagcaccactaagcgtaaatgtgcctcctcctcctcctataccacctcctcagcctctgacgacgacaggcagaggacaggtccagtctctgtggggaccaagaaagatccgccgtcagcagcgctgtctggggagggggccaccccacggaaggagccagtggtgggaggcaccctgagcccgctcgccctggccaataaggcggagagtgtggtgtccgtcaccagtcagtgtagcttcagctccaccatcgtccatgtgggagacaagaagcccccggagtcggacatcatcatgatggaggacctgcctggtctagccccaggcccagcccccagcccagcccccagccccacagtagcccctgacccagccccagacgcctaccgtccagtggggctgaccaaggccgtgctgtccctgcacacgcagaaggaagagcaagccttcctcagccgcttccgagacctgggcaggctgcgtggactcgacagctcttccacagctccctcagcccttggcgagcgaggctgccaccacggccccgcacccccaagccgccgacaccactgccgatccaaagccaagcgctcacgccaccaccagaaccctcgggctgaagcgccctgctatgtctcacacccctcacccgtgccaccctccaccccctggcccaccccaccagccactacccccttcccagcggttgtccagccctaccctctcccagtgttctctcctcgaggaggcccccagcctcttccccctgctcccacatctgtgcccccagctgctttccccgcccctttggtgaccccaatggtggccttggtgctccctaactatctgttcccaaccccatccagctatccttatggggcactccagacccctgctgaagggcctcccactcctgcctcgcactccccttctccatccttgcccgccctccccccgagtcctcctcaccgcccggactctccactgttcaactcgagatgcagctctccactccagctcaatctgctgcagctggaggagctcccccgtgctgagggggctgctgttgcaggaggccctgggagcagtgccgggcccccacctcccagtgcggaggctgctgagccagaggccagactggcggaggtcactgagtcctccaatcaggacgcactttccggctccagtgacctgctcgaacttctgctgcaagaggactcgcgctccggcacaggctccgcagcctcgggctccttgggctctggcttgggctctgggtctggttcaggctcccatgaagggggcagcacctcagccagcatcactcgcagcagccagagcagccacacaagcaaatactttggcagcatcgactcttccgaggctgaggctggggctgctcggggcggggctgagcctggggaccaggtgattaagtacgtgctccaggatcccatttggctgctcatggccaatgctgaccagcgcgtcatgatgacctaccaggtgccctccagggacatgacctctgtgctgaagcaggatcgggagcggctccgagccatgcagaagcagcagcctcggttttctgaggaccagcggcgggaactgggtgctgtgcactcctgggtccggaagggccaactgcctcgggctcttgatgtgatggcctgtgtggactgtgggagcagcacccaagatcctggtcaccctgatgacccactcttctcagagctggatggactggggctggagcccatggaagagggtggaggcgagcagggcagcagcggtggcggcagtggtgagggagagggctgcgaggaggcccaaggcggggccaaggcttcaagctctcaggacttggctatggaggaggaggaagaaggcaggagctcatccagtccagccttacctacagcaggaaactgcaccagctagactccattctgggaccatctccaggagtccatgagaggctttcttctcctatgtcccaattctcagaactcagatgtggctagaccaaccagtgggaaactgccccagcttctcccaccatagggggccggacccccatcaccagcctaggatccaggggctgcctctggcctcttagggagcagagagcagaactccgcagcccagcccagaggagtgtcacctcccacctttggagaggaatccttccctcccctggacaaagttgctgacaagctgctgaagtggcctctccatattccagctgagcctgaatctgactcttgagggttggggctgcacttatttattgcggggagacagctctctctcccacctcctccccagatgggaggagagcctgaggcccaagcaggacccgggggttccagcccctagctgctctggagtgggggaggttggtggaccatggagtccctggtgctgcccctcaggtgggacccaggggttctcagctgtaccctctgccgatggcatttgtgtttttgatatttgtgtctgttactacttttttaatacaaaaagataaaaacgcc

SEQ ID NO: 5 - DNA, 6342 bp, Homo sapiens
agcgccggctcgggcagcggaggcgccgccggaagttccttgggctgctggactcctcggcttgaaacggcgccggcgtgggggcgtgtgcccttggccctgtcccaggtggagagtggtcgagccgcgcgcagggtgcgctcgtttgaactgcggtgacaccgagggttggggactcgaacccccgcttcgcagctcaggagcctgaggtccgaaagcttcgttccagagcccagcatgaatggatacgcggaatttccgcccagccccagtaaccccaccaaggagcccgtggagccccagcccagccaggtcccactgcaggaagatgtggacatgagcagtggctccagtggacatgagaccaacgaaaactgctccacggggcgggactcgcagggcagtgactgtgacgacagtgggaaggagctggggatgctggtggagccaccggatgcccgccagagtccagatacctttagcctgatgatggcaaaatctgaacacaacccatctacaagtggctgcagtagcgaccagtcttcgaaagtggacacacacaaagaactgataaaaacactaaaggagctgaaggtccacctccctgcagacaagaaggccaagggcaaggccagtacgctggccaccttgaagtacgccctcaggagcgtgaagcaggtgaaagccaatgaagagtattaccagctgctgatgtccagcgagggtcacccctgtggagcagacgtgccctcctacaccgtggaggagatggagagcgttacctctgagcacattgtgaagaatgccgatatgtttgcggtggccgtgtccctggtgtctgggaagatcctgtacatctctgaccaggttgcatccatatttcactgtaaaagagatgccttcagcgatgccaagtttgtggagttcctggcgcctcacgatgtgggcgtgttccacagtttcacctccccgtacaagcttcccttgtggagcatgtgcagtggagcagattcttttactcaagaatgcatggaggagaaatctttcttttgccgtgtcagtgtccggaaaagccacgagaatgaaatccgctaccaccccttccgcatgacgccctacctggtcaaggtgcgggaccaacaaggtgctgagagtcagctttgctgccttctgctggcagagagagtgcactctggttatgaagcccctagaattcctcctgaaaagagaatttttacaaccacccatacaccaaattgtttgttccaggatgtggatgaaagggcggtccctctcctgggctacctacctcaggacctgattgaaaccccagtgctcgtgcagctccaccctagtgacaggcccttgatgctggccatccacaaaaagatcctgcagtcaggcgggcagcctttcgactattctcccattcggtttcgcgcccggaacggagagtacatcacgttggacaccagctggtccagcttcatcaacccatggagcaggaaaatctccttcatcattgggaggcacaaagtcagggtgggccctttgaatgaggacgtgtttgcagcccacccctgcacagaggagaaggccctgcaccccagcattcaggagctcacagagcagatccaccggctcctgctgcagcccgtcccccacagcggctccagtggctacgggagtctgggcagcaacgggtcccacgagcaccttatgagccagacctcctccagcgacagcaacggccatgaggactcacgccggaggagagccgaaatttgtaaaaatggtaacaagaccaaaaatagaagtcattattctcatgaatctggagaacaaaagaaaaaatccgttacagaaatgcaaactaatcccccagctgagaagaaagctgtccctgccatggaaaaggacagcctgggggtcagcttccccgaggagttggcctgcaagaaccagcccacctgctcctaccagcagatcagctgcttggacagcgtcatcaggtacttggagagctgcaatgaggctgccaccctgaagaggaaatgcgagttcccagcaaacgtcccagcgctaaggtccagtgataagcggaaggccacagtcagcccagggccacacgctggagaggcagagccgccctccagggtgaacagccgcacgggagtaggtacgcacctgacctcgctggcactgccgggcaaggcagagagtgtggcgtcgctcaccagccagtgcagctacagcagcaccatcgtccatgtgggagacaagaagccgcagccggagttagagatggtggaagatgctgcgagtgggccagaatccctggactgcctggcgggccctgccctggcctgtggtctcagccaagagaaggagcccttcaagaagctgggcctcaccaaggaggtactcgctgcacacacacagaaggaggagcagagcttcctgcagaagttcaaagaaataagaaaactcagcattttccagtcccactgccattactacttgcaagaaagatccaaggggcagccaagtgaacgaactgcccctggactaagaaatacttccggaatagattcaccttggaaaaaaacaggaaagaacagaaaattgaagtccaagcgggtcaaacctcgagactcatctgagagcaccggatctggggggcccgtgtccgcccggcccccgctggtgggcttgaacgccacagcctggtcaccctcagacacgtcccagtccagctgcccagccgtgccctttcccgccccagtgccagcagcttattcactgcccgtgtttccagcgccagggactgtggcagcacccccggcacctccccacgccagcttcacagtgcctgctgtgcccgtggacctccagcaccagtttgcagtccagcccccacctttccctgcccctttggcgcctgtcatggcattcatgctacccagttattccttcccctcggggaccccaaacctgccccaggccttcttccccagccagcctcagtttccgagccaccccacactcacatccgagatggcctctgcctcacagcctgagttccccagccggacctcgatccccagacagccatgtgcttgtccagccacccgggccaccccaccatcggccatgggtagggcctccccaccgctctttcagtcccgcagcagctcgcccctgcagctcaacctgctgcagctggaggaagcccctgagggtggcactggagccatggggaccacaggggccacagagacagcagctgtaggggcggactgcaaacctggcacttctcgggaccagcagccgaaggcgcctctgacccgtgatgaaccctcagacacacagaacagtgacgccctttccacgtcaagcggcctcctaaacctcctgctgaatgaggacctctgctcagcctcgggctctgctgcttcggagtctctgggctccggctcactgggctgcgacgcctccccgagtggggcaggcagtagtgacacaagtcataccagcaaatattttggaagcattgactcctcagagaataatcacaaagcaaaaatgaacactggtatggaagaaagtgagcatttcattaagtgcgtcctgcaggatcccatctggctgctgatggcagatgcggacagcagcgtcatgatgacgtaccagctgccttcccgaaatttagaagcggttttgaaggaggacagagagaagctgaagctcctacagaaactccagcccaggttcacggagagtcagaagcaggagctgcgcgaggtccaccagtggatgcagacgggcggcctgcccgcagccatcgacgtggcagaatgtgtttactgtgaaaacaaggaaaaaggtaatatttgcataccatatgaggaagatattccttctctgggactcagcgaagtgtcggacaccaaagaagacgaaaatggatcccccttgaatcacaggatcgaagagcagacgtaacccctgccccacctcagcccggcagccagcgaggtacaccaggtggtgcttggaagagatgaaagatcttcatggctgtttccactgaaatggacacatatgctcatgttgctttttttgttttagaaaaaaaaacaacatagttttctgaaggggcgacttaaaactgtggagagtggggagagttcggaaagaaatatgtttttatatataaaatatatatgtggagttttgtgggatggggaagagattttagttgttatttaacttgagaaagactaagcgcctcttagtgtcagggaagttgcctcagtgctcccagaagtcctgtgactgtgacgagacctctgtctgctgcaccagctggggactctggcttccagagctttcccagggtgtttggatcagatcaaattttgtcctctcttggggactgctttttatctgaattatcatttagtcaaggtagagtgtttttttatacataccaaatggagatagcagcctctcctagttttatttcaaaacgtttcacattaaatggtgtgaagcgttgtttggcaaaccaacagctttggcttctggtgtggtcaatatttcagtctgacataggttttgtttgtagtgaacaaagttgaaacatttgctctggactaaagaagcctagtggtttgtgtggccaactccatcggatgaatgcacacgcagacagaccctctgtatatttctgcattattcttgtctccttttcagaccatgatggccaatatggagattaaaatatgtcatcagtcatctctttatggtgacttccctttgcaaaccaggctgtgaccaacacatgtgagacccagtcctgtttggttttcttccgttggaaccacccagacatctgcttccacccagccaagcccacatcacatctcctggccgagagcagccactgccactcagtctgacagcttgcgactgcatctgtattttcaggggtgcagtgagctcacctctcccactgcaccctgggttgggtgcacagccctcattcttttcatgagcccgacctctctcggagcagcttcaggcctctgccagtgtccccagcacttttaggtcatttggacacttggggaaaagtgaggccagtctgcccggctttttacaaaacctcatgttgcattgtatattccaaagatggttcagaaaatttaatattggtccctggtggaaattcaaagttatcactgaagaacagttgacttaaaattggaccaagactatgaggcttaaaagggaccagggttttcttttttttttttttttttttttttttttagatggagtttctttttgcccaggctggagtgcagtggcgccatcttggctcactgcaacctctgcctcccaggttcaagcgattctcctgcctcagcctcctgagtagctgggaccacaggcgactgccaccacacccagctaattttttgtatttttagtagagacagggtttcaccatgttggccaggctggtctcgaactcctgacctcaagcgatccacccacctcggcctcccaaagtgctgggattacaggcgtgagccaccacgcccaactgggaccagggttttctgttttttgatggaggtgaaatctctttgtaatccactaggttttcatcgtaaaaccatcttatgcctgactattaaacctattcttcataaacacaagaacactttaatttttcgttaatttacaaagtaacatcagctgcctatgcctatgataaggtagcagtctgcattcttatggccattagatgttacaaactccttgcctctaaagtcagatcatgaagggataggtgttcatctaaggttacagttatgttaccgaaacacaaaactgccaaaatcttactctgctgttatgaatgtttaccatcagcattattttatcatttaatatgtgctcactgattgttaactgtagcttcagcgcgtgccaagcagttgacttaataggatcatcttgtgaatttgtttacgtgatgccaagcatcaagtcatgttttctttagtgtgtgtgcttacacaggtgttaaacagtttttctctattttaaactgagccttctttttaatatattcccgaagagatatgtaaataagctctcagagtttctgtgatgatttgttgagccttgctggacaagtggtttgtttgtgtgcaaaccaaactttctttacccagtgcaatagatttgtttgactgcttgtgtctttttatgacctgtttgccttttagaaaattggtaaataaagcaagtatatttttattttta

SEQ ID NO: 6 - DNA, 6203 bp, Homo sapiens
ggaaaagctcctcggagatgagcgtgaccccctggctcgtggtggccgcctgttctcactaacgccatggcggggaccggagtgagaaaccggtgtctgtcactgactgcaaagtgagcgagaagcaggctgcgggccgtcccagcacgacgtggagccccgcggagacctcgagatgccccgcggggaagctcctggccccgggagacggggggctaaggacgaggccctgggcgaagaatcgggggagcggtggagccccgagttccatctgcagaggaaattggcggacagcagccacagtgaacagcaagatcgaaacagagtttctgaagaacttatcatggttgtccaagaaatgaaaaaatacttcccctcggagagacgcaataaaccaagcactctagatgccctcaactatgctctccgctgtgtccacagcgttcaagcaaacagtgagtttttccagattctcagtcagaatggagcacctcaggcagatgtgagcatgtacagtcttgaggagctggccactatcgcttcagaacacacttccaaaaacacagatacctttgtggcagtattttcatttctgtctggaaggttagtgcacatttctgaacaggctgctttgatcctgaatcgtaagaaagatgtcctggcgtcttctcactttgttgacctgcttgcacctcaagacatgagggtattctacgcgcacactgccagagctcagcttcctttctggaacaactggacccaaagagctgcacggtatgaatgtgctccggtgaaaccttttttctgcaggatccgtggaggtgaagacagaaagcaagagaagtgtcactccccattccggatcatcccctatctgattcatgtacatcaccctgcccagccagaattggaatcggaaccttgctgtctcactgtggttgaaaagattcactctggttatgaagctcctcggatcccagtgaataaaagaatcttcaccaccacacacaccccagggtgtgtttttcttgaagtagatgaaaaagcagtgcctttgctgggttacctacctcaggacctgattggaacatcgatcctaagctacctgcaccctgaagatcgttctctgatggttgccatacaccaaaaagttttgaagtatgcagggcatcctccctttgaacattctcccattcgattttgtactcaaaacggagactacatcatactggattccagttggtccagctttgtgaatccctggagccggaagatttctttcatcattggtcggcataaagttcgaacgagcccactaaatgaggatgtttttgctaccaaaattaaaaagatgaacgataatgacaaagacataacagaattacaagaacaaatttacaaacttctcttacagccagttcacgtgagcgtgtccagcggctacgggagcctggggagcagcgggtcgcaggagcagcttgtcagcatcgcctcctccagtgaggccagtgggcaccgtgtggaggagacgaaggcggagcagatgaccttgcagcaggtctatgccagtgtgaacaaaattaaaaatctgggtcagcagctctacattgagtcaatgaccaaatcatcattcaagccagtgacggggacacgcacagaaccgaatggtggtggtgaatgtaagacctttacttccttccaccaaacactgaaaaacaatagtgtgtacactgagccctgtgaggatttgaggaacgatgagcacagcccatcctatcaacagatcaactgtatcgacagtgtcatcagatacctgaagagctacaacattccagctttgaaaagaaagtgtatctcctgtacaaatacaacttcttcctcctcagaagaagacaaacagaaccacaaggcagatgatgtccaagccttacaagctggtttgcaaatcccagccatacctaaatcagaaatgccaacaaatggacggtccatagacacaggaggaggagctccacagatcctgtccacggcgatgctgagcttggggtcgggcataagccaatgcggttacagcagcaccattgtccatgtcccacccccagagacagccagggatgctaccctcttctgtgagccctggaccctgaacatgcagccagcccctttgacctcggaagaatttaaacacgtggggctcacagcggctgttctgtcagcgcacacccagaaggaagagcagaattatgttgataaattccgagaaaagatcctgtcatcaccctacagctcctatcttcagcaagaaagcaggagcaaagctaaatattcatattttcaaggagattctacttccaagcagacgcggtcggccggctgcaggaaagggaagcacaagcggaagaagctgccggagccgccagacagcagcagctcgaacaccggctctggtccccgcaggggagcgcatcagaacgcacagccctgctgcccctccgcggcctcctctccgcacacctcgagcccgaccttcccacctgccgccatggtgcccagccaggccccttacctcgtcccagcttttcccctcccagccgcgacctcacccggaagagaatacgcagcccccggaactgcaccggaaggcctgcatgggctgcccttgtccgagggcttgcagccttacccagctttcccttttccttacttggatacttttatgaccgttttcctgcctgacccccctgtctgtcctctgttgtcgccatcgtttttgccatgtccattcctgggggcgacagcctcttctgcgatatcaccctcaatgtcgtcagcaatgagtccaactctggacccacccccttcagtcaccagccaaaggagagaggaggaaaagtgggaggcacaaagcgaggggcacccgttcattacttcgagaagcagctcacccttgcagttaaacttacttcaggaagagatgcccagaccctctgaatctccagatcagatgagaaggaacacgtgcccacaaactgagtattgtgttacaggcaacaatggcagtgagagcagtcctgctactaccggtgcactgtccacggggtcacctcccagggagaatccatcccatcctactgccagcgctctgtccacaggatcgcctcccatgaagaatccatcccatcctactgccagcgctctgtccacaggatcgcctcccatgaagaatccatcccatcctactgccagcacactgtccatgggattgcctcccagcaggactccatcccatcctactgccactgttctgtccacggggtcacctcccagcgaatccccatccagaactggttcagcagcatcaggaagcagcgacagcagtatataccttactagtagtgtttattcttctaaaatctcccaaaatgggcagcaatctcaggacgtacagaaaaaagaaacatttcctaatgtcgccgaagagcccatctggagaatgatacggcagacacctgagcgcattctcatgacataccaggtacctgagagggttaaagaagttgtactaaaagaagacctggaaaagctagaaagtatgaggcagcagcagccccagttttctcatgggcaaaaggaggagctggctaaggtgtataattggattcaaagccagactgtcactcaagaaatcgacattcaagcctgtgtcacttgtgaaaatgaagattcagctgatggtgcggccacatcctgtggtcaggttctggtagaagacagctgttgagtgactgtgaggatgaaccttcataccctttccaagacgtgttacacagacagacctttttaagtcctggacttttaaatgaccatgaagttatcattgaatgttaagattttttcttcttgattttttaatacacgtaatctttttgaagcagacattgtatacagaatcttacttctctttgttcctgatatattaaaatggccagttaggctctttttgtagttgaattgtcttctaaagagattggatggcctctaaagaggtatgtgtatctttatttcagatgtcacccagagtaaattataattagaagtatagctagaatgagccccaaaccttagcctcatttattttgttctgttacataagtcattttccccttagagtgcttgaagaaatgccacctacaggttgtgtacttttcataatggtttccatgaatgtagtacgttcatacaggcttcattcaacctggcgttcccctccataattaagatgaaacattccggttttctcacaacacattagcacatactgtccattagcatatctgggataaccaggttttgggggttgagttttggccttcatccttgtagatccctttcctattgatttcccaccttccagtgaaattctgaaagtcttatcttaaaaatcgatccgcttaccatgggcctattcttgtaagtttcagttagcatttgcatgtgtaatattaaaatgaaagagcttcttacccagtgctgttgcccttttgagtatttttgtttttaaaataatgattgtaaaatgttttacaagtaatgtaaaagctagtatcattcttacatacttctgtgtttaaattttcattcttaccaaaacagttaactctttctttccaatcaatttatacaaaagaggtcgctccagccctaccacaggtctgactggcactgccttttgtttgcccttgaacagggcagtgttgtggggactgcaaaagagaaaacgtccaggcgagcccagttgtcctcgcccacagggtcctgcaggctccatcagtcaccgctttctatggcgtttgtagttgtgtcttttaagaagtgagtgtgattgtttacttgataaatcagctcactctctggtgctttttagagaagtccctgattccttcttaaacttggaatgatagatgaaattcacacccctgcagatcagaaaaaacaaatagaagaaaatgagggttacagtaacctgttgtctttatataacttgcaacaaactaatttatttttttttcctttttttgtttttggttttttatggttttttaaggaaaatacttttctcctttgaagttttacagctttttgtaaatgcgtcctgataatgattaggaaaatcgaccttttcatccatgatgaccatcctcatagctcagatctcctttcaaagtagtggctttctggatggtaattccatcttaaggtgtcagaactattttcaaatgctgcctttgacagttcttggaattttctgatattaagcagttccatgcaaatattcgtgttttataaatagctctcatagtctgctccatcttgatagttaagtgatttctgaagcgtttgtgtgtgtgttgatcaggttgtgtgatatttttgcttgatagagaatcaaatttgaaacaattaaccagccagtagattgtctgtcagtgaccttctgtagtaataaagtttttgccactgtaaataaaaacagtatccgtagctatcaggatcattgcgcactcatatatgctaagccttctgttctctaatagaagcctttcttttccattgtttctggatatttgtattatccaaatgtgcttatttctttgccttagcacacgttttatggagtacttgttatactaggtttgatttgaaactggtgcttgtcgcagaactgtcagagcatgaggagcgctcctcctgtgggtggacgcattcacgcactcccaggttgcacctgctgctggcggtgagcagggggttcagcagcttgaccgatgccccccgagggggctctccccagcttaaactttgttgtttaaatttgttaactttttatattaatgactattgaaagtggtaataaaaatttatattataggcttcaatgttttcatgaatgttacccaaaaagctgtgttttctttggtcagaggtcaaaatttatgaaaaacaaaatgctgtatgaatggaaatcattttgcaattgagtgacacttcattgtaattcacagtgtaaatttaatccaaactgaaattttgtttcaactgaatttgtaattaactctgaatttgtttttaatcattagtaatatttcagttgggtatctttttaagtaaaaacaacaaataaactctgtacatgtaaaacgtga

SEQ ID NO: 7 - DNA, 2999 bp, Homo sapiens
agttacccgggcagcctcgggaccggtcaccggccggcaaccgtccagcggcctcgaccaccgcctctagcctccgttcccggtcctttctcccgggccgagagacagcgtcgccgacaggggctcattcccctccggttctcctcggtgactcacctcgggcgggccgttttgtctttaggggccgccttggtggggcgaggtttccgtgacgaatctcctggggccgtccgtgccggctcgggccgtcgtggcgactcgagctcctggaacttgctcaggctccggaggtccgaggccctcgaagttatgcgtcgcctccaggcggttgcggcgggcgcgggctcctaaagggcgtcacacccggactccgccgactaggcaacctccattcatctttccactgcgcctccagcgcccccgccttctccggtcccctcctcggagtcattttttcctgttccccctctgccgccctttcctcacgccccgggtgaggcaattctcttggaagcgaaggtgtcggctatgagccggagcctccttccttgaatttctccgtggaggacccgccgcgccccccggcatgggggtgaacgccgtgcactggttccgaaaggggctccggctccacgacaaccccgccctgaaggagtgcattcagggcgccgacaccatccgctgcgtctacatcctggacccctggttcgccggctcctccaatgtgggcatcaacaggtggcgatttttgcttcagtgtcttgaggatcttgatgccaatctacgaaaattaaactcccgtctgtttgtgattcgtggacaaccagcagatgtgtttcccaggcttttcaaggaatggaacattactaaactttcaattgagtatgattctgagccctttggaaaggaacgagacgcagctattaagaaactggcgactgaagctggagtagaagtcattgtaagaatttcacatacattatatgacctagacaagatcatagaactcaatggtggacaaccgcctctaacttataaaagattccagactctcatcagcaaaatggaaccactagagataccagtagagacaattacttcagaagtgatagaaaagtgcacaactcctctgtctgatgaccatgatgagaaatatggagtcccttcactggaagagctaggttttgatacagatggcttatcctctgcagtgtggccaggcggagaaactgaagcacttactcgtttggaaaggcatttggaaagaaaagcttgggtggcaaattttgaaagacctcgaatgaatgcgaattctctgcttgcaagccctactggacttagtccttatctccgatttggttgtttgtcatgtcgactgttttacttcaaactaacagatctctacaaaaaggtaaagaagaacagttcccctcccctttccctttatgggcaactgttatggcgtgaatttttctatacagcagcaacaaataatccacgctttgataaaatggaaggaaaccctatctgtgttcagattccttgggataaaaatcctgaggctttagccaaatgggcggaaggccggacaggctttccatggattgatgccatcatgacacagcttcgtcaggagggttggattcatcatctagccaggcatgcagttgcttgcttcctgacacgaggggacctgtggattagttgggaagaaggaatgaaggtatttgaagaattattgcttgatgcagattggagcataaatgctggaagttggatgtggctgtcttgtagttccttttttcaacagttttttcactgctattgccctgttggttttggtaggagaacagatcccaatggagactatatcaggcgttatttgcctgtcctaagaggcttccctgcaaaatatatctatgatccctggaatgcaccagaaggtatccaaaaggtagccaaatgtttgataggagttaattatcctaaaccaatggtgaaccatgctgaggcaagccgtttgaatatcgaaaggatgaaacagatctatcagcagctttcacgatatagaggactaggtcttctggcatcagtaccttctaatcctaatgggaatggaggcttcatgggatattctgcagaaaatatcccaggttgtagcagcagtggaagttgctctcaagggagtggtattttacactatgctcatggcgacagtcagcaaactcacctgttgaagcaaggaagaagctccatgggcactggtctcagtggtgggaaacgtcctagtcaggaagaggacacacagagtattggtcctaaagtccagagacagagcactaattagaaaacattcaggaggaatactgttgcagctgaaattggtggggagttcaatagcttttcaattaagttatttaaaaatattcttcattgatggaaagcagttacatattgaaatatgttgtttctaatgacatttctgtggtttttaactttttaatgaatttcacagaggacaattggtaatttgtatataaagaacttggcaagagaatttgcttaatgtaaatataaacagtcacaattagtatagacccatcgatatatttttgataatttttcatgtatggtaaagttaaaatgacaaattgatattctgatataaaactcaaagtttgaagtcagtgggaaaaaaggaggtttttagactttcttaaaagacgttaaaattttaggacagaattttcttgatgttgtttaatctaactttgcactctttgataataatgttttagataatgtcgtaatccaaattggtattgtagcctctgttaacacagacagtatatgttttaaactttgatgtaaacctttttagacccaaacttgtggaagtatcatgtgttaagttctctgtctctgtttctttgttcatttattactaaaatgaacttgttattaaagtatatgcaaatatgaaaaaaaaaaaaaaaaaa

SEQ ID NO: 8 - DNA, 4145 bp, Homo sapiens
agtctggacagtcatggcggcgactgtggcgacggcggcagctgtggccccggcgccagcgcccggcacggacagcgcctcttcggtgcactggttccgcaaagggctgcgactccacgacaacccggcgttgctggcggccgtgcgcggggcgcgctgcgtgcgctgcgtttacattctcgacccgtggttcgcggcctcctcctcagtcgggatcaaccgatggaggttcctacttcagtctctggaagatttggacacaagtttaaggaaactgaactcccgcctgtttgtagtccggggacagccagccgacgtgttcccaaggctgttcaaggaatggggagtgacccgcttgacctttgaatatgactctgaaccctttgggaaagaacgggatgcagccatcatgaagatggccaaggaggctggtgtggaagtagtgacggagaattctcataccctctatgacctggacaggatcattgagctgaatgggcagaagccaccccttacatacaagcgctttcaggccatcatcagccgcatggagctgcccaagaagccagtgggcttggtgaccagccagcagatggagagctgcagggccgagatccaggagaaccacgacgagacctacggcgtgccctccctggaggagctggggttccccactgaaggacttggtccagctgtctggcagggaggagagacagaagctctggcccgcctggataagcacttggaacggaaggcctgggttgccaactatgagagaccccgaatgaacgccaactccctcctggccagccccacaggcctcagcccctacctgcgctttggttgtctctcctgccgcctcttctactaccgcctgtgggacctgtataaaaaggtgaagcggaacagcacacctcccctctccctatttgggcaactcctatggcgagagttcttctacacggcagctaccaacaaccccaggtttgaccgcatggaggggaaccccatctgcatccagatcccctgggaccgcaatcctgaggccctggccaagtgggctgagggcaagacaggcttcccttggattgatgccatcatgacccaactgaggcaggagggctggatccaccacctggcccggcatgccgtggcctgcttcctgacccgcggggacctctgggtcagctgggagagcggggtccgggtatttgatgagctgctcctggatgcagatttcagcgtgaacgcaggcagctggatgtggctgtcctgcagtgctttcttccagcagttcttccactgctactgccctgtgggctttggccgtcgcacggaccccagtggggactacatcaggcgatacctgcccaaattgaaagcgttcccctctcgatacatctatgagccctggaatgccccagagtcaattcagaaggcagccaagtgcatcattggtgtggactacccacggcccatcgtcaaccatgccgagaccagccggcttaacattgaacgaatgaagcagatttaccagcagctttcgcgctaccggggactctgtctactggcatctgtcccttcctgtgtggaagacctcagtcaccctgtggcagagcccagctcgagccaggctggcagcatgagcagtgcaggcccaagaccactacccagtggcccagcatcccccaaacgcaagctggaagcagccgaggaaccacctggtgaagaactcagcaaacgggcccgggtggcagagttgccaaccccagagctgccgagcaaggatgcctgagactgcagagcccttgctccgtgagcaaagcctgggtgcccaagcagccaccgcagcagcagagtacaacctgcagagaagctgatcaccgggcagagatagagcgagcatgtgtgtgtgtgtgcgcgtgtgcagaggagggagtggtgtgcctgtttgtgtgtgcatgcatctgttgacactcatgattctgaatgttgcctgggctgggggagtacctgtagcacgccagtgctgtttcccggcctccagacacaaggctcgaggttatggcagtgactttcagctgagacctgttcctgcaagccagctgccttgtctgaacagaacgtagtggtaggaccctagctgggattctggcatctgcctccctagacctccttccctccctcctcacgtcaggctgtggagcaggagcacagcagttctggctgttgtccaaagcatgggattctggaggcagccagagccctgctgagttcctgctttctgacctggaggctgagcaggccggagtggatggatgctgtccagacgtagccacctggcctctgtttcttattttaaaattctctgctactgggctcagtcccaggcccttccttgggcttctgggactgagcatgaggccatagacagatctaaaaagtttccaccaccctacagaagtacacacagatacctgactggtgtggggtatgcctggtactgtaataggagcctaagacagcacacctaccttttcaggatttagaacctaaaattagaaagagaatcccagctgtcattgttccttccccagaagctaagagccagcctcagagcctacccaggagctgtgaaggggcaagggtcaaactgactcactctaccaggaggagaccaggttgcagtggcgtaaggccccctggtttctctggccacactccaaggcaccacagtgctgccagtgaggacagctgacacccagccagggaaaccattctagtctttattctgttggcttccagggcctgtcctggacttgtcagcatccagactgccatgtcagctatcccagtagctgagctccaaggactcaggcagagggactcagggatggggactgccaggggcagttggcaaaagtccaagtagagattacacccagcacaccattccttccaggagcagtaggtgggaggtttgacccagagaagccaatccttgcattccaggagtggcctgtgcctcccacctcttccttcccactgccaaaggcctgtgttgagaaagatgtcatgcaaaaggacgacggtggccaactaaagcaagtcttccttccaccctgtggcctgcacttgagccacaaagtgtgtgtgtgtgtgtgcgtgtgtggtacgtgtgtgtgtgtgtggctatgaggctgattcctgtttggatttttgtcctcacgtgtatcattaagctggcctttgggccttttcctttctacctcccctgtgacctttcctagcctcagatctgttaattcttttggccccagccctgtccctcactgtcctctgtccttggaccagaaccctggggtcagacccatctcctgtagctgtccatcacactgacaggcttcttcctgagatatcctcaggttttctcagccagagagctgcctttagagtccaactgttgtacgtatgtcaccttcactagaaatgtcccatcatcgtgggaggggagcagggcacaggggatggtgtgcattcagagcattgggttgggggcttccctgttccctcagccccagtcgagaggaaagagaatcgggccactgccagaaagagagtcaagcaaacctggaagggcaaatctgagagtgggaaggccaaaggccgaggcccagatttagtattcactagcagcgccttcgggtagcaggatgattccttttcctgcctgtctgctgctggctctcttccctaaggtacaggttggcaggaccacctccgcctacttctccaccatccctagcatgccagcccgttcccagatcaacctgccagtggagtcaggcagtgcactcctggagccaagagggaagggcagggtagagagggtatgtccagtagcctggagctccatggtggcttcatgcctcccttctcccagctcaggtggccctgagggctccctcggaacagtgcctcaaatcctgacccaagggccagcatggggaagagatggttgcaggcaaaatgcactttatagagattttctattgctgggaaggtgtgtttctcccacaatttgtttgtgaatattcacttgttttataaatgtctgacctgtcttgaggaaaaaaaaaaaaaaa

SEQ ID NO: 9 - DNA, 2766 bp, Homo sapiens
cgaggcgctccctgggatcacatggtacctgctccagtgccgcgtgcggcccgggaaccctgggctgctggcgcctgcgcagagccctctgtcccagggaaaggctcgggcaaaaggcggctgagattggcagagtgaaatattactgccgagggaacgtagcagggcacacgtctcgcctctttgcgactcggtgccccgtttctccccatcacctacttacttcctggttgcaacctctcttcctctgggacttttgcaccgggagctccagattcgctaccccgcagcgctgcggagccggcaggcagaggcaccccgtacactgcagagacccgaccctccttgctaccttctagccagaactactgcaggctgattccccctacacactctctctgctcttcccatgcaaagcagaactccgttgcctcaacgtccaacccttctgcagggctgcagtccggccaccccaagaccttgctgcagggtgcttcggatcctgatcgtgagtcgcggggtccactccccgcccttagccagtgcccagggggcaacagcggcgatcgcaacctctagtttgagtcaaggtccagtttgaatgaccgctctcagctggtgaagacatgacgaccctggactccaacaacaacacaggtggcgtcatcacctacattggctccagtggctcctccccaagccgcaccagccctgaatccctctatagtgacaactccaatggcagcttccagtccctgacccaaggctgtcccacctacttcccaccatcccccactggctccctcacccaagacccggctcgctcctttgggagcattccacccagcctgagtgatgacggctccccttcttcctcatcttcctcgtcgtcatcctcctcctccttctataatgggagcccccctgggagtctacaagtggccatggaggacagcagccgagtgtcccccagcaagagcaccagcaacatcaccaagctgaatggcatggtgttactgtgtaaagtgtgtggggacgttgcctcgggcttccactacggtgtgcacgcctgcgagggctgcaagggctttttccgtcggagcatccagcagaacatccagtacaaaaggtgtctgaagaatgagaattgctccatcgtccgcatcaatcgcaaccgctgccagcaatgtcgcttcaagaagtgtctctctgtgggcatgtctcgagacgctgtgcgttttgggcgcatccccaaacgagagaagcagcggatgcttgctgagatgcagagtgccatgaacctggccaacaaccagttgagcagccagtgcccgctggagacttcacccacccagcaccccaccccaggccccatgggcccctcgccaccccctgctccggtcccctcacccctggtgggcttctcccagtttccacaacagctgacgcctcccagatccccaagccctgagcccacagtggaggatgtgatatcccaggtggcccgggcccatcgagagatcttcacctacgcccatgacaagctgggcagctcacctggcaacttcaatgccaaccatgcatcaggtagccctccagccaccaccccacatcgctgggaaaatcagggctgcccacctgcccccaatgacaacaacaccttggctgcccagcgtcataacgaggccctaaatggtctgcgccaggctccctcctcctaccctcccacctggcctcctggccctgcacaccacagctgccaccagtccaacagcaacgggcaccgtctatgccccacccacgtgtatgcagccccagaaggcaaggcacctgccaacagtccccggcagggcaactcaaagaatgttctgctggcatgtcctatgaacatgtacccgcatggacgcagtgggcgaacggtgcaggagatctgggaggatttctccatgagcttcacgcccgctgtgcgggaggtggtagagtttgccaaacacatcccgggcttccgtgacctttctcagcatgaccaagtcaccctgcttaaggctggcacctttgaggtgctgatggtgcgctttgcttcgttgttcaacgtgaaggaccagacagtgatgttcctaagccgcaccacctacagcctgcaggagcttggtgccatgggcatgggagacctgctcagtgccatgttcgacttcagcgagaagctcaactccctggcgcttaccgaggaggagctgggcctcttcaccgcggtggtgcttgtctctgcagaccgctcgggcatggagaattccgcttcggtggagcagctccaggagacgctgctgcgggctcttcgggctctggtgctgaagaaccggcccttggagacttcccgcttcaccaagctgctgctcaagctgccggacctgcggaccctgaacaacatgcattccgagaagctgctgtccttccgggtggacgcccagtgacccgcccggccggccttctgccgctgcccccttgtacagaatcgaactctgcacttctctctcctttacgagacgaaaaggaaaagcaaaccagaatcttatttatattgttataaaatattccaagatgagcctctggccccctgagccttcttgtaaatacctgcctccctcccccatcaccgaacttcccctcctcccctatttaaaccactctgtctcccccacaaccctcccctggccctctgatttgttctgttcctgtctcaaatccaatagttcacagctgagctgg

SEQ ID NO: 10 - DNA, 4346 bp, Homo sapiens
ggctgcaggaagccgccgcgccgccgcttttgttgtcagggacccagcgaggagcgccgctcgccggccgccgccaccctctctcgctgcagcctgctgtgcgctgcacggcctggggcccgggagccccgcccgctctgcccatgagggggccccgcgaccaccgctgcttccagcccggggcggcgcggcgctgaggcggcggcggcggcgctgccccctctgcgggaagcgggcggccccggccgcctccgcgagggcaccatggaggtgaatgcaggaggtgtgattgcctatatcagttcttccagctcagcctcaagccatgcctcttgtcacagtgagggttctgagaatagtttccagtcctcctcctcttctgttccatcttctccaaatagctctaattctgataccaatggtaatcccaagaatggtgatctcgccaatattgaaggcatcttgaagaatgatcgaatagattgttctatgaaaacaagcaaatcgagtgcacctgggatgacaaaaagtcatagtggtgtgacaaaatttagtggcatggttctactgtgtaaagtctgtggggatgtggcgtcaggattccactatggagttcatgcttgcgaaggctgtaagggtttctttcggagaagtattcaacaaaacatccagtacaagaagtgcctgaagaatgaaaactgttctataatgagaatgaataggaacagatgtcagcaatgtcgcttcaaaaagtgtctgtctgttggaatgtcaagagatgctgttcggtttggtcgtattcctaagcgtgaaaaacagaggatgctaattgaaatgcaaagtgcaatgaagaccatgatgaacagccagttcagtggtcacttgcaaaatgacacattagtagaacatcatgaacagacagccttgccagcccaggaacagctgcgacccaagccccaactggagcaagaaaacatcaaaagctcttctcctccatcttctgattttgcaaaggaagaagtgattggcatggtgaccagagctcacaaggatacctttatgtataatcaagagcagcaagaaaactcagctgagagcatgcagcccaagagaggagaacggattcgcaagaacatggagcaatataatttaaatcatgatcattgcggcaatgggcttagcagccattttccctgtagtgagagccagcagcatctcaatggacagttcaaagggaggaatataatgcattacccaaatggtcatgccatttgtattgcaaatggacattgtatgaacttctccaatgcttatactcaaagagtatgtgatagagttccgatagatggattttctcagaatgagaacaagaatagttacctgtgcaacactggaggaagaatgcatctggtttgtccaatgagtaagtctccatatgtggatcctcataaatcaggacatgaaatctgggaagaattttcgatgagcttcactccagcagtgaaagaagtggtggaatttgcaaagcgtattcctgggttcagagatctctctcagcatgaccaggtcaaccttttaaaggctgggacttttgaggttttaatggtacggttcgcatcattatttgatgcaaaggaacgtactgtcacctttttaagtggaaagaaatatagtgtggatgatttacactcaatgggagcaggggatctgctaaactctatgtttgaatttagtgagaagctaaatgccctccaacttagtgatgaagagatgagtttgtttacagctgttgtcctggtatctgcagatcgatctggaatagaaaacgtcaactctgtggaggctttgcaggaaactctcattcgtgcactaaggaccttaataatgaaaaaccatccaaatgaggcctctatttttacaaaactgcttctaaagttgccagatcttcgatctttaaacaacatgcactctgaggagctcttggcctttaaagttcacccttaaggcctttgtttatttaaacatgaactgatggtaactgtacattttgtgctaaaatgcatatttatatgtgtataccatatgtggagatagaaaagacctttaagacaataaaagattgtaggctatctctgtaatcatgcaatagctgttcggattgagaactcttcagccatgattagacgttgactgcatctccctgatagaccaatcagctgtgtcgcacttaaactggagaagttacactgaagtataatcacactgaatgttatactttttcatctgccaaaaccaaaaaccattttgatctccctgtggttatcaatataacgcacaatcacaagtgtatgaggacttagaaattaatcctttgtggtaggagttctgttgaatgatggaaatcttattactaccacaagactatttgttctggtaattggagacttcgggatttaggagatctccatgtctgtatttactctaccactgctaaagtgtgtggtcctgggtagtttacttgcttgcggaaaatgagaattgatggtgtccccaatgccccacctcacagagttactaaaaaatgtctgtaaagcatatttacctcttgggagataggcactatgtaaataaggtaaaatttctgttattacaattattcataataatattcttttcttatttctaagcctttctgggaaatcatttcagtccacaccaaccatattattcagggttcctgccatatgtgtggggtatcctactgatacacacgtattcaaagtttatgggtacaacaaagacatagtacatgtacataatatgtatgtgaatatagttaaatatatttcttcacaatattttaaactgtgaagaactttatcatacaggaaacttaaaacaagaggtgtcaaaagacccaaattaggtgcattttacttgtttatgatggcataaccattgctttaaaatgtttagacagtagaatattgaatttatgctctatttttgtttatttaagcaacacttaatgtaaaagtgcaacaggcaattgaatccaaatttcaacgacaaaaaaaaaaaacatgtattttagagttcatctttggcaaaatctttggttcagggtactagttgtttaaaagttgattcatattcttaccttgtgctgagaaaggttgcattgctgccccttatacacatgctgcagcttgatgttaaagaatttttattctttctgaagaactaattaatgtttaaagcaactgtttaatatgatggcatgtgtgtgtgtgcgtgcgtgtgtatgttctgagtccacttcttttttcctaaataacactacagggattttgtcatattagatttaatttataatttgaaaaatcatctagtgtgtgacctacaggcttagaaatggtatagtcaaagacattttatccacatttctaatagtggacttgattaagtagataagatcagcatctgtttatggtattaggagaaatagccaaagttgaggattttatgtatgttttcctgtttacctggaaaatagcaattaattggattttttggtaaagattgccttctgtataatgtttggattatataaaattgcaaaaatgataacagcccgctttactgtactaagcctgttactctcatgacgtgtgagcagaatgccttattttgtaatcttgtttaacttgttgctactgggacttgatttactgtggcactagttaagtaagttaaaaaaaagttaaaccctctcattattaaagaggaaaggcgatggtgatgtctgtagtacaatataaaccataattgtgatttaccttaagtaggtataactcttatgggatatacagtatagtttttgtgaatctttacatgatagcattatctttttataattttttttcctaagataaacaaatgcatagttttcttctatgggtgatagaaacagctttttgaagtaatgaaaacctcaaaagatcatgttgattcttaatttttgccttttgcataagcctctttataacatgtatctttaaaacaattaagtctttaggaatgtgtaaccagaactatgttagtattgcttataaaactttagttaggttcaatatatacatatatacatctctatataggtatatagatttgcattttgtcttgtaaaattttatttgaataaattcttcctgtaggtaatgggaaacaaaattaatagttcatatgtcactcatagcatttctatatttgaaagtagcccaatataaaacttttgattctaaaattaaaccagcagcctattacaagcaaaaaaaaaaaaaaaa

SEQ ID NO: 11 - DNA, 1847 bp, Homo sapiens
ggtaccatagagttgctctgaaaacagaagatagagggagtctcggagctcgccatctccagcgatctctacattgggaaaaaacatggagtcagctccggcagcccccgaccccgccgccagcgagccaggcagcagcggcgcggacgcggccgccggctccagggagaccccgctgaaccaggaatccgcccgcaagagcgagccgcctgccccggtgcgcagacagagctattccagcaccagcagaggtatctcagtaacgaagaagacacatacatctcaaattgaaattattccatgcaagatctgtggagacaaatcatcaggaatccattatggtgtcattacatgtgaaggctgcaagggctttttcaggagaagtcagcaaagcaatgccacctactcctgtcctcgtcagaagaactgtttgattgatcgaaccagtagaaaccgctgccaacactgtcgattacagaaatgccttgccgtagggatgtctcgagatgctgtaaaatttggccgaatgtcaaaaaagcagagagacagcttgtatgcagaagtacagaaacaccggatgcagcagcagcagcgcgaccaccagcagcagcctggagaggctgagccgctgacgcccacctacaacatctcggccaacgggctgacggaacttcacgacgacctcagtaactacattgacgggcacacccctgaggggagtaaggcagactccgccgtcagcagcttctacctggacatacagccttccccagaccagtcaggtcttgatatcaatggaatcaaaccagaaccaatatgtgactacacaccagcatcaggcttctttccctactgttcgttcaccaacggcgagacttccccaactgtgtccatggcagaattagaacaccttgcacagaatatatctaaatcgcatctggaaacctgccaatacttgagagaagagctccagcagataacgtggcagacctttttacaggaagaaattgagaactatcaaaacaagcagcgggaggtgatgtggcaattgtgtgccatcaaaattacagaagctatacagtatgtggtggagtttgccaaacgcattgatggatttatggaactgtgtcaaaatgatcaaattgtgcttctaaaagcaggttctctagaggtggtgtttatcagaatgtgccgtgcctttgactctcagaacaacaccgtgtactttgatgggaagtatgccagccccgacgtcttcaaatccttaggttgtgaagactttattagctttgtgtttgaatttggaaagagtttatgttctatgcacctgactgaagatgaaattgcattattttctgcatttgtactgatgtcagcagatcgctcatggctgcaagaaaaggtaaaaattgaaaaactgcaacagaaaattcagctagctcttcaacacgtcctacagaagaatcaccgagaagatggaatactaacaaagttaatatgcaaggtgtctacattaagagccttatgtggacgacatacagaaaagctaatggcatttaaagcaatatacccagacattgtgcgacttcattttcctccattatacaaggagttgttcacttcagaatttgagccagcaatgcaaattgatgggtaaatgttatcacctaagcacttctagaatgtctgaagtacaaacatgaaaaacaaacaaaaaaattaaccgagacactttatatggccctgcacagacctggagcgccacacactgcacatcttttggtgatcggggtcaggcaaaggaggggaaacaatgaaaacaaataaagttgaacttgtttttctca

SEQ ID NO: 12 - DNA, 3604 bp, Homo sapiens
tctctcccctctctttctctctcgctgctcccttcctccctgtaactgaacagtgaaaattcacattgtggatccgctaacaggcacagatgtcatgtgaaaacgcacatgctctgccatccacaccgcctttctttcttttctttctgtttccttttttcccccttgttccttctccctcttctttgtaactaacaaaaccaccaccaactcctcctcctgctgctgcccttcctcctcctcctcagtccaagtgatcacaaaagaaatcttctgagccggaggcggtggcattttttaaaaagcaagcacattggagagaaagaaaaagaaaaacaaaaccaaaacaaaacccaggcaccagacagccagaacatttttttttcacccttcctgaaaacaaacaaacaaacaaacaatcatcaaaacagtcaccaccaacatcaaaactgttaacatagcggcggcggcggcaaacgtcaccctgcagccacggcgtccgcctaaagggatggttttctcggcagagcagctcttcgccgaccaccttcttcactcgtgctgagcgggatttttgggctctccggggttcgggctgggagcagcttcatgactacgcggagcgggagagcggccacaccatgcgagcacaaattgaagtgataccatgcaaaatttgtggcgataagtcctctgggatccactacggagtcatcacatgtgaaggctgcaagggattctttaggaggagccagcagaacaatgcttcttattcctgcccaaggcagagaaactgtttaattgacagaacgaacagaaaccgttgccaacactgccgactgcagaagtgtcttgccctaggaatgtcaagagatgctgtgaagtttgggaggatgtccaagaagcaaagggacagcctgtatgctgaggtgcagaagcaccagcagcggctgcaggaacagcggcagcagcagagtggggaggcagaagcccttgccagggtgtacagcagcagcattagcaacggcctgagcaacctgaacaacgagaccagcggcacttatgccaacgggcacgtcattgacctgcccaagtctgagggttattacaacgtcgattccggtcagccgtcccctgatcagtcaggacttgacatgactggaatcaaacagataaagcaagaacctatctatgacctcacatccgtacccaacttgtttacctatagctctttcaacaatgggcagttagcaccagggataaccatgactgaaatcgaccgaattgcacagaacatcattaagtcccatttggagacatgtcaatacaccatggaagagctgcaccagctggcgtggcagacccacacctatgaagaaattaaagcatatcaaagcaagtccagggaagcactgtggcaacaatgtgccatccagatcactcacgccatccaatacgtggtggagtttgcaaagcggataacaggcttcatggagctctgtcaaaatgatcaaattctacttctgaagtcaggttgcttggaagtggttttagtgagaatgtgccgtgccttcaacccattaaacaacactgttctgtttgaaggaaaatatggaggaatgcaaatgttcaaagccttaggttctgatgacctagtgaatgaagcatttgactttgcaaagaatttgtgttccttgcagctgaccgaggaggagatcgctttgttctcatctgctgttctgatatctccagaccgagcctggcttatagaaccaaggaaagtccagaagcttcaggaaaaaatttattttgcacttcaacatgtgattcagaagaatcacctggatgatgagaccttggcaaagttaatagccaagataccaaccatcacggcagtttgcaacttgcacggggagaagctgcaggtatttaagcaatctcatccagagatagtgaatacactgtttcctccgttatacaaggagctctttaatcctgactgtgccaccggctgcaaatgaaggggacaagagaactgtctcatagtcatggaatgcatcaccattaagacaaaagcaatgtgttcatgaagacttaagaaaaatgtcactactgcaacattaggaatgtcctgcacttaatagaattatttttcaccgctacagtttgaagaatgtaaatatgcacctgagtggggctcttttatttgtttgtttgtttttgaaatgaccataaatatacaaatataggacactgggtgttatcctttttttaattttattcgggtatgttttgggagacaactgtttatagaattttattgtagatatatacaagaaaagagcggtactttacatgattacttttcctgttgattgttcaaatataatttaagaaaattccacttaataggcttacctatttctatgtttttaggtagttgatgcatgtgtaaatttgtagctgtcttggaaagtactgtgcatgtatgtaataagtatataatatgtgagaatattatatatgactattacttatacatgcacatgcactgtggcttaaataccatacctactagcaatggaggttcagtcaggctctcttctatgatttaccttctgtgttatatgttacctttatgttagacaatcaggattttgttttcccagccagagttttcatctatagtcaatggcaggacggtaccaactcagagttaagtctacaaaggaataaacataatgtgtggcctctatatacaaactctatttctgtcaatgacatcaaagccttgtcaagatggttcatattgggaaggagacagtattttaagccattttcctgtttcaagaattaggccacagataacattgcaaggtccaagacttttttgaccaaacagtagatattttctatttttcaccagaacacataaaaacactttttttcttttggatttctggttgtgaaacaagcttgatttcagtgcttattgtgtcttcaactgaaaaatacaatctgtggattatgactaccagcaatttttttctaggaaagttaaaagaataaatcagaacccagggcaacaatgccatttcatgtaaacattttctctctcaccatgttttggcaagaaaaggtagaaagagaagacccagagtgaagaagtaattctttatattcctttctttaatgtatttgttaggaaaagtggcaataaagggggaggcatattataaaatgctataatataaaaatgtagcaaaaacttgacagactagaaaaaaaaagatctgtgttattctagggaactaatgtaccccaaagccaaaactaattcctgtgaagtttacagttacatcatccatttaccctagaattatttttttagcaacttttagaaataaagaatacaactgtgacattaggatcagagattttagacttccttgtacaaattctcacttctccacctgctcaccaatgaaattaatcataagaaaagcatatattccaagaaatttgttctgcctgtgtcctggaggcctatacctctgttattttctgatacaaaataaaacttaaaaaaaagaaaacaagctaa

SEQ ID NO: 13 - DNA, 3084 bp, Homo sapiens
gccaggtgctcccgccttccaccctccgccctcctccctcccctgggccctgctccctgccctcctgggcagccagggcagccaggacggcaccaagggagctgccccatggacagggccccacagagacagcaccgagcctcacgggagctgctggctgcaaagaagacccacacctcacaaattgaagtgatcccttgcaaaatctgtggggacaagtcgtctgggatccactacggggttatcacctgtgaggggtgcaagggcttcttccgccggagccagcgctgtaacgcggcctactcctgcacccgtcagcagaactgccccatcgaccgcaccagccgaaaccgatgccagcactgccgcctgcagaaatgcctggcgctgggcatgtcccgagatgctgtcaagttcggccgcatgtccaagaagcagagggacagcctgcatgcagaagtgcagaaacagctgcagcagcggcaacagcagcaacaggaaccagtggtcaagacccctccagcaggggcccaaggagcagataccctcacctacaccttggggctcccagacgggcagctgcccctgggctcctcgcctgacctgcctgaggcttctgcctgtccccctggcctcctgaaagcctcaggctctgggccctcatattccaacaacttggccaaggcagggctcaatggggcctcatgccaccttgaatacagccctgagcggggcaaggctgagggcagagagagcttctatagcacaggcagccagctgacccctgaccgatgtggacttcgttttgaggaacacaggcatcctgggcttggggaactgggacagggcccagacagctacggcagccccagtttccgcagcacaccggaggcaccctatgcctccctgacagagatagagcacctggtgcagagcgtctgcaagtcctacagggagacatgccagctgcggctggaggacctgctgcggcagcgctccaacatcttctcccgggaggaagtgactggctaccagaggaagtccatgtgggagatgtgggaacggtgtgcccaccacctcaccgaggccattcagtacgtggtggagttcgccaagaggctctcaggctttatggagctctgccagaatgaccagattgtgcttctcaaagcaggagcaatggaagtggtgctggttaggatgtgccgggcctacaatgctgacaaccgcacggtcttttttgaaggcaaatacggtggcatggagctgttccgagccttgggctgcagcgagctcatcagctccatctttgacttctcccactccctaagtgccttgcacttttccgaggatgagattgccctctacacagcccttgttctcatcaatgcccatcggccagggctccaagagaaaaggaaagtagaacagctgcagtacaatctggagctggcctttcatcatcatctctgcaagactcatcgccaaagcatcctggcaaagctgccacccaaggggaagcttcggagcctgtgtagccagcatgtggaaaggctgcagatcttccagcacctccaccccatcgtggtccaagccgctttccctccactctacaaggagctcttcagcactgaaaccgagtcacctgtggggctgtccaagtgacctggaagagggactccttgcctctccctatggcctgctggcccacctccctggaccccgttccaccctcacccttttcctttcccatgaaccctggagggtggtccccaccagctctttggaagtgagcagatgctgcggctggctttctgtcagcaggccggcctggcagtgggacaatcgccagagggtggggctggcagaacaccatctccagcctcagctttgacctgtctcatttcccatattccttcacacccagcttctggaaggcatggggtggctgggatttaaggacttctgggggaccaagacatcctcaagaaaacaggggcatccagggctccctggatgaatagaatgcaattcattcagaagctcagaagctaagaataagcctttgaaatacctcattgcatttccctttgggcttcggcttggggagatggatcaagctcagagactggcagtgagagcccagaaggacctgtataaaatgaatctggagctttacattttctgcctctgccttcctcccagctcagcaaggaagtatttgggcaccctaccctttacctggggtctaaccaaaaatggatgggatgaggatgagaggctggagataattgttttatgggatttgggtgtgggactagggtacaatgaaggccaagagcatctcagacatagagttaaaactcaaacctcttatgtgcactttaaagatagactttaggggctggcacaaatctgatcagagacacatatccatacacaggtgaaacacatacagactcaacagcaatcatgcagttccagagacacatgaacctgacacaatctctcttatccttgaggccacagcttggaggagcctagaggcctcaggggaaagtcccaatcctgagggaccctcccaaacatttccatggtgctccagtccactgatcttgggtctggggtgatccaaataccaccccagctccagctgtcttctaccactagaagacccaagagaagcagaagtcgctcgcactggtcagtcggaaggcaagatcagatcctggaggactttcctggcctgcccgccagccctgctcttgttgtggagaaggaagcagatgtgatcacatcaccccgtcattgggcaccgctgactccagcatggaggacaccagggagcagggcctgggcctgtttccccagctgtgatcttgcccagaacctctcttggcttcataaacagctgtgaaccctcccctgagggattaacagcaatgatgggcagtcgtggagttgggggggttgggggtgggattgtgtcctctaaggggacgggttcatctgagtaaacataaaccccaacttgtgccattctttataaaatgattttaaaggcaaaaaaaaaaaaaaaaaaaa

SEQ ID NO: 14 - DNA, 2922 bp, Homo sapiens
ggacaccgggccatgcacgcccccaactgaagctgcatctcaaagccgaagattccagcagcccaggggatttcaaagagctcagactcagaggaacatctgcggagagacccccgaagccctctccagggcagtcctcatccagacgctccgctagtgcagacaggagcgcgcagtggccccggctcgccgcgccatggagcggatccccagcgcgcaaccaccccccgcctgcctgcccaaagcaccgggactggagcacggagacctaccagggatgtaccctgcccacatgtaccaagtgtacaagtcaagacggggaataaagcggagcgaggacagcaaggagacctacaaattgccgcaccggctcatcgagaaaaagagacgtgaccggattaacgagtgcatcgcccagctgaaggatctcctacccgaacatctcaaacttacaactttgggtcacttggaaaaagcagtggttcttgaacttaccttgaagcatgtgaaagcactaacaaacctaattgatcagcagcagcagaaaatcattgccctgcagagtggtttacaagctggtgagctgtcagggagaaatgtcgaaacaggtcaagagatgttctgctcaggtttccagacatgtgcccgggaggtgcttcagtatctggccaagcacgagaacactcgggacctgaagtcttcgcagcttgtcacccacctccaccgggtggtctcggagctgctgcagggtggtacctccaggaagccatcagacccagctcccaaagtgatggacttcaaggaaaaacccagctctccggccaaaggttcggaaggtcctgggaaaaactgcgtgccagtcatccagcggactttcgctcactcgagtggggagcagagcggcagcgacacggacacagacagtggctatggaggagaatcggagaagggcgacttgcgcagtgagcagccgtgcttcaaaagtgaccacggacgcaggttcacgatgggagaaaggatcggcgcaattaagcaagagtccgaagaaccccccacaaaaaagaaccggatgcagctttcggatgatgaaggccatttcactagcagtgacctgatcagctccccgttcctgggcccacacccacaccagcctcctttctgcctgcccttctacctgatcccaccttcagcgactgcctacctgcccatgctggagaagtgctggtatcccacctcagtgccagtgctatacccaggcctcaacgcctctgccgcagccctctctagcttcatgaacccagacaagatctcggctcccttgctcatgccccagagactcccttctcccttgccagctcatccgtccgtcgactcttctgtcttgctccaagctctgaagccaatcccccctttaaacttagaaaccaaagactaaactctctaggggatcctgctgctttgctttccttcctcgctacttcctaaaaagcaacaaaaaagtttttgtgaatgctgcaagattgttgcattgtgtatactgagataatctgaggcatggagagcagattcagggtgtgtgtgtgtgtgtgtgtgtgtgtgtgtatgtgcgtgtgcgtgcacatgtgtgcctgcgtgttggtataggactttaaagctccttttggcatagggaagtcacgaaggattgcttgacatcaggagacttgggggggattgtagcagacgtctgggcttttccccacccagagaatagcccccttcgatacacatcagctggattttcaaaagcttcaaagtcttggtctgtgagtcactcttcagtttgggagctgggtctgtggctttgatcagaaggtactttcaaaagagggctttccagggctcagctcccaaccagctgttaggaccccacccttttgcctttattgtcgacgtgactcaccagacgtcggggagagagagcagtcagaccgagctttctgctaacatggggaggtagcaggcactggcatagcacggtagtggtttggggaggtttccgcaggtctgctccccacccctgcctcggaagaataaagagaatgtagttccctactcaggctttcgtagtgattagcttactaaggaactgaaaatgggccccttgtacaagctgagctgccccggagggagggaggagttccctgggcttctggcacctgtttctaggcctaaccattagtacttactgtgcagggaaccaaaccaaggtctgagaaatgcggacaccccgagcgagcaccccaaagtgcacaaagctgagtaaaaagctgcccccttcaaacagaactagactcagttttcaattccatcctaaaactccttttaaccaagcttagcttctcaaaggcctaaccaagccttggcaccgccagatcctttctgtaggctaattcctcttgcccaacggcatatggagtgtccttattgctaaaaaggattccgtctccttcaaagaagttttatttttggtccagagtacttgttttcccgatgtgtccagccagctccgcagcagcttttcaagatgcactatgcctgattgctgatcgtgttttaactttttcttttcctgtttttattttggtattaagtcgttgcctttatttgtaaagctgttataaatatatattatataaatatattaaaaaggaaaatgtttcagatgtttatttgtataattacttgattcacacagtgagaaaaaatgaatgtattcctgtttttgaagagaagaataatttttttttctctagggagaggtacagtgtttatattttggagccttcctgaaggtgtaaaattgtaaatatttttatctatgagtaaatgttaagtagttgttttaaaatacttaataaaataattcttttcctgtggaag

SEQ ID NO: 15 - DNA, 3641 bp, Homo sapiens
ctgcactgaagagggagagcgagagagagactggagacgcacagatccccccaaggtctcccaagcctaccgtcccacagattattgtacagagccccaaaaatcgaaacagaggaaacgaacagcagttgaacatggacgaaggaattcctcatttgcaagagagacagttactggaacatagagattttataggactggactattcctctttgtatatgtgtaaacccaaaaggagcatgaaacgagacgacaccaaggatacctacaaattaccgcacagattaatagaaaagaaaagaagagaccgaattaatgaatgcattgctcagctgaaagatttactgcctgaacatctgaaattgacaactctgggacatctggagaaagctgtagtcttggaattaactttgaaacacttaaaagctttaaccgccttaaccgagcaacagcatcagaagataattgctttacagaatggggagcgatctctgaaatcgcccattcagtccgacttggatgcgttccactcgggatttcaaacatgcgccaaagaagtcttgcaatacctctcccggtttgagagctggacacccagggagccgcggtgtgtccagctgatcaaccacttgcacgccgtggccacccagttcttgcccaccccgcagctgttgactcaacaggtccctctgagcaaaggcaccggcgctccctcggccgccgggtccgcggccgccccctgcctggagcgcgcggggcagaagctggagcccctcgcctactgcgtgcccgtcatccagcggactcagcccagcgccgagctcgccgccgagaacgacacggacaccgacagcggctacggcggcgaagccgaggcccggccggaccgcgagaaaggcaaaggcgcgggggcgagccgcgtcaccatcaagcaggagcctcccggggaggactcgccggcgcccaagaggatgaagctggattcccgcggcggcggcagcggcggcggcccggggggcggcgcggcggcggcggcagccgcgcttctggggcccgaccctgccgccgcggccgcgctgctgagacccgacgccgccctgctcagctcgctggtggcgttcggcggaggcggaggcgcgcccttcccgcagcccgcggccgccgcggcccccttctgcctgcccttctgcttcctctcgccttctgcagctgccgcctacgtgcagcccttcctggacaagagcggcctggagaagtatctgtacccggcggcggctgccgccccgttcccgctgctataccccggcatccccgccccggcggcagccgcggcagccgccgccgccgctgccgccgccgccgccgcgttcccctgcctgtcctcggtgttgtcgccccctcccgagaaggcgggcgccgccgccgcgaccctcctgccgcacgaggtggcgccccttggggcgccgcacccccagcacccgcacggccgcacccacctgcccttcgccgggccccgcgagccggggaacccggagagctctgctcaggaagatccctcgcagccaggaaaggaagctccctgaatccttgcgtcccgaaggacggaggttcaagcagagtgagaagttaaaatacccttaaggaggttcaagcagagtgagaagttaaaatacccttaaggtctttaagggaggaagtgtaatagatgcacgacaggcataaacaagaacaacaaaacaggtgttatgtgtacattcggagttcctgttttgctcatcccgcaccaccccaccctccacacactaacatccctttcttccccccaccagctgtaaaagatcctatgcgaaagacactggctcttttttttaatcccccaaataaattttgcccccttttaggccatgttccattatctcttaaaattggaacctaattcgagaggaagtaagaagggtctgttctgtggctgagctaggtgaaccccggggtaggggaaagatgttaacacctttgacgtctttggagttgacatggaacagcaggtagttgttatgtagagctagttctcaaagctgccctgcctgttttaggaggcgttccacaaacagattgaggctctttttagaattgaatttactcttcagtattttctaatgttcagctttctaaaaggcatatatttttcaaagaagtgaggatgcagtttctcacgttgcaacctattctgaagtggtttaaatggtatctcttagtaacttgcactcgttaaagaaacacggagctgggccatcgtcagaactaagtcagggaaggagatggatgagaaggccagaatcattcctagtacatttgctaacactttattgagaaattgaccatgaattaatggactcatcttaatttcttctaagtccatatatagatagatatctatctgtacagatttctatttatccatagataggtatctatacatacacatctcaagtgcatctattcccactctcattaatccatcatgttcctaaatttttgtaatcttactgtaaaaaaaagtgcactgaacttcaaaacaaaacaaaaaacaacaacaacaaaaaacaagtccaaactgatatatcctatattctgttaaaattcaaaagtgaacgaaagcatttaactggccagttttgattgcaaatgctgtaaagatatagaatgaagtcctgtgaggccttcctatctccaagtctatgtattttctggagaccaaaccagataccagataatcacaaagaaagcttttttaataaggcttaaaccaagaccttgtctagatatttttagtttgttgccaaggtagcactgtgagaaatctcacttggatgttatgtaaggggtgagacacaacagtctgactatgagtgaggaaaatatctgggtcttttcgtcagtttggtgcatttgctgctgctgttgctactgtttgcctcaaacgctgtgtttaaacaacgttaaactcttagcctacaaggtggctcttatgtacatagttgttaatacatccaattaatgatgtctgacatgctatttttgtagggagaaaatatgtgctaatgatattttgagttaaaatatcttttggggaggatttgctgaaaagttgcacttttgttacaatgcttatgcttggtacaagcttatgctgtcttaaattattttaaaaaaattaaatactgtctgtgagaaaccagctggtttagaaaagtttagtatgtgacgataaactagaaattacctttatattctagtattttcagcactccataaattctattacctaaatattgccacactattttgtgatttaaaaattcttactaaggaataaaaactttaatatacgatatgatattgtctaataattaaaaaagacataatggatgctcaattagttttaagatatctataactatagggatacaaatcactacagttctcagatttacaccttttttttgtcattggcttgatgtcacacatttccaatctcttgcaagcctccaggctctggctttgtctacctgctcgttcccaatgtatcttaatgaaaagtgcaaaagaaaaacctaccaattaaaaaaaaaaaaaaaaaa

SEQ ID NO: 16 - DNA, 1658 bp, Homo sapiens
cgcgcacacctctcggtgcagattgcaaagcgccttccgttgcgagagctgcagattttgcaagagccaggctcgcccaccttgtagaaggagcgccttgagtcccctctcaccctcggttgcaaagagccgaccgcttgatctggacaccccctcgcccagattgcatgatctcccgggaccctcttgagttgcacgtttctgcaccgaggacctcaaatccccgtcgctcctaggatttgcagcgttctggatactggagggttgcaggctacactcgcccgcccctgggcagacactcgtccaaaccactggagtgtgctggtgactggcaggccagcccttcgcctctccatgaacccgtgagcctgggggcaggtgccaggcgatggcgcggcctgtgagcgacaggaccccggcccctctgctgctgggcggcccggccgggacaccccctggcgggggagcgctgcttgggttgcggagccttctgcaggggaccagcaagcccaaagagccggccagctgtctcctgaaggaaaaggagcgcaaggcggccctgcctgcagccacaacccctgggccaggcctggagactgcgggcccggcggatgccccggctggggcagtggtgggcggagggtccccgcgggggcgcccggggccggtgcccgccccgggtctgttggcgccactgctgtgggagcgcacgctgccgttcggcgatgtggagtacgtagacctggacgccttcctgctggagcacgggctcccgcccagcccgccgccccccggtggcccgtcgccggagccgtcgcccgcgcggacgcccgcaccctccccagggccgggttcgtgcggctcggcttccccccgctcctctcctgggcacgcccccgcccgggctgccctcgggaccgccagcggccaccgcgcaggcctgacctctcgggacacacccagccctgtggacccagacaccgtggaggtgttgatgacctttgaacccgacccagctgatcttgccctatcaagcattcctggccacgagacctttgaccctcgaagacatcgcttctcagaagaggaacttaagccccagccaatcatgaagaaggcaagaaaaatccaggtgccggaggagcagaaggatgagaaatactggagccggcggtacaagaacaacgaggcagccaagcggtcccgtgacgcccggcggctcaaggagaaccagatatcggtgcgggcggccttcctggagaaggagaacgccctgctgcggcaggaagttgtggccgtgcgccaggagctgtcccactaccgcgccgtgctgtcccgataccaggcccagcacggggccctgtgaggctgccccacatccccacctggcggagctctcctccgccttgctgagacttacgccctgttcccttcctgccctgtggcccacgggccggccagctgggtgccccagggacgtgataatgcagataaatacatttatatttttaagaaaaagcgagcctcccccctcccttgcgggggcggggagggttctctgtgtgtgtccccggcacgtcagggaccctatcctcccaccgcctccgttaacacgatcctgaataaatcttgagaaccccagaaaaaaaaaaaaaaaa

SEQ ID NO: 17 - DNA, 4382 bp, Homo sapiens
cggcagctgcagcgggtcgcacggctccggcccatctcggggggcgggcgggggaggcgaggtgcgcgagccgagtccggggcacgatgtccgacgcgggcggcggaaagaagccgcctgtggacccgcaggcaggacccggtccggggccggggcgcgcagctggggaaaggggcctgtcggggtccttccccctggtcctgaagaagctgatggagaaccccccgcgcgaggcgcgcctcgataaggaaaaggggaaggaaaagctggaggaggacgaggccgcagccgccagcaccatggctgtctcagcctccctcatgccacccatctgggacaagaccatcccatatgatggcgaatctttccacctggagtacatggacctggatgagttcctgctggagaatggcatccccgccagccccacccacctggcccacaacctgctgctgcctgtagcagagctagaagggaaggagtctgccagctcttccacagcatccccaccatcctcctccactgccatctttcagccctctgaaaccgtgtccagcacagaatcttccctggagaaggagagggagactcccagtcccatcgaccccaattgtgtggaagtggatgtgaacttcaatccggaccccgccgacctggtgctctccagtgtgccaggcggggagctcttcaaccctcggaagcacaagtttgctgaggaggacctgaagccccagcctatgatcaaaaaggccaagaaggtctttgtccccgacgagcagaaggatgaaaagtactggacaagacgcaagaagaacaacgtggcagctaaacggtcacgggatgcccggcgcctgaaagagaatcagatcaccatccgggcagccttcctggagaaggagaacacagccctgcggacggaggtggccgagctacgcaaggaggtgggcaagtgcaagaccatcgtgtccaagtatgagaccaaatacgggcccttgtaacccgtgccccccgcccgggcggggtactgcctgcacctcagacctctgcctgggggctccctgtaacccctcacacgcgtggagacttatgactcgtcgtgggcgcatggcggcgcacctgctgcaggagcggccacgtctcagcttcattataccatggcctgcgcacgtggcgacgtccctgaggggccagtctcctcactggtggggaacgcaagagaatctgcgtagatgggtgactcagccttagtttctattcttggatgtcccagttgaatcagaaggggacctctggagtacacacctctctcctgggcgctcagggtccctggactctccctcagtctccagcctgggctgccgagggctatctctgcagaatgagttgtgatcattgtcaccctatgtcttctcaggtagcagggcgcgtttccacttaaggtgtgtctgtcacgcacctcattctccccagacagtctttgagtaacatctgttcccatcttccttggaagcaggacacaccagctcctccgtcagtgtctgcatgggtagcaggctgcaggagtggggtctctgcacagcctgggatggggcttggggctggggcctgcagcagaagtgtgcccagcgtttctcggctcccgcaccccttttcccttatggctctgaggccatcggctgtctctgcatttcattggctgtggaggagagactcctaggatggctgctgtctgagccatgagtgccagggctgagagaggcctcttcatttcctctccaggctactcagaggccatgtgaagctcgtttgtcccactagaccaggcctctgggcctgctctttctttccacccaatgtccagtcttggatcatagatttaaaaggaaaacccctcttatctaggaggctttaacttcctggaccccaggattcaccttcctagtggtgtttagaaaatgcctccacagcccccttccaccatgggcatgagagctggggtgtgtttcttgagaagctcccttttttcttgctctgctcaccggtgtggcctgggctggagtgcactctccctgggggcagctggggcctcgcaattcttgcttcaggatctctcccatgcgagctgcccggagggtgtcagcagggcaagacacctagtctagagtcaccaaggtcacagtgccactttcacgggatagcaggctcttgggacttttacacaggcctagggtcccctcagtcttggtcccaggagatgggggccactcgtgaggctggccatgctgtggcttctcacagctgtggtctcccctgcctcacaacgactcctttctcttgtgtggcgggactcgcccttttgctgtgctcagaagattcactgaggaaactcatggaagcctctgctcatttgggtcactgggacacccctgagatgggtgtgtttatttgctcagggcgggcagcctatggtgaagaggagacagaggcgatgggcgtgcttcgtcctccgtaacactggctttatttaccgtggtggttcagagtcccaggccctgacctctaaagacttttcataacagacgttaagaccaagccgtggacctcaccccaggggaatgccacggccctttggggacctgcacacccacctctccgggggacttgacaaggggccctgaggccaagggaggtcactcctccctccaggcccctgacttttactttgtggttctctaaaaaccatgtacacactttcactctattgtaaccacacagggcaggcgcatccagcatgtcagtgtcctgccccgggcagctctccctcccgggcacgctccctctggcctggtggatcaccaagagggcggttctcattttgttattagtggaagagccttgagcttaaaagctcttcattttctttgccggaaagtatatggtttgtgtttttgcagttttatttttttaaggatggacactaaatctctggtgtccatgttccgagcccggtggctgggatggtggctcgatgtgtctcctctttatcccgccctctgcctgtttggtgccctcccttctttcccccaggcagtgggtatcgggttctttcccaaagtgcttacttggaaagagtgtggctgctggactcttttcgaaatgcccctctgagtcaggagcctggtggggacaagatggaggatgtccacagaggctgacctgtgggggaaaagaagtgctcaggtaaggttgtctcctctcctgtcctaaaaaaatccatgcttgcaggagagggttggtgcctgctcagtttctgtcgagggaatgggagtctcctcggctccctcctgggccctctgcttcttggaggccgaccgctggagactgcggctcctgtgcttggatctttgacatctgtcagtcactggaggctagagaagttgactttaccttggctttctgtgggttcccgatgggcttggaagtgccgtctacttcctaagcatcctgtctaaagctttgtggcaccctcagtgcaacctcagaacagacaaatcatgaatgagctggaactttgcaagaatattcatattataaatgtctcatctgatggaggaacgtgtgcatttagagagagggagagttttcaaggtttatggcaactttgtggaggacctgggtaactcttacccttggccaaaggaagaggttttcctgtctggcttctgaggttggagggggcacttagcagtgaaccttaagtctgggtacatgtaaccctgctgaggggctgtgcaggccgctcctacggtcctttggcctgaggcagggcgggaggcatgcaagccagtgggggaaaacccctctgaagctgggcagccctctacctgggccccgggagccgtgctccttggaacgcaaagggccgaggagcatctggttttcatggcaaagctctactccagagctcctttaacatctgctaattaagtgcaataaatttttctagaaaatggcaaagatgacttccaggtggatattgctctcttacggtgttggggatgccagaacaccacttggttttatttttctaagtgcatgtgatgtgatagagtgtgtggggctctgtgtccttccctgggagctggcattccagcgggcccctctctttacctttgttgggggaaggaggcaagagagaaattccttcttcccagccagagagggcagaagcagaccgtagcccattggccttatgtgcgtgtgtgcgtgcgagtgtgtcactgctggtgggccggagtgatgtggtgggagggaagccgggaatgtatccttttcagacaaaattaaatattttgaaatgagaaaaaaaaaaaaaaaaaaaa

SEQ ID NO: 18 - DNA, 5607 bp, Homo sapiens
actcttgtcagggccgcggcacatgggcggccggatgcgctgagcccggcgctgcggggccgcggagcgctggggagcagcggccgccggcgcggggaggggggtggggtgggacggcgcaccgcctccggtgctggcactaggggctggggtcggcgcggtgtcttctgcccttctgcagccgtcgacatttttttttctttctttttttcaattttgaacattttgcaaaacgaggggttcgaggcaggtgagagcatcctgcacgtcgccggggagcccgcgggcacttggcgcgctctcctgggaccgtctgcactggaaacccgaaagtttttttttaatatatatttttatgcagatgtatttataaagatataagtaatttttttcttcccttttctccaccgccttgagagcgagtacttttggcaaaggacggaggaaaagctcagcaacattttagggggcggttgtttctttcttatttctttttttaaggggaaaaaatttgagtgcatcgcgatggagaaaatgtcccgaccgctccccctgaatcccacctttatcccgcctccctacggcgtgctcaggtccctgctggagaacccgctgaagctcccccttcaccacgaagacgcatttagtaaagataaagacaaggaaaagaagctggatgatgagagtaacagcccgacggtcccccagtcggcattcctggggcctaccttatgggacaaaacccttccctatgacggagatactttccagttggaatacatggacctggaggagtttttgtcagaaaatggcattccccccagcccatctcagcatgaccacagccctcaccctcctgggctgcagccagcttcctcggctgccccctcggtcatggacctcagcagccgggcctctgcaccccttcaccctggcatcccatctccgaactgtatgcagagccccatcagaccaggtcagctgttgccagcaaaccgcaatacaccaagtcccattgatcctgacaccatccaggtcccagtgggttatgagccagacccagcagatcttgccctttccagcatccctggccaggaaatgtttgaccctcgcaaacgcaagttctctgaggaagaactgaagccacagcccatgatcaagaaagctcgcaaagtcttcatccctgatgacctgaaggatgacaagtactgggcaaggcgcagaaagaacaacatggcagccaagcgctcccgcgacgcccggaggctgaaagagaaccagatcgccatccgggcctcgttcctggagaaggagaactcggccctccgccaggaggtggctgacttgaggaaggagctgggcaaatgcaagaacatacttgccaagtatgaggccaggcacgggcccctgtaggatggcatttttgcaggctggctttggaatagatggacagtttgtttcctgtctgatagcaccacacgcaaaccaacctttctgacatcagcactttaccagaggcataaacacaactgactcccattttggtgtgcatctgtgtgtgtgtgcgtgtatatgtgcttgtgctcatgtgtgtggtcagcggtatgtgcgtgtgcgtgttcctttgctcttgccattttaaggtagccctctcatcgtcttttagttccaacaaagaaaggtgccatgtctttactagactgaggagccctctcgcgggtctcccatcccctccctccttcactcctgcctcctcagctttgcttcatgttcgagcttacctactcttccaggactctctgcttggattcactaaaaagggccctggtaaaatagtggatctcagtttttaagagtacaagctcttgtttctgtttagtccgtaagttaccatgctaatgaggtgcacacaataacttagcactactccgcagctctagtcctttataagttgctttcctcttactttcagttttggtgataatcgtcttcaaattaaagtgctgtttagatttattagatcccatatttacttactgctatctactaagtttccttttaattctaccaaccccagataagtaagagtactattaatagaacacagagtgtgtttttgcactgtctgtacctaaagcaataatcctattgtacgctagagcatgctgcctgagtattactagtggacgtaggatattttccctacctaagaatttcactgtcttttaaaaaacaaaaagtaaagtaatgcatttgagcatggccagactattccctaggacaaggaagcagagggaaatgggaggtctaaggatgaggggttaatttatcagtacatgagccaaaaactgcgtcttggattagcctttgacattgatgtgttcggttttgttgttccccttccctcacaccctgcctcgcccccacttttctagttaactttttccatatccctcttgacattcaaaacagttacttaagattcagttttcccactttttggtaatatatatatttttgtgaattatactttgttgtttttaaaaagaaaatcagttgattaagttaataagttgatgttttctaaggccctttttcctagtggtgtcatttttgaatgcctcataaattaatgattctgaagcttatgtttcttattctctgtttgcttttgaacgtatgtgctcttataaagtggacttctgaaaaatgaatgtaaaagacactggtgtatctcagaaggggatggtgttgtcacaaactgtggttaatccaatcaatttaaatgtttactatagaccaaaaggagagattattaaatcgtttaatgtttatacagagtaattataggaagttcttttttgtacagtatttttcagatataaatactgacaatgtattttggaagacatatattatatatagaaaagaggagaggaaaactattccatgttttaaaattatatagcaaagatatatattcaccaatgttgtacagagaagaagtgcttgggggtttttgaagtctttaatattttaagccctatcactgacacatcagcatgttttctgctttaaattaaaattttatgacagtatcgaggcttgtgatgacgaatcctgctctaaaatacacaaggagctttcttgtttcttattaggcctcagaaagaagtcagttaacgtcacccaaaagcacaaaatggattttagtcaaatatttattggatgatacagtgttttttaggaaaagcatctgccacaaaaatgttcacttcgaaattctgagttcctggaatggcacgttgctgccagtgccccagacagttcttttctaccctgcgggcccgcacgttttatgaggttgatatcggtgctatgtgtttggtttataatttgatagatgtttgactttaaagatgattgttcttttgtttcattaagttgtaaaatgtcaagaaattctgctgttacgacaaagaaacattttacgctagattaaaatatcctttcatcaatgggattttctagtttcctgccttcagagtatctaatcctttaatgatctggtggtctcctcgtcaatccatcagcaatgcttctctcatagtgtcatagacttgggaaacccaaccagtaggatatttctacaaggtgttcattttgtcacaagctgtagataacagcaagagatgggggtgtattggaattgcaatacattgttcaggtgaataataaaatcaaaaacttttgcaatcttaagcagagataaataaaagatagcaatatgagacacaggtggacgtagagttggcctttttacaggcaaagaggcgaattgtagaattgttagatggcaatagtcattaaaaacatagaaaaatgatgtctttaagtggagaattgtggaaggattgtaacatggaccatccaaatttatggccgtatcaaatggtagctgaaaaaactatatttgagcactggtctctcttggaattagatgtttatatcaaatgagcatctcaaatgttttctgcagaaaaaaataaaaagattctaataaaatgtattctcttgtgtgccaggagaggtttcagaaacctacctcgtcttacaaatttaaacactttggagtctgtacaggtgccttatatgtaggtcattgtcacgatacacacacacgaacactccctctggactggctgcctctccatccagggcagttaactagcaaacaaggcagatctgcttcatggagcgggaggccatggcttgactctgagtgatttgggtcaaccggagtcagacgcatgtctgcacgctgcagctattatgagagtccctttgtcatttttcaccttttcatcctaagcatctttcagagattaattatttggccattaacaatgaatccaaatcatatcatactgacatcatctagacatgatttggaaggaacagcttaggacctcctgatgaggtcacattgttgtttcttttaactagacttggcaaagaaaggcaaaaattgaccagcctatctttctgctggtgctgccttaaggaggtagtttgttgaggggagggctgtagatcattacttctttctcttcaggaagtggccactttgaaccattcaaataccacattaggcaagactgtgataggccttttgtcttcaaatacaacaggcctccactgacccatccctcaaagcagaaggaccctttgaggagagtacagatgggattccacagtggggtgggtggaatggaaacctgtactagaccacccagaggttccttctaacccactggtttggtggggaactcacagtaattccaaatgtacaatcagatgtctagggtctgttttcggaagaagcaagaattatcagtggcaccctccccactgcccccagtgtaaaacaatagacattctgtgaaatgcaaagctattctttggtttttctagtagtttatctcattttaccctattcttcctttaaggaaaactcaatctttatcacagtcaattagagcgatcccaaggcatgggaccaggcctgcttgcctatgtgtgatggcaattggagatctggatttagcactggggtctcagcaccctgcaggtgtctgagactaagtgatctgccctccaggtggcgatcaccttctgctcctaggtacccccactggcaaggccaaggtctcctccacgttttttctgcaattaataatgtcatttaaaaaatgagcaaagccttatccgaatcggatatagcaactaaagtcaatacattttgcaggaggctaagtgtaagagtgtgtgtgtgtgtgtgtgcgtgcatgtgtgtgtgtgtgtatgtgtgtgaataagtcgacataaagtctttaattttgagcaccttaccaaacataacaataatccattatccttttggcaacaccacaaagatcgcatctgttaaacaggtacaagttgacatgaggttagtttaattgtacaccatgatattggtggtatttatgctgttaagtccaaacctttatctgtctgttattcttaatgttgaataaactttgaattttttcctttcaaaaaaaa

SEQ ID NO: 19 - DNA, 2104 bp, Homo sapiens
acgtagcgcggcgctcggaactgacctactaacacacatctctccgcgcggccacggcgcccgcggacccggcgcgcccgcccgcctcccgcgccgcgccctcgccgccgcccgcctcccgccgcggccccggaggcccggcccggcccgagccccgagcgccggcggcccgactcccggccgcccctttctttctcctcgccggcccgagagcaggaacacgataacgaaggaggcccaacttcattcaataaggagcctgacggatttatcccagacggtagaacaaaaggaagaatattgatggattttaaaccagagtttttaaagagcttgagaatacggggaaattaatttgttctcctacacacatagatagggtaaggttgtttctgatgcagctgagaaaaatgcagaccgtcaaaaaggagcaggcgtctcttgatgccagtagcaatgtggacaagatgatggtccttaattctgctttaacggaagtgtcagaagactccacaacaggtgaggagctgcttctcagtgaaggaagtgtggggaagaacaaatcttctgcatgtcggaggaaacgggaattcattcctgatgaaaagaaagatgctatgtattgggaaaaaaggcggaaaaataatgaagctgccaaaagatctcgtgagaagcgtcgactgaatgacctggttttagagaacaaactaattgcactgggagaagaaaacgccactttaaaagctgagctgctttcactaaaattaaagtttggtttaattagctccacagcatatgctcaagagattcagaaactcagtaattctacagctgtgtactttcaagattaccagacttccaaatccaatgtgagttcatttgtggacgagcacgaaccctcgatggtgtcaagtagttgtatttctgtcattaaacactctccacaaagctcgctgtccgatgtttcagaagtgtcctcagtagaacacacgcaggagagctctgtgcagggaagctgcagaagtcctgaaaacaagttccagattatcaagcaagagccgatggaattagagagctacacaagggagccaagagatgaccgaggctcttacacagcgtccatctatcaaaactatatggggaattctttctctgggtactcacactctcccccactactgcaagtcaaccgatcctccagcaactccccgagaacgtcggaaactgatgatggtgtggtaggaaagtcatctgatggagaagacgagcaacaggtccccaagggccccatccattctccagttgaactcaagcatgtgcatgcaactgtggttaaagttccagaagtgaattcctctgccttgccacacaagctccggatcaaagccaaagccatgcagatcaaagtagaagcctttgataatgaatttgaggccacgcaaaaactttcctcacctattgacatgacatctaaaagacatttcgaactcgaaaagcatagtgccccaagtatggtacattcttctcttactcctttctcagtgcaagtgactaacattcaagattggtctctcaaatcggagcactggcatcaaaaagaactgagtggcaaaactcagaatagtttcaaaactggagttgttgaaatgaaagacagtggctacaaagtttctgacccagagaacttgtatttgaagcaggggatagcaaacttatctgcagaggttgtctcactcaagagacttatagccacacaaccaatctctgcttcagactctgggtaaattactactgagtaagagctgggcatttagaaagatgtcatttgcaatagagcagtccattttgtattatgctgaattttcactggacctgtgatgtcatttcactgtgatgtgcacatgttgtctgtttggtgtctttttgtgcacagattatgatgaagattagattgtgttatcactctgcctgtgtatagtcagatagtccatgcgaaggctgtatatattgaacattatttttgttgttctattataaagtgtgtaagttaccagtttcaataaaggattggtgacaaacacagaaaaaaaaaaaaaaaaaaaaa

SEQ ID NO: 20 - DNA, 685 bp, Mus musculus
cggcctgaaagctttgtcctctgaagctgtatgcccaccgggggaacagtgttttctgctcccttggtttccaggaaccttagggaggcacctcatgccctggctacaggaagcagtcacgtgtggaccctttattaggcactgccatataagctcagggcacaagagaccaggacatccctaggcaaagatcagcaagcaaaggccatgctgactgcaatgttgctgagttgtgttctgctgttggcactgcctcccacactgggggtccagatgggcgtggctccactgaagggcatcagaaggcctgaccaggctctgttcccagagttcccaggtctaagtctgaatggcctcaagaagacaactgcagaccgagcagaagaagttctgctgcagaaggcagaagctttggcggaggtgctagatccacagaaccgcgagtctcgttctccgcgtcgctgtgtaaggctgcacgagtcctgcttgggacagcaggtaccttgctgcgacccgtgcgctacgtgctactgccgcttcttcaatgccttttgctactgccgcaagctgggtacggccacgaacctctgtagtcgcacctagccaatggatgttgtttgggcaaaggcaggggatgagaataaaggatgggacggtttaaaaaaaaaaaaaaaaaaaaaaaaaa

SEQ ID NO: 21 - DNA, 507 bp, Mus musculus
atccccaggcattccaggtcatctgtcctcaccaccaagaccatgctgtcttcaggcaccatctgcagtttgctgctactcagcatgctctggatggacatggccatggcaggctccagcgaaagcccagcagagaaaggaatccaagaagccaccagctaaactgcagccacgagctctggaaggctggctccacccagaggacagaggacaagcagaagagacagaggaggagctggagatcaggttcaatgctcccttcgatgttggcatcaagctgtcaggagctcagtatcagcagcatggccgggccctggggaagtttcttcaggatatcctctgggaagaggtcaaagaggcgccagctgacaagtaaccacggacaggcctgacccccgtgctttccttctcctgagcaagaactcacatccgcctcagcctcctcggcaactcccagcactctcctaccactttaagaataaatgttcacctgtatgccaaatgttc

SEQ ID NO: 22 - DNA, 3257 bp, Mus musculus
gagggatccctgctccagcagctgcaaggtgcaagaagaagaagatcccagggaggaaaatgtgctggagacccctgtgtcggttcctgtggctttggtcctatctgtcttatgttcaagcagtgcctatccagaaagtccaggatgacaccaaaaccctcatcaagaccattgtcaccaggatcaatgacatttcacacacgcagtcggtatccgccaagcagagggtcactggcttggacttcattcctgggcttcaccccattctgagtttgtccaagatggaccagactctggcagtctatcaacaggtcctcaccagcctgccttcccaaaatgtgctgcagatagccaatgacctggagaatctccgagacctcctccatctgctggccttctccaagagctgctccctgcctcagaccagtggcctgcagaagccagagagcctggatggcgtcctggaagcctcactctactccacagaggtggtggctttgagcaggctgcagggctctctgcaggacattcttcaacagttggatgttagccctgaatgctgaagtttcaaaggccaccaggctcccaagaatcatgtagagggaagaaaccttggcttccaggggtcttcaggagaagagagccatgtgcacacatccatcattcatttctctccctcctgtagaccacccatccaaaggcatgactccacaatgcttgactcaagttatccacacaacttcatgagcacaaggaggggccagcctgcagaggggactctcacctagttcttcagcaagtagagataagagccatcccatcccctccatgtcccacctgctccgggtacatgttcctccgtgggtacacgcttcgctgcggcccaggagaggtgaggtagggatgggtagagcctttgggctgtctcagagtctttgggagcaccgtgaaggctgcatccacacacagctggaaactcccaagcagcacacgatggaagcacttatttatttattctgcattctattttggatggatctgaagcaagccatcagctttttcaggctttgggggtcagccaggatgaggaaggctcctggggtgctgctttcaatcctattgatgggtctgcccaaggcaaacctaatttttgagtgactggaaggaaggttgggatcttccaaacaagagtctatgcaggtagcgctcaagcttgacctctggtgactggttttgtttctattgtgactgactctatgcaaacacgtttgcagcggcattgccgggagcataggctaggttattatcaaaagcagatgaattttgtcaagtgtaatatgtatctatgtgcacctgagggtagaggatgtgttagagggagggtgaaggatccggaagtgttctctgaattacatatgtgtggtaggcttttctgaaagggtgaggcattttcttacctctgtggccacatagtgtggctttgtgaaaaggacaaaggagttgactctttccggaacatttggagtgtaccaggcacccttggaggggctaaagctacaggccttttgttggcatattgctgagctcagggagtgagggccccacatttgagacagtgagccccaagaaaagggtccctggtgtagatctccaaggttgtccagggttgatctcacaatgcgtttcttaagcaggtagacgtttgcatgccaatatgtggttctcatctgattggttcatccaaagtagaaccctgtctcccacccattctgtggggagttttgttccagtgggaatgagaaatcacttagcagatggtcctgagccctgggccagcactgctgaggaagtgccagggccccaggccaggctgccagaattgcccttcgggctggaggatgaacaaaggggcttgggtttttccatcacccctgcaccctatgtcaccatcaaactggggggcagatcagtgagaggacacttgatggaaagcaatacactttaagactgagcacagtttcgtgctcagctctgtctggtgctgtgagctagagaagctcaccaaatacatataaaaatcagaggctcatgtccctgtggttagaccctactcacggcggtgtactccaccacagcagccccgcaccgctggaagtacagtgctgtcttcaacaggtgtgaaagaacctgagctgagggtgacagtgcccaggggaaccctgcttgcagtctattgcatttacataccgcatttcagggcacattagcatccactgctatggtagcacactgttgacacgggatacctggggtcgtaaaaataagaaaatacaggttgactatcccttatccaaaatgcttgggactagaagagttttggattttagagtcttttcaggcataggtatatttgagtatatataaaatgagatatcttggggatggggcccaagtataaacatgaagttcatttatatttcataataccgtatagacactgcttgaagtgtagttttatacagtgttttaaataacgttgtatgcatgaaagacgtttttacagcatgaacctgtctactcatgccagcactcaaaaaccttggggttttggagcagtttggatcttgggttttctgttaagagatggttagcttatacctaaaaccataatggcaaacaggctgcaggaccagactggatcctcagccctgaagtgtgcccttccagccaggtcataccctgtggaggtgagcgggatcaggttttgtggtgctaagagaggagttggaggtagattttggaggatctgaggggtgatgtgatgttttattggacacttggtatgttgaagggatgaaagtccaaacaggaagtgacagggaagactgaagagaccgggaaagagtgacaggaagtgctgagaggactttatgggccacaaaagtggcttctgaaagatcccacgtgccacagtctggagcgaaggctcgtggtggctggtgtcagattgctctggggctgtgctatgccaccttggtcacctcatcaagctggaatgtcctgagcctttcgctcagagaaccttgcactatggcttgttcccagattgtgaaacttcccatatgcaaaaatgcttggtttggtttttttggtttttgtttttgttttcttttttaaatacatatatatatgtaacaacagcaacaacaaaattttgttttattttgtgtcaattcaaataaattaatgatgcctcc

SEQ ID NO: 23 - DNA, 561 bp, Mus musculus
gtggatctcttctctcacagaggcacccagagcagagcacccgccgctcagcgacgactgcccgcccgccacgatgctaggtaacaagcgaatggggctgtgtggactgaccctcgctctatctctgctcgtgtgtttgggcattctggctgaggggtacccctccaagccggacaatccgggcgaggacgcgccagcagaggacatggccagatactactccgctctgcgacactacatcaatctcatcaccagacagagatatggcaagagatccagccctgagacactgatttcagacctcttaatgaaggaaagcacagaaaacgcccccagaacaaggcttgaagacccttccatgtggtgatgggaaatgaaacttgttctcccgacttttccaagtttccaccctcatctcatctcatcccctgaaaccagtctgcctgtcccaccaatgcatgccaccactaggctggactccgccccatttcccttgttgttgttgttgtatatatgtgtgtttaaataaagtaccatgcattcaaaaaaaaaaaaaaaaaa

SEQ ID NO: 24 - DNA, 1007 bp, Mus musculus
aaacgggaggcgacggaagagaaaagaggttaagagcagtgactaagagaggccactgaacatctttgtccccagagagctgcctttccgcgacaggggtccctccaatcttgtttgcctctgcagagactaggcctgacacgtggaagatgccgagattctgctacagtcgctcaggggccctgttgctggccctcctgcttcagacctccatagatgtgtggagctggtgcctggagagcagccagtgccaggacctcaccacggagagcaacctgctggcttgcatccgggcttgcaaactcgacctctcgctggagacgcccgtgtttcctggcaacggagatgaacagcccctgactgaaaacccccggaagtacgtcatgggtcacttccgctgggaccgcttcggccccaggaacagcagcagtgctggcagcgcggcgcagaggcgtgcggaggaagaggcggtgtggggagatggcagtccagagccgagtccacgcgagggcaagcgctcctactccatggagcacttccgctggggcaagccggtgggcaagaaacggcgcccggtgaaggtgtaccccaacgttgctgagaacgagtcggcggaggcctttcccctagagttcaagagggagctggaaggcgagcggccattaggcttggagcaggtcctggagtccgacgcggagaaggacgacgggccctaccgggtggagcacttccgctggagcaacccgcccaaggacaagcgttacggtggcttcatgacctccgagaagagccagacgcccctggtgacgctcttcaagaacgccatcatcaagaacgcgcacaagaagggccagtgagggtgcaggggtcttctcattccaaggccccctccctgcatgggcgagctgatgacctctagcctcttagagttacctgtgttaggaaataaaacctttcagatttcacagtcggctctgatcttcaataaaaactgcgtaaataaagtc

SEQ ID NO: 25 - DNA, 1295 bp, Homo sapiens
ccttcccctggcccggggagctgctccttgtgctgccgggaaggtcaaagtcccgcgcccaccaggagagctcggcaagtatataaggacagaggagcgcgggaccaagcggcggcgaaggaggggaagaagagccgcgaccgagagaggccgccgagcgtccccgccctcagagagcagcctcccgagacaggcacttgctggattctccaaaagtatctgcagtggctgttccaccaggagagcctcagcctgcctggaagatgccgagatcgtgctgcagccgctcgggggccctgttgctggccttgctgcttcaggcctccatggaagtgcgtggctggtgcctggagagcagccagtgtcaggacctcaccacggaaagcaacctgctggagtgcatccgggcctgcaagcccgacctctcggccgagactcccatgttcccgggaaatggcgacgagcagcctctgaccgagaacccccggaagtacgtcatgggccacttccgctgggaccgattcggccgccgcaacagcagcagcagcggcagcagcggcgcagggcagaagcgcgaggacgtctcagcgggcgaagactgcggcccgctgcctgagggcggccccgagccccgcagcgatggtgccaagccgggcccgcgcgagggcaagcgctcctactccatggagcacttccgctggggcaagccggtgggcaagaagcggcgcccagtgaaggtgtaccctaacggcgccgaggacgagtcggccgaggccttccccctggagttcaagagggagctgactggccagcgactccgggagggagatggccccgacggccctgccgatgacggcgcaggggcccaggccgacctggagcacagcctgctggtggcggccgagaagaaggacgagggcccctacaggatggagcacttccgctggggcagcccgcccaaggacaagcgctacggcggtttcatgacctccgagaagagccagacgcccctggtgacgctgttcaaaaacgccatcatcaagaacgcctacaagaagggcgagtgagggcacagcggggccccagggctaccctcccccaggaggtcgaccccaaagccccttgctctcccctgccctgctgccgcctcccagcctggggggtcgtggcagataatcagcctcttaaagctgcctgtagttaggaaataaaacctttcaaatttcacatccacctctgactttgaatgtaaactgtgtgaataaagtaaaaatacgtagccgtcaaataacagc

SEQ ID NO: 26 - DNA, 1413 bp, Mus musculus
ccagagtctgggtcctacctacatatggcaccgaggatacctagaggccccatgcaagagaaggcccttgttttccaggcactgaggaccgcagtccctaattcctggcagttcctgagatctcaaggaaagcagggtcagcgaggaggcctggggagaggcatcctacacccgatcttgtggcctgctgcctaagggaaacaggagaccatgacagctatgctaacactagaaaccatggccagtgaagaagaatatgggccgaggaactgtgtggtgtgtggagaccgggccacaggctatcatttccacgccctgacttgtgagggctgcaagggcttcttcagacgaacagtcagcaaaaccattggtcccatctgtccgtttgctggaaggtgtgaggtcagcaaggcccagagacgccactgtccagcctgcaggttgcagaagtgtctaaatgttggcatgaggaaagacatgatactgtcagcagaagccctggcattgcggcgagccagacaggcacagcggcgggcagagaaagcatctttgcaactgaatcagcagcagaaagaactggtccagatcctcctgggggcccacactcgccatgtgggccccatgtttgaccagtttgtgcagttcaagcctccggcctatctgttcatgcatcaccggcctttccagcctcggggccccgtgttgcctctgctcacacactttgcagatatcaacacgtttatggtgcaacagatcatcaagttcaccaaggatctgccgctcttccggtccctaaccatggaggaccagatctcccttctcaagggagcggctgtggaaatattgcatatctcactcaacactacgttctgtcttcaaacagagaatttcttctgtgggcctctttgctacaagatggaggacgcagtccatgcagggttccagtacgagtttttggagtcgatcctccacttccataaaaacctgaaaggactgcatctccaggagcctgagtatgtgctcatggctgccacggccctcttctcccctgacagacccggagttacccaaagagaagagatagatcagctacaagaggagatggcgctgattctgaacaaccacattatggaacaacagtctcggctccaaagtcggtttctgtatgcaaagctgatgggcctgctggctgacctccggagtataaacaatgcatactcctatgaacttcagcgcttggaggaactgtctgctatgacgccgctgctcggggagatttgcagttgaggcccaggcttgcatcctttccccagacccccagggatacactggcctggaaagggtacagcgctggaccccacacgggaaccagcaggaaggagcttgggagtggcaatgaaatgctgaacagtc

SEQ ID NO: 27 - DNA, 1408 bp, Homo sapiens
ataaaacagacatctcttgttttccagatactacgggtcataatccctaactccaatcactggcaactcctgagatcagaggaaaaccagcaacagcgtgggagtttggggagaggcattccataccagattctgtggcctgcaggtgacatgctgcctaagagaagcaggagtctgtgacagccaccccaacacgtgacgtcatggccagtagggaagatgagctgaggaactgtgtggtatgtggggaccaagccacaggctaccactttaatgcgctgacttgtgagggctgcaagggtttcttcaggagaacagtcagcaaaagcattggtcccacctgcccctttgctggaagctgtgaagtcagcaagactcagaggcgccactgcccagcctgcaggttgcagaagtgcttagatgctggcatgaggaaagacatgatactgtcggcagaagccctggcattgcggcgagcaaagcaggcccagcggcgggcacagcaaacacctgtgcaactgagtaaggagcaagaagagctgatccggacactcctgggggcccacacccgccacatgggcaccatgtttgaacagtttgtgcagtttaggcctccagctcatctgttcatccatcaccagcccttgcccaccctggcccctgtgctgcctctggtcacacacttcgcagacatcaacactttcatggtactgcaagtcatcaagtttactaaggacctgcccgtcttccgttccctgcccattgaagaccagatctcccttctcaagggagcagctgtggaaatctgtcacatcgtactcaataccactttctgtctccaaacacaaaacttcctctgcgggcctcttcgctacacaattgaagatggagcccgtgtatctcccacagtggggttccaggtagagtttttggagttgctctttcacttccatggaacactacgaaaactgcagctccaagagcctgagtatgtgctcttggctgccatggccctcttctctcctgctccctatcttacagaccgacctggagttacccagagagatgagattgatcagctgcaagaggagatggcactgactctgcaaagctacatcaagggccagcagcgaaggccccgggatcggtttctgtatgcgaagttgctaggcctgctggctgagctccggagcattaatgaggcctacgggtaccaaatccagcacatccagggcctgtctgccatgatgccgctgctccaggagatctgcagctgaggccatgctcacttccttccccagctcacctggaacaccctggatacactggagtgggaaaatgctgggaccaaagattgggccgggttcaaagggagcccagtggttgcaatgaaagactaaagcaataa

SEQ ID NO: 28 - DNA, 1892 bp, Homo sapiens
ggcgcccgcgcccgcccccgcgccgggcccggctcggcccgacccggctccgccgcgggcaggcggggcccagcgcactcggagcccgagcccgagccgcagccgccgcctggggcgcttgggtcggcctcgaggacaccggagaggggcgccacgccgccgtggccgcagatttgaaagaagccaacactaaaccacaaatatacaacaaggccattttctcaaacgagagtcagcctttaacgaaatgaccatggttgacacagagatgccattctggcccaccaactttgggatcagctccgtggatctctccgtaatggaagaccactcccactcctttgatatcaagcccttcactactgttgacttctccagcatttctactccacattacgaagacattccattcacaagaacagatccagtggttgcagattacaagtatgacctgaaacttcaagagtaccaaagtgcaatcaaagtggagcctgcatctccaccttattattctgagaagactcagctctacaataagcctcatgaagagccttccaactccctcatggcaattgaatgtcgtgtctgtggagataaagcttctggatttcactatggagttcatgcttgtgaaggatgcaagggtttcttccggagaacaatcagattgaagcttatctatgacagatgtgatcttaactgtcggatccacaaaaaaagtagaaataaatgtcagtactgtcggtttcagaaatgccttgcagtggggatgtctcataatgccatcaggtttgggcggatgccacaggccgagaaggagaagctgttggcggagatctccagtgatatcgaccagctgaatccagagtccgctgacctccgggccctggcaaaacatttgtatgactcatacataaagtccttcccgctgaccaaagcaaaggcgagggcgatcttgacaggaaagacaacagacaaatcaccattcgttatctatgacatgaattccttaatgatgggagaagataaaatcaagttcaaacacatcacccccctgcaggagcagagcaaagaggtggccatccgcatctttcagggctgccagtttcgctccgtggaggctgtgcaggagatcacagagtatgccaaaagcattcctggttttgtaaatcttgacttgaacgaccaagtaactctcctcaaatatggagtccacgagatcatttacacaatgctggcctccttgatgaataaagatggggttctcatatccgagggccaaggcttcatgacaagggagtttctaaagagcctgcgaaagccttttggtgactttatggagcccaagtttgagtttgctgtgaagttcaatgcactggaattagatgacagcgacttggcaatatttattgctgtcattattctcagtggagaccgcccaggtttgctgaatgtgaagcccattgaagacattcaagacaacctgctacaagccctggagctccagctgaagctgaaccaccctgagtcctcacagctgtttgccaagctgctccagaaaatgacagacctcagacagattgtcacggaacacgtgcagctactgcaggtgatcaagaagacggagacagacatgagtcttcacccgctcctgcaggagatctacaaggacttgtactagcagagagtcctgagccactgccaacatttcccttcttccagttgcactattctgagggaaaatctgacacctaagaaatttactgtgaaaaagcattttaaaaagaaaaggttttagaatatgatctattttatgcatattgtttataaagacacatttacaatttacttttaatattaaaaattaccatattatgaaattgctgatagta

SEQ ID NO: 29 - DNA, 1820 bp, Homo sapiens
ttcaagtctttttcttttaacggattgatcttttgctagatagagacaaaatatcagtgtgaattacagcaaacccctattccatgctgttatgggtgaaactctgggagattctcctattgacccagaaagcgattccttcactgatacactgtctgcaaacatatcacaagaaatgaccatggttgacacagagatgccattctggcccaccaactttgggatcagctccgtggatctctccgtaatggaagaccactcccactcctttgatatcaagcccttcactactgttgacttctccagcatttctactccacattacgaagacattccattcacaagaacagatccagtggttgcagattacaagtatgacctgaaacttcaagagtaccaaagtgcaatcaaagtggagcctgcatctccaccttattattctgagaagactcagctctacaataagcctcatgaagagccttccaactccctcatggcaattgaatgtcgtgtctgtggagataaagcttctggatttcactatggagttcatgcttgtgaaggatgcaagggtttcttccggagaacaatcagattgaagcttatctatgacagatgtgatcttaactgtcggatccacaaaaaaagtagaaataaatgtcagtactgtcggtttcagaaatgccttgcagtggggatgtctcataatgccatcaggtttgggcggatgccacaggccgagaaggagaagctgttggcggagatctccagtgatatcgaccagctgaatccagagtccgctgacctccgggccctggcaaaacatttgtatgactcatacataaagtccttcccgctgaccaaagcaaaggcgagggcgatcttgacaggaaagacaacagacaaatcaccattcgttatctatgacatgaattccttaatgatgggagaagataaaatcaagttcaaacacatcacccccctgcaggagcagagcaaagaggtggccatccgcatctttcagggctgccagtttcgctccgtggaggctgtgcaggagatcacagagtatgccaaaagcattcctggttttgtaaatcttgacttgaacgaccaagtaactctcctcaaatatggagtccacgagatcatttacacaatgctggcctccttgatgaataaagatggggttctcatatccgagggccaaggcttcatgacaagggagtttctaaagagcctgcgaaagccttttggtgactttatggagcccaagtttgagtttgctgtgaagttcaatgcactggaattagatgacagcgacttggcaatatttattgctgtcattattctcagtggagaccgcccaggtttgctgaatgtgaagcccattgaagacattcaagacaacctgctacaagccctggagctccagctgaagctgaaccaccctgagtcctcacagctgtttgccaagctgctccagaaaatgacagacctcagacagattgtcacggaacacgtgcagctactgcaggtgatcaagaagacggagacagacatgagtcttcacccgctcctgcaggagatctacaaggacttgtactagcagagagtcctgagccactgccaacatttcccttcttccagttgcactattctgagggaaaatctgacacctaagaaatttactgtgaaaaagcattttaaaaagaaaaggttttagaatatgatctattttatgcatattgtttataaagacacatttacaatttacttttaatattaaaaattaccatattatgaaattgctgatagta

SEQ ID NO: 30 - DNA, 2766 bp, Homo sapiens; identical to SEQ ID NO: 9

SEQ ID NO: 31 - DNA, 1249 bp, Mus musculus
ccacgcgtccgctgggcttaacgggtcctccctgcccgagcaagaggaagggacgctcacctttgagctgctccacagcgccgcctctgcactggcactacctagcccaggtggctctgcaggagtccgaagtcgcgggtttcgtgcccgcatcaggcaacagtgccactgttgtcttcagggctgagtccttttgttcttgcactcacgcctctctgccctccaagccaggatggtgaacccgacaacttccgaagtgcaacccaccatgggggtcaagatcttctcagccggagtttcagcttgcctggcagatatcatcaccttcccgctggacactgccaaagtccgccttcagatccaaggtgaaggccaggcttccagtaccattaggtataaaggtgtcctagggaccatcaccaccctggcaaaaacagaaggattgccgaaactgtacagcggtctgcctgcgggcattcagaggcaaatcagctttgcctcactcaggattggcctctacgactcagtccaagagtacttctcttcagggagagaaacacctgcctctctcggaaacaagatctcagccggcttaatgactggaggtgtggcagtgttcattgggcagcctacagaggtcgtgaaggtcagaatgcaagcccagagccatctgcatgggatcaaaccccgctacacggggacctacaatgcttacagagttatagccaccacagaaagcttgtcaacactttggaaagggacgacccctaatctaatgagaaatgtcatcatcaattgtacagagctggtaacatatgacctcatgaagggggcccttgtaaacaacaaaatactggcagatgacgtcccctgccatttactgtcagctcttgttgccgggttttgcaccacactcctggcctctccagtggatgtggtaaaaacaagattcatcaactctctgccaggacagtacccaagcgtaccaagctgtgcgatgtccatgtacaccaaggaaggaccgacggcctttttcaaagggtttgtggcttcttttctgcgactcgggtcctggaacgtcatcatgtttgtgtgctttgaacagctgaaaaaagagctgatgaagtccagacagacagtggattgtaccacataagcaacttggaggaagagatactgaacatcattgggcttctatgctgggagaccacgaataaaaccaaccaaagaaatcaaaaaaaaaaaaaaa

SEQ ID NO: 32 - DNA, 4133 bp, Mus musculus
cgggttcgcagctactgtcagttccgccctcggtgtcgtcgggtcgccagcttcctgggcagccaccactctcccgccgtcggacacagccttctgcactcctgtgttctcctgcggtccggacacaatagtatgaactttaagtgtttcgtctcccagccattttctatggaaaatcgaggggatcgggccatggtagccaccggcagctttgaagaacgagacacctttagagaagcttgaccttggaggcctcagcctgagacctcaaagcagcctccagaactccggcagagttcctctgtctcgtcttgccgattgaaggtccccgtttctccaatttctctccatcttctgggaggtagcaggaaatcagaatcatggttggtttcaaggccacagatgtgcccccaacagccactgtgaagttcctgggggctgggacagctgcctgcattgcagatctcatcactttccctctggataccgccaaggtccggctgcagatccaaggggagagtcaagggctagtgcgcaccgcagccagcgcccagtaccgtggcgttctgggtaccatcctaaccatggtgcgcactgagggtccacgcagcctctacaatgggctggtcgccggcctgcagcgccagatgagctttgcctccgtccgcattggcctctacgactctgtcaaacagttctacaccaagggctcagagcatgcaggcatcgggagccgcctcctggcaggtagcaccacaggtgccctggccgtggctgtagcccagcctacagatgtggtaaaggtccgcttccaggctcaggcccgggctggtggtggtcggagataccagagcactgtcgaagcctacaagaccattgcacgagaggaagggatccggggcctctggaaagggacttctcccaatgttgcccgtaatgccattgtcaactgtgctgagctggtgacctatgacctcatcaaagatactctcctgaaagccaacctcatgacagatgacctcccttgccacttcacttctgccttcggggccggcttctgcaccaccgtcatcgcctcccctgttgatgtggtcaagacgagatacatgaactctgccttgggccagtaccacagcgcaggtcactgtgcccttaccatgctccggaaggagggaccccgcgccttctacaaggggttcatgccttcctttctccgcttgggatcctggaacgtagtgatgtttgtcacctatgagcagctcaaaagagccctaatggctgcctaccaatctcgggaggcacctttctgagcctctccatgctgacctggaccctgcttcccagccctgccctgtctttttcttcatcctctgcccagtcccattctcttcccatttcctgcaccccgatttacttcccacctcacctccctgtgcctctgtactgatgactcacagtgaggaggcctgacaccagaccctgagccctcagccctttctacagctaagcccacatcttcatcttcatccccagcccagcccagcccagctcagccagccttcacccataaagcaagctcaatgttggtgtcttctttctcatatgtttacagaggtcttggtccaagggaccttttcaggaccttggcaggcaggtgaggaccccagtgtctttaaaaagggatgtgacccacattctgcctgtaacatctgagaggggctggagggtcttccagtctgttcctccagacccagtgttggctccagagatcagtggcacagccaggggacactgcagcctttgtccctcctaccctttcctgaacaccatgtaagctgtcactcagtacctggtactcccacccacactggccaggcctgtctatctgcagagtggaagtatccctgcccctcccacatcaacttgttaggagatgtagggaaactccagaaccttccattttgggggggagcttactttactctgttttacacatagcaacccacctcctgaggccatagacctacagaagacaaggcaggctggcctcagctataatcacaccctgagacatgctctgaaccgggggtgggtggggacagggcaggtctgacccattgaagggggctcaggctccctagccaagatctagcctgtaggggtgttgttgttgtttcaaacggggcttcacactagcacactggcctggaactcgctgtgtagtctagaactcatgacaattctgcctgagtttctcaaggctgggattacagccacctgtagcacccgacctctgaagagcctttctgatggaagccttaccttttcccccaagactggggaccagtcaacgcttagattgtcagggtgtttcagtcagtcctctttcccgccagctctcctcagccaggagagggaggcaggaccactcaaggagcaggaaccaccggtgaggtccctcccagagcagggcggggcctgtcaagtctccacgacccattttatacatttcagacatctcctacgggtcaccatcgaacgccaaggcaagacacacagtgctgggtccttgggggattgtctggcagctgtgaaactgggcccagacaataggatgtcctctcggcctaaagtgatggcttctgccccttcacctctttagcagaatgggtcagagctaaaaagttagaccttcccagtgcttggcaagaggccaggctgttcgattggctcccagagaagagcaccagttctcctcagcttctggtaaatccagccccggtctcggtcctgaggcagcagcaagccgcagtgagggttggccggcgtgcagctggtgcttcagcacacaagggcacagcaaatgaggatctggtcattgtgttaggtccttcaagggacagtttactaccaacagctgacaaacaggtcaagagagggcacagtgtgtccaatagctccttcactagacatgtgatataggtgtgagaccactagactccatgactaggaatgctgtcagttggcctgaggaaggggcagcagtctttagaaaacagcatagcagagaccttagcaatgcttccagagggatgcaccagacgccctgctttgccttctaaggcagcccagttactggctgccttagaagttacagggatctcataaagggcatggtggaggcctgaggccaagcttcccacagagccctccaggacagaagtcctagttccccaacctctctacagaactggagggtcaccctcagagcaggaggttacagtcaccttcgtgtcagtcctgccacagggcagtgaacactccaccgtctggtcccacaggtctgtaatgaaggggttgaagtctttgctgtaaaaactagagcctggcagtggagtctcccctttaatcccagcagtgggggaggtgggggcagactctgtgagttcaaggtcagccagggctacacaaagaaatcctgtctcaaacaaaaacaaagatggatcctgagggctggaaagatggcttggcagtcaagaacactagcaactctggcaaaggtcctaggttccagacccagggcccacactatagctcacaaccatctgtttaactcgagttccaggagttctggcctccgagggcactgcaagcatgtgtatggcacagtaacatgcaggcaaaacaactttattccacaaaaaggacctagagaaatgaagtgacttgcccaggaatctgaccgaaggcccacatttgactgttaaaatgagatgcttcctggctggagccccagccccagagtctttatctccaggtgttttttgggtttggttgtttttgagacagaggctctctgtgtagccctggctatcctggagcttgctctgtagaccaggcttgtctcagagatctacctgcatctgcctcccaagtgctgggattaaaggtgtgcactgcaccaccaagtttaggcctcttatctcagggttttttctgttgctgccttcatgatggttcaagatggcttcaggcagtaggataacttgatcccaagggtttggggacagcagggacaagactgtatgtgttcaaaagtaaaacacttgccaagggctacattcccactttac

SEQ ID NO: 33 - DNA, 2448 bp, Mus musculus
agacaacagtgaatggtgaggcccggccgtcagatcctgctgctacctaatggagtggagccttagggtggccctgcactacccaaccttggctagacgcacagcttcctccctgaactgaagcaaaagattgccaggcaagctctctcctcggacctccataggcagcaaaggaaccaggcccattccccgggaccatggttggacttcagccctccgaagtgcctcccacaacggttgtgaagttcctgggggccggcactgcggcctgttttgcggacctcctcacttttcccctggacaccgccaaggtccgtctgcagatccaaggggagaacccaggggctcagagcgtgcagtaccgcggtgtgctgggtaccatcctgactatggtgcgcacagagggtccccgcagcccctacagcggactggtcgctggcctgcaccgccagatgagttttgcctccattcgaattggcctctacgactctgtcaagcagttctacacccccaagggagcggaccactccagcgtcgccatcaggattctggcaggctgcacgacaggagccatggcagtgacctgcgcccagcccacggatgtggtgaaggtccgatttcaagccatgatacgcctgggaactggaggagagaggaaatacagagggactatggatgcctacagaaccatcgccagggaggaaggagtcaggggcctgtggaaagggacttggcccaacatcacaagaaatgccattgtcaactgtgctgagatggtgacctacgacatcatcaaggagaagttgctggagtctcacctgtttactgacaacttcccctgtcactttgtctctgcctttggagctggcttctgtgccacagtggtggcctccccggtggatgtggtaaagacccgatacatgaacgctcccctaggcaggtaccgcagccctctgcactgtatgctgaagatggtggctcaggagggacccacggccttctacaaaggatttgtgccctcctttctgcgtctgggagcttggaacgtgatgatgtttgtaacatatgagcaactgaagagggccttaatgaaagtccaggtactgcgggaatctccgttttgaacaaggcaagcaggctgcctggaacagaacaaagcgtctctgccctggggacacaggcccacacggtccagaaccctgcactgctgctgacacgagaaactgaactaaaagaggagagttttagtcctccgtgtttcgtcctaaaacacctctgttttgcactgacctgatgggaaataaattatattaatttttaaaccccttccggttggatgcctaacatttaggcaagagacaacaaagaaaaccagagtcaactcccttgaaatgtaggaataaaggatgcataataaacaggaaaggcacaggttttgagaagatcagcccacagtgttgtccttgaatcaaacaaaatggtcggaggaacccttcggcttcagcacaaagaggtgactacagccttctggtcaccagatgactccgcccctctgtaatgagtctgccaagtagactctatcaagattctggggaaaggagaaagaacacattgatactgcacaaatgagtggtgctgggcccaccgaggacactggaggatggagcgtgatctgggataacagtccttctctgtctgcctcatcagggtgttgggaagatagaaagcgaagcagacatggaagcacttcctaacaaggcctgtcatcgtcatcatctacaaatgtaagcctgaggacaatgttttaggagagattctgtccagagaagtagtttgaggaaaatgcagtttgtagtggtaaagccatgcacacctggactgcatggtaaggaccaggggtgacggaagccatggggatccggtgcctggtaacatcaaagggctgtggggggggggggcactgcctgtccatcagttcaaagcagcaggactcagaatctttagggaattgttaggactggtaaaagaatttccaccttagggcaagaacgagaacagctgctcttctgccttctctctcggaggttttctcatctcagggtcctacctgccaggctcctgaccagctccacctgcccacacttcctcctgctctcgctgcctttggctgcagagcctttgctcctcctgttaagccttcagtcttccatctgcaaaagggagggcaaagcacaggaccaacttccaagcttaaaaatgcacatctgacaacaaaatggctcagtggggtccattcatgggacccacatggtggaaggacagaatggactcttgcaaattgtcctctgacctccatttgagcgccctatacatgtgactgtacatatgtacaaacacgataaagatggaaacacatgtaaaaacataaaaataaaaagttgtactgga

SEQ ID NO: 34 - DNA, 3277 bp, Homo sapiens
ctcggcgttgactccgccgcacgctgcagccgcggctggaagatggcggggaacgactgcggcgcgctgctggacgaagagctctcctccttcttcctcaactatctcgctgacacgcagggtggagggtccggggaggagcaactctatgctgactttccagaacttgacctctcccagctggatgccagcgactttgactcggccacctgctttggggagctgcagtggtgcccagagaactcagagactgaacccaaccagtacagccccgatgactccgagctcttccagattgacagtgagaatgaggccctcctggcagagctcaccaagaccctggatgacatccctgaagatgacgtgggtctggctgccttcccagccctggatggtggagacgctctatcatgcacctcagcttcgcctgccccctcatctgcaccccccagccctgccccggagaagccctcggccccagcccctgaggtggacgagctctcactgctgcagaagctcctcctggccacatcctacccaacatcaagctctgacacccagaaggaagggaccgcctggcgccaggcaggcctcagatctaaaagtcaacggccttgtgttaaggcggacagcacccaagacaagaaggctcccatgatgcagtctcagagccgaagttgtacagaactacataagcacctcacctcggcacagtgctgcctgcaggatcggggtctgcagccaccatgcctccagagtccccggctccctgccaaggaggacaaggagccgggtgaggactgcccgagcccccagccagctccagcctctccccaggactccctagctctgggcagggcagaccccggtgccccggtttcccaggaagacatgcaggcgatggtgcaactcatacgctacatgcacacctactgcctcccccagaggaagctgcccccacagacccctgagccactccccaaggcctgcagcaacccctcccagcaggtcagatcccggccctggtcccggcaccactccaaagcctcctgggctgagttctccattctgagggaacttctggctcaagacgtgctctgtgatgtcagcaaaccctaccgtctggccacgcctgtttatgcctccctcacacctcggtcaaggcccaggccccccaaagacagtcaggcctcccctggtcgcccgtcctcggtggaggaggtaaggatcgcagcttcacccaagagcaccgggcccagaccaagcctgcgcccactgcggctggaggtgaaaagggaggtccgccggcctgccagactgcagcagcaggaggaggaagacgaggaagaagaggaggaggaagaggaagaagaaaaagaggaggaggaggagtggggcaggaaaaggccaggccgaggcctgccatggacgaagctggggaggaagctggagagctctgtgtgccccgtgcggcgttctcggagactgaaccctgagctgggcccctggctgacatttgcagatgagccgctggtcccctcggagccccaaggtgctctgccctcactgtgcctggctcccaaggcctacgacgtagagcgggagctgggcagccccacggacgaggacagtggccaagaccagcagctcctacggggaccccagatccctgccctggagagcccctgtgagagtgggtgtggggacatggatgaggaccccagctgcccgcagctccctcccagagactctcccaggtgcctcatgctggccttgtcacaaagcgacccaacttttggcaagaagagctttgagcagaccttgacagtggagctctgtggcacagcaggactcaccccacccaccacaccaccgtacaagcccacagaggaggatcccttcaaaccagacatcaagcatagtctaggcaaagaaatagctctcagcctcccctcccctgagggcctctcactcaaggccaccccaggggctgcccacaagctgccaaagaagcacccagagcgaagtgagctcctgtcccacctgcgacatgccacagcccagccagcctcccaggctggccagaagcgtcccttctcctgttcctttggagaccatgactactgccaggtgctccgaccagaaggcgtcctgcaaaggaaggtgctgaggtcctgggagccgtctggggttcaccttgaggactggccccagcagggtgccccttgggctgaggcacaggcccctggcagggaggaagacagaagctgtgatgctggtgccccacccaaggacagcacgctgctgagagaccatgagatccgtgctagcctcaccaaacactttgggctgctggagaccgccctggaggaggaagacctggcctcctgcaagagccctgagtatgacactgtctttgaagacagcagcagcagcagcggcgagagcagcttcctcccagaggaggaagaggaagaaggggaggaggaggaggaggacgatgaagaagaggactcaggggtcagccccacttgctctgaccactgcccctaccagagcccaccaagcaaggccaaccggcagctctgttcccgcagccgctcaagctctggctcttcaccctgccactcctggtcaccagccactcgaaggaacttcagatgtgagagcagagggccgtgttcagacagaacgccaagcatccggcacgccaggaagcggcgggaaaaggccattggggaaggccgcgtggtgtacattcaaaatctctccagcgacatgagctcccgagagctgaagaggcgctttgaagtgtttggtgagattgaggagtgcgaggtgctgacaagaaataggagaggcgagaagtacggcttcatcacctaccggtgttctgagcacgcggccctctctttgacaaagggcgctgccctgaggaagcgcaacgagccctccttccagctgagctacggagggctccggcacttctgctggcccagatacactgactacgattccaattcagaagaggcccttcctgcgtcagggaaaagcaagtatgaagccatggattttgacagcttactgaaagaggcccagcagagcctgcattgataacagccttaaccctcgaggaatacctcaatacctcagacaaggcccttccaatatgtttacgttttcaaagaaatcaagtatatgaggagagcgagcgagcgtgagagaacacccgtgagagagacttgaaactgctgtcctttaaaaaaaaaaaaaaaaa

SEQ ID NO: 35 - DNA, 1887 bp, Mus musculus
tggctcggaggcttgggcggggcagtcaagcgatattttaacagtcgttctggccgctttgctgtgtggtgatctggaccgtgcggacttgctcgtccctcagctctcctgttaggcgtctcttttctccaggaggaaaaaatggcagcagcagtagtggatccgcaacagagcgtggtgatgagagtggccaacctgcccttggtgagctctacctacgaccttgtgtcctccgcttatgtcagtacaaaggatcagtacccgtatttgagatccgtgtgtgagatggccgagaagggcgtgaagaccgtgacctctgcggccatgacaagtgccctgcccatcatccagaagctggagccacaaattgcggttgccaatacctatgcctgcaaggggctagacaggatggaggaaagactgcctattctgaaccagccaacgtccgagattgttgccagtgccagaggtgccgtaactggggcgaaggatgtggtgacgactaccatggctggagccaaggattctgtagccagcacagtctcaggggtggtggataagaccaaaggagcagtgactggcagcgtggaaaggaccaagtctgtggtcaatggcagcatcaatacagttttggggatggtgcagttcatgaacagtggagtagataatgccatcaccaagtcggagctgctggtagaccagtacttccctctcactcaggaggagctggagatggaagcaaaaaaggtggaaggatttgatatggttcagaagccgagcaactatgaacggctggagtccctgtctaccaagctctgctctcgggcttatcaccaggctctcagcagggttaaagaggccaaacaaaagagccaggagaccatttctcagctccactccactgtccacctgattgaattcgccaggaagaatatgcacagtgccaaccagaaaattcagggtgctcaggataagctctatgtctcgtgggtggagtggaagagaagcatcggctacgacgacaccgatgagtcccactgtgttgagcacatcgagtcacgtactctggctatcgcccgcaacctgacccagcagctccagactacatgccagactgtcctggtcaacgcccaagggttaccacagaacattcaagatcaggccaaacacttgggggtgatggcaggcgacatctactccgtattccgcaatgctgcctcctttaaggaagtgtccgatggcgtcctcacatctagcaaggggcagctgcagaaaatgaaggaatccttagatgaagttatggattactttgttaacaacacgcctctcaactggctggtaggtcccttttatcctcagtctaccgaggtgaacaaggccagcctgaaggtccagcagtctgaggtcaaagctcagtaaacccctccttgtcaccagagcatgatgttgctggccagatgaccccttttgctgtattgaaattaacttggtagatggctttagcttagaaaagcagcttcttagaaccaagggcctcattatggtcactcacagctcagttatggtcttgccccagctggccctggcacaggagttctcttacctggctggtgagtggcctgtgttagtcttgtgaggacctcgaggaacctaaaagctcagatgcacttacagtcttgtctgtggcctttgtattgttattggctgtaaacgtctgtctggaccgaataaagattcattcacgtggcctctgctcctgtgtggtctgagcaggcttcatctctgtttctctcaaggcgtgtgcttgggcagcttgaggtgaggtttttccttccctgtgaagaaataccaacctttggacccaataacattcataactggtagagc

SEQ ID NO: 36 - DNA, 1233 bp, Mus musculus
taagctggggtctgcctgtccccatgagtaccagactaatgagacctggccactttctcctcatttctgtctgtacgattgtcagtggatctgacgacaccaaaagggctcaggatgctactgttgcaagctctcctgttcctcttaatcctgcccagtcatgccgaagatgacgttactacaactgaagagctagctcctgctttggtccctccacccaagggaacttgtgcaggttggatggcaggcatcccaggacatcctggccacaatggcacaccaggccgtgatggcagagatggcactcctggagagaagggagagaaaggagatgcaggtcttcttggtcctaagggtgagacaggagatgttggaatgacaggagctgaagggccacggggcttccccggaacccctggcaggaaaggagagcctggagaagccgcttatgtgtatcgctcagcgttcagtgtggggctggagacccgcgtcactgttcccaatgtacccattcgctttactaagatcttctacaaccaacagaatcattatgacggcagcactggcaagttctactgcaacattccgggactctactacttctcttaccacatcacggtgtacatgaaagatgtgaaggtgagcctcttcaagaaggacaaggccgttctcttcacctacgaccagtatcaggaaaagaatgtggaccaggcctctggctctgtgctcctccatctggaggtgggagaccaagtctggctccaggtgtatggggatggggaccacaatggactctatgcagataacgtcaacgactctacatttactggctttcttctctaccatgataccaactgactgcaactacccatagcccatacaccaggagaatcatggaacagtcgacacactttcagcttagtttgagagattgattttattgcttagtttgagagtcctgagtattatccacacgtgtactcacttgttcattaaacgactttataaaaaataatttgtgttcctagtccagaaaaaaaggcactccctggtctccacgactcttacatggtagcaataacagaatgaaaatcacatttggtatgggggcttcacaatattcgcatgactgtctggaagtagaccatgctatttttctgctcactgtacacaaatattgttcacataaaccctataatgtaaatatgaaatacagtgattactcttctcact

SEQ ID NO: 37 - DNA, 1364 bp, Homo sapiens
ggagccatggattgcactttcgaagacatgcttcagcttatcaacaaccaagacagtgacttccctggcctatttgacccaccctatgctgggagtggggcagggggcacagaccctgccagccccgataccagctccccaggcagcttgtctccacctcctgccacattgagctcctctcttgaagccttcctgagcgggccgcaggcagcgccctcacccctgtcccctccccagcctgcacccactccattgaagatgtacccgtccatgcccgctttctcccctgggcctggtatcaaggaagagtcagtgccactgagcatcctgcagacccccaccccacagcccctgccaggggccctcctgccacagagcttcccagccccagccccaccgcagttcagctccacccctgtgttaggctaccccagccctccgggaggcttctctacaggaagccctcccgggaacacccagcagccgctgcctggcctgccactggcttccccgccaggggtcccgcccgtctccttgcacacccaggtccagagtgtggtcccccagcagctactgacagtcacagctgcccccacggcagcccctgtaacgaccactgtgacctcgcagatccagcaggtcccggtcctgctgcagccccacttcatcaaggcagactcgctgcttctgacagccatgaagacagacggagccactgtgaaggcggcaggtctcagtcccctggtctctggcaccactgtgcagacagggcctttgccgaccctggtgagtggcggaaccatcttggcaacagtcccactggtcgtagatgcggagaagctgcctatcaaccggctcgcagctggcagcaaggccccggcctctgcccagagccgtggagagaagcgcacagcccacaacgccattgagaagcgctaccgctcctccatcaatgacaaaatcattgagctcaaggatctggtggtgggcactgaggcaaagctgaataaatctgctgtcttgcgcaaggccatcgactacattcgctttctgcaacacagcaaccagaaactcaagcaggagaacctaagtctgcgcactgctgtccacaaaagcaaatctctgaaggatctggtgtcggcctgtggcagtggagggaacacagacgtgctcatggagggcgtgaagactgaggtggaggacacactgaccccacccccctcggatgctggctcacctttccagagcagccccttgtcccttggcagcaggggcagtggcagcggtggcagtggcagtgactcggagcctgacagcccagtctttgaggacagcaagacagaataactgaggcctggagccac

SEQ ID NO: 38 - DNA, 10260 bp, Mus musculus
agtaattccgagggcgagcgagcgggccgggaccggcagagcccacttctctccgcggcgcagcgcaaagctgggcagggggcgccgcgggacccgcgcaaccacagccggcttggggagctgctctgctccctgtttccccccacttttttcttcccctttctggaagggtttgtgcaggggtagggaaaacagactcaaacagcaaagtggaaaacagttaatgaccagccacagagtcacagctctgtgctctggctgctccctccagggctctcgagccgcagacgcaggtcgctgtgggtgccggctgtggtgacatggcttgttggcctcagttaaggctgctgctgtggaagaatctgacatttcgaaggagacaaacatgtcagctgttactggaagtggcctggcctctctttatcttcctgatcctgatctctgtacgcctgagctacccaccctacgaacaacatgagtgccactttccgaataaagccatgccgtctgcaggaaccctcccctgggtacaggggattatctgtaatgccaacaacccctgcttccgttatccaactcccggcgaggctcccggtgttgttggaaactttaacaagtccatcgtgtctcgcctgttctcagacgctcagaggcttcttctgtacagccaaagagataccagcattaaggacatgcacaaggtcctgagaatgttacggcagatcaagcatcccaactcaaatttgaagctccaggattttctggtggacaatgaaacattctctggattcctgcagcacaatttgtcccttccaagatctactgtggacagcctgctgcaggcgaatgttggtctccagaaggtatttttgcaaggctaccaattacatttggccagtctgtgtaacggatcaaaattagaagaaattattcagcttggtgatgcggaagtttctgccctctgtggtctaccgaggaagaagctcgatgcagccgagagagtactgcgctacaacatggacatcctgaagccagttgtgacaaaactaaattccacatctcatctcccgacccagcatctggctgaagccaccacagtgttgcttgacagcttggggggcctggcccaagagctgttcagcacaaagagctggagcgacatgcggcaggaggtgatgtttctgaccaacgtgaacagctccagctcctccacccagatctaccaggcagtgtcccgcatcgtgtgtggtcacccagagggtgggggcctgaagatcaagtccctcaactggtacgaggataacaactacaaagccctctttggagggaataacaccgaggaagacgtggacaccttctatgacaattctacaactccttattgcaatgatttgatgaagaacttggagtctagtcctctttctcgaattatttggaaggcactcaagccactgcttgttggaaagattctctatacacctgacacaccagctacaaggcaggtcatggctgaggtgaacaagacctttcaggagttggctgtgttccatgacctggagggcatgtgggaagaactcagcccccaaatttggaccttcatggagaacagccaagagatggaccttgtccggacgctgttagacagcagaggcaatgaccagttttgggaacagaagttggatggattagattggactgcccaagacatcatggcgtttctggccaagaacccagaagatgttcagtccccaaatggctctgtgtatacctggagagaagctttcaatgagaccaaccaggcaatccagacgatatctcgattcatggagtgtgtcaacctgaacaagctggaacccattccgacagaagtcaggctcatcaacaagtccatggagctgctggacgagaggaagttctgggctggcatcgtgttcacaggcatcactccagatagtgtggagctgccccatcatgtaaagtacaagatccggatggacattgacaacgtggagagaactaataagatcaaggatgggtactgggaccctggtcctcgggctgacccttttgaagatatgcgctatgtctggggcggcttcgcctacttgcaggatgtggtggaacaggccatcatcagagtgctgacgggatctgagaagaaaacgggtgtctacgtgcaacagatgccctacccctgttatgttgatgacatttttctgcgggtcatgagccggtcaatgcccctcttcatgactctagcctggatctactctgtcgctgtgatcatcaagagcattgtgtatgagaaggaggctcggctgaaggagaccatgcggatcatgggtctggacaatggcatcctctggtttagctggtttgttagcagcctcatccctctgcttgtgagcgctggcctgctggtggtcatcttgaagttaggaaacctgctgccctatagtgaccccagcgtggtgttcgtcttcctgtctgtgtttgccatggtgaccatcctacagtgcttcctcattagcacgctcttctcccgtgccaacctggcagcagcctgtgggggcatcatctacttcacgctgtacctgccctatgtgctgtgcgtagcctggcaggactatgtgggcttctccatcaagatctttgctagcctgctgtctcctgtggcttttggattcggctgtgagtatttcgcccttttcgaggagcaaggtatcggggtccaatgggacaatctctttgagagcccggtggaggaggacggcttcaatctcaccactgcagtgtccatgatgctctttgacacctttctctatggcgtgatgacatggtacatcgaagccgtctttccaggacagtatggaattcccaggccctggtattttccttgtaccaagtcatactggtttggtgaggaaattgatgagaagagccaccctggttccagccagaagggagtgtcagaaatctgcatggaagaggaacccactcatctgaggctgggggtgtccattcagaacctggtgaaggtttaccgagatggcatgaaggttgctgtggatggcttggcgctcaacttttacgaaggccagattacctccttcctgggccacaatggagcagggaagaccaccaccatgtcaatactgactgggctgtttcccccaacttctggcacggcctacatcctggggaaggacattcgctcggagatgagctccatccggcagaacctgggagtctgtccccagcataatgtgctgtttgacatgctgactgtcgaagagcacatctggttctatgcgcgcctaaaggggctctcagagaagcacgtgaaagcagagatggagcagatggccctggatgttggcttacccccgagcaagctgaaaagcaaaacgagtcagctctcaggtgggatgcagagaaagctgtctgtggccttggccttcgtgggtggatccaaggttgtcattctggacgagcccacagccggggtggacccgtactctcgcaggggaatatgggaactcctgctaaaataccggcaaggccgcaccattattttgtctacacaccacatggacgaagctgacatccttggggacagaattgccatcatttcccatgggaagctgtgttgtgtgggctcctccctgtttttgaaaaaccagttgggaacgggttactatctgaccctggttaagaaagatgtggaatcgtccctcagttcctgcagaaacagtagcagcaccgtgtcttgtctgaaaaaggaggacagtgtttctcagagcagttctgatgctggcctgggcagcgaccatgaaagtgacacgctgaccatcgatgtctctgctatctccaacctcatcaggaagcacgtgtctgaagcccggctggtggaggacattgggcacgagctgacctatgtgctgccgtacgaagccgcgaaggagggagcctttgtggaactcttccatgagattgatgaccggctctcagacctgggcatctccagttatggcatctcggagaccaccctggaagaaatattcctcaaagtggctgaagagagcggggtggatgctgagacctcagatggtactttgccagcaagacgaaacagacgggccttcggggacaagcagagctgtctgcacccatttacggaagatgatgctgttgatcccaatgactctgacatagacccagaatccagggagaccgacctgctcagtgggatggacggcaaaggctcctaccagctgaagggctggaaactcacccagcaacagtttgtggcccttttgtggaagaggctgctgattgccagacggagccggaagggtttctttgctcagattgtcctgccagctgtctttgtttgcattgccctggtcttcagcctgattgtgccaccctttggcaagtaccccagcctggaacttcagccctggatgtataatgagcagtatacatttgtcagtaatgatgctcccgaggacatgggcacccaggaactcctgaatgctctgaccaaagatccaggctttgggacccgctgtatggaaggaaacccaatcccagataccccttgcttggctggggaggaggactggaccatcagccccgtcccccagagcatcgtggacctcttccagaatggaaactggaccatgaagaacccctcacctgcgtgccagtgtagcagtgacaaaatcaagaagatgctgcctgtgtgtcccccaggggcaggggggctgccacctcctcagagaaaacagaaaaccgcagacatccttcagaatctgacaggaagaaatatttcagattacctggtgaagacgtacgtgcagatcatagcaaagagcttaaagaataagatctgggtgaacgagtttcggtatggcgggttttccctgggtgtcagtaattctcaagcacttcctccgagccatgaagttaatgatgctatcaagcaaatgaagaaactcctgaagctgaccaaggacagctccgcagatcgcttcctcagcagcctgggaaggttcatggcagggctggatacgaaaaacaatgtcaaggtgtggttcaataacaagggctggcatgctatcagttcgttcctgaatgtcatcaacaatgccattctccgggccaacctgcagaagggagagaacccgagccagtatggaatcactgctttcaaccaccccttgaacctcactaaacagcagctctcagaggtggctctgatgaccacctctgtcgacgtcctcgtgtctatctgtgtcatctttgcgatgtcctttgtccctgccagctttgttgtgttcctgatccaggagcgtgtgagcaaagccaagcatcttcagttcatcagcggcgtgaagcctgtcatctactggctgtccaattttgtctgggatatgtgcaattatgtggtccctgctacactggtcattatcatcttcatctgcttccagcagaagtcctatgtgtcctctaccaacctgcccgttctagcccttctgctcttgctgtatgggtggtcgatcactcctctcatgtatccagcatcctttgtgttcaagatccccagcaccgcctatgtggttctcaccagtgtgaacctcttcatcggcatcaatggcagtgtggccactttcgtactggagctgtttacaaacaataagctcaatgacatcaatgacatcctgaagtctgtgtttcttatcttcccacatttttgcctggggcgagggctcatcgacatggtgaagaaccaggccatggccgatgccctggagaggtttggggagaaccgcttcgtctctccgctctcttgggacttggtaggacggaacctttttgccatggccgtggaaggggtggtgttcttcctcattactgttctgatccagtacagatttttcatcaggcccagacctgtaaaggcgaagcttcctcctttgaatgacgaggatgaggatgtgaggcgggagagacagaggattctggacggtggcggacagaatgacatcctagagatcaaggaactgaccaagatctataggaggaagcggaagcctgcagtcgacaggatctgcatcggcatccctcccggagagtgctttggactcctgggagttaacggagctgggaagtcaacaactttcaagatgctgactggagacacccctgtgaccagaggggatgcgttccttaacaaaaacagcatcttatcaaatatccatgaagtacaccagaacatgggctactgccctcagtttgacgccatcacagagctgctgacgggaagagagcatgtggagttctttgccctcctgaggggagtcccagaaaaggaagttggcaaggttggtgaatgggcaattcgcaaactgggcctggtaaagtatggagaaaaatatgccagtaactacagtggcggcaacaaacgaaagctctccacagccatggctttgattggcggacctcctgtggtgtttctggatgaaccaaccacaggcatggaccctaaagcccggagattcttgtggaattgtgccctaagcattgtcaaggaggggagatctgtagtccttacatctcatagtatggaagaatgtgaagctctttgtacaaggatggccataatggtcaatggaaggttcaggtgccttggcagtgtccaacatctgaaaaacaggtttggagatggttatacaatagttgtacgaatagcaggctccaaccctgacctgaagcctgtccaggagttctttggacttgcgtttccgggaagtgtcctaaaagagaaacatcgaaacatgcttcagtaccagcttccatcctccttgtcatctctagccaggatattcagcatcctctcccagagcaaaaagcgactccacatagaagactactctgtctctcagacaacacttgaccaagtatttgtgaactttgccaaggaccaaagtgatgatgaccacttaaaggacctgtcactgcacaaaaaccagacagttgtggatgtggccgttctcacatcctttttgcaggatgagaaagtgaaagaaagttatgtatgaagaatcccgttcacacagggtgaatgaaaggaaggaagagcgaggtcttcctttgcactgtgtcaagtgttctagaagaaagcgtcctgcgtttctgtggagaagaacaaactggatactgtactgacactattcaatgcaatgcacttcaatgcaacgagaacacaattccattacaggggcagtgcctttgtagcctatgtcttgtatggctctctagtgaaaatgacttgaagttagttcattaccttatacagatgtgaaactctggtgtggaaccaagcagactctgggtttggattcatactttttttgttcctgtgtattctcactaggattgcaacaacagtctatcaaatagtcatggccagtgataatcaaagtcaaaggcacacacatcctcgtccattaagccattaagccatgctgaaccacaaaacaggtttcccggtgacacatccattgctggcaatgagtgtgccagagttactagtgccaagttgctcagaaagtctgaagcactgagtgtgtcacaaacacttttgtgaaaaccgccctactgtcggttgacatcattaaatatcaggtgacaaaaacggtgccacatgtgactaaatccccattttccttctctctttgatgagctgctgttgtggctgtcttgtacaaaatgtgcatctctctaacccaggtacttggttctcttgttcagtgttgcccatgcccctgtcatggcttgccatagcatctttctgagactttttcaaatacattagatcctcctaagcagcaaagattagcagccaaactgctggggctgcaagcggctcagttcagggtgtggcatgaaagatccagtgcatttacacgtggcaggtctgggttggtttgtgctgactgtctcctaacacaagatgggtacactacaccttgagatccttcattatttaacagaaatctagttctttctaactgtttgaattaacctagaaaatgaaagggtggcatttcattttgacaaaaatgtttgcattgttagtattatttggaattttaagttttatcaatgcttctggaagcttagaactgtacacgtgtgatgtcagtcacatagaggaatgtgcccggactgcctcatgcctttattttccttggtaaatttgaagatagaatgtctgactagcgcagtgaccagaaaacaatgtggtagtcaacatctcaggccatattttaagatcctgtagagcactattcatttcaggttgcagatggagtatttttgaaacatcattactatgtagatgcttggataggagtgagggggagctagcagatttcctgtgccatttattcagctgattgatgtacagatgtaggtttattttgtaaaatccactgaaagaatatggccacacccttgcctacttgatagcatcaatacagaagccaagaaggaccactaagtaaccccctcttcccagggagagcagctagcttgaaatctctcggatacaatcgatgcgtctgacctttgggatcctcaccatatgggcaaacaatgggctttgcaggatgagagacacccacttaaacctctgacgatctcgaatggttcatctcttccgtcattaaccagtcatggaaaacaatcaacaaactctgccacgtgaaatattttttcagacttttctaacccaagcttaatttgttttcatctgcaagcaacgtggaaaaaaatagttatttcaccagtgctcaatgtcatccgtcttcatacaaaacaaaaatatgagtaagttcctgtattgggcaaagttcaagtgagcttttgctatccttatttaacttcttctaaaaatttggaagaataagatttcagatctatttcaaattatgtttatataatgttatgtaattcattgcttgaaaggaaaaatgacaagtttgatactaatgtcaacataggtttctaaaatgataaggaaagtgtgtttccagtagttattggcataccattcattttagatatcaaagataccgaaatcaaagaagcatgtctttatttttcaaaaacaaacttccgttggctttctcagtccattatcaccatgtacagcccttagaaaaatccttgttttaattactcagatttttgaggccacaaaacaacaacaaaagtaaggcaccatttttgaaaacaaaatcaattgagtgtagatttaaaatcttttctgaagctagagacaatctgtagctattatgttaccttttacactatctgaagagcaatcttcaactttcctgtttaaacgtaattattttagaaagttaaaaatcaatcctatcttcaaataagaatttcttagattccctatggagatgtgcattgtgagttgagaaattctcaagtgcaaacacttctggtttactttaaaaaaaaatagtggaaaacttactaactgtgaatatgagaaagacaaaagaaagtgagtcctctcgctagatatacctagcataattcattatgaaacaaacaaacctcaaactactgtattttggtgtctgtaccgcaagcatatgcctcatgactataaatgttacatacatcatttgctctctgtatagtaggcattgacttaaagggattgtttgttgtcttctcatggttgtatatatcaggtaaaattgttccaaagagccatgtgttatgtaatggggaaccactttgatactgaattactaatttgtactttcattactatttgctggtaatagtgtaacgccacagtaatactgttctgattcaaaactgttgcatccctttttgtagaacatttatatttccataaggattcggtatgttcttttccctcctgccctaggatgaagctggttttgtgctttttctttatcattggccctcattccaagcactttatgctgtctgtaatggatctatttttgcactggaatatctgagatttgcaaaactagacaaaagtttcagagcagatttctaagttaaatcgttttcattaaaagaaaaaaaaactgaaaaaaattgtattgtgaataactttatatgacgtgtttttttaaaagcttgtttctatgttatgagtcacaaaataaagctgtgacagtcctgctggtc

SEQ ID NO: 39 - DNA, 1682 bp, Mus musculus
agagccacttctgccccgtgctgagatggggctgccccagctatggctgtggctgaagcggcttgtgatattcctgcaggtggccttggaggtggctgtaggcaaggtgctaatgacgctgttcccagggagagtcaaacagagcatcctggccatgggccagaagaccgggatggccaggaacccccgattcgcccctgacaactgggtccccaccttcttcagcatccagtacttctggtttgtcctgaaggtccgctggcagagactggaagacagggctgagtttggggggctggcccccaactgcaccgtggtctgcctctcaggacagaagtgcaacatctgggatttcattcaaggcagcaggcccctggtgttgaactttggcagttgcacctgaccttcatttcttctcaaatttgaccagttcaagagactcgtagatgactttgcctccacagccgatttcctcatcatttacattgaagaagctcacgccacagatggctgggcttttaagaacaacgtggacatccggcagcaccggagcctccaggagcgcgtgcgggcagcccgcatgctgctggccaggagcccccagtgccctgtggtggtggacacaatgcagaaccagagcagccagctctacgcggccctgcctgagaggctctacgtgatacaggagggcaggatctgctacaagggtaaagctggcccttggaactacaatcctgaggaagtccgagctgtcctggaaaagctttgcactccacctagacacgtgcctcagctctaggggaccagcaggaaggctccccaagcttggtactttcccacaccagtacagatgtcttttacctttgacctgtgttcccagatgaagtactagctcagatttttctgatctaaacaaataactaccagggaggcaatgcagctcacagcacaaactgtgacaaccagaaataaagcaatgctgagctgttagcaaaagtaagttacagctccacactgctcccacagcagagaccaatccagagtgtccaccttctggtgggagggcactcactcacatgcttggatgacagacttctgaagtgtcgtgactcctgaagatgacgtcaaaagctcaatccatgtgtccaattttgccacttatagacccaatcgtataaaatgctgaactggtttgtttagcacaagcaagaggcaggcatgttctgcttgtaggaaccataggcattggaaacacttttctggccgaaagattgaaatctgttgagattgttggtgataggtgtttccatggcaacatagaatctcattctactccctctaccatcttgaaatagattgcacaggaatctggctctctggcactgatgccaaagctttataactttaactaaaccaaatcgcaggcgccagcaaaagctgccatgtaggccctgttgtgactctgtcctcctgggtcacagtctcttactggtcttttgtgttcgatagcattggactgataggtagccatggcttcatctgtcatgtctgcttctttttatatttgtgtatgatggtcacagtgtaaagttcccacagctgtgacttgatttttaaaaatgtcggaagatgcagcaagctaacaattaaaatctgtcaggctaaaaaaaaaaaaaaaaaaa

SEQ ID NO: 40 - DNA, 5843 bp, Mus musculus
tgggatttcttctaatttagcttttctccctctccctcacccccctcccaaccttccccttggtcccccacttctctaccaccaccttcctttgcaaaaagaaggtgactggggaagcagagtgcccaggagactgaccgaggaggcagagaagatgggactcctcagcgtagacttgctgatcaccctgcagatcctgccagtctttttctccaactgcctcttcctggcgctctatgactcggtcattctgctcaagcacgtggcgttgcttctgagccgctccaagtccactcgcggagagtggaggcgcatgctgacctcagaagggctgcgctgtgtctggaacagcttcctcctagatgcctacaaacaggttaaactgggtgaagatgctcccaattccagtgtggtgcacgtctccaatcctgaatcaggtaacaattatgcctcggagaagaccgctgatggggccgaatgccaccttcttgactttgccagtgcagagcgcccactggtggtcaactttggttcagccacctgaccacctttcactaggcaactgccagccttccgccagctggtggaagagttctcctcggtggctgacttcctgttggtatacattgatgaggctcacccttcggatggctgggcagtgcctggggactcctctctgtcttttgaggttaagaagcaccggaaccaagaggaccgatgtgcagcagctcaccagctcctggagcgtttctccttgccgccccagtgtcaagttgtggctgaccgcatggacaataatgccaacgtagcttacggggtagcctttgaacgtgtgtgcatcgtgcagagacggaaaattgcttacttaggagggaagggccccttcagctataacctacaagaagtccgaagttggctggagaagaatttcagcaagagatgaattctagattagctggatacaagtgtgattgtaatagagtttattattttaaagaaatatgtaaaagaagttgagaactgaactgaatctattatttcaactgaatcccattgcctcaccgaaagacggggacacacctgtcagaagaccttgaacctcttaacatctcaatactttctctagtacacaaatgacatctggctaaatagcagcccttttacctcccttctgagcgaattgatccaaactggagtgcaagaaaccctgttgcagcctgtattcattcttgcttgcgaaagaagtgattctgtcctgcgtgtgctctgggaccagaggaccataagttctcagaatacttattgttaagggagctactacctatgatctgattaagtgtattgtctcagctttagtcaccagaaacaaacccaactggaaagtcccccagatacatacttacgatgtgatcttgaagccatgccatgcagttaggactgaagtgttagttccagccatgcaatgtcccggttagtctctgtagccccgaattcccaagtgtgacaagcaaagacagaggaagcagaaagatgaggaaatcgcatagtgtttttacctggaagctgtaggtaatgagtgttgttcaacagcatcagcattgaggcatgtacacagctgggaaaacaaaggcgataactaaaagtagcacgggcaggatgcacacggaaaggagatgtgtagcaatattcctacactgaaaggaagtgggcgatggcaaagataggtgaacgtttttaatgtggagagaagtactttatgggactaattgagatatacccatttcagtggataatatccgttcagagaaaactccagggggtctggtgctgatgtgttgttcctgccaaattcctacagtcacaatgctacacccagctccattcctaacctctgtagcattgttttctttgggtgctgagtgaagggtgtaagaggcaggtacactaaccattcagtttctgccttctcctccagtaaaagaactgtaatgataagggatttcttcacataaacatgagagcaatttattctgagaatctctacctatagttttgagggcttacacaagcttattcttggtaccacaggaatttggttaaatggaatttcctttgacatttgaatttggacttggttcttttttgttcaactgggattaacccattagttgacacttaatagctgtgtacatacctatgataaaaactagatatgaatacatatctcttaaaatacaagagacacagctgtacctacaagcaatacctaaagatcacaacataaaaaacactccacaaaaaacccaaaaccaaaacacaccaacagatcaaccaatgtattgtaattattttttaaactcaaagacattaagatctcaacatatggttatagttacatgccaaatcaagggtcttatgtctattccattcaataattaaaccataatattgagttatttggaaaaagacaattgaaatttaaaagtacattgttaaaatatattgtcgcaaatgtggaaaataggaagtgggtatgcataaaacaagagtcttgtttttaaaaatgggagcaagaaataagtcagatcgctaacccatatattgtttagtcatggaagcagcactatggctaatgtttttggcagcatctaagttctccagtgttttaaattctgtaaaagacacacccacaaggaaacacagtgaattcccaaaatgcaacagtgtctaatgaacttctgtagaatcatattgaagatcgattacttcagactcttcagatgtcaaggccttcacttgaggcttatgagcgatccctcactcatcttcatcttcaaaatgctgttgcgattgatgtggctccctaaagaagtaaaatggaaaattggctgccccacacccacaccgtcgtccgcaaatgacccctttggtttccacgtgtgatagcgaagcagaaagtcagagagtgggtggggggatgagttttggctaacgccatgctagttgtctggggaaaagggataatggggaaaaaaaatcacccagttgtgctacatttttaaagaaagagaaggttgtgtgcgtgtaccatttgccttttggagaataggccaatggaggaaggaagaagaggaagcaactatacaaagatctaggctgactgtcagggacgcagacgtgttcaatagagcatgtccaaaacactggaagaaaaacccttgaagggcccaggaagaaagtgattagcagagctcaggaatcttacactgtgtagaatgggttggtctcccaggtatgataagcctgtaattgtataacctatttatctcaatgcaaactgctatgaattcctacgacgtgccttttgtaaaattaacaagaagtcactcatccagagatgagaagaaaaaatcaatgctcggctactgtgctcactcagagatactatgaggctgtcagtacccacctacctaatatgccttttataatatatattcctctgaagagttatagctataattctcccaaggaaacacaaatatgtatatacatacattcttacaaggacacacacacacacatcccttgcagttacctttcttagaacataaagatttctctcataggatatgtttacatggggatatcagtttatgctttcaaactcaattggcctgtctactataaactgaactggcctgtctactattaatttagattctcagaacttaccatagcacctggatttctcaaacactaagcgtttgaaagacatcttagacctattcaaaactctctttagtttgttgattagaggaagtaacctggacaatgacttccttgaatgtagagcctgcccagcaaatgtagacacactttgtacaaattcagtggatgtctgtggaggcaaaccagccattggtggttctagctccttattgccaaagtgtcaatcatttcacacacttgttaacttcattcatgctttagatctctgctcctgtggcattcatagattgtatcccctgattttttgataatatcagcttctaagtggtctattaggttagttgaattcttctaataatcaatagacactcgttgattccctttgtgtgaatgtatttgactctttgggattttgaataaaattcataaaatgtggtgaggtcacaggtgggggctgcctcacacaaactactggaggggaaggtggggggggacagtattgatgctattcatagaattctcaggtggatacaagctgcccttggcatgccctgtaggttccatccacagccagggggatttgctgatgtaccagacttctcattatgtaaatcgtaagaggatcaacctggacattagttccacctgacctctgactgatggtttggaaaataagtttaattagaatcccttggccactgcggagaggaaaattaggctgatttctgtcccactgaaggataaaggaagacttaggccagcgcttccgcttgtcagaacatgttcaatgccatctcttttagtggaaattgactgtgagtctttaaattctaggagctttctttatgatatggctccaaaccagaacccaagtatatttagatattctccaacttctaccattgccttaaatgtagaagccaaacctgctctttttatggactttcagaatgggcataaagaatcacttgctgttaggttacagtagtgtcttgggactgtcctgagtccctttaggaagggaaggatctgcagctgcgtgagctgggaaagttgctaactggaaggaattagtgcccccccccacccccagccccaaggtccgggtttatatatttgaaaagatttaaaacgaaacttctgatgctcagaggaaggctgccgaatgtcaacgaatgactttaggttgaacaagcaccggctctattcttcataccctgtgttctagataacaccagacacaaggtctcagacttaacagactcagctctgttccaaggtgagtctgaaccagcaaaaagcaaacacatacagatatccaaacaagactgctcacgcaagccagggcttgctgcctgtctcgggcaacagcaccagggctcttgggagttcgtttaatatttactgagacttcggagacctagcagatgtttaatgaagtcactattttggctcaatctgccctcccccatctgttttgagaaaaaaaatttttttgaacaggtaaacataaaaatgaaagagagccacagaaggggatgggaaataaaattctctcaagactgctccagagtatgccatgtgattttgatgtgtcaggagtcgggggtgagaagacctatgtacctagtactttataaccaaagcaatcacaaggtcttggggtagggaatgttggccagttttgtttagtttttggaacaggtttttcgccagactcaccagcccatgtaaccagcaccggaaagaggaaacggagatgttcagagctcactggtgtgcgaatgataactactgacgaaagagctgtctgctcagtctgtggttggatgtagtcacacgagtctgcctttctgcatctctgtctccttagcaaggaggaacatttgggtcatggtgcaaggagtcctgagccagtgcgactgagaacacgtgtgtccatctctgcttctcggtcgcagagaaggagagaagctttggggattattagtagaaagagtgttataatattggtgctgagtggtatgtgtgcttttacaacttgttcttatattttaataaactttgaataaaagaatagagttacaaaaaaaaaaaaaaaaaaaaaaaaaaaa

SEQ ID NO: 41 - DNA, 1823 bp, Homo sapiens
gagaagctaggggtgaggaagccctggggcgctgccgccgctttccttaaccacaaatcaggccggacaggagagggaggggtgggggacagtgggtgggcattcagactgccagcactttgctatctacagccggggctcccgagcggcagaaagttccggccactctctgccgcttgggttgggcgaagccaggaccgtgccgcgccaccgccaggatatggagctactgtcgccaccgctccgcgacgtagacctgacggcccccgacggctctctctgctcctttgccacaacggacgacttctatgacgacccgtgtttcgactccccggacctgcgcttcttcgaagacctggacccgcgcctgatgcacgtgggcgcgctcctgaaacccgaagagcactcgcacttccccgcggcggtgcacccggccccgggcgcacgtgaggacgagcatgtgcgcgcgcccagcgggcaccaccaggcgggccgctgcctactgtgggcctgcaaggcgtgcaagcgcaagaccaccaacgccgaccgccgcaaggccgccaccatgcgcgagcggcgccgcctgagcaaagtaaatgaggcctttgagacactcaagcgctgcacgtcgagcaatccaaaccagcggttgcccaaggtggagatcctgcgcaacgccatccgctatatcgagggcctgcaggctctgctgcgcgaccaggacgccgcgccccctggcgccgcagccgccttctatgcgccgggcccgctgcccccgggccgcggcggcgagcactacagcggcgactccgacgcgtccagcccgcgctccaactgctccgacggcatgatggactacagcggccccccgagcggcgcccggcggcggaactgctacgaaggcgcctactacaacgaggcgcccagcgaacccaggcccgggaagagtgcggcggtgtcgagcctagactgcctgtccagcatcgtggagcgcatctccaccgagagccctgcggcgcccgccctcctgctggcggacgtgccttctgagtcgcctccgcgcaggcaagaggctgccgcccccagcgagggagagagcagcggcgaccccacccagtcaccggacgccgccccgcagtgccctgcgggtgcgaaccccaacccgatataccaggtgctctgaggggatggtggccgcccacccgcccgagggatggtgcccctagggtccctcgcgcccaaaagattgaacttaaatgcccccctcccaacagcgctttaaaagcgacctctcttgaggtaggagaggcgggagaactgaagtttccgcccccgccccacagggcaaggacacagcgcggttttttccacgcagcacccttctcggagacccattgcgatggccgctccgtgttcctcggtgggccagagctgaaccttgaggggctaggttcagctttctcgcgccctcccccatgggggtgagaccctcgcagacctaagccctgccccgggatgcaccggttatttgggggggcgtgagacccagtgcactccggtcccaaatgtagcaggtgtaaccgtaacccacccccaacccgtttcccggttcaggaccactttttgtaatacttttgtaatctattcctgtaaataagagttgctttgccagagcaggagcccctggggctgtatttatctctgaggcatggtgtgtggtgctacagggaatttgtacgtttataccgcaggcgggcgagccgcgggcgctcgctcaggtgatcaaaataaaggcgctaatttataaaaaaaaaaaaaaaaaa

SEQ ID NO: 42 - DNA, 2395 bp, Homo sapiens
agaggcaggggctggcctgggatgcgcgcgcacctgccctcgccccgccccgcccgcacgaggggtggtggccgaggccccgccccgcacgcctcgcctgaggcgggtccgctcagcccaggcgcccgcccccgcccccgccgattaaatgggccggcggggctcagcccccggaaacggtcgtacacttcggggctgcgagcgcggagggcgacgacgacgaagcgcagacagcgtcatggcagagcaggtggccctgagccggacccaggtgtgcgggatcctgcgggaagagcttttccagggcgatgccttccatcagtcggatacacacatattcatcatcatgggtgcatcgggtgacctggccaagaagaagatctaccccaccatctggtggctgttccgggatggccttctgcccgaaaacaccttcatcgtgggctatgcccgttcccgcctcacagtggctgacatccgcaaacagagtgagcccttcttcaaggccaccccagaggagaagctcaagctggaggacttctttgcccgcaactcctatgtggctggccagtacgatgatgcagcctcctaccagcgcctcaacagccacatgaatgccctccacctggggtcacaggccaaccgcctcttctacctggccttgcccccgaccgtctacgaggccgtcaccaagaacattcacgagtcctgcatgagccagataggctggaaccgcatcatcgtggagaagcccttcgggagggacctgcagagctctgaccggctgtccaaccacatctcctccctgttccgtgaggaccagatctaccgcatcgaccactacctgggcaaggagatggtgcagaacctcatggtgctgagatttgccaacaggatcttcggccccatctggaaccgggacaacatcgcctgcgttatcctcaccttcaaggagccctttggcactgagggtcgcgggggctatttcgatgaatttgggatcatccgggacgtgatgcagaaccacctactgcagatgctgtgtctggtggccatggagaagcccgcctccaccaactcagatgacgtccgtgatgagaaggtcaaggtgttgaaatgcatctcagaggtgcaggccaacaatgtggtcctgggccagtacgtggggaaccccgatggagagggcgaggccaccaaagggtacctggacgaccccacggtgccccgcgggtccaccaccgccacttttgcagccgtcgtcctctatgtggagaatgagaggtgggatggggtgcccttcatcctgcgctgcggcaaggccctgaacgagcgcaaggccgaggtgaggctgcagttccatgatgtggccggcgacatcttccaccagcagtgcaagcgcaacgagctggtgatccgcgtgcagcccaacgaggccgtgtacaccaagatgatgaccaagaagccgggcatgttcttcaaccccgaggagtcggagctggacctgacctacggcaacagatacaagaacgtgaagctccctgacgcctacgagcgcctcatcctggacgtcttctgcgggagccagatgcacttcgtgcgcagcgacgagctccgtgaggcctggcgtattttcaccccactgctgcaccagattgagctggagaagcccaagcccatcccctatatttatggcagccgaggccccacggaggcagacgagctgatgaagagagtgggtttccagtatgagggcacctacaagtgggtgaacccccacaagctctgagccctgggcacccacctccacccccgccacggccaccctccttcccgccgcccgaccccgagtcgggaggactccgggaccattgacctcagctgcacattcctggccccgggctctggccaccctggcccgcccctcgctgctgctactacccgagcccagctacattcctcagctgccaagcactcgagaccatcctggcccctccagaccctgcctgagcccaggagctgagtcacctcctccactcactccagcccaacagaaggaaggaggagggcgcccattcgtctgtcccagagcttattggccactgggtctcactcctgagtggggccagggtgggagggagggacaagggggaggaaaggggcgagcacccacgtgagagaatctgcctgtggccttgcccgccagcctcagtgccacttgacattccttgtcaccagcaacatctcgagccccctggatgtcccctgtcccaccaactctgcactccatggccaccccgtgccacccgtaggcagcctctctgctataagaaaagcagacgcagcagctgggacccctcccaacctcaatgccctgccattaaatccgcaaacagcc

SEQ ID NO: 43 - DNA, 4872 bp, Homo sapiens
tattcagatattctccagattcctaaagattagagatcatttctcattctcctaggagtactcacttcaggaagcaaccagataaaagagaggtgcaacggaagccagaacattcctcctggaaattcaacctgtttcgcagtttctcgaggaatcagcattcagtcaatccgggccgggagcagtcatctgtggtgaggctgattggctgggcaggaacagcgccggggcgtgggctgagcacagccgcttcgctctctttgccacaggaagcctgagctcattcgagtagcggctcttccaagctcaaagaagcagaggccgctgttcgtttcctttaggtctttccactaaagtcggagtatcttcttccaaaatttcacgtcttggtggccgttccaaggagcgcgaggtcggaatggatcttgaaggggaccgcaatggaggagcaaagaagaagaacttttttaaactgaacaataaaagtgaaaaagataagaaggaaaagaaaccaactgtcagtgtattttcaatgtttcgctattcaaattggcttgacaagttgtatatggtggtgggaactttggctgccatcatccatggggctggacttcctctcatgatgctggtgtttggagaaatgacagatatctttgcaaatgcaggaaatttagaagatctgatgtcaaacatcactaatagaagtgatatcaatgatacagggttcttcatgaatctggaggaagacatgaccaggtatgcctattattacagtggaattggtgctggggtgctggttgctgcttacattcaggtttcattttggtgcctggcagctggaagacaaatacacaaaattagaaaacagttttttcatgctataatgcgacaggagataggctggtttgatgtgcacgatgttggggagcttaacacccgacttacagatgatgtctccaagattaatgaaggaattggtgacaaaattggaatgttctttcagtcaatggcaacatttttcactgggtttatagtaggatttacacgtggttggaagctaacccttgtgattttggccatcagtcctgttcttggactgtcagctgctgtctgggcaaagatactatcttcatttactgataaagaactcttagcgtatgcaaaagctggagcagtagctgaagaggtcttggcagcaattagaactgtgattgcatttggaggacaaaagaaagaacttgaaaggtacaacaaaaatttagaagaagctaaaagaattgggataaagaaagctattacagccaatatttctataggtgctgctttcctgctgatctatgcatcttatgctctggccttctggtatgggaccaccttggtcctctcaggggaatattctattggacaagtactcactgtattcttttctgtattaattggggcttttagtgttggacaggcatctccaagcattgaagcatttgcaaatgcaagaggagcagcttatgaaatcttcaagataattgataataagccaagtattgacagctattcgaagagtgggcacaaaccagataatattaagggaaatttggaattcagaaatgttcacttcagttacccatctcgaaaagaagttaagatcttgaagggtctgaacctgaaggtgcagagtgggcagacggtggccctggttggaaacagtggctgtgggaagagcacaacagtccagctgatgcagaggctctatgaccccacagaggggatggtcagtgttgatggacaggatattaggaccataaatgtaaggtttctacgggaaatcattggtgtggtgagtcaggaacctgtattgtttgccaccacgatagctgaaaacattcgctatggccgtgaaaatgtcaccatggatgagattgagaaagctgtcaaggaagccaatgcctatgactttatcatgaaactgcctcataaatttgacaccctggttggagagagaggggcccagttgagtggtgggcagaagcagaggatcgccattgcacgtgccctggttcgcaaccccaagatcctcctgctggatgaggccacgtcagccttggacacagaaagcgaagcagtggttcaggtggctctggataaggccagaaaaggtcggaccaccattgtgatagctcatcgtttgtctacagttcgtaatgctgacgtcatcgctggtttcgatgatggagtcattgtggagaaaggaaatcatgatgaactcatgaaagagaaaggcatttacttcaaacttgtcacaatgcagacagcaggaaatgaagttgaattagaaaatgcagctgatgaatccaaaagtgaaattgatgccttggaaatgtcttcaaatgattcaagatccagtctaataagaaaaagatcaactcgtaggagtgtccgtggatcacaagcccaagacagaaagcttagtaccaaagaggctctggatgaaagtatacctccagtttccttttggaggattatgaagctaaatttaactgaatggccttattttgttgttggtgtattttgtgccattataaatggaggcctgcaaccagcatttgcaataatattttcaaagattataggggtttttacaagaattgatgatcctgaaacaaaacgacagaatagtaacttgttttcactattgtttctagcccttggaattatttcttttattacatttttccttcagggtttcacatttggcaaagctggagagatcctcaccaagcggctccgatacatggttttccgatccatgctcagacaggatgtgagttggtttgatgaccctaaaaacaccactggagcattgactaccaggctcgccaatgatgctgctcaagttaaaggggctataggttccaggcttgctgtaattacccagaatatagcaaatcttgggacaggaataattatatccttcatctatggttggcaactaacactgttactcttagcaattgtacccatcattgcaatagcaggagttgttgaaatgaaaatgttgtctggacaagcactgaaagataagaaagaactagaaggttctgggaagatcgctactgaagcaatagaaaacttccgaaccgttgtttctttgactcaggagcagaagtttgaacatatgtatgctcagagtttgcaggtaccatacagaaactctttgaggaaagcacacatctttggaattacattttccttcacccaggcaatgatgtatttttcctatgctggatgtttccggtttggagcctacttggtggcacataaactcatgagctttgaggatgttctgttagtattttcagctgttgtctttggtgccatggccgtggggcaagtcagttcatttgctcctgactatgccaaagccaaaatatcagcagcccacatcatcatgatcattgaaaaaacccctttgattgacagctacagcacggaaggcctaatgccgaacacattggaaggaaatgtcacatttggtgaagttgtattcaactatcccacccgaccggacatcccagtgcttcagggactgagcctggaggtgaagaagggccagacgctggctctggtgggcagcagtggctgtgggaagagcacagtggtccagctcctggagcggttctacgaccccttggcagggaaagtgctgcttgatggcaaagaaataaagcgactgaatgttcagtggctccgagcacacctgggcatcgtgtcccaggagcccatcctgtttgactgcagcattgctgagaacattgcctatggagacaacagccgggtggtgtcacaggaagagattgtgagggcagcaaaggaggccaacatacatgccttcatcgagtcactgcctaataaatatagcactaaagtaggagacaaaggaactcagctctctggtggccagaaacaacgcattgccatagctcgtgcccttgttagacagcctcatattttgcttttggatgaagccacgtcagctctggatacagaaagtgaaaaggttgtccaagaagccctggacaaagccagagaaggccgcacctgcattgtgattgctcaccgcctgtccaccatccagaatgcagacttaatagtggtgtttcagaatggcagagtcaaggagcatggcacgcatcagcagctgctggcacagaaaggcatctatttttcaatggtcagtgtccaggctggaacaaagcgccagtgaactctgactgtatgagatgttaaatactttttaatatttgtttagatatgacatttattcaaagttaaaagcaaacacttacagaattatgaagaggtatctgtttaacatttcctcagtcaagttcagagtcttcagagacttcgtaattaaaggaacagagtgagagacatcatcaagtggagagaaatcatagtttaaactgcattataaattttataacagaattaaagtagattttaaaagataaaatgtgtaattttgtttatattttcccatttggactgtaactgactgccttgctaaaagattatagaagtagcaaaaagtattgaaatgtttgcataaagtgtctataataaaactaaactttcatgtgactggagtcatcttgtccaaactgcctgtgaatatatcttctctcaattggaatattgtagataacttctgctttaaaaaagttttctttaaatatacctactcatttttgtgggaatggttaagcagtttaaataattcctgttgtatatgtctattcacattgggtcttacagaaccatctggcttcattcttcttggacttgatcctgctgattcttgcatttccacat

SEQ ID NO: 44 - DNA, 2768 bp, Homo sapiens
cactgctgtgcagggcaggaaagctccatgcacatagcccagcaaagagcaacacagagctgaaaggaagactcagaggagagagataagtaaggaaagtagtgatggctctcatcccagacttggccatggaaacctggcttctcctggctgtcagcctggtgctcctctatctatatggaacccattcacatggactttttaagaagcttggaattccagggcccacacctctgccttttttgggaaatattttgtcctaccataagggcttttgtatgtttgacatggaatgtcataaaaagtatggaaaagtgtggggcttttatgatggtcaacagcctgtgctggctatcacagatcctgacatgatcaaaacagtgctagtgaaagaatgttattctgtcttcacaaaccggaggccttttggtccagtgggatttatgaaaagtgccatctctatagctgaggatgaagaatggaagagattacgatcattgctgtctccaaccttcaccagtggaaaactcaaggagatggtccctatcattgcccagtatggagatgtgttggtgagaaatctgaggcgggaagcagagacaggcaagcctgtcaccttgaaagacgtctttggggcctacagcatggatgtgatcactagcacatcatttggagtgaacatcgactctctcaacaatccacaagacccctttgtggaaaacaccaagaagcttttaagatttgattttttggatccattctttctctcaataacagtctttccattcctcatcccaattcttgaagtattaaatatctgtgtgtttccaagagaagttacaaattttttaagaaaatctgtaaaaaggatgaaagaaagtcgcctcgaagatacacaaaagcaccgagtggatttccttcagctgatgattgactctcagaattcaaaagaaactgagtcccacaaagctctgtccgatctggagctcgtggcccaatcaattatctttatttttgctggctatgaaaccacgagcagtgttctctccttcattatgtatgaactggccactcaccctgatgtccagcagaaactgcaggaggaaattgatgcagttttacccaataaggcaccacccacctatgatactgtgctacagatggagtatcttgacatggtggtgaatgaaacgctcagattattcccaattgctatgagacttgagagggtctgcaaaaaagatgttgagatcaatgggatgttcattcccaaaggggtggtggtgatgattccaagctatgctcttcaccgtgacccaaagtactggacagagcctgagaagttcctccctgaaagattcagcaagaagaacaaggacaacatagatccttacatatacacaccctttggaagtggacccagaaactgcattggcatgaggtttgctctcatgaacatgaaacttgctctaatcagagtccttcagaacttctccttcaaaccttgtaaagaaacacagatccccctgaaattaagcttaggaggacttcttcaaccagaaaaacccgttgttctaaaggttgagtcaagggatggcaccgtaagtggagcctgaattttcctaaggacttctgctttgctcttcaagaaatctgtgcctgagaacaccagagacctcaaattactttgtgaatagaactctgaaatgaagatgggcttcatccaatggactgcataaataaccggggattctgtacatgcattgagctctctcattgtctgtgtagagtgttatacttgggaatataaaggaggtgaccaaatcagtgtgaggaggtagatttggctcctctgcttctcacgggactatttccaccacccccagttagcaccattaactcctcctgagctctgataagagaatcaacatttctcaataatttcctccacaaattattaatgaaaataagaattattttgatggctctaacaatgacatttatatcacatgttttctctggagtattctataagttttatgttaaatcaataaagaccactttacaaaagtattatcagatgctttcctgcacattaaggagaaatctatagaactgaatgagaaccaacaagtaaatatttttggtcattgtaatcactgttggcgtggggcctttgtcagaactagaatttgattattaacataggtgaaagttaatccactgtgactttgcccattgtttagaaagaatattcatagtttaattatgccttttttgatcaggcacagtggctcacgcctgtaatcctagcagtttgggaggctgagccgggtggatcgcctgaggtcaggagttcaagacaagcctggcctacatggttgaaaccccatctctactaaaaatacacaaattagctaggcatggtggactcgcctgtaatctcactacacaggaggctgaggcaggagaatcacttgaacctgggaggcggatgttgaagtgagctgagattgcaccactgcactccagtctgggtgagagtgagactcagtcttaaaaaaatatgcctttttgaagcacgtacattttgtaacaaagaactgaagctcttattatattattagttttgatttaatgttttcagcccatctcctttcatatttctgggagacagaaaacatgtttccctacacctcttgcattccatcctcaacacccaactgtctcgatgcaatgaacacttaataaaaaacagtcgattggtc

SEQ ID NO: 45 - DNA, 1669 bp, Homo sapiens
ctccctcagcaaggacagcagaggaccagctaagagggagagaagcaactacagaccccccctgaaaacaaccctcagacgccacatcccctgacaagctgccaggcaggttctcttcctctcacatactgacccacggctccaccctctctcccctggaaaggacaccatgagcactgaaagcatgatccgggacgtggagctggccgaggaggcgctccccaagaagacaggggggccccagggctccaggcggtgcttgttcctcagcctcttctccttcctgatcgtggcaggcgccaccacgctcttctgcctgctgcactttggagtgatcggcccccagagggaagagttccccagggacctctctctaatcagccctctggcccaggcagtcagatcatcttctcgaaccccgagtgacaagcctgtagcccatgttgtagcaaaccctcaagctgaggggcagctccagtggctgaaccgccgggccaatgccctcctggccaatggcgtggagctgagagataaccagctggtggtgccatcagagggcctgtacctcatctactcccaggtcctcttcaagggccaaggctgcccctccacccatgtgctcctcacccacaccatcagccgcatcgccgtctcctaccagaccaaggtcaacctcctctctgccatcaagagcccctgccagagggagaccccagagggggctgaggccaagccctggtatgagcccatctatctgggaggggtcttccagctggagaagggtgaccgactcagcgctgagatcaatcggcccgactatctcgactttgccgagtctgggcaggtctactttgggatcattgccctgtgaggaggacgaacatccaaccttcccaaacgcctcccctgccccaatccctttattaccccctccttcagacaccctcaacctcttctggctcaaaaagagaattgggggcttagggtcggaacccaagcttagaactttaagcaacaagaccaccacttcgaaacctgggattcaggaatgtgtggcctgcacagtgaagtgctggcaaccactaagaattcaaactggggcctccagaactcactggggcctacagctttgatccctgacatctggaatctggagaccagggagcctttggttctggccagaatgctgcaggacttgagaagacctcacctagaaattgacacaagtggaccttaggccttcctctctccagatgtttccagacttccttgagacacggagcccagccctccccatggagccagctccctctatttatgtttgcacttgtgattatttattatttatttattatttatttatttacagatgaatgtatttatttgggagaccggggtatcctgggggacccaatgtaggagctgccttggctcagacatgttttccgtgaaaacggagctgaacaataggctgttcccatgtagccccctggcctctgtgccttcttttgattatgttttttaaaatatttatctgattaagttgtctaaacaatgctgatttggtgaccaactgtcactcattgctgagcctctgctccccaggggagttgtgtctgtaatcgccctactattcagtggcgagaaataaagtttgcttagaaaagaa

SEQ ID NO: 46 - DNA, 1240 bp, Homo sapiens
cacattgttctgatcatctgaagatcagctattagaagagaaagatcagttaagtcctttggacctgatcagcttgatacaagaactactgatttcaacttctttggcttaattctctcggaaacgatgaaatatacaagttatatcttggcttttcagctctgcatcgttttgggttctcttggctgttactgccaggacccatatgtaaaagaagcagaaaaccttaagaaatattttaatgcaggtcattcagatgtagcggataatggaactcttttcttaggcattttgaagaattggaaagaggagagtgacagaaaaataatgcagagccaaattgtctccttttacttcaaactttttaaaaactttaaagatgaccagagcatccaaaagagtgtggagaccatcaaggaagacatgaatgtcaagtttttcaatagcaacaaaaagaaacgagatgacttcgaaaagctgactaattattcggtaactgacttgaatgtccaacgcaaagcaatacatgaactcatccaagtgatggctgaactgtcgccagcagctaaaacagggaagcgaaaaaggagtcagatgctgtttcgaggtcgaagagcatcccagtaatggttgtcctgcctgcaatatttgaattttaaatctaaatctatttattaatatttaacattatttatatggggaatatatttttagactcatcaatcaaataagtatttataatagcaacttttgtgtaatgaaaatgaatatctattaatatatgtattatttataattcctatatcctgtgactgtctcacttaatcctttgttttctgactaattaggcaaggctatgtgattacaaggctttatctcaggggccaactaggcagccaacctaagcaagatcccatgggttgtgtgtttatttcacttgatgatacaatgaacacttataagtgaagtgatactatccagttactgccggtttgaaaatatgcctgcaatctgagccagtgctttaatggcatgtcagacagaacttgaatgtgtcaggtgaccctgatgaaaacatagcatctcaggagatttcatgcctggtgcttccaaatattgttgacaactgtgactgtacccaaatggaaagtaactcatttgttaaaattatcaatatctaatatatatgaataaagtgtaagttcacaacaaaaaaaaaaaaaaaaaaaaaaaaaaaaaa

SEQ ID NO: 47 - DNA, 1972 bp, Homo sapiens
gaaactcccgcctggccaccataaaagcgccggccctccgcttccccgcgagacgaaacttcccgtcccggcggctctggcacccagggtccggcctgcgccttcccgccaggcctggacactggttcaacacctgtgacttcatgtgtgcgcgccggccacacctgcagtcacacctgtagccccctctgccaagagatccataccgaggcagcgtcggtggctacaagccctcagtccacacctgtggacacctgtgacacctggccacacgacctgtggccgcggcctggcgtctgctgcgacaggagcccttacctcccctgttataacacctgaccgccacctaactgcccctgcagaaggagcaatggccttggctcctgagagggcagccccacgcgtgctgttcggagagtggctccttggagagatcagcagcggctgctatgaggggctgcagtggctggacgaggcccgcacctgtttccgcgtgccctggaagcacttcgcgcgcaaggacctgagcgaggccgacgcgcgcatcttcaaggcctgggctgtggcccgcggcaggtggccgcctagcagcaggggaggtggcccgccccccgaggctgagactgcggagcgcgccggctggaaaaccaacttccgctgcgcactgcgcagcacgcgtcgcttcgtgatgctgcgggataactcgggggacccggccgacccgcacaaggtgtacgcgctcagccgggagctgtgctggcgagaaggcccaggcacggaccagactgaggcagaggcccccgcagctgtcccaccaccacagggtgggcccccagggccattcctggcacacacacatgctggactccaagccccaggccccctccctgccccagctggtgacaagggggacctcctgctccaggcagtgcaacagagctgcctggcagaccatctgctgacagcgtcatggggggcagatccagtcccaaccaaggctcctggagagggacaagaagggcttcccctgactggggcctgtgctggaggcccagggctccctgctggggagctgtacgggtgggcagtagagacgacccccagccccgggccccagcccgcggcactaacgacaggcgaggccgcggccccagagtccccgcaccaggcagagccgtacctgtcaccctccccaagcgcctgcaccgcggtgcaagagcccagcccaggggcgctggacgtgaccatcatgtacaagggccgcacggtgctgcagaaggtggtgggacacccgagctgcacgttcctatacggccccccagacccagctgtccgggccacagacccccagcaggtagcattccccagccctgccgagctcccggaccagaagcagctgcgctacacggaggaactgctgcggcacgtggcccctgggttgcacctggagcttcgggggccacagctgtgggcccggcgcatgggcaagtgcaaggtgtactgggaggtgggcggacccccaggctccgccagcccctccaccccagcctgcctgctgcctcggaactgtgacacccccatcttcgacttcagagtcttcttccaagagctggtggaattccgggcacggcagcgccgtggctccccacgctataccatctacctgggcttcgggcaggacctgtcagctgggaggcccaaggagaagagcctggtcctggtgaagctggaaccctggctgtgccgagtgcacctagagggcacgcagcgtgagggtgtgtcttccctggatagcagcagcctcagcctctgcctgtccagcgccaacagcctctatgacgacatcgagtgcttccttatggagctggagcagcccgcctagaacccagtctaatgagaactccagaaagctggagcagcccacctagagctggccgcggccgcccagtctaataaaaagaactccagaaca

SEQ ID NO: 48 - DNA, 13 bp, Artificial Sequence
  Synthetic DNA
aggtcanaggtca

SEQ ID NO: 49 - DNA, 11 bp, Artificial Sequence
  Synthetic DNA
gaggcngaggc

SEQ ID NO: 50 - DNA, 88 bp, Bos taurus
ataactgtcctttcacctggcagctgtccagccctcaaatagctcttgtgtttggtccaaaaataagatcacatgagaaggggagaaa

SEQ ID NO: 51 - DNA, 87 bp, Unknown
  Canis species
acaccggtcctttcgcctggcagctgtccagcccccaaatagcttttgtgtccattccaaaaataagatcacatgagaggggagaaa

SEQ ID NO: 52 - DNA, 88 bp, Unknown
  Equus species
agaactgccctttcacctggcagctctccagcccgcaaatagcttttgtgtccagtccaaaaataagatcacatgaaagggggagaaa

SEQ ID NO: 53 - DNA, 88 bp, Pan troglodytes
atcattgtcctttcacctggcagctgtccagcccccaaatagcttttgtgtccagtccaaaaataagatcacatgagagggggagaaa

SEQ ID NO: 54 - DNA, 88 bp, Homo sapiens
atcactgtcctttcacctggcagctgtccagcccccaaatagcttttgtgtccagtccaaaaataagatcacatgagagggggagaaa

SEQ ID NO: 55 - DNA, 88 bp, Unknown; identical to SEQ ID NO: 53
  Pongo species

SEQ ID NO: 56 - DNA, 84 bp, Unknown
  Rattus species
atatttagcctttcacctggcagctatccagcccccaaatagcctgcgtgtctaatccaaaaataaatcacatgagaggaaaaa

SEQ ID NO: 57 - DNA, 84 bp, Mus musculus
atatttgtcctttcacctggcagctgtccagcccccaaatagcctgcgtgtctaatccaaaaataaatcacacgagaggggaaa

SEQ ID NO: 58 - DNA, 86 bp, Trichosurus vulpecula
atgtttgtccttttatctggctgatttccagcccccaaatagctcttatgtctactccaaaaataagatcacatgaaggggaaaaa